(19) United States
(12) Patent Application Publication
(10) Pub. No.: US 2006/0211040 A1
(43) Pub. Date: Sep. 21, 2006

(54) Crystal structure of chorismate synthase and uses thereof

(76) Inventors: William Ure Primrose, Cambridge (GB); John Kinnaird Maclean, Kilmarnock (GB); Sohai Tahir Ali, Glasgow (GB)

Correspondence Address: BROWN, RAYSMAN, MILLSTEIN, FELDER & STEINER LLP, 900 THIRD AVENUE, NEW YORK, NY, 10022, US

(21) Appl. No.: 10/529,196

(22) PCT Filed: Sep. 26, 2003
(86) PCT No.: PCT/GB03/04104

§ 371 Date: Oct. 28, 2005

(30) Foreign Application Priority Data
Sep. 27, 2002 (GB) 0222479.8

(51) Int. Cl. G06F 19/00

(52) U.S. Cl. 435/7.1; 702/19

(57) ABSTRACT

The invention describes the identification of the structure coordinates for the enzyme Chorismate Synthase. There is a computer programmed to produce a three-dimensional representation of a molecule or molecular complex, wherein the molecule or molecular complex comprises a binding domain defined by the structure coordinates of (a) Arg 39, His 110, Ser 132, Thr 136, Lys 254, Gly 297, Lys 311, Thr 315, Arg 337 and Asp 339; or (b) Ser 9, His 10, Arg 39, Asp 54, Arg 107, His 110, Ser 132, Ala 133, Arg 134, Thr 136, Arg 337 and Asp 339. 1, or where the molecular complex or binding domain has a root mean square deviation of conserved residue backbone atoms of less than 2 A when superimposed on the relevant backbone atoms described by the structure coordinates of said amino acids.

### FIELD OF THE INVENTION

The present invention relates to the identification of inhibitors of pathogenic organisms for treating bacterial, fungal and parasitic infections.

### BACKGROUND OF THE INVENTION

Chorismate Synthase (CS) catalyses the seventh and final step in the Shikimate biosynthetic pathway. The product of the reaction catalysed by CS is the precursor for several biosynthetic pathways, leading to the production of the aromatic amino acids and other vital metabolites. The Shikimate pathway has been identified in bacteria, plants, fungi and apicomplexan parasites, but is not present in animals. For this reason, enzymes of the pathway are well known and validated targets for the generation of anti-infectives, anti-fungals and herbicides, and have been proposed as viable anti-parasitic targets. CS is particularly attractive as an anti-infective target as it sits at the branch point of the Shilkimate Pathway, and the product, Chorismic Acid, is the precursor for five distinct subsequent pathways. Significantly, one of these branches leads to the Folate Pathway. The enzymes of the Folate pathway are also absent in animals and several of them are very well characterised anti-infective targets exploited by existing anti-infective agents.

CS catalyses the conversion of 5-Enolpyruvyl-3-Shikimate Phosphate (EPSP) to Chorismic Acid (Chorismate), via the 1,4-anti-elimination of phosphate. The stereochemistry of this reaction is unique in nature. A further extremely unusual aspect of the CS enzyme is the absolute requirement for reduced Flavin Mononucleotide (FMN) for activity, the reaction involving no overall change in redox state. Although this suggests that the FMN fulfils a purely structural role, there is evidence that FMN is in fact involved in the reaction mechanism (Ramjee et al, J. Am. Chem. Soc., 1991, Vol 113, p 8566-8567; Macheroux et al, J. Biol. Chem., 1996, Vol 271, p 25850-25858; and Macheroux et al, Planta, 1999, Vol 207, p 325-334).

### SUMMARY OF THE INVENTION

The present invention is based on the identification of the structure coordinates for Chorismate Synthase, in particular the identification of the coordinates for two binding domains in Chorismate Synthase.

Agents may be produced, based on the structure coordinates, that will interact with either or both of these two binding domains.

According to a first aspect of the invention, a computer is programmed to produce a three-dimensional representation of a molecule or molecular complex, wherein the molecule or molecular complex comprises a binding domain defined by the structure coordinates of
(a) Arg 39, His 110, Ser 132, Thr 136, Lys 254, Gly 297, Lys 311, Thr 315, Arg 337 and Asp 339 according to FIG. 1; or
(b) Ser 9, His 10, Arg 39, Asp 54, Arg 107, His 110, Ser 132, Ala 133, Arg 134, Thr 136, Arg 337 and Asp 339 according to FIG. 1,
   or where the molecular complex or binding domain has a root mean square deviation of conserved residue backbone atoms of less than 2 Å when superimposed on the relevant backbone atoms described by the structure coordinates of said amino acids.

According to a second aspect of the invention, a method for identifying the potential of a chemical entity to associate with Chorismate Synthase enzyme comprises the steps of:
a) applying computational means to perform a fitting operation between the chemical entity and the Chorismate Synthase binding domain defined by the structure coordinates of either or both of:
   (a) Arg 39, His 110, Ser 132, Thr 136, Lys 254, Gly 297, Lys 311, Thr 315, Arg 337 and Asp 339 according to FIG. 1; or
   (b) Ser 9, His 10, Arg 39, Asp 54, Arg 107, His 110, Ser 132, Ala 133, Arg 134, Thr 136, Arg 337 and Asp 339 according to FIG. 1; and
b) analysing the results of the fitting operation to quantify the association.

According to a third aspect of the invention, a method for identifying a potential inhibitor/agent which will bind to a molecule comprising a Chorismate Synthase binding domain comprises the steps of:
(a) using the atomic coordinates of
   (a) Arg 39, His 110, Ser 132, Thr 136, Lys 254, Gly 297, Lys 311, Thr 315, Arg 337 and Asp 339 according to FIG. 1; or
   (b) Ser 9, His 10, Arg 39, Asp 54, Arg 107, His 110, Ser 132, Ala 133, Arg 134, Thr 136, Arg 337 and Asp 339 according to FIG. 1, to generate a three-dimensional structure of a molecule comprising a Chorismate Synthase binding domain;
b) employing the three-dimensional structure to design or select the inhibitor/agent;
c) synthesising the inhibitor/agent; and
d) contacting the inhibitor/agent with the molecule to determine the ability of the inhibitor/agent to interact with the molecule.

According to a fourth aspect of the invention, there is a crystal of the Chorismate Synthase molecule containing the binding domain of Chorismate Synthase, wherein the binding domain has a three-dimensional structure characterised by the atomic structure coordinates of FIG. 1.

### DESCRIPTION OF THE FIGURES

The invention is described with reference to the accompanying figures, wherein:

FIG. 1 indicates the structure coordinates of the SpCS-FMN-EPSP complex;

FIG. 2 shows the sequence alignment for Chroismate Synthase from pathogenic bacteria, fungi plants and apicomplexan parasites;

FIG. 3(a) shows the topology of Chorisome Synthase, with α-Helices indicated as dark rectangles and β-Sheets as light arrows; and

FIG. 3(b) shows the sequence alignment of four gram +ve (top) and four gram −ve (bottom) pathogens with the CS secondary structure elements superimposed, using the same colour scheme as in FIG. 3(a) and numbering based on the sequence of S. pneumoniae CS.

### DETAILED DESCRIPTION OF THE INVENTION

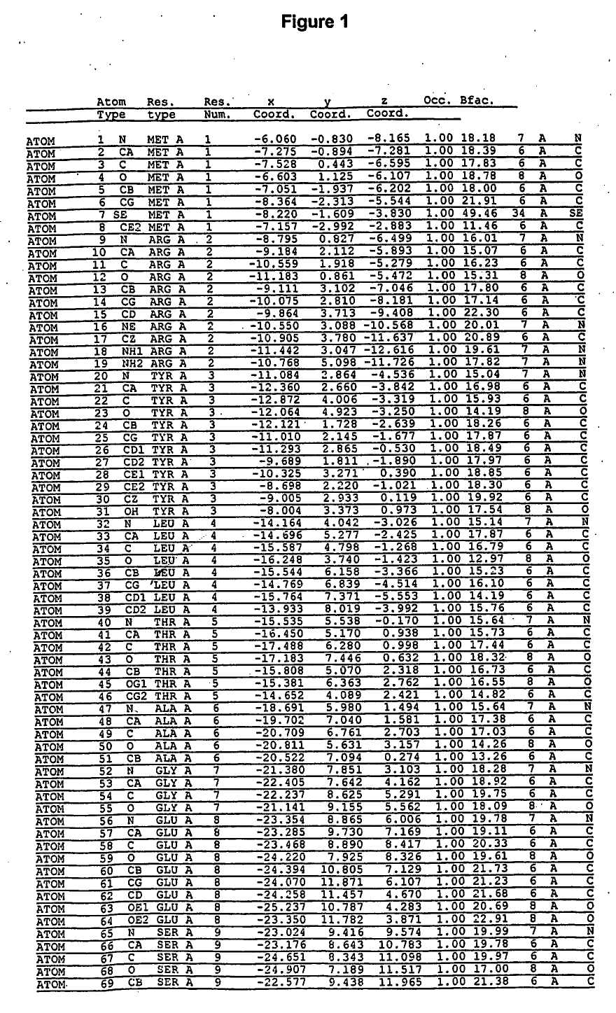

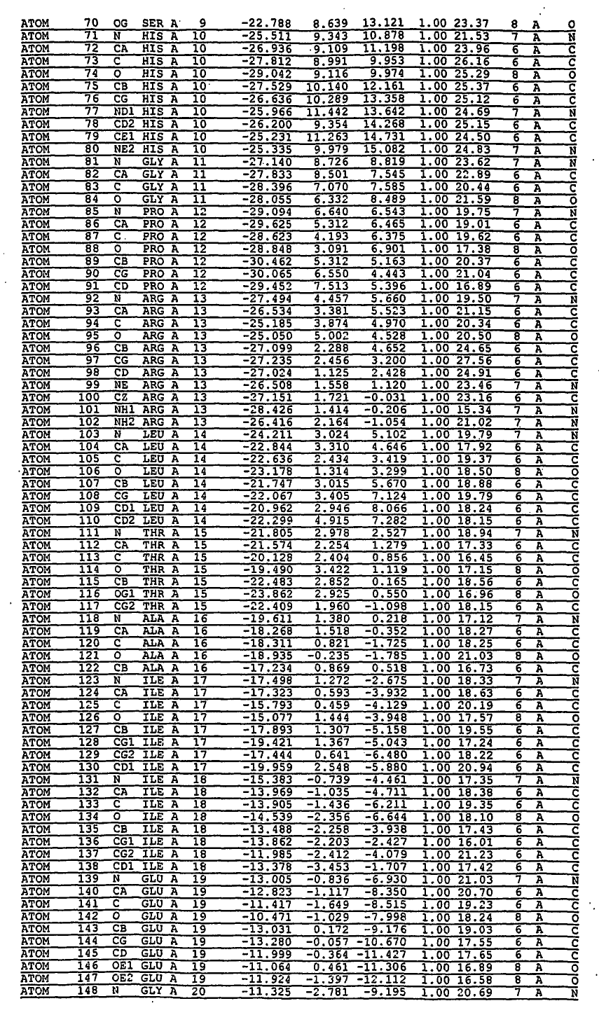

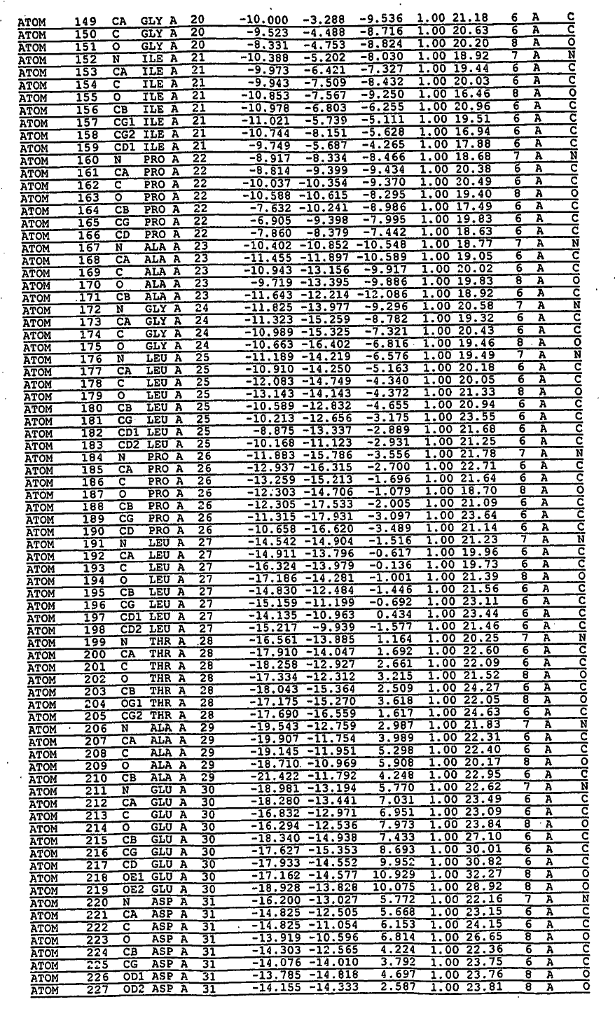

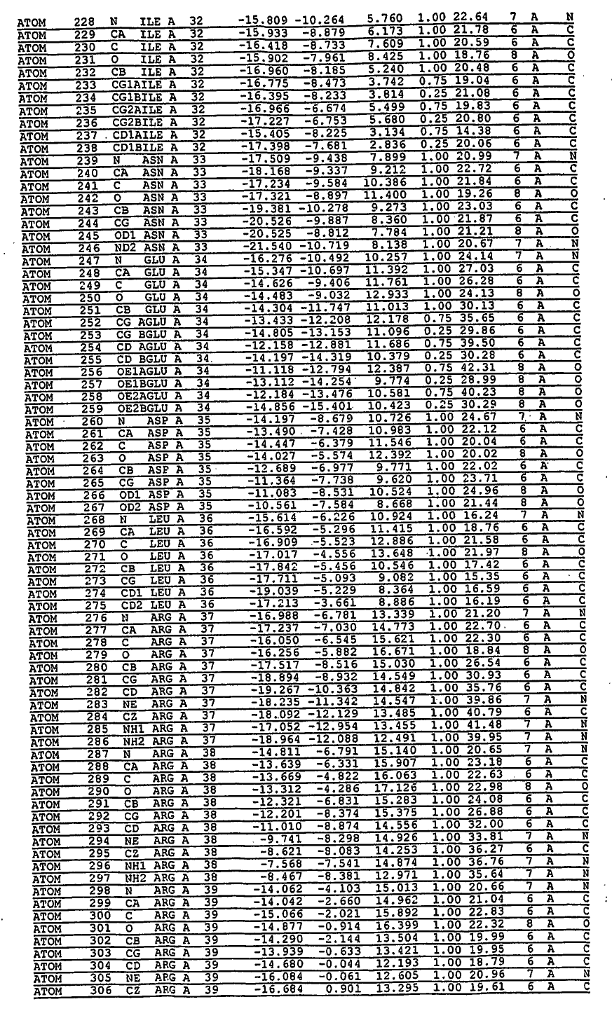

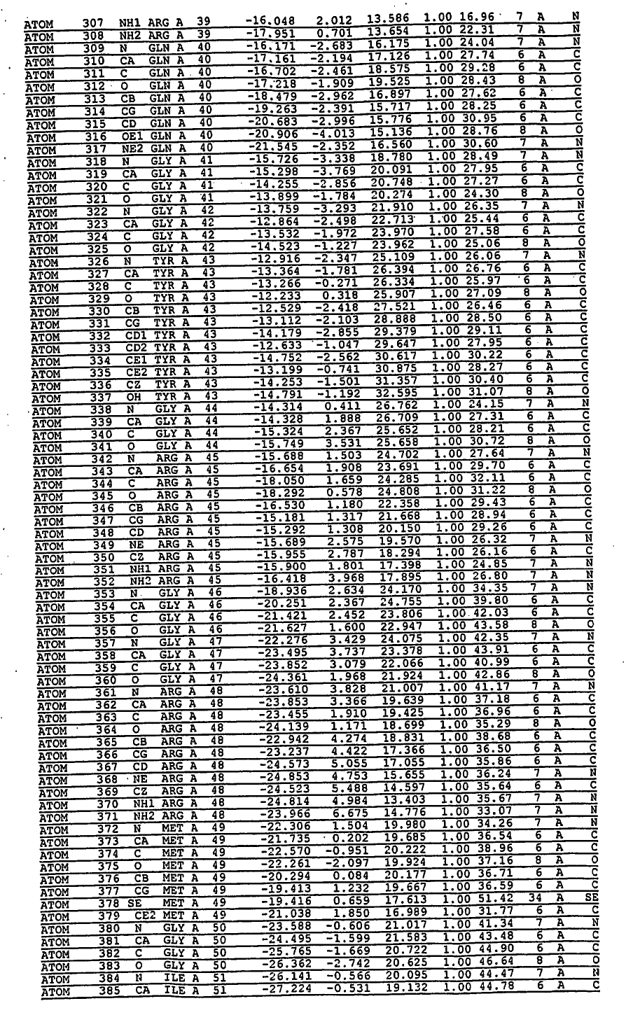

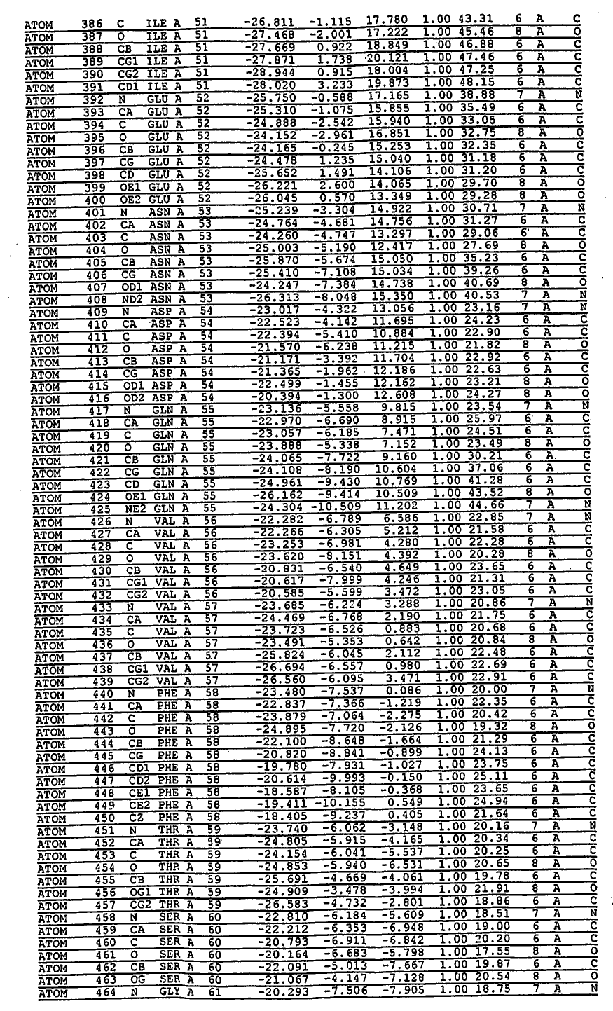

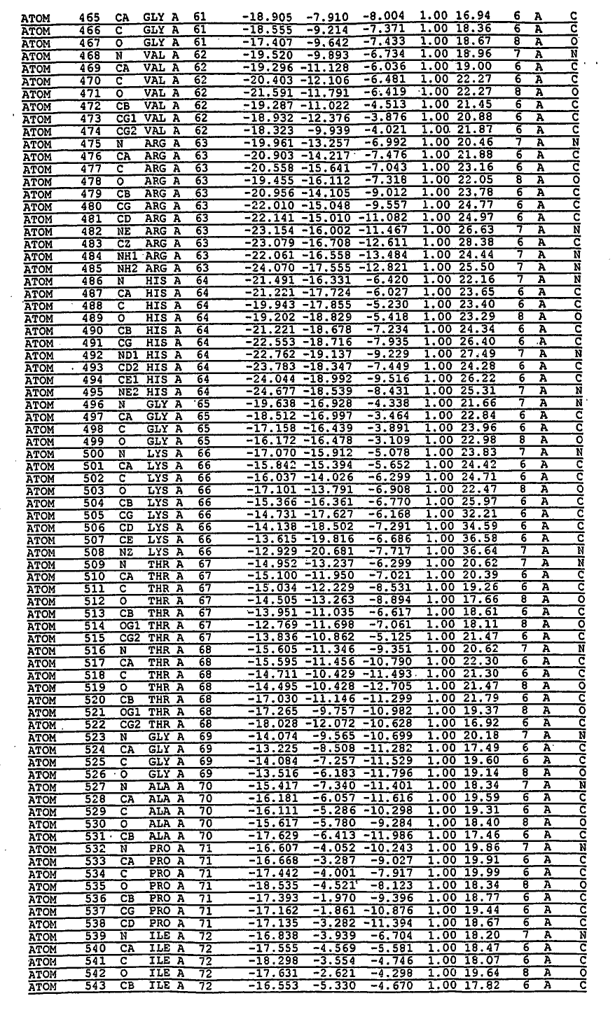

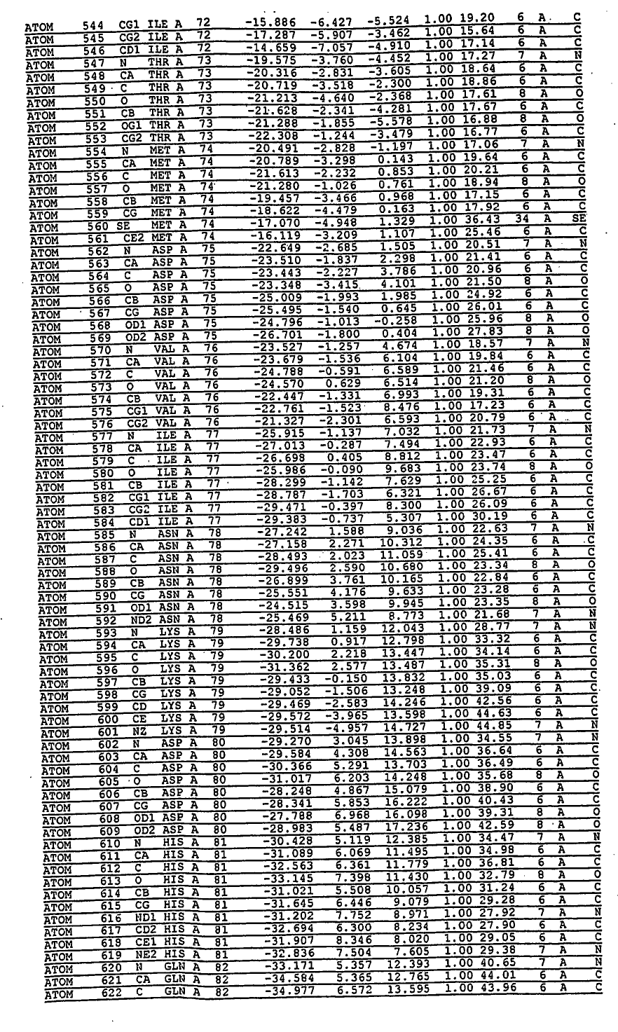

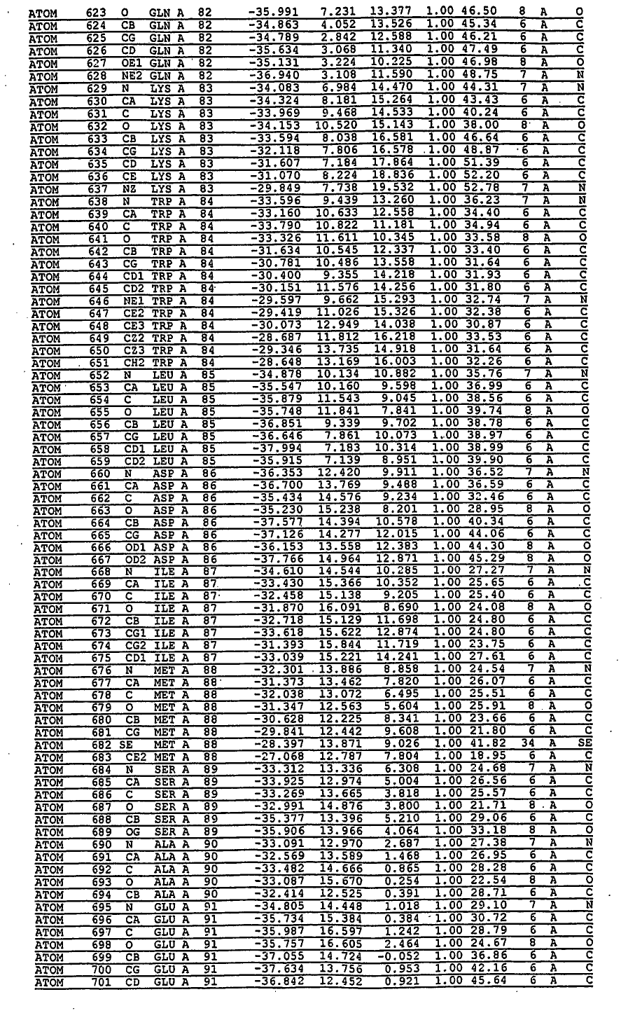

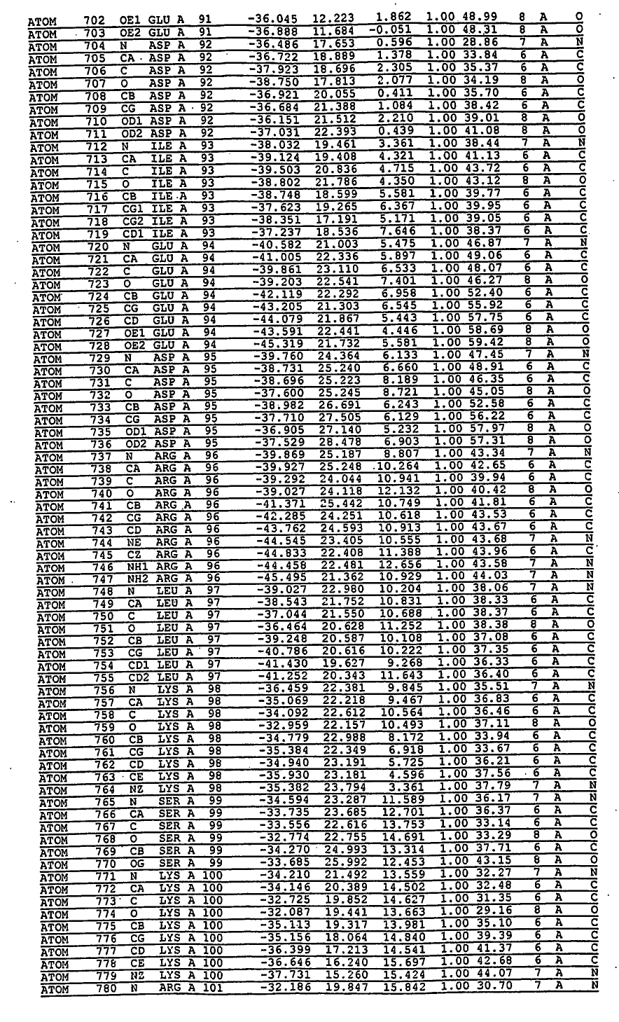

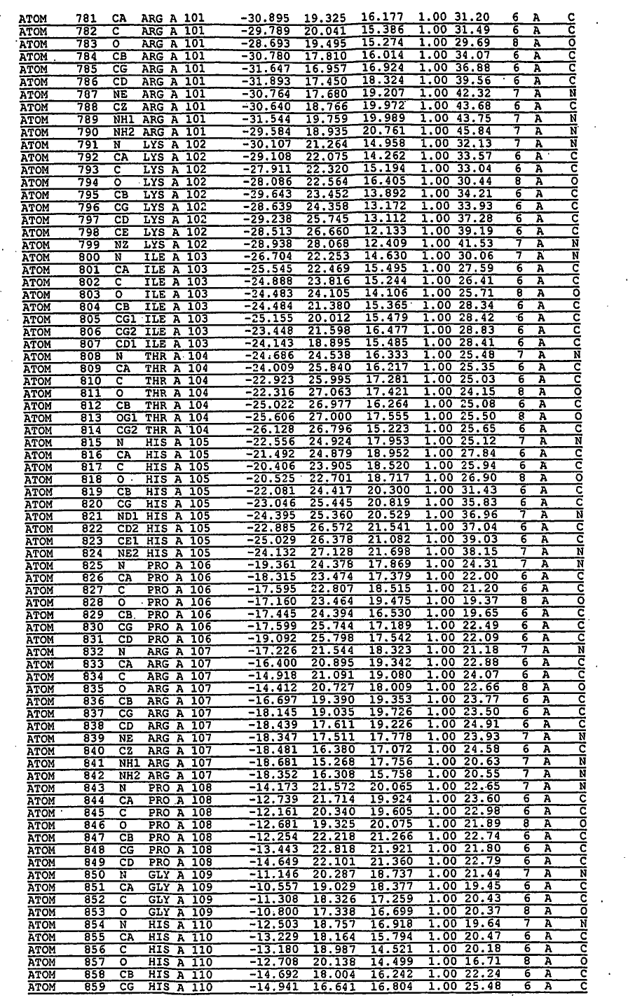

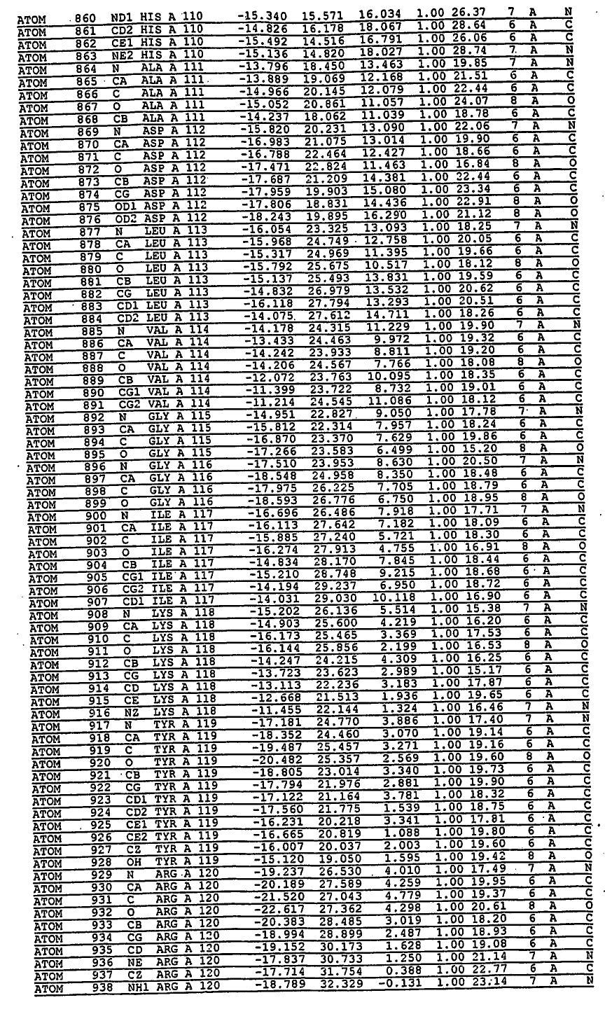

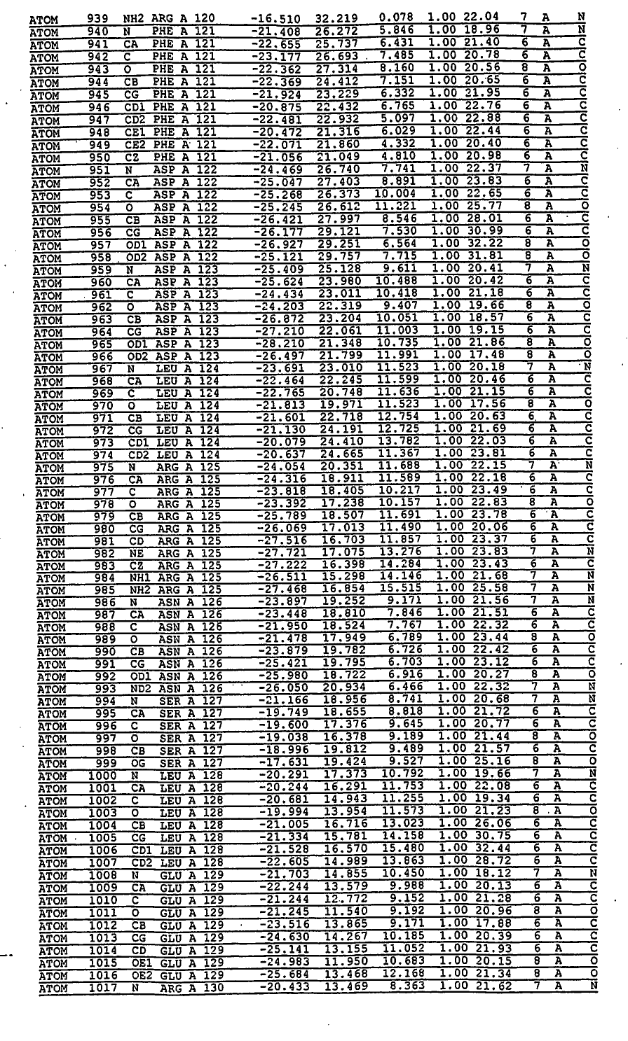

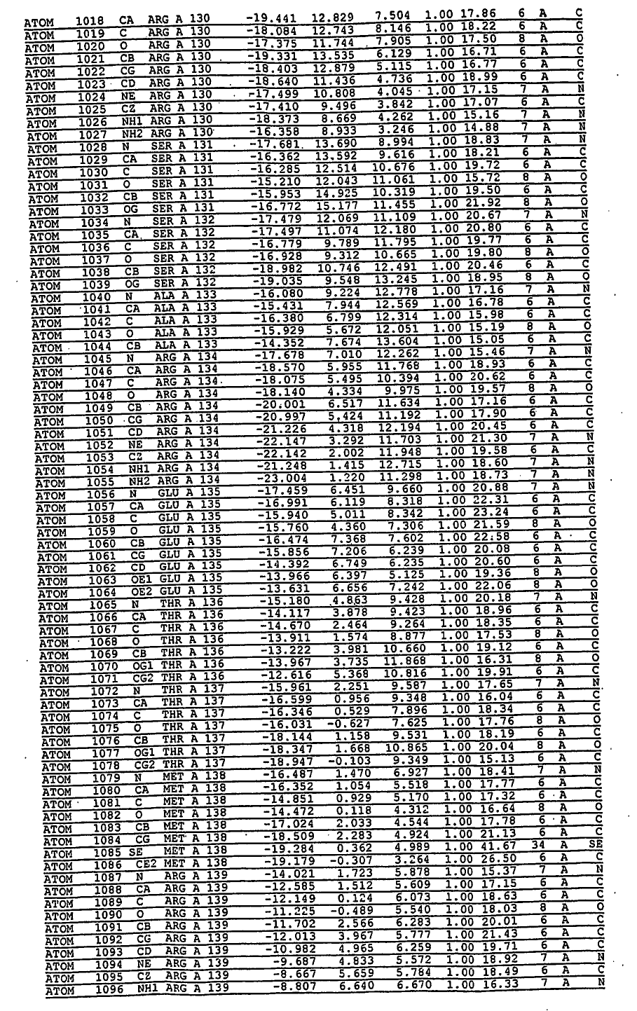

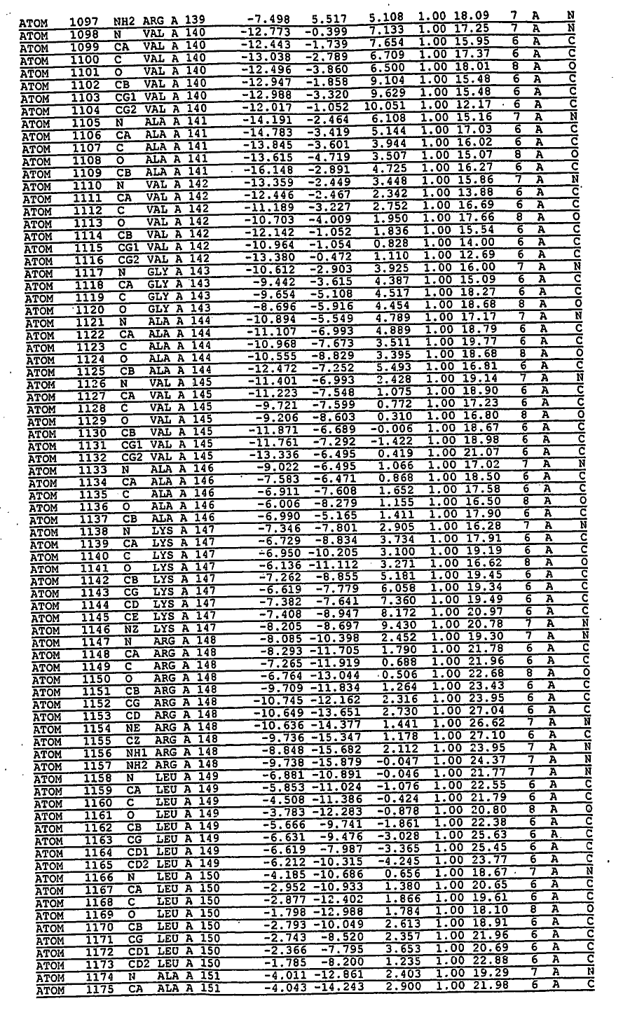

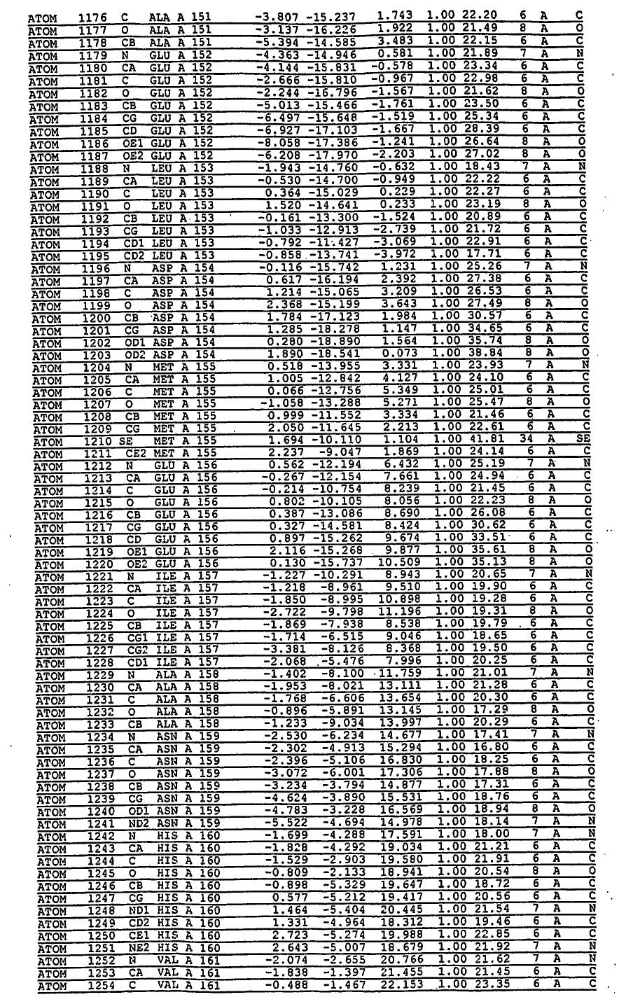

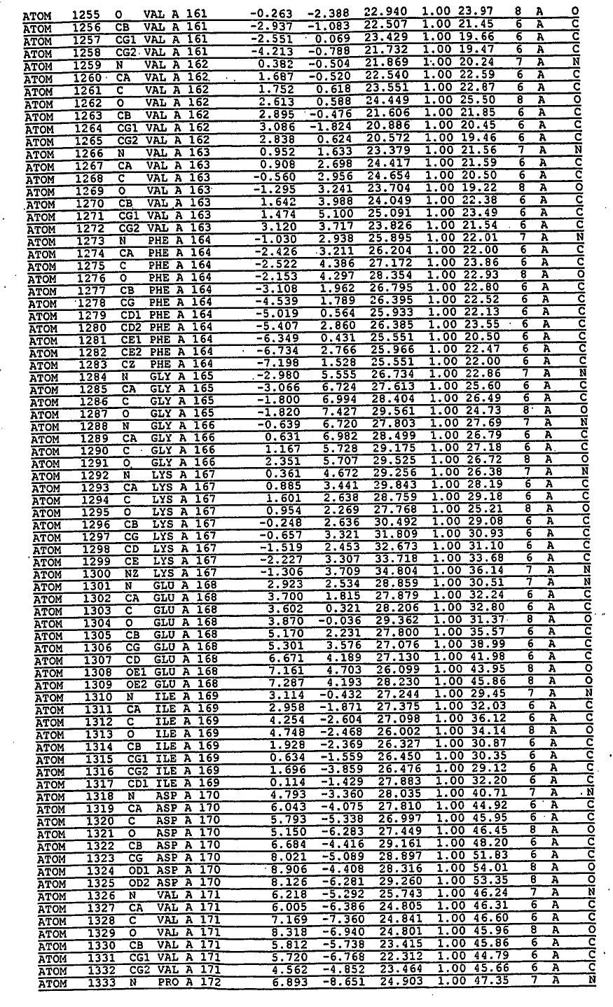

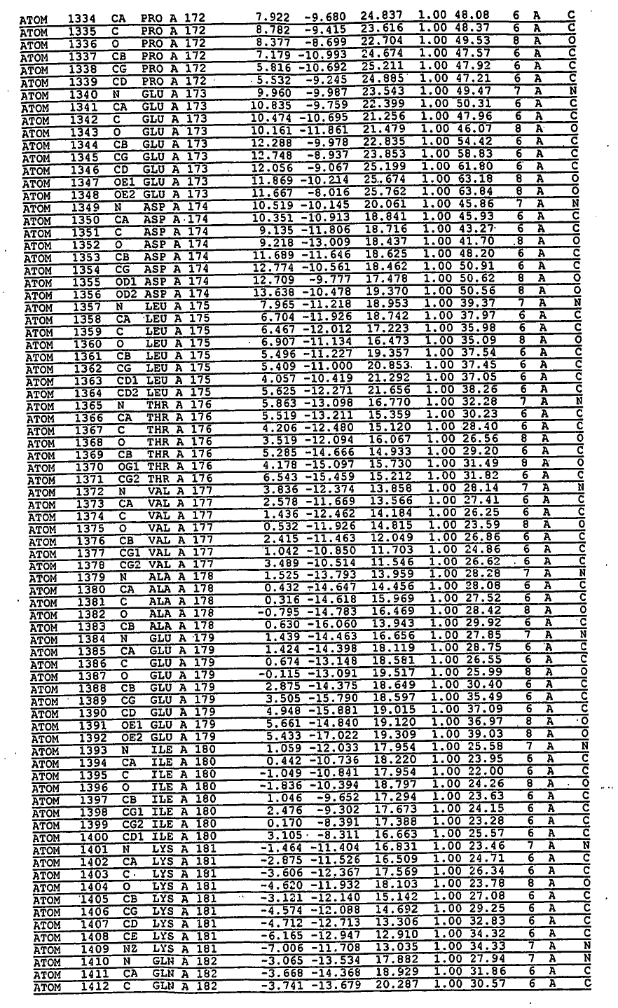

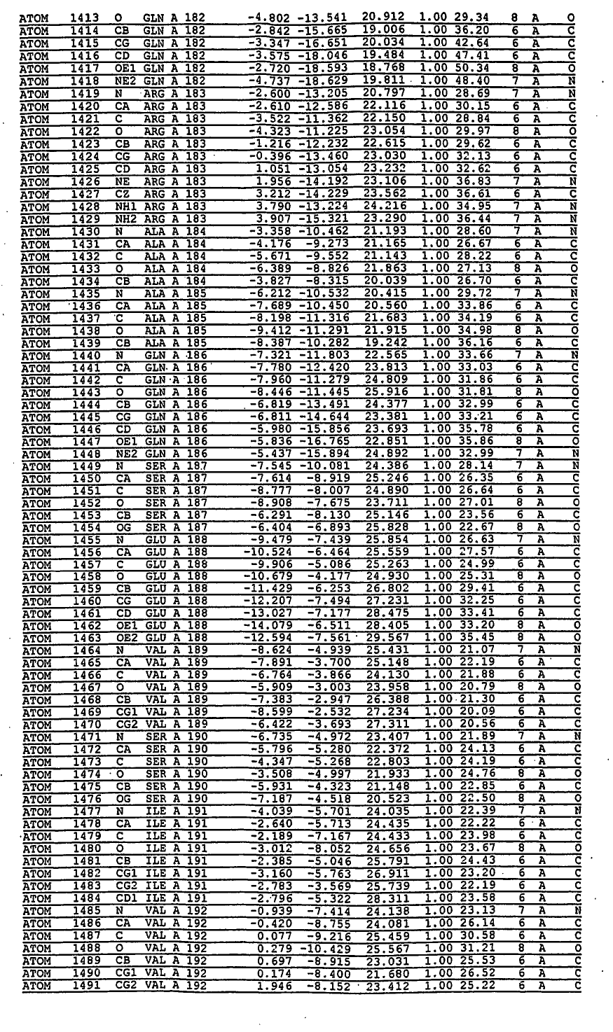

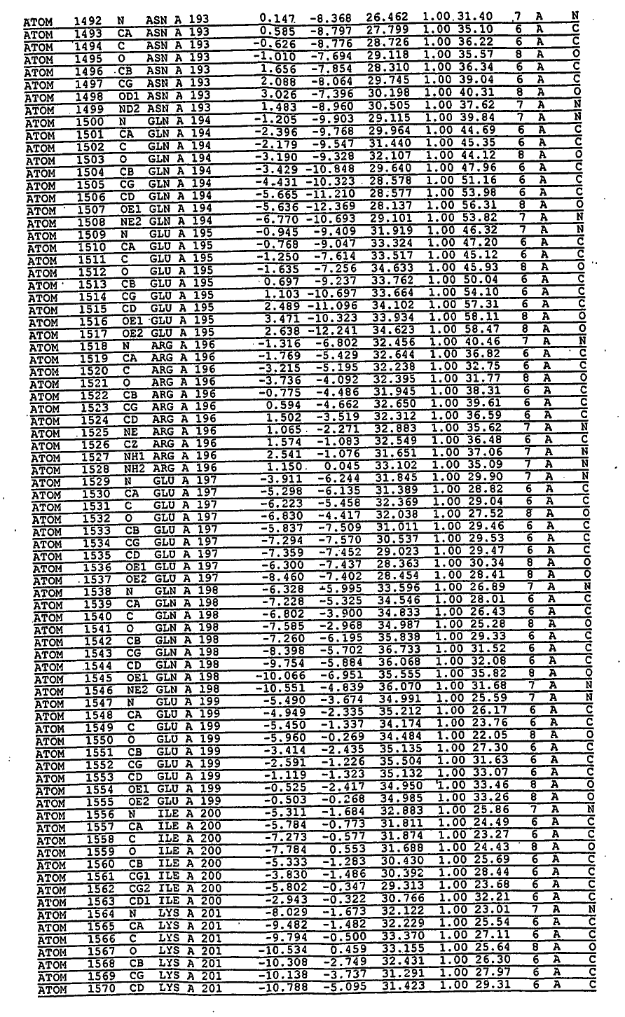

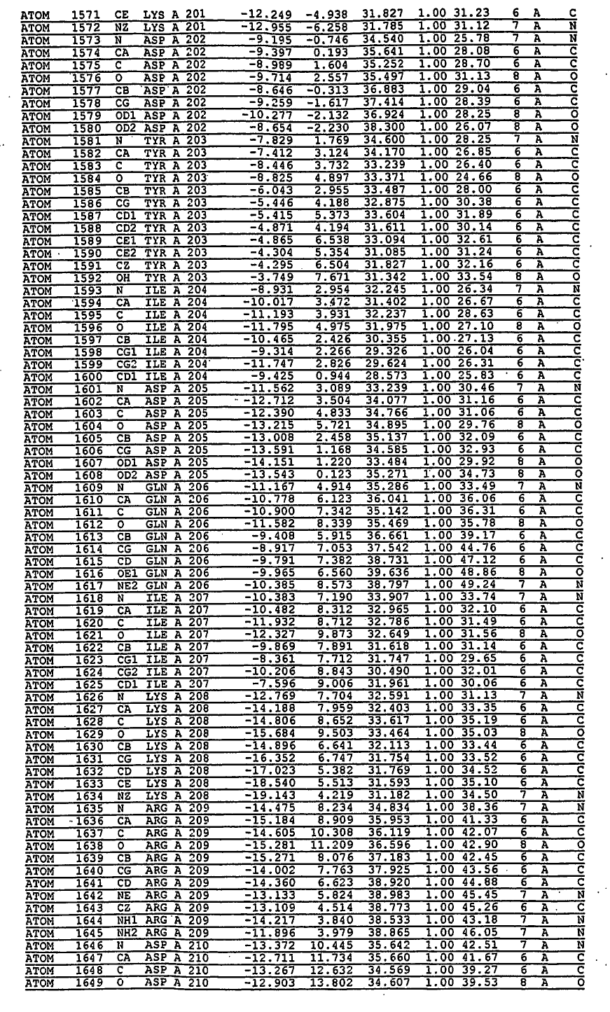

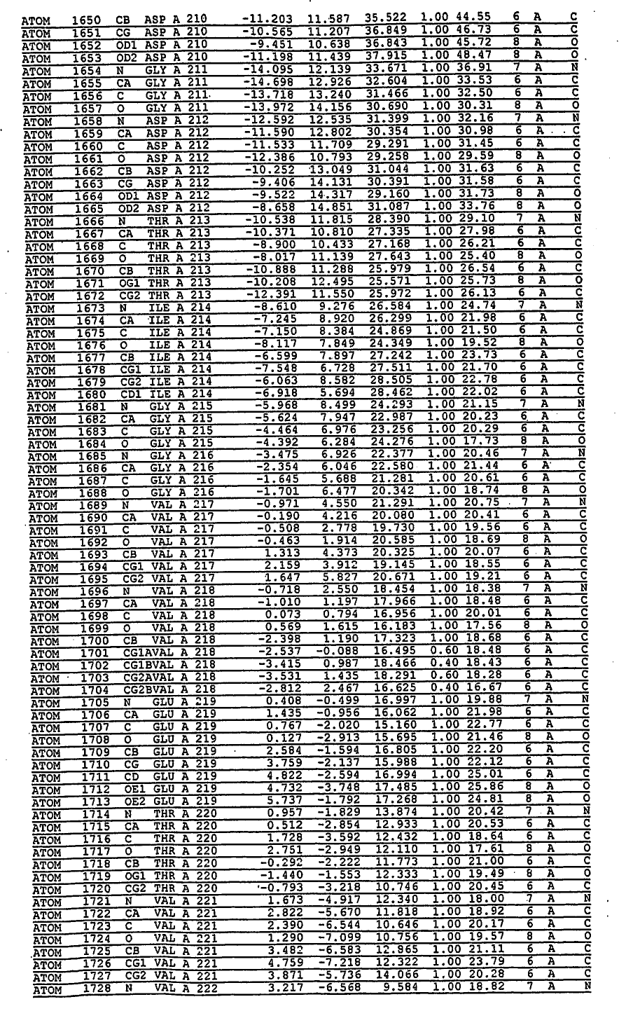

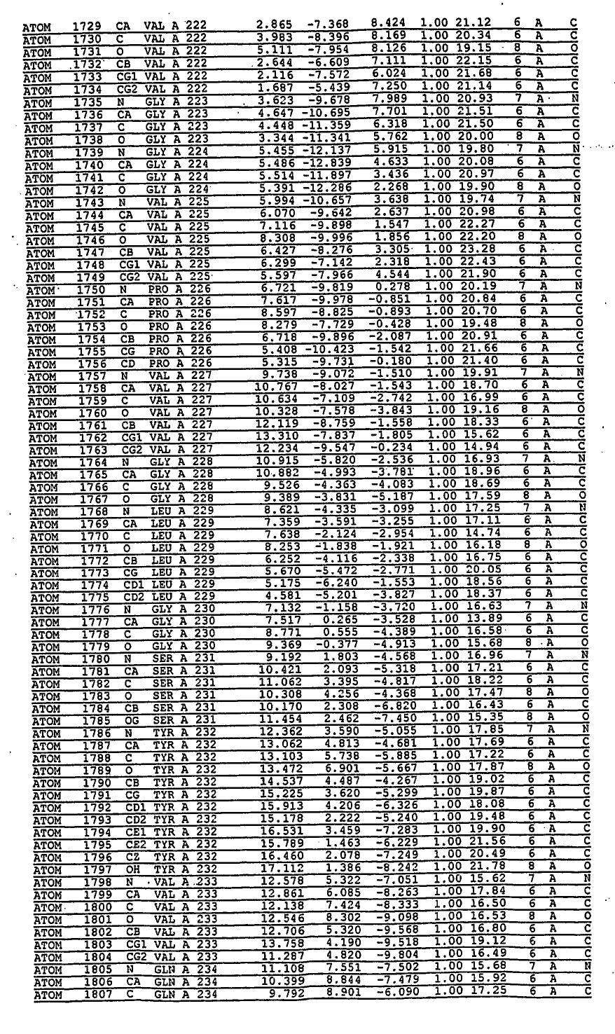

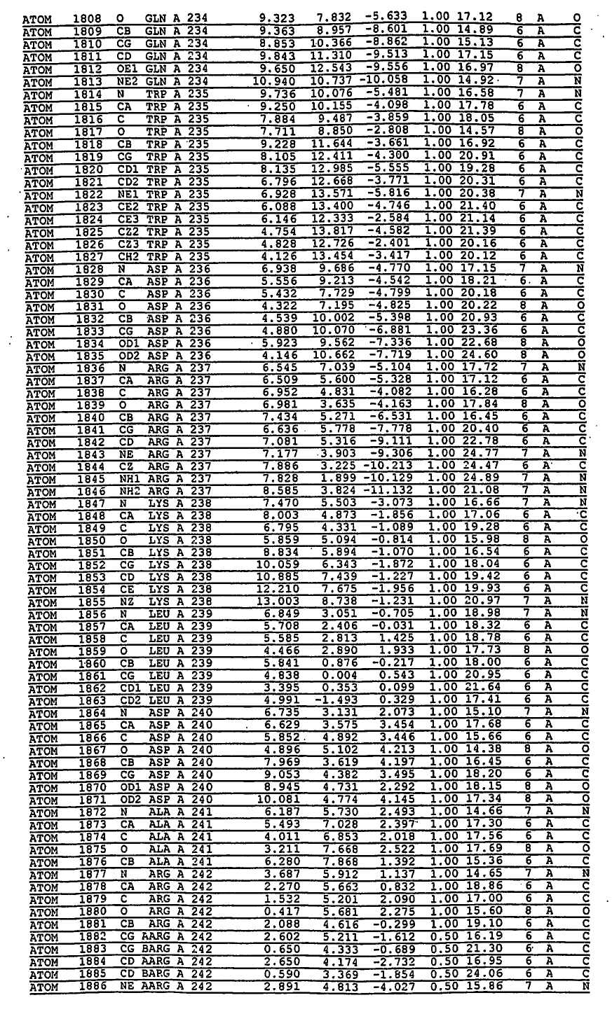

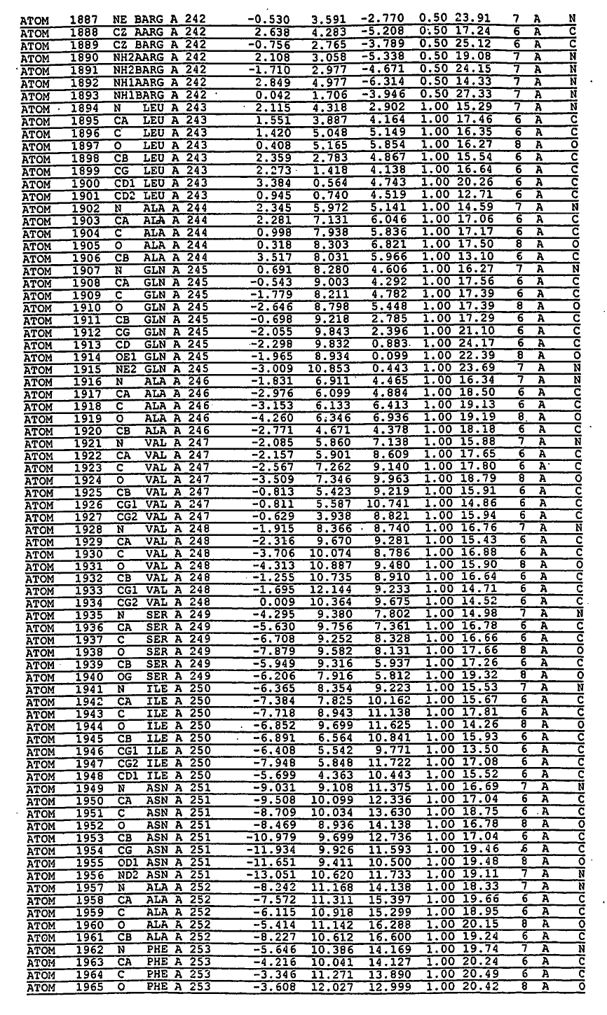

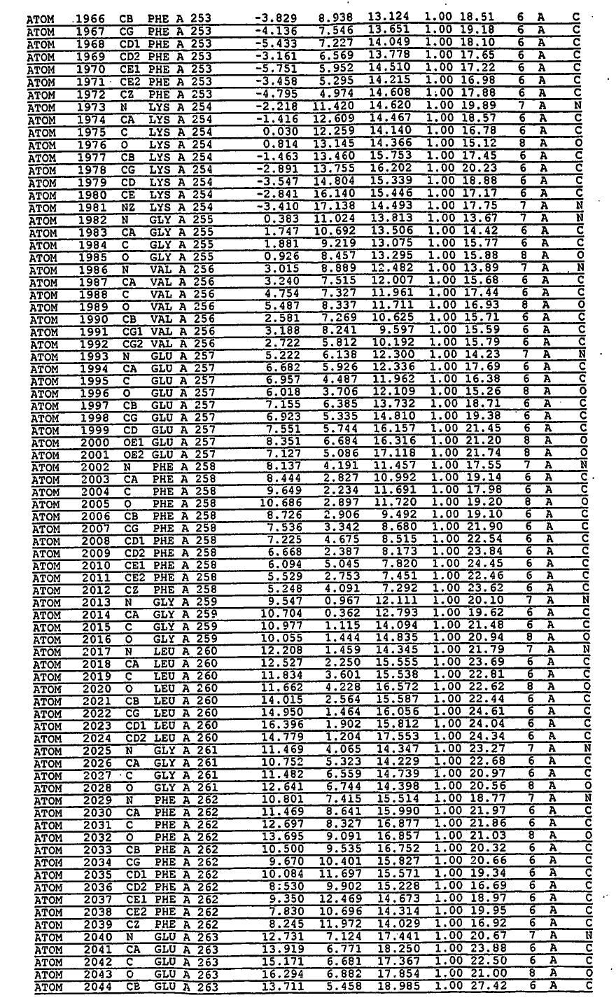

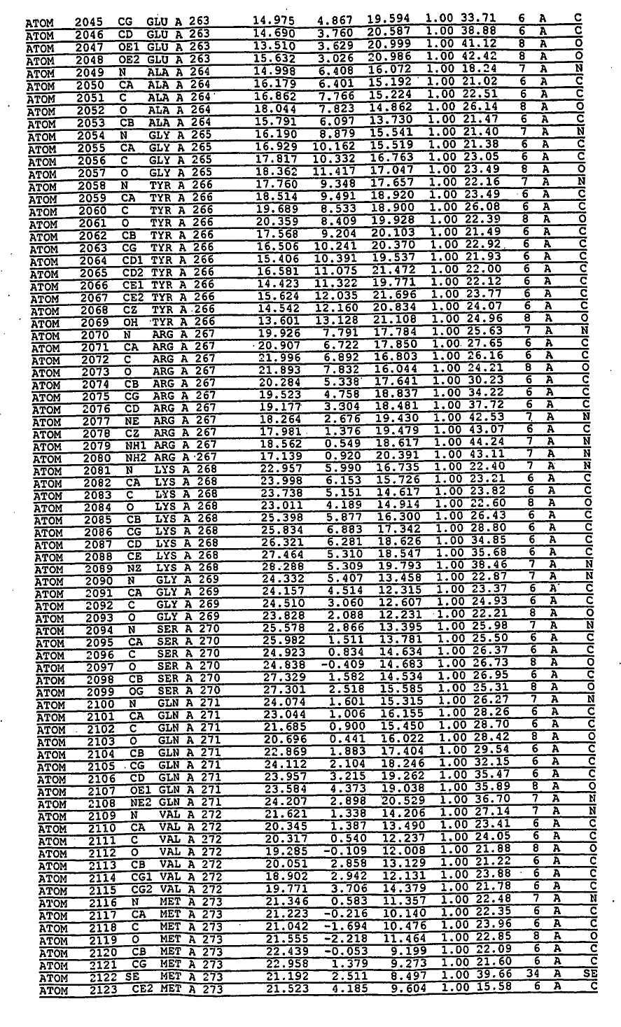

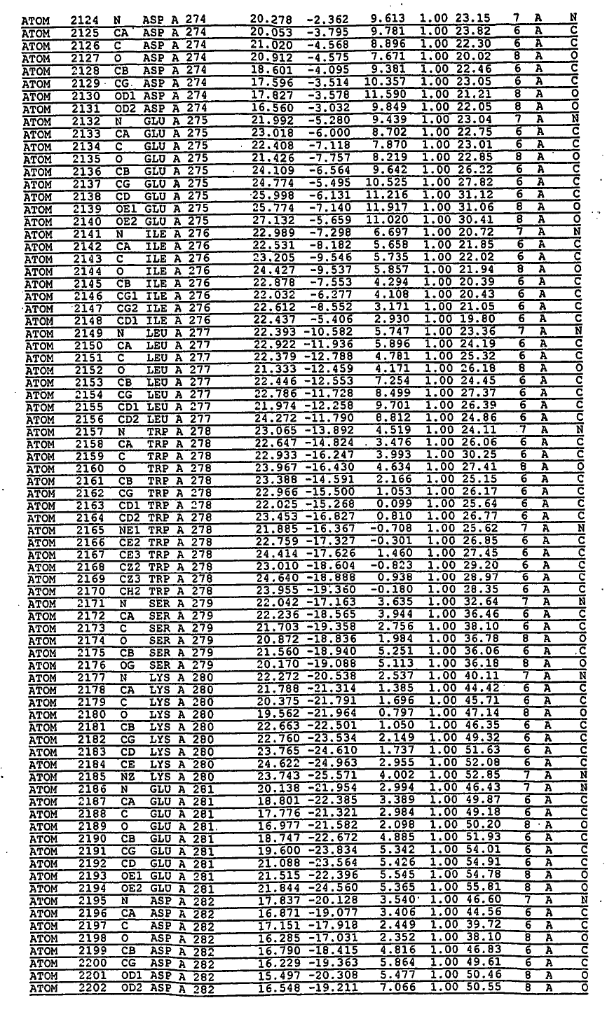

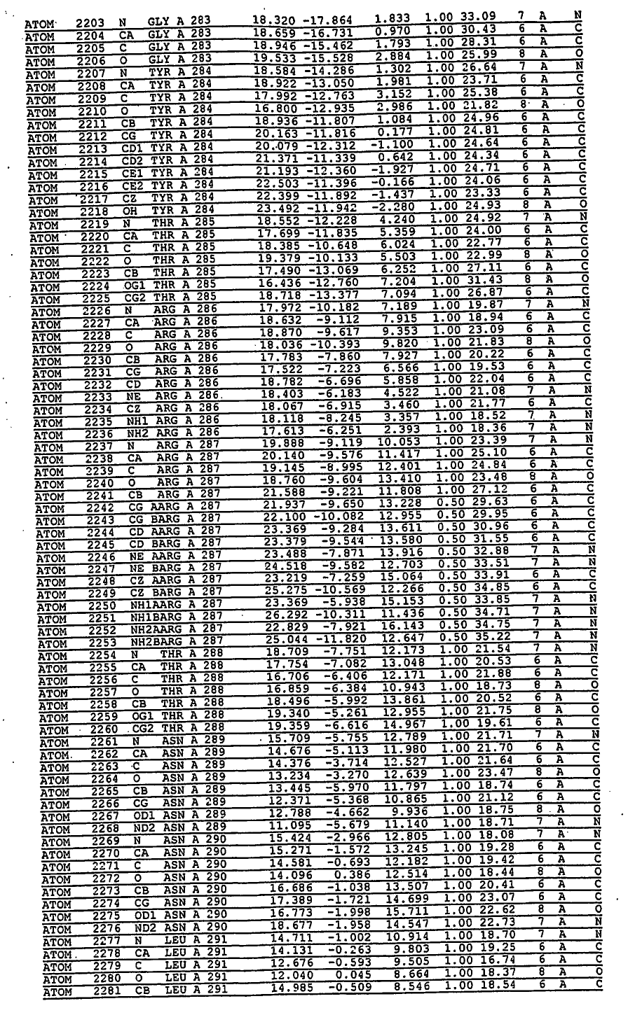

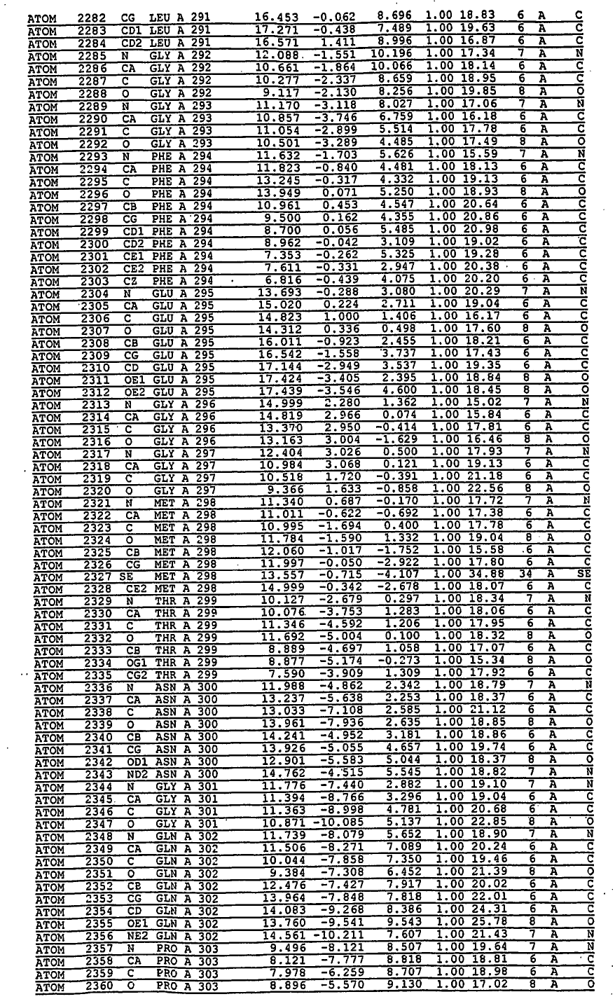

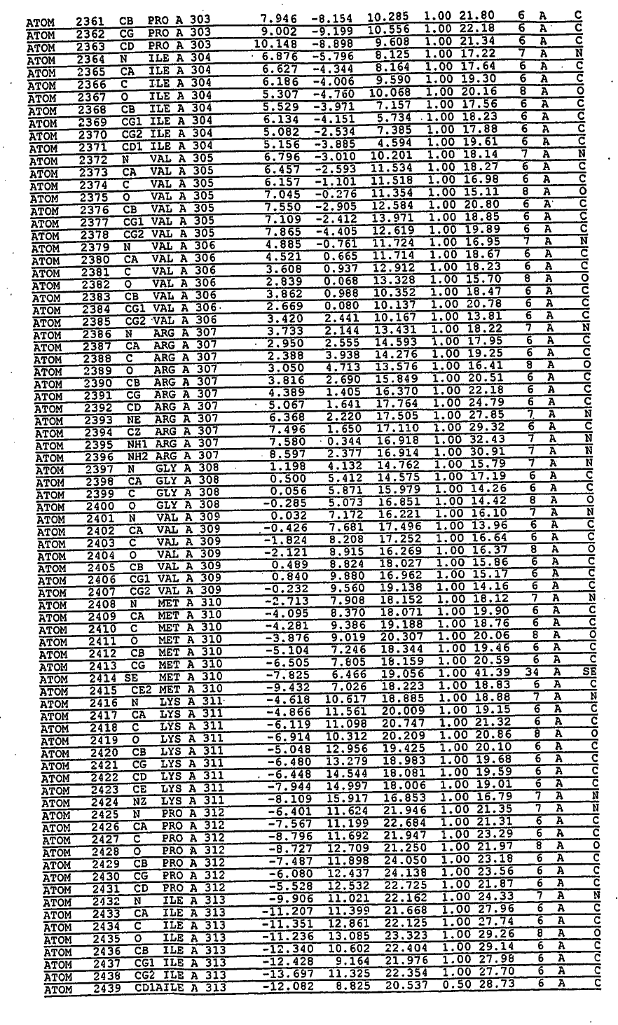

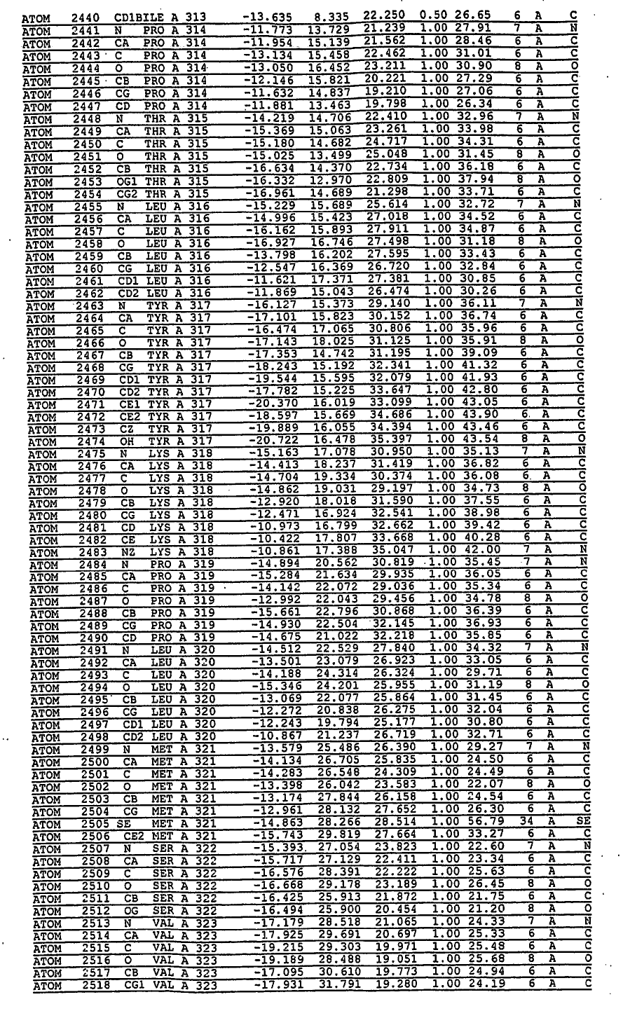

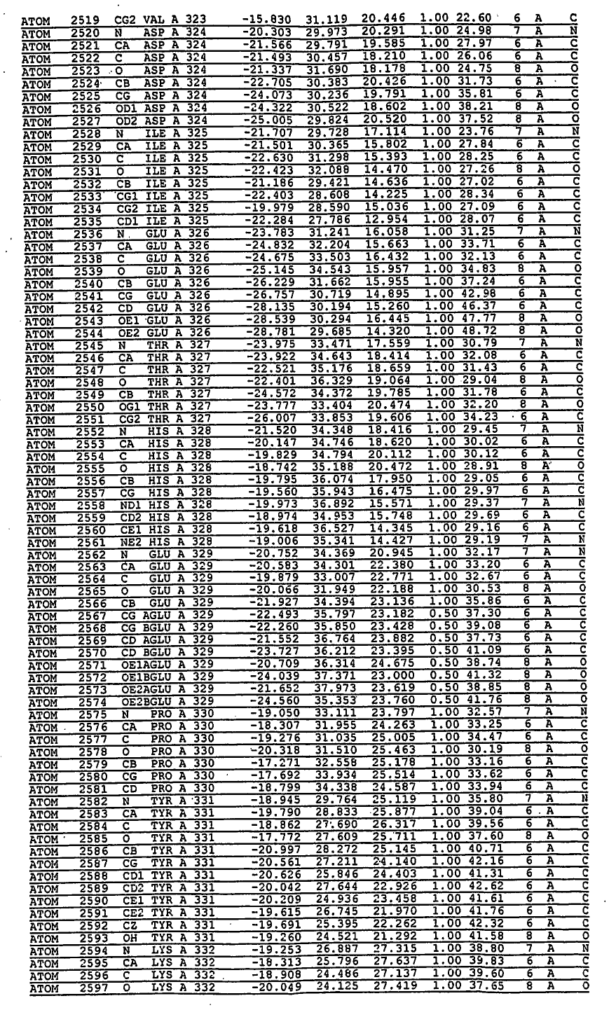

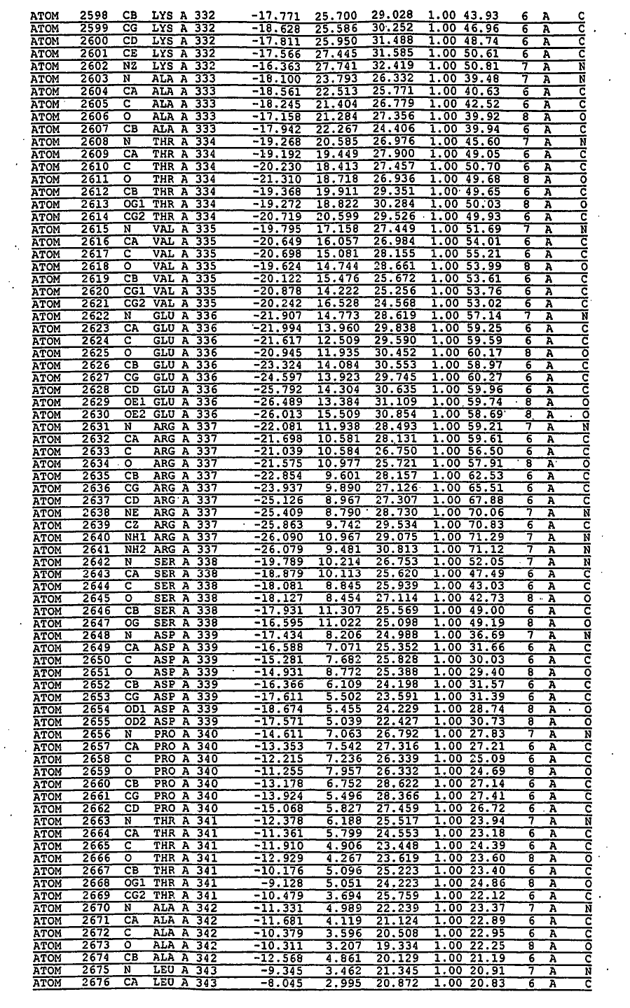

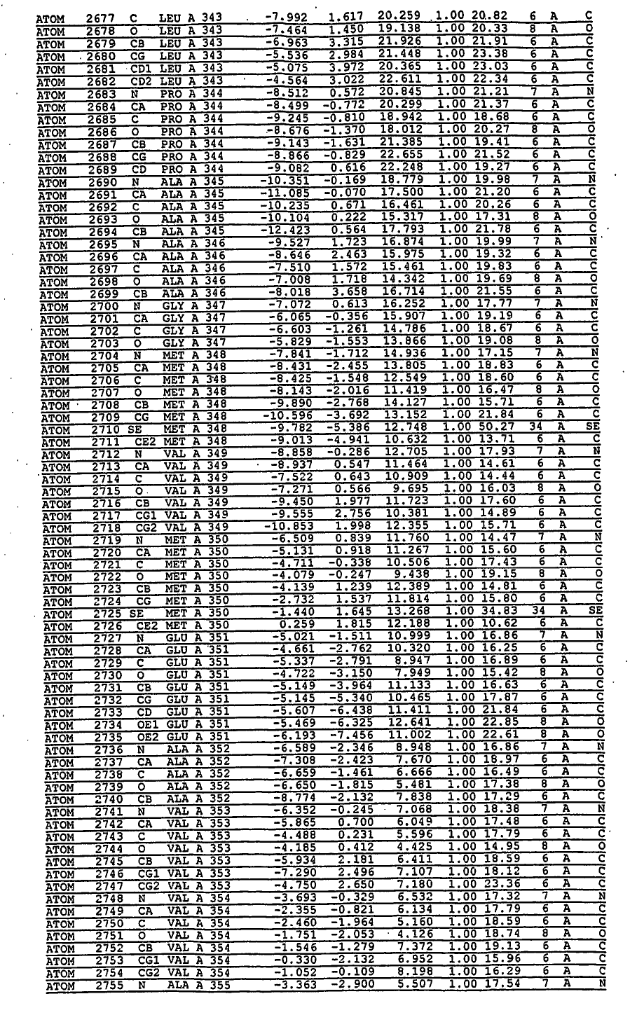

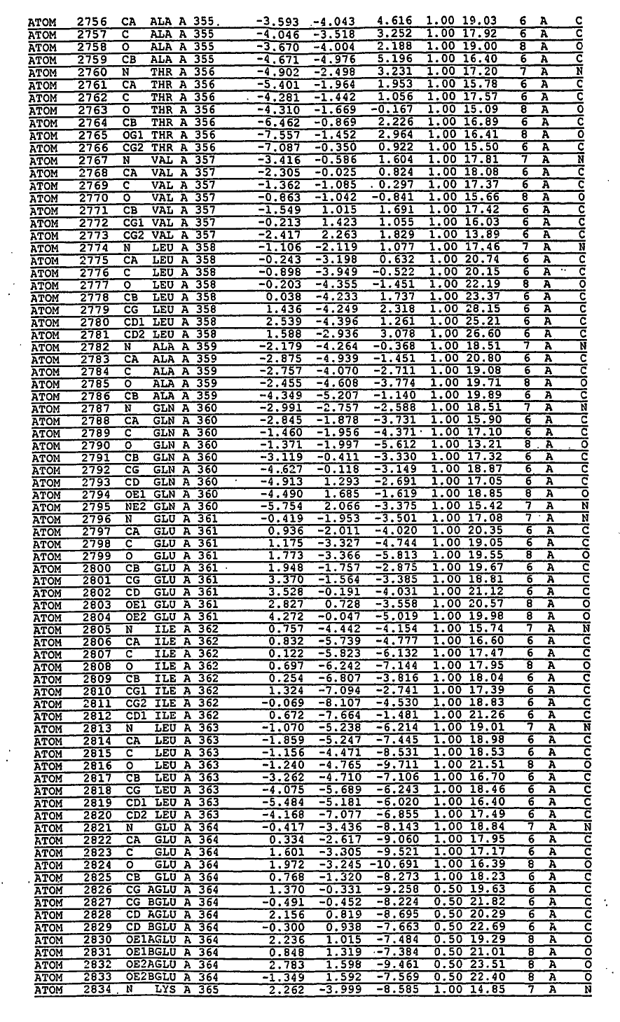

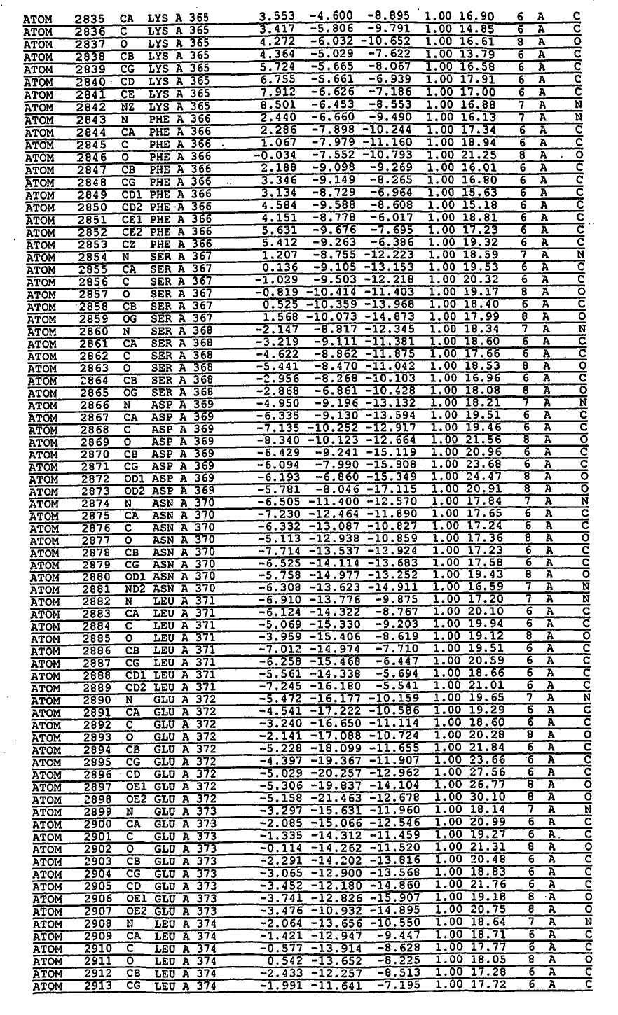

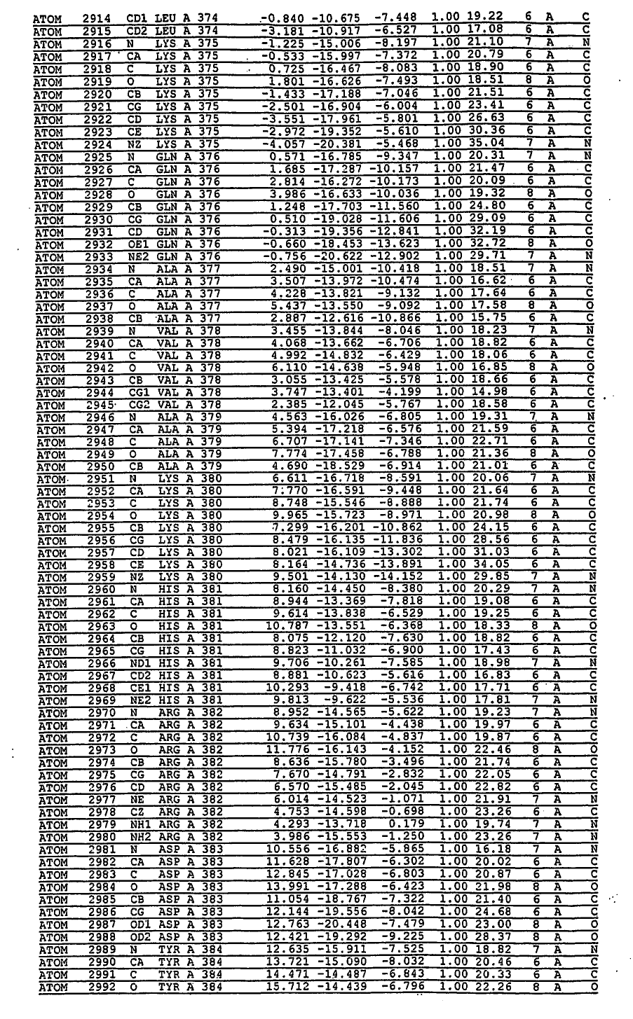

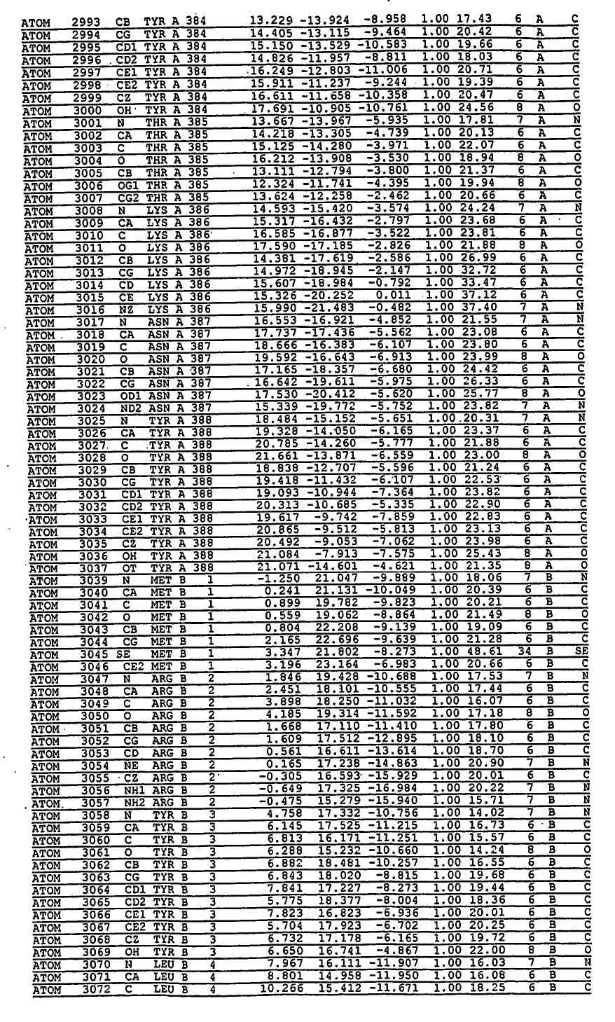

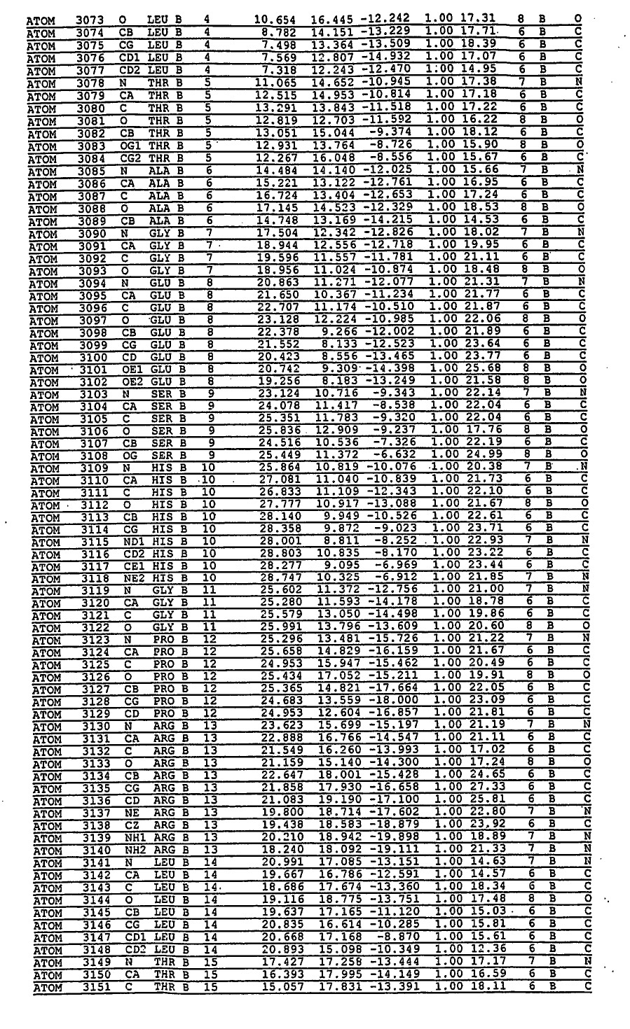

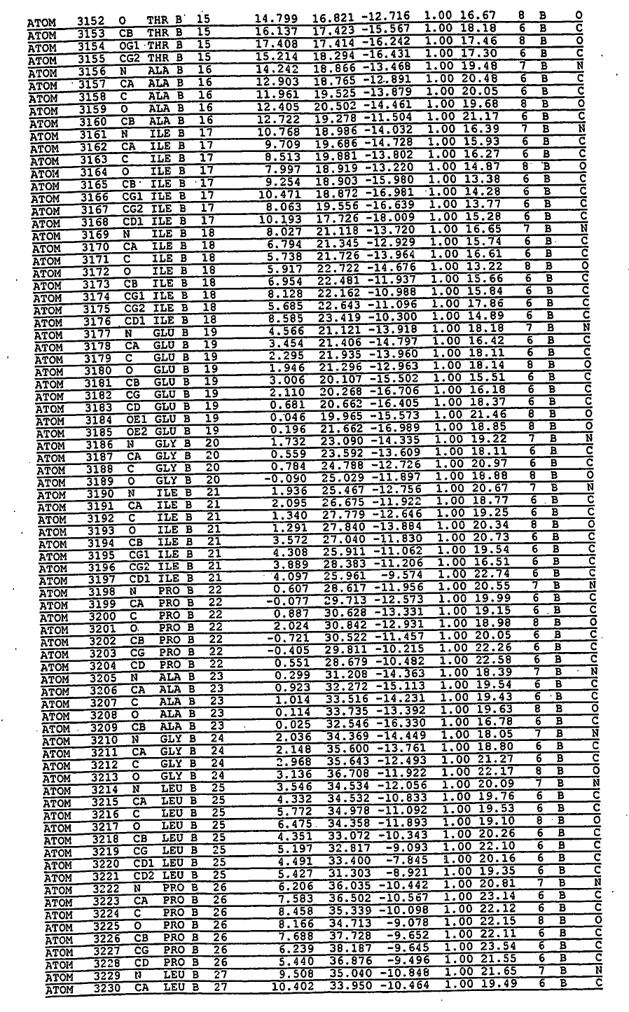

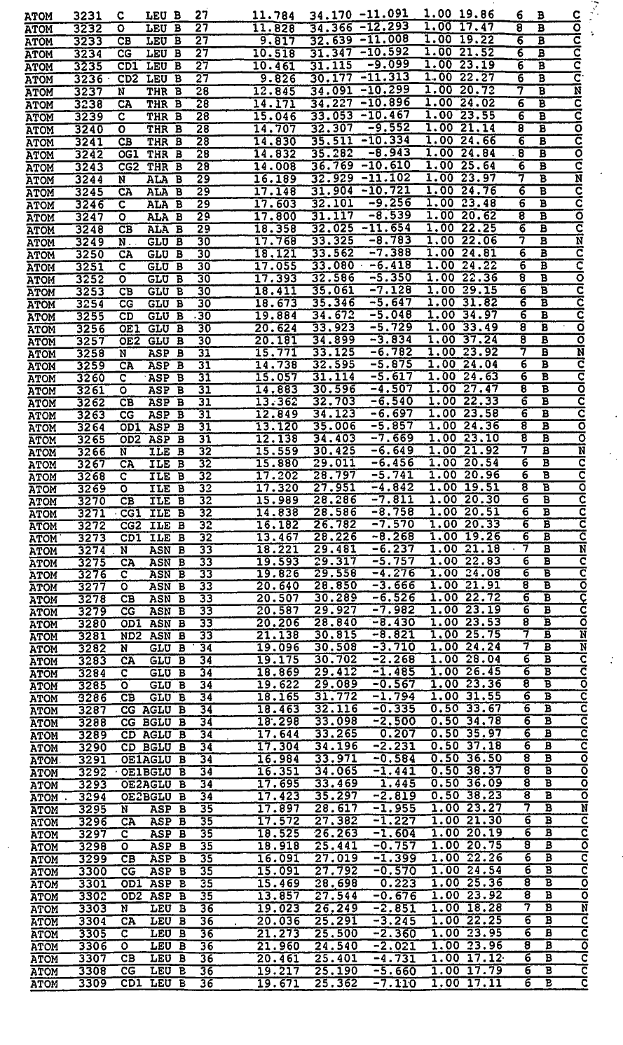

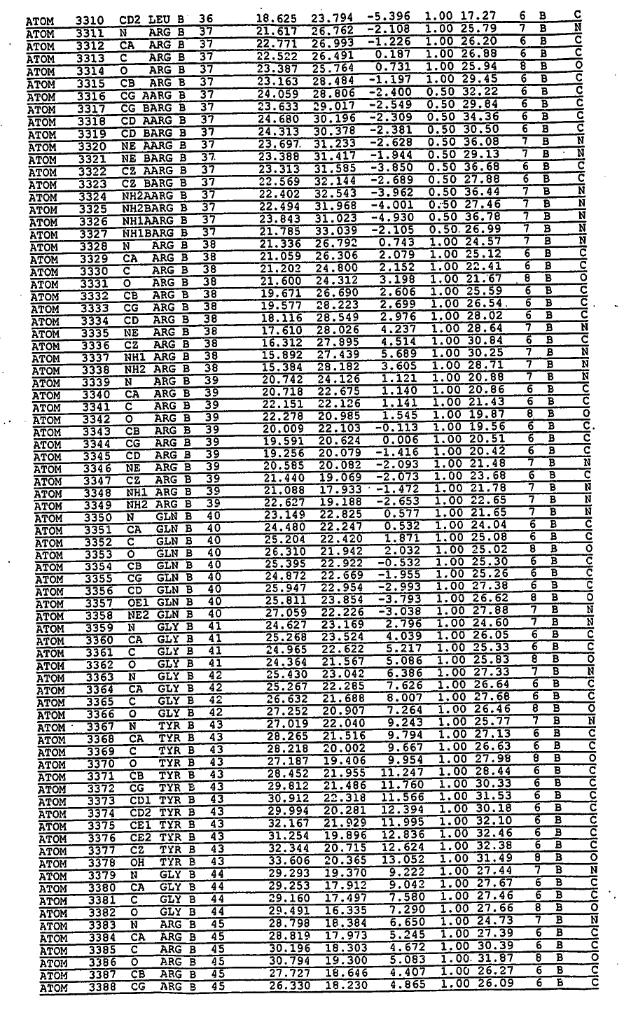

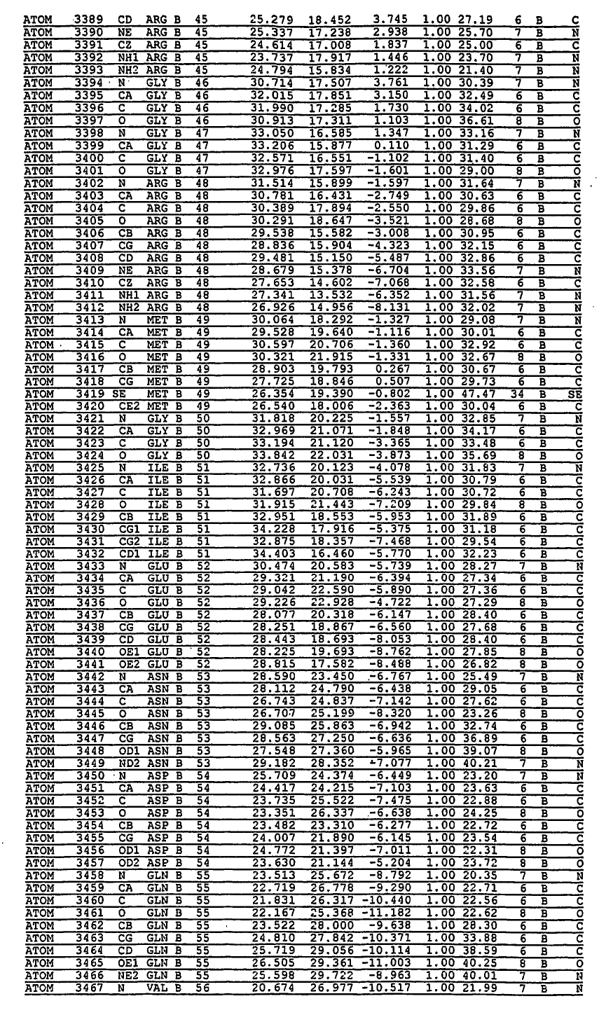

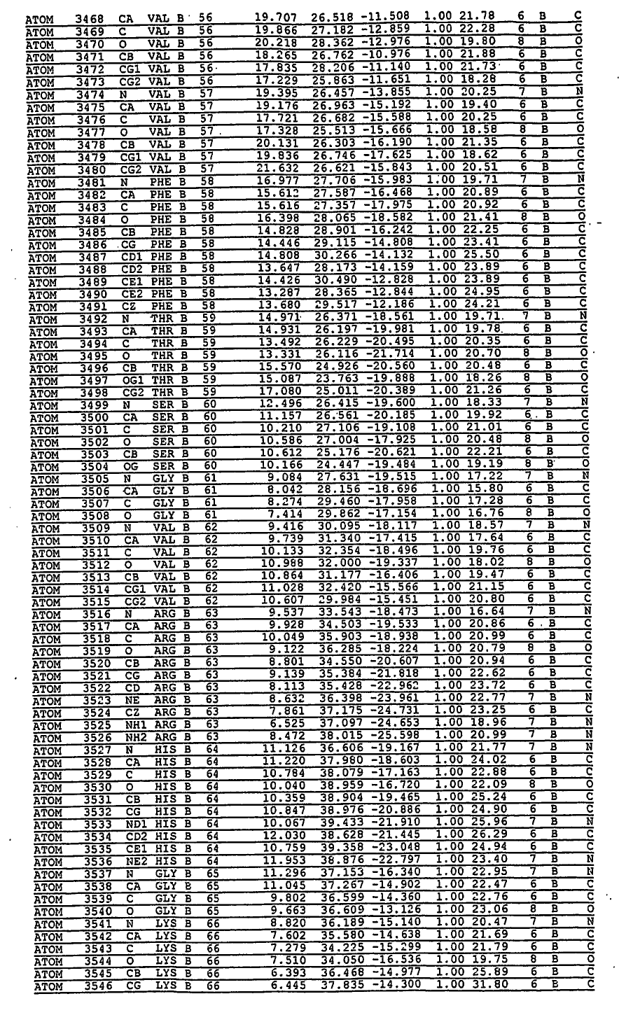

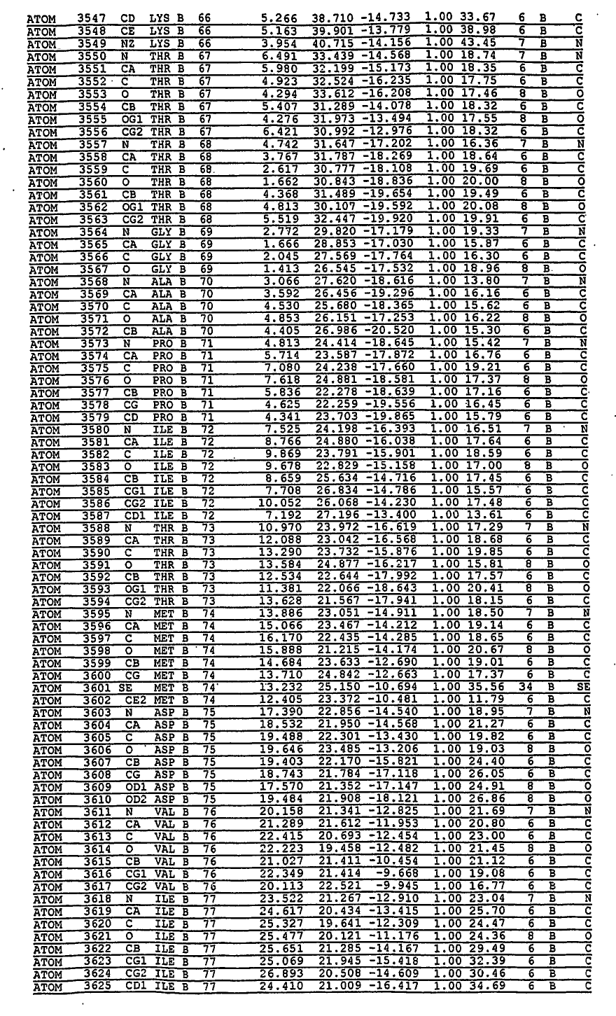

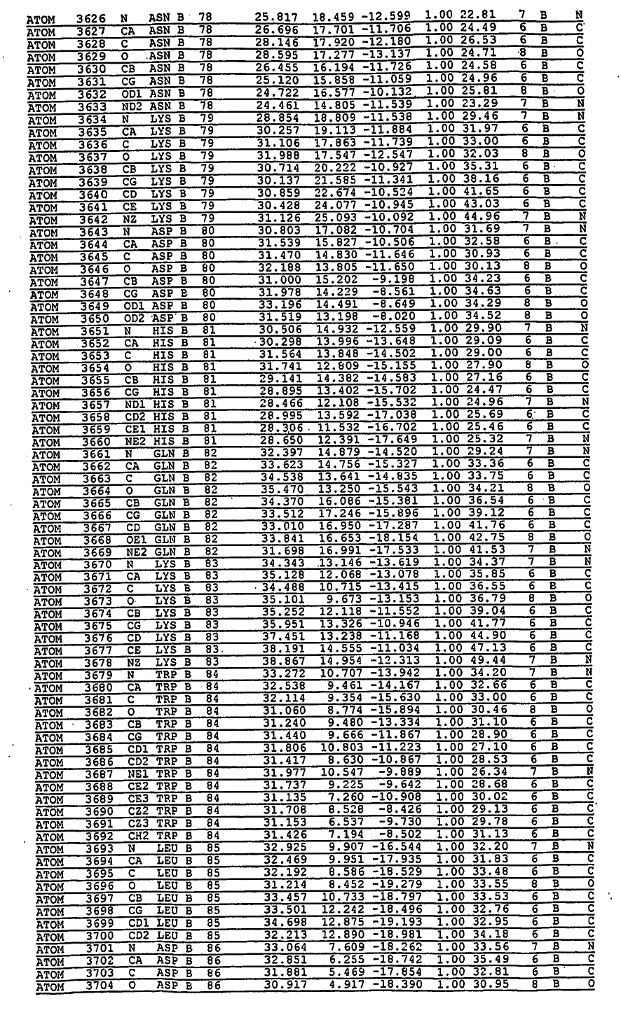

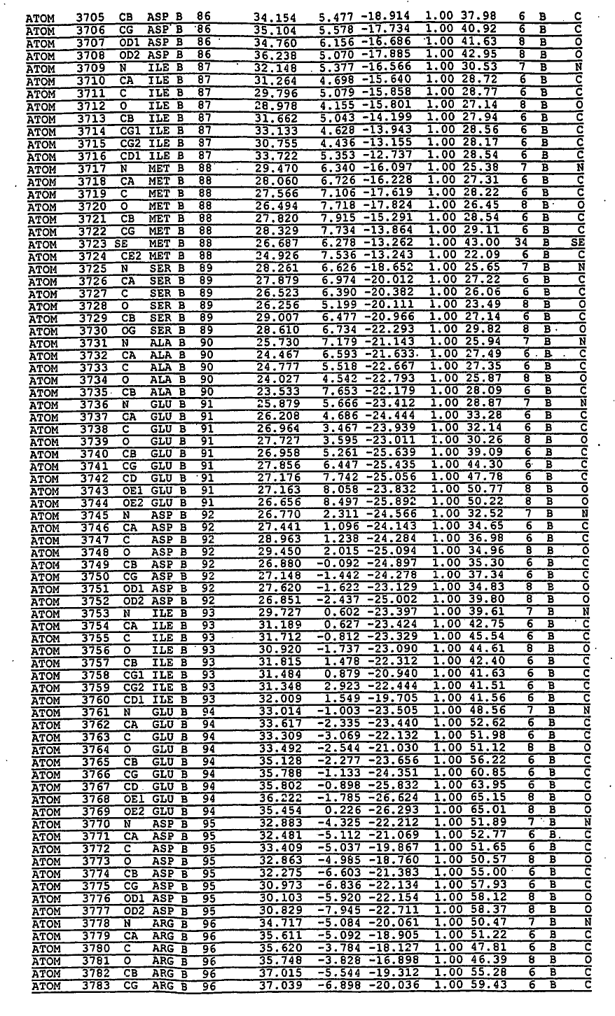

The invention describes in FIG. 1 the atomic coordinate data for two binding domains of Chorismate Synthase. The first binding domain is referred to herein as the FMN binding domain, due to its interaction with the FMN molecule. The second domain is referred to herein as the EPSP binding domain, due to its interaction with the substrate EPSP.

In order to use the structure coordinates generated for Chorismate Synthase, it is usually necessary to convert them into a three-dimensional representation. This can be achieved using conventional software that allows 3-dimensional graphic representation of molecules to be prepared. Suitable software packages include: Rasmol, Cerius, Insight, Quanta, Sybyl, Molcad, VMD, O.

In resolving the crystal structure of Chorismate Synthase, it has been found that the amino acids
a) Arg 39, Arg 45, Gly 109, His 110, Ala 111, Ser 131, Ser 132, Ala 133, Thr 136, Ile250, Asn 251, Ala 252, Phe 253, Lys 254, Met 310, Lys 311, Ile 313, Pro 314, Thr 315, Arg 337, Ser 338, Asp 339, Ala 342, Ala 345, Ala 346 and Val 349 according to FIG. 1;
   are within 5 Å of the atoms comprising the FMN cofactor, and are therefore considered to form part of the FMN binding domain. In addition, residues Asp 240, Phe 294, Glu 295, Gly 296 and Gly 297 are part of an adjacent monomer and are also within 5 Å of the atoms comprising the FMN cofactor, and therefore also form part of the binding site. Furthermore, residue Lys 238 is identified in a water-mediated interaction with the FMN phosphate group, and also forms part of the FMN binding domain.

The amino acid residues that form part of the EPSP-binding domain are
b) Ser 9, His 10, Arg 39, Arg 45, Arg 48, Met 49, Asp 54, Asp 80, Arg 107, His 110, Ser 131, Ser 132, Ala 133, Arg 134, Thr 136, Thr 137, Glu 336, Arg 337, Ser 338 and Asp 339 according to FIG. 1.

It will be readily apparent to those skilled in the art that the numbering of amino acids in other isoforms of Chorismate Synthase may be different than that specified herein. Corresponding amino acids in other isoforms of Chorismate Synthase may be identified readily by comparison of the amino acid sequences, for example using commercially available homology modeling software packages or conventional sequence alignment packages.

The key amino acids required to define the binding domains are:
(a) Arg 39, His 110, Ser 132, Thr 136, Lys 254, Gly 297, Lys 311, Thr 315, Arg 337 and Asp 339 according to FIG. 1; or
(b) Ser 9, His 10, Arg 39, Asp 54, Arg 107, His 110, Ser 132, Ala 133, Arg 134, Thr 136, Arg 337 and Asp 339 according to FIG. 1.

In a preferred embodiment, the binding domain for (a) is further defined by the data for the amino acids
(i) Arg 45, Gly 109, Ala 111, Ser 131, Ala 133, Lys 238, Asp 240, Ile 250, Asn 251, Ala 252, Phe 253, Phe 294, Gly 296, Met 310, Ile 313, Pro 314, Ala 342, Ala 345, Ala 346 and Val 349 according to FIG. 1;
   and (b) is further defined by the data for the amino acids
(ii) Arg 45, Met 49, Asp 80, Ser 131, and Thr 137 according to FIG. 1.

In addition, data from conservative amino acid substitutions for any of those amino acid residues specified in (i) or (ii), are also within the scope of the invention.

In a further preferred embodiment, binding domain defined by (a) further comprises the data for Ser 339, and/or binding domain (b) further comprises the data for Arg 48, Glu 336 and Ser 338.

Each of the amino acids of Chorismate Synthase is defined by a set of structure coordinates shown in FIG. 1. The term “structure coordinates” refer to Cartesian coordinates derived from mathematical equations related to the patterns obtained by diffraction of a monochromatic beam of X-rays by the atoms of a protein or protein ligand complex in crystal form. The diffraction data are used to calculate an electron density map of the repeating units of the crystal. The electron density map is then used to establish the positions of the individual atoms of the enzyme or enzyme complex.

It will be apparent to the person skilled in the art that variations in the data set of coordinates could define a similar or identical shape. Slight variations in the individual coordinates will have little effect on overall structure. In terms of the binding domains—such variations would not be expected to significantly alter the nature of ligands which would bind to those domains, nor the affinity that the ligands have for the domains.

The variations in coordinates may be generated by manipulating the crystallographic permutations of the structure coordinates, fractionalisation of the structure coordinates, integer additions or subtractions to sets of the structure coordinates, inversion of the structure coordinates or any combination of the above. Alternatively, modifications in the crystal structure due to mutations, additions, substitutions, and/or deletions of amino acids, or other changes in any of the components that make up the crystal could also contribute to variations in the structure coordinates. Further, alternative crystal forms may exhibit alterations in the interfaces between molecules. If such variations are within an acceptable standard error as compared to the original coordinates, the resulting 3-dimensional shape is considered to be the same. Various computational analyses may therefore be necessary to determine whether a molecule or the binding domain portion of the molecule is sufficiently similar to the Chorismate Synthase binding domain described herein. This analysis may be carried out using conventional software packages, including the Molecular Similarity application of QUANTA (Accelrys, San Diego, Calif.) version Quanta2006, or lsqkab of the CCP4 suite.

The Molecular Similarity program allows a comparison between different structures, based on superimposing a target structure over the previously defined structure, using defined atom equivalencies to perform a fitting operation. For the purposes of this invention, equivalent atoms are defined as protein backbone atoms (N, C and O) for all conserved residues between the two structures being compared. In addition, a rigid fitting operation is performed.

For the purposes of this invention, any molecule or molecular complex or binding domain thereof that has a root mean square deviation of conserved residue backbone atoms of less than 2 Å when superimposed on the relevant backbone atoms described by the structure coordinates of FIG. 1, is considered identical. More preferably, the root mean square deviation is less than 1 Å, more preferably less than 0.5 Å.

The term “root mean square deviation” means the square root of the arithmetic mean of the squares of the deviations from the mean.

The present invention may make use of standard computer hardware and software, suitably programmed with the structure coordinates listed in FIG. 1, or those relating to either or both of the two binding domains specified above.

The present invention permits the use of molecular design techniques to identify, select and design chemical entities, including inhibitors, agonists or antagonists, capable of binding to one or both of the Chorismate Synthase binding domains. The invention is particularly useful in identifying inhibitory compounds that can be used to treat pathogenic infections.

The use of computational methods to design compounds that interact with specific enzymes is now well established.

A potential inhibitor may be evaluated by a series of steps in which various chemical entities are screened and selected for their ability to associate with one or more of the binding domains. Computer programs that assist in this process of selecting chemical entities include:
1. GRID (P. J. Goodford, “A Computational Procedure for Determining Energetically Favorable Binding Sites on Biologically Important Macromolecules”, J. Med. Chem., 28, pp. 849-857 (1985)). GRID is available from Oxford University, Oxford, UK.
2. MCSS (A. Miranker et al., “Functionality Maps of Binding Sites: A Multiple Copy Simultaneous Search Method.” Proteins: Structure, Function and Genetics, 11, pp. 29-34 (1991)). MCSS is available from Accelrys, San Diego, Calif.
3. AUTODOCK (D. S. Goodsell et al., “Automated Docking of Substrates to Proteins by Simulated Annealing”, Proteins: Structure, Function, and Genetics, 8, pp. 195-20 (1990)). AUTODOCK is available from Scripps Research Institute, La Jolla, Calif.
4. DOCK (I. D. Kuntz et al., “A Geometric Approach to Macromolecule-Ligand Interactions”, J. Mol. Biol., 161, pp. 269-288 (1982)). DOCK is available from University of California, San Francisco, Calif.
5. Glide—Halgren, Abstr. pap. Am. Chem. Soc., 2000, V220, 83-PHYS part2.
6. Cerius—Diller & K. M. Merz, Proteins, 2001, Vol 43, p 113-124; and Jain, J. Comp. Aided Molec. Design, 1996, Vol 10, p 427-440.
7. FlexX—Rarey et al, “Docking of hydrophobic ligands with interaction-based matching algorithms”, Bioinformatics, 1999, 15: 243-250. Available through Tripos Associates, St. Louis, Mo.
8. GOLD—Nissink et al, Proteins, 2002; 49: 457-471. Available from CCDC, Cambridge, UK.

On identification of suitable chemical entities, a single compound can be assembled and tested for efficacy.

An alternative method of identifying a compound or compounds that associate with one or more of the binding domains, is to use De Novo ligand design methods, for example:
1. LUDI (H.-J. Bohm, “The Computer Program LUDI: A New Method for the De Novo Design of Enzyme Inhibitors”, J. Comp. Aid Molec. Design, 6, pp. 61-78 (1992)). LUDI is available from Accelrys, San Diego, Calif.
2. LEGEND (Y. Nishibata et al., Tetrahedron, 47, p. 8985 (1991)). LEGEND is available from-(Tripos), San Diego, Calif.
3. LeapFrog (available from Tripos Associates, St. Louis, Mo.).
4. SPROUT (V. Gillet et al, “SPROUT: A Program for Structure Generation)”, J. Comput. Aided Mol. Design, 7, pp. 127-153 (1993)). SPROUT is available from the University of Leeds, UK.
5. Rachel—C. Ho “Sophisticated tools for optimization of lead compounds”. Available from Tripos Associates, St. Louis, Mo.
6. SKELGEN—M. Stahl et al “A validation study on the practical use of automated de novo design” J Comput Aided Mol Des. 2002; 16: 459-78. Available through DeNovo Pharmaceuticals, Cambridge, UK.

Other molecular modeling techniques may also be employed in accordance with this invention [see, e.g. N. C. Cohen et al., “Molecular Modeling Software and Methods for Medicinal Chemistry, J. Med. Chem., 33, pp. 883-894 (1990); see also, M. A. Navia and M. A. Murcko, “The Use of Structural Information in Drug Design”, Current Opinions in Structural Biology, 2, pp. 202-210 (1992); L. M. Balbes et al., “A Perspective of Modern Methods in Computer-Aided Drug Design”, in Reviews in Computational Chemistry, Vol. 5, K. B. Lipkowitz and D. B. Boyd, Eds., VCH, New York, pp. 337-380 (1994); see also, W. C. Guida, “Software For Structure-Based Drug Design”, Curr. Opin. Struct, Biology, 4, pp. 777-781 (1994)].

Compounds designed using computational methods, can then be synthesised and tested in an in vitro model, to measure their activity. Suitable assays will be apparent to the skilled person, based on conventional assays for screening compounds against the Chorismate Synthase enzymes. For example a suitable enzymatic assay may be that revealed by Webster et al (GB patent application 0130529.1).

The present invention is based on the crystal structure of Chorismate Synthase from S. pneumoniae. However, isoforms in other microorganisms can also be prepared using the same methods, as disclosed in the Examples.

The following Example illustrates the invention.

### EXAMPLE

### Production and Purification of Wild Type and SeMet CS from Streptococcus pneumoniae

The SpCS gene was identified based on its homology to other known CS genes and proteins from non-annotated genomic sequences of S. pneumoniae deposited in the public databases. The gene was cloned by firstly amplifying the relevant region of the S. pneumoniae genome using the polymerase chain reaction and the DNA fragment corresponding to the amplified SpCS gene cloned into the expression vector pET22b. Protein was over-produced in the E. coli strain BL21 (DE3) using methods well known in the art. SpCS protein was found to be produced as a soluble, active enzyme. SpCS protein was purified using a modified protocol based on that published by Horsburgh et al., Microbiology 1996; 142(10): 2943-2950. Cells were disrupted in buffer (Buffer A: 50 mM Tris-HCL pH 7.5, 50 mM KCl, 0.5 mM DTT, 10% glycerol) by sonication and debris pelleted by centrifugation. The supernatant was applied directly to an anion exchange chromatography column (Q-sepharose, purchased from AP Biotech. Ltd) and bound protein eluted with a 150-300 mM KCl gradient in Buffer A. Fractions were collected and those containing SpCS identified by SDS-PAGE and enzyme assay. SpCS-containing fractions were pooled and applied directly to a Blue-sepharose 4B resin (Sigma Chemical Co.) pre-equilibrated with Buffer A plus 300 mM KCl. Bound protein was eluted with Buffer A plus 600 mM KCl. SpCS activity was dialysed extensively against Buffer B (25 mM KH₂PO₄, pH 7.0, 0.5 mM DTT, 10% glycerol). Cellulose phosphate P11 resin (Whatman Ltd) was prepared fresh as per the manufacturer's instructions immediately prior to use and pre-equilibrated with Buffer B. SpCS protein was applied to the resin and bound protein eluted with a 25-500 mM gradient of K PO4, pH 7.0. SpCS fractions were pooled and concentrated and finally dialysed into Buffer A plus 50% glycerol for long-term storage at −20° C.

Crystallisation of CS from S. pneumoniae. Crystal structures were prepared under two different crystallising conditions, resulting in a total of four crystal forms.

(i) CS from S. pneumoniae was crystallised by hanging-drop vapour diffusion. 2 microlitre drops of CS complex solution (10 mg/ml in 10 mM Tris pH 7.5, 2 mM EDTA, 0.5 mM DTT, 2 mM FMN, 1 mM EPSP) were mixed with an equal volume of reservoir buffer (9% PEG 8000 (w/v), 100 mM HEPES pH 7.5, 10% Ethylene Glycol). 0.2 microlitres of a 250 mM solution of NCO was then added and the drops were incubated at a constant 23° C. Monoclinic crystals (space group P21) with a=81.059, b=124.582, c=85.163, beta=115.15 degrees, grew within 1 week. Wild type and SeMet samples gave crystals in identical conditions. Orthorhombic crystals (space group P212121) with a=85.62 Å, b=125.29 Å, c=148.15 Å were also obtained using these conditions, and both crystal forms were obtained from the same drops.
(ii) CS from S. pneumoniae was crystallised by hanging-drop vapour diffusion. 2 microlitre drops of CS complex solution (10 m/ml in 10 mM Tris pH 7.5, 2 mM EDTA, 0.5 mM DTT, 2 mM FMN, 1 mM EPSP) were mixed with an equal volume of reservoir buffer (36% PEG400 (v/v), 100 mM Na/KPO₄ pH 6.2, 200 mM NaCl). The drops were incubated at a constant 23° C.; Orthorhombic crystals (space group P21212) with a=92.92 A, b=122.32 A, c=72.72 A. grew within 1 week. Monoclinic crystals (space group P21) with a=83.81 Å, b=96.02 Å, c=131.96 Å and beta=108.11 degrees were also obtained using these conditions, and both crystal forms were obtained from the same drops.
   Structure Solution and Refinement.

All data sets used to solve the SeMet CS structure were collected at ESRF, Grenoble, France, using a Mar charge-coupled detector, and were processed and reduced using programmes of the HKL and CCP4 suites. A three wavelength MAD (Multiwavelength Anomalous Dispersion) dataset was collected to 2.7 Å, and a high resolution dataset was collected to 1.9 Å. In both cases the crystals were mnonoclinic, and grown from condition (i) as described above. 30 of 48 Selenium atom positions were identified using Shake'n'Bake (SnB), and programs of the CCP4 suite were used to locate the remaining Selenium atom positions, refine these atomic parameters and to generate MAD phases. Initial maps were of sufficient quality to determine matrices describing the Non-crystallographic symmetry (NCS) within the crystal. A combination of solvent-flattening, phase extension and four-fold NCS averaging using the program DM produced traceable maps with a mean Figure of Merit (FOM) of 0.77 to 2.0 Å resolution.

The protein model was constructed using iterative cycles of model building (Quanta) and refinement (REFMAC). NCS restraints were initially applied but were relaxed as it became apparent that there were differences between NCS-related molecules. Progress of the refinement was monitored using the Free R-value. The final model contains all 388 residues of each of four monomers. All protein atoms are well defined in electron density. Each of the four active sites contains FMN and EPSP. In addition, two other FMN molecules have been identified bound to the surface of the protein. The final model also contains seven Ethylene Glycol (ETG) molecules, nine Hexaammine Cobalt (III) chloride (NCO) molecules, four sodium ions and 1925 water molecules. The R-factor of the refined model is 15.69% (Rfree=22.24%) and the geometry of the model has been verified using PROCHECK. Table 1 summarises the crystallographic data sets that were used to solve the CS structures described herein.

TABLE 1

| | Resolution | Wavelength | Completeness | Rmerge |
|---|---|---|---|---|
| Data set | (Å) | (λ) | (%) | (%) |
| SpCS SeMet peak | 2.5 | 0.9755 | 99.6 | 4.9 |
| SpCS SeMet | 2.5 | 0.9790 | 99.5 | 5.2 |
| inflection pt | | | | |
| SpCS SetMet | 2.8 | 0.8855 | 99.6 | 3.7 |
| remote | | | | |
| SpCS high resolu- | 2.0 | 0.9788 | 99.9 | 5.7 |
| tion ternary | | | | |
| SpCS CMIP | 2.0 | 0.9780 | 96.6 | 10.0 |
| inhibitor | | | | |
| SPCS CMSPD | 2.6 | 1.5418 | 99.0 | 14.0 |
| inhibitor | | | | |
| SpCS CPCD | 2.6 | 0.9792 | 99.9 | 12.8 |
| inhibitor | | | | |
| SpCS BSACB | 2.3 | 1.5418 | 95.0 | 11.3 |
| inhibitor | | | | |
| EfCS ternary | 2.7 | 0.9340 | 99.0 | 7.6 |
| DfCS apo | 2.0 | 0.9780 | 95.9 | 3.2 |
| HiCS apo | 2.05 | 0.9780 | 96.4 | 5.3 |

EFCS and HiCS represent Chorismate Synthase from Enteroccoccus faecalis and Haemophilus influenzae respectively
Structure of SpCS/Inhibitor Complexes Derived from SpCS Crystals Soaked with Four Distinct CS Inhibitors

Complex structures were derived for the CS inhibitors 5-carboxymethoxy-isophthalic acid (CMIP), 4-carboxymethylsulphonyl-pyridine-2,6-dicarboxylic acid (CMSPD), 4-(4-carbamoyl-phenoxy)-3-cyano-benzoic acid (CPCD) and benzenesulphonylamino-5-((E)-2-carboxyvinyl)-benzoic acid (BSACB).

SpCS-inhibitor soak data sets were collected at Daresbury Laboratory, Warrington, UK, using an ADSC quantum4 charge-coupled detector, or in-house using a Rigaku/MSC RaxsIV++ imaging plate and were processed and reduced using programmes of the HKL and CCP4 suites. The protein structure was solved by Molecular Replacement using AmoRe, and initial electron density maps showed clearly that the inhibitors were present at the EPSP site in each case. A representation of the inhibitor was built using Cerius2 and was fitted into the electron density. Iterative cycles of model building (Quanta) and refinement (REFMAC) for both protein and inhibitor resulted in the final model. Residues 47-51 were not well defined by the electron density and consequently have been omitted from the protein model for each complex. Therefore, for each inhibitor, the final structure contains 383 of 388 residues for each of the four monomers within the asymmetric unit, as well as four FMN molecules and four inhibitor molecules. Table 2 summarizes the refinement statistics for each of the CS complexes.

TABLE 2

| Inhibitor | Initial Rf | Initial Rfree | Final Rf | Final Rfree |
|---|---|---|---|---|
| CMIP | 33.0 | 32.8 | 16.1 | 24.7 |
| CMSPD | 35.3 | 35.9 | 20.3 | 28.9 |
| CPCD | 32.9 | 32.8 | 23.7 | 30.5 |
| BSACB | 29.7 | 29.8 | 20.8 | 25.4 |

Three-dimensional structure of Chorismate Synthase-FMN-EPSP complex.

The structure of SpCS shows the tetrameric arrangement of monomers. Within each tetramer, there are two intimately associated dimers, which pack together much less tightly to give the overall tetrameric assembly. The monomeric structure of SpCS has been compared with the three-dimensional structures of related R-binding and FAD-binding) and unrelated proteins, and no significant structural homologies have been observed. The overall fold of SpCS is therefore unique with respect to all known structures, and accurate modelling of the three-dimensional coordinates of CS would have been impossible from the sequence alone.

The SpCS monomer consists of a single large core domain, which is surrounded by various loops and discrete stretches of secondary structure. This domain consists of an internal layer of four long alpha helices, flanked on either side by four-stranded beta-sheets. Beta-alpha-beta secondary structure arrangements are very uncommon and only a few are described in the SCOP database of standard protein fold classifications (Murzin et al, J. Mol. Biol., 1995; 247: 536-540).

1) Secondary Structure Definitions.

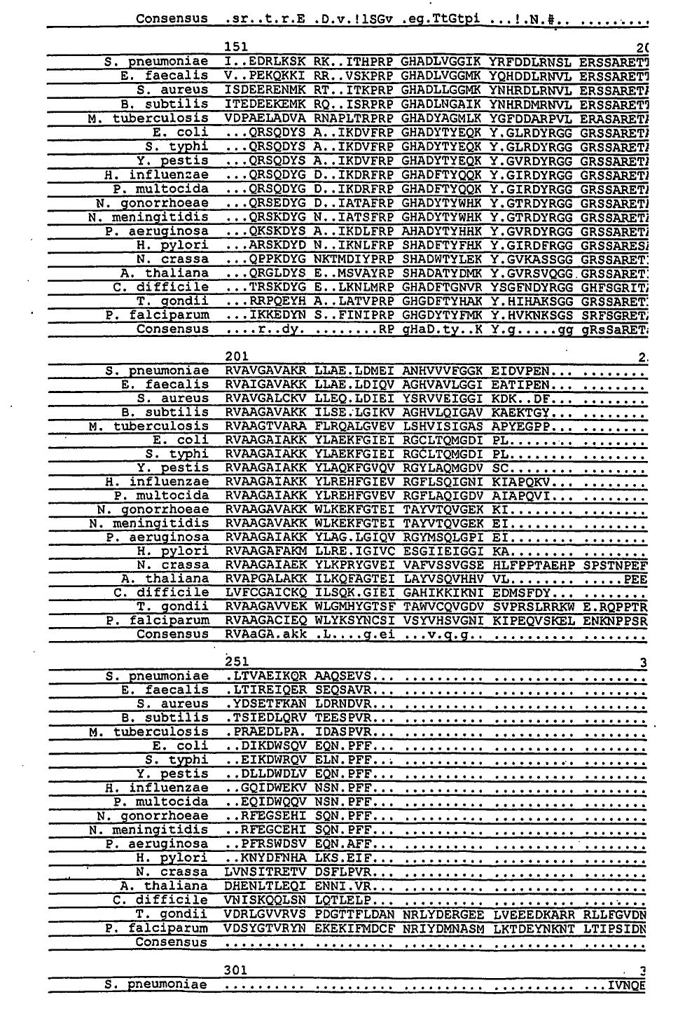

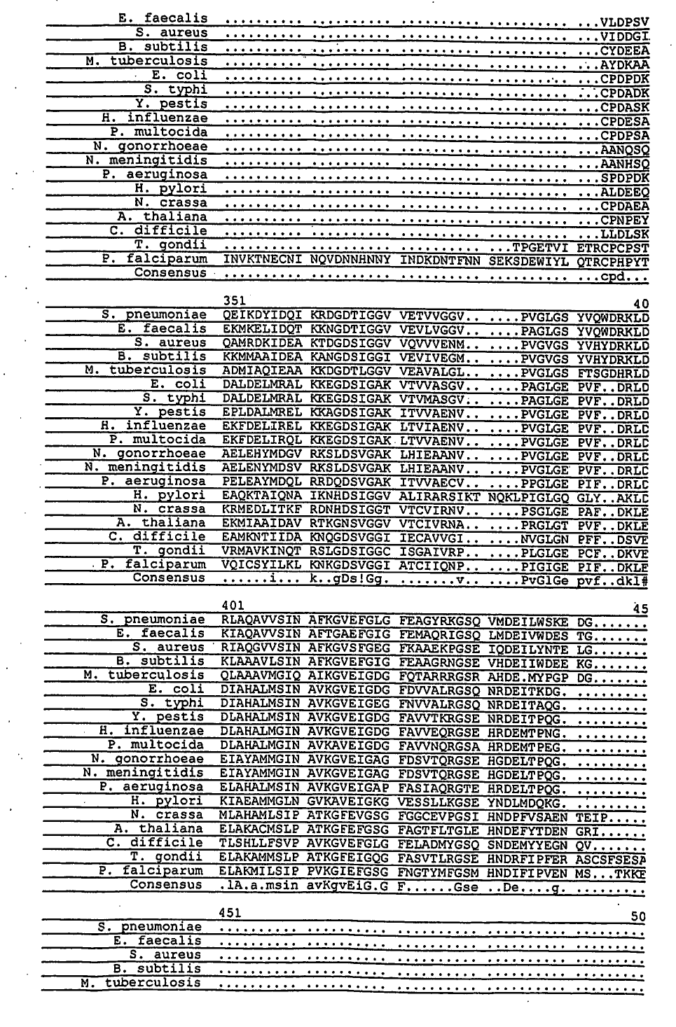

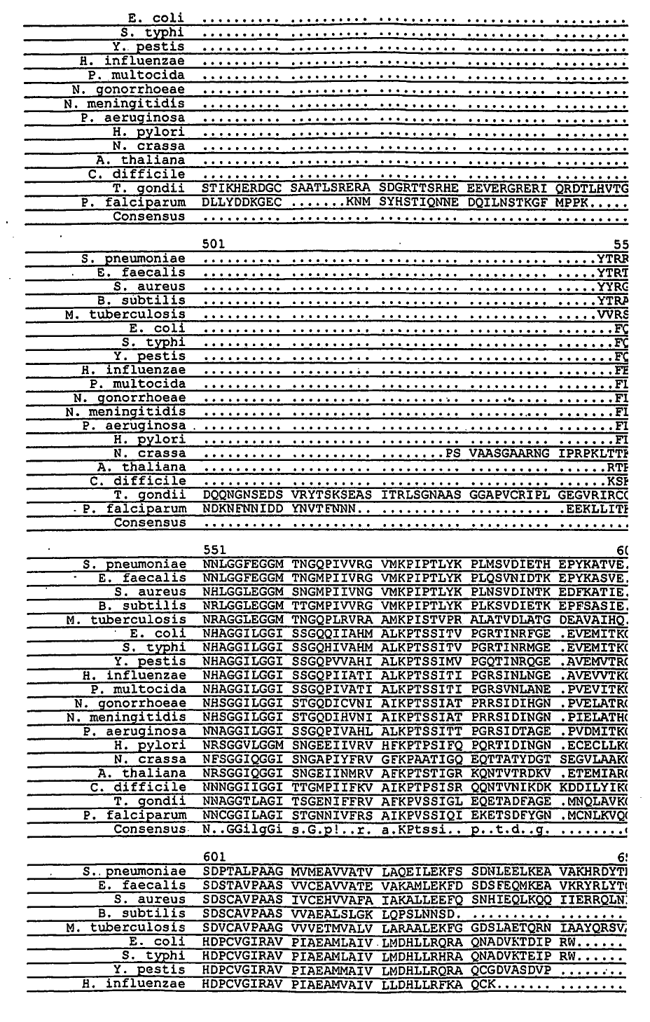

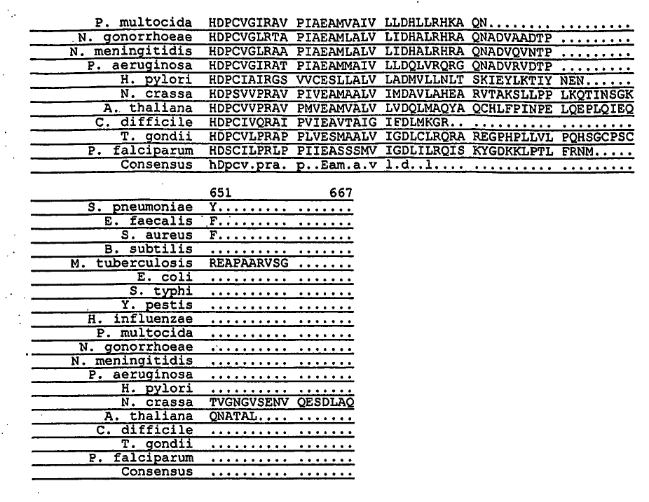

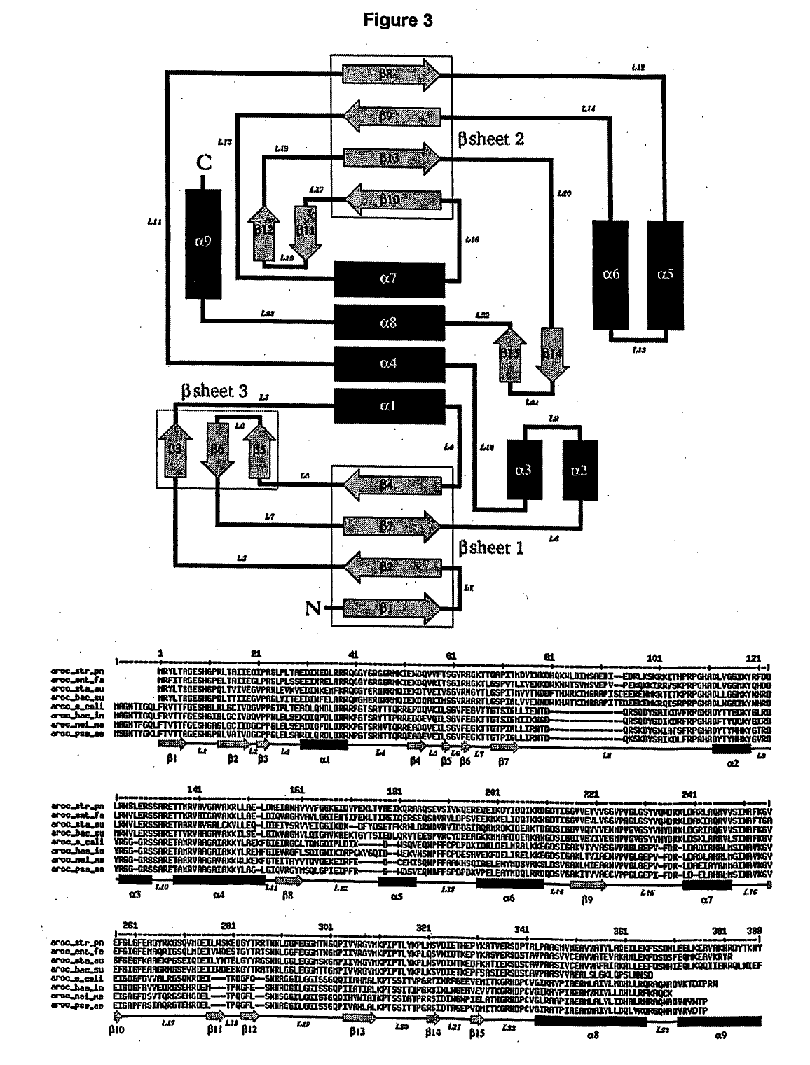

Beta-sheet 1 includes the N-terminus of the protein, and consists of beta-strands B1, B2, B7 and B4 in an anti-parallel arrangement (see FIG. 3 for definition of secondary structure elements). The central helix layer consists of helices A1, A2, A6 and A5, arranged up-down-down-up. The second beta-sheet is also anti-parallel, and consists of strands B8, B10, B14 and B11. The FMN-binding site is at the interface between beta-sheet 2 and one end of the helix layer. At this point the four helices diverge to leave a small hydrophobic pocket which is part of the binding site for the FUN isoalloxazine ring system. The remainder of the FMN and EPSP-binding sites are formed by beta-sheet 2 and several loops lacking defined secondary structure. The active site is described in more detail below.

2) Description of Dimer and Tetramer Interfaces.

The major SpCS dimer is quite elongated in shape, but nevertheless it appears to be tightly associated. The major feature of the dimerisation interface is the extension of beta-sheet 2 from each monomer into an eight-stranded anti-parallel beta sheet. The two beta sheets come together at strand B11, providing four good hydrogen bonds, but there are many other strong interactions at the dimer interface. The only other secondary structure element which is heavily involved in stabilisation of the dimer is helix A5, which sits directly below B11 in the monomer. This pair of symmetry-related helices pack together along their length at the interface, and while they do not form any specific hydrophilic interactions they bury a considerable amount of hydrophobic surface when they interact. Several other regions of the structure are involved in dimerisation, notably loops between B5 and A10, and between B11 and B14, which extend out from the monomer and pack against the dimer partner. Although there are many strong hydrogen-bonding interactions, there is only one possible salt-bridge at the dimer interface-Lys 238 of one monomer interacts (via water) with the phosphate portion of the active site FMN molecule from its neighbour.

The major component of the tetramerisation interface is beta sheet 1 from each monomer. This sheet is involved in a beta-sandwich type interaction with the equivalent portion of an adjacent dimer. In addition, there are loops on either side of this sheet which are also involved in the dimer-dimer interaction, most notably the loop between strand B7 and helix A2, and the short beta sheet formed by strands B3, B5 and B6. Although much of this interface is hydrophobic, there are several significant hydrogen-bonding interactions, and two strong salt-bridges which are clearly important to the integrity of the tetramer. Arg 13 and Asp 75, which are adjacent on one monomer and close to one of the non-crystallographic symmetry axes, form salt-bridges with the respective NCS-related residues on the second monomer. These bonds appear to be strong, based on the inter-residue distances and on the directionality of the interaction. There are further ion-pair interactions between Arg 63 and Asp 123, and Arg 120 and Asp 372.

3) Active Site Definition.

Within the ternary crystal structure, the enzyme is present in two distinct states, which are here designated the “open” and “closed” forms. In the “open” form a portion of the active site is solvent-accessible, while in the “closed” form neither of the ligands at the active site is accessible to solvent. These differences can be ascribed purely to the motions of several of the loops surrounding the active site. Therefore while the “closed” form must approximate to the transition state conformation of the protein, the “open” form can be considered to be a snapshot of an active site near the beginning or end of the reaction cycle, allowing either entry of substrate or departure of products from the active site. As both conformations are accessible to the protein, both are therefore valid targets for the identification of potential inhibitors or agents by the methods claimed.

Although CS binds both a substrate and a cofactor, these two ligands are tightly associated with each other, and the enzyme can be considered to have a single active site or ligand-binding site. The FMN molecule is buried deep within the enzyme, and EPSP binds on top of the remaining exposed portion of the isoalloxazine ring system, completely burying FMN. For this reason, each of the two ligands forms part of the binding site for the other.

As described above, one end of beta-sheet 2 provides a flat, fairly hydrophobic surface against which the FMN isoalloxazine ring system packs. The ribityl portion of FMN is well buried, sandwiched between three loops which provide interactions with the FMN hydroxyl and phosphate groups. In the monomer, the FMN phosphate is solvent accessible, but this group is completely buried on dimerisation. The FMN phosphate is coordinated by three Lysine residues, Lys 311, Lys 254 (via water) and Lys 238 (via water), and has close contacts with main-chain nitrogen atoms of Gly 296 and Ala 252. The interactions with Lys 238 and Gly 296 may be particularly significant as these residues belong to the adjacent molecule within the major dimer, and hence they contribute to stabilisation of the dimer.

Although the FMN has been described as well buried in the structure of the CS dimer, there are a considerable number of solvent molecules close to both the phosphate and ribityl regions of FMN. These water molecules are discrete and well-ordered, and many mediate interactions between FMN and CS, while a few also coordinate EPSP. FMN oxygens O5* and O4* are surrounded by several solvent molecules, and neither makes any direct interactions with the protein. Oxygen O3* also makes no interactions with CS, but is involved in a strong intramolecular hydrogen bond with one of the FMN phosphate oxygens, which is likely to stabilise FMN in the conformation present in the active site. Oxygen O2* is the only FMN atom which makes a direct interaction with EPSP—there is a hydrogen bond between O2* and one of the oxygens of the EPSP carboxylate. O2* also coordinates the side-chain nitrogen of conserved residue Asn 251.

In contrast to the remainder of the molecule, the isoalloxazine ring system makes few specific interactions with CS, but nevertheless it helps to bury a considerable area of hydrophobic surface. Unusually for an FMN-binding protein, there are no pi-stacking interactions between protein and FMN; instead the binding surface for the isoalloxazine rings is formed by small hydrophobic residues Ala 342, Ala 346, Ala 252, Ile 313 and Met 310. This may help the protein to accommodate FMN in the reduced state, in which the isoalloxazine system is proposed to bow slightly around the two central nitrogen atoms.

Interactions made by the pyrimidinedione portion of the isoalloxazine ring system are affected by the conformations of active site loops which determine whether the protein is in the “open” or “closed” state. The catalytic histidine residue His 110 is close to both N1 and O2 of FMN in the “open” state, and appears to be hydrogen-bonded to O2 in the crystal structure. However, in the “closed” state, the histidine side-chain moves relative to FMN and no longer interacts. The movement of His 110 is correlated with a change in conformation of the loop between residues Pro 314 and Leu 320, which results in residue Thr 315 coming considerably closer to FMN in the “closed” form. FMN O2 is 3.4 Å from 315 N in the “open” form, but the main-chain nitrogen makes a stronger hydrogen bond in the “closed” form and is just 3.1 A from O2. In addition, the conformation of the side chain of Thr 315 changes; allowing the side-chain hydroxyl to also make a hydrogen-bonding interaction with O2 of FMN.

The change of conformation of the loop containing Thr 315 is associated with a concerted change in the conformation of the loop between residues Tyr 331 and Pro 340. In the “open” form, residues from this loop are involved in protein-FMN interactions, but each of these is mediated by solvent. Two water molecules make strong hydrogen bonds to N3 and O4 of FMN, and are also hydrogen-bonded to the side-chains of residues Ser 338, Asp 339 and Arg 45. In the “closed” form, the positions of several of the residues between 331 and 340 change considerably, and the loop moves closer to the FMN molecule, displacing the two water molecules bound to N3 and O4 of FMN. Consequently, both N3 and O4 of FMN make direct interactions with the protein when CS is in the “closed” form, which will impart considerable binding energy. The main chain of Asp 339 moves by over 1.7 Å to allow a hydrogen bond from FMN O4 to the main chain nitrogen of residue 339. There is a more pronounced shift of almost 3 Å in the position of Ser 338, resulting in the side-chain oxygen of this residue sitting within 0.6 Å of the position of one of the water molecules displaced from the “open” form, and making a hydrogen bond to FMN N3.

The remaining FMN heteroatom is N5, which does not make any direct interaction with the protein, but is hydrogen-bonded to a water molecule in both “open” and “closed” forms of the enzyme. In each case the solvent molecule is also hydrogen-bonded to both Arg 45 and Asp 339. In addition to this interaction, N5 sits almost directly under C2 of EPSP, and is poised to abstract the pro-R hydrogen atom which points down towards it. Asp 339 acts as a base to deprotonate N5 of FMN, thus facilitating the removal of the C6-pro-R proton from EPSP. The separation of atoms N5 and C2 is 3.5 Å in both “open” and “closed” forms of CS.

Although EPSP makes just one interaction with FMN, there are extensive interactions between EPSP and the enzyme. The enol-pyruvyl moiety is particularly tightly bound, with three conserved Arginine residues forming an enclosed binding site. There is a strong salt-bridge interaction with Arg 39, with N—O separations of 2.6 Å (NH1-O20) and 2.9 Å (NH2-O19). In addition, there are further strong hydrogen bonds from O20 to Arg 45 NH2 (2.7 Å) and from O19 to Arg 134 NH1 (3.1 Å). These residues and others in the immediate environment form a tight pocket within which the pyruvyl moiety fits snugly. O15 of EPSP makes an additional interaction with NH2 of Arg 45, and the vinyl group is surrounded by the aliphatic portions of Arg 134 and Arg 48.

The interactions of the second carboxyl group of EPSP have already been described. There is a hydrogen bond to O2* of FMN, and also an interaction with His 110 (“closed” form) orwith a solvent molecule which is also boundcto His 110 (“open” form). There is one other interaction—in both forms of the enzyme there is a water-mediated interaction between EPSP O8 and NH1 of conserved Arg 107. This residue is held in place by an interaction with Asp 112 (both residues completely conserved) and its position is identical in both “open” and “closed” forms.

O21 of EPSP appears to make little contribution to binding. It makes a single water-mediated interaction with the side-chain of Asp 339, the position of which is affected very little by the change in conformation of adjacent residues.

In contrast, the binding of the phosphate group of EPSP is influenced to a much greater extent by the conformation of the loop between residues 331 and 340. In particular, the guanidinium portion of Arg 337, which sits at the apex of the loop, interacts strongly with the EPSP phosphate when in the “closed” conformation, but is displaced by almost 10 Å away from the active site in the “open” conformation. In both forms, the phosphate group is liganded by the side-chains of His 10 and Arg 48. In the “open” form, the phosphate makes no further interactions with the protein, and is surrounded by a number of solvent molecules. However, in the “closed” form, the phosphate makes direct hydrogen bonds to both the main chain carbonyl and the guanidinium group of Arg 337, this latter a strong salt-bridge interaction. The interaction with the carbonyl of Arg 337 necessitates a proton on the phosphate oxygen, and allows the likely protonation states of the remaining phosphate oxygen atoms to be assigned. O10 of EPSP shows a strong H-bond to a water molecule in both “open” and closed forms of the active site. This water is additionally coordinated by the sidechains of the completely conserved Serine residues. Ser 9 and Ser 132. Its position, allied to the fact that it is very tightly bound (low B factor), suggests a possible role in the catalytic mechanism. It interacts directly with O10 of EPSP, and as it makes the only strong H-bond with this atom, it is likely to be involved in stabilising the partial negative charge that will build up on O10 as the bond between it and C1 lengthens and ultimately is broken. This water molecule is conserved in the inhibitor structures, except for the BSACB structure in which it is displaced by one of the inhibitor oxygens, and again is very well-ordered in relation to adjacent solvent by comparison of temperature factors. The positions of several other water molecules are conserved in each of the CS crystal structures, and therefore define a number of interaction points for potential inhibitors, as demonstrated by the displacement of one of them by a carboxylate oxygen in the SpCS-CMSPD structure.

In addition, EPSP makes water-mediated hydrogen bonds with a number of other main and side-chain atoms, including the side chain of Arg 101. The side chain conformation of this residue changes considerably between the two forms of the enzyme in order for this interaction to be possible.

4) Three-Dimensional Structure of Chorismate Synthase-FMN-CMIP Complex.

The structure of CMIP bound to the complex of SpCS and FMN was determined to 2.0 Å resolution. An overlay of the protein coordinates from the CMIP and ternary structures showed that there were few-significant differences between them. The most significant of these was the absence of the “open” form of the SpC1 active site in the inhibitor-bound structure. This has subsequently been demonstrated to be a consequence of the orthorhombic symmetry of the inhibitor structure; as opposed to the monoclinic symmetry of the ternary structure. Crystal contacts, present in the monoclinic form but not in the orthorhombic form, are responsible for the presence of the “open” form of the active site in the ternary structure. Thus each of the four monomers within the SpC1-FMN-CMIP structure has the “closed” conformation at the active site. Comparison of the Cα positions of the “closed” forms of both ternary and inhibitor structures shows they are essentially identical, with an RMSD of 1.2 Å. Although the protein backbone follows the same path in each case, there are differences in sidechain positions due to the absence of the EPSP phosphate group in the inhibitor structure. When the phosphate group is present, it makes a number of interactions (as described above), which cannot be fulfilled in the inhibitor structure. In particular, the sidechain of Arg 337, which is critically involved in coordination of the EPSP phosphate, adopts a very different conformation in the inhibitor structure. The other region in which there are differences which have a significant effect on the active site is the loop between residues Tyr 43 and Glu 52, which has a helical conformation in the ternary structure. Five residues at the centre of this loop—Gly 47 to Ile 51—were impossible to place in the electron density for the inhibitor structure, but from the positions of the residues on either side of the missing ones it is clear that this loop does not occupy the same region of space as in the ternary structure. This is also a consequence of the absence of the phosphate group of EPSP-Arg 48 at the apex of the ‘missing’ loop is another residue which makes a strong hydrogen-bond interaction with the phosphate group, and it is therefore likely that this interaction is required in order to tie this loop into the helical conformation. Although five residues are missing from this loop, it is clear from the positions of those residues which it has been possible to fit, that the loop (from Tyr 43 to Glu 52) has flexed out of the active site, and therefore increases the space which is available at the EPSP site, specifically at the O21 (hydroxyl) and C17 (vinyl) positions as well as that of the phosphate. Each of the other SpCS-inhibitor structures has also been determined in this orthorhombic crystal form, therefore only the closed form of the active site is present in each structure. The structural differences outlined above for the CMIP structure are also observed for each of the other inhibitor structures described below.

CMIP mimics each of the interactions made by the two carboxyl groups of EPSP. When the protein coordinates from the ternary and CMIP structures are overlaid, the positions of the oxygen atoms of the two carboxylate groups from each ligand superimpose almost exactly. Both EPSP and CMIP possess two carboxylate groups separated by a five atom chain in a trans configuration, and this simple motif appears to be a major determinant of the binding of each molecule. One difference however, is that in EPSP the majority of the five linker atoms, and all of those within the EPSP ring, are saturated and are sp3 hybridised. In contrast, three of the five linker atoms in CMIP come from the phenyl ring, and therefore the majority of the linker in this case is unsaturated and sp2 hybridised. Although the carboxymethoxy chain has two sp3 hybridised atoms, these are almost coplanar with the inhibitor phenyl ring. The inhibitor, therefore, represents a second method of placing the two vital carboxylate groups in the appropriate positions to make the interactions corresponding to those of EPSP. Lacking the saturated ring system of EPSP, and the subsequent kink at C5, the inhibitor compensates with an almost planar system in which several of the bonds within the five atom linker are shorter than those in EPSP itself. Despite this, the distance between the carbon atoms of the carboxylate groups in CMIP (7.2 Å) is slightly longer than in EPSP (7.0 Å)—this suggests that there is the potential to improve the affinity of the inhibitor by shortening this distance.

While the two carboxylate groups therefore overlay well, the remainder of the two molecules do not. Their central rings occupy quite different regions of the active site. Specifically, while the carboxylate which sits above FMN and interacts with His 110 in EPSP is the one which is directly attached to the central ring, the corresponding interaction in the inhibitor structure is made by the carboxylate which is not directly attached to the phenyl ring. The central rings of the two ligands therefore do not overlap at all. The central ring of the inhibitor sits considerably further out of the plane of the FMN rings than EPSP, and therefore comes into van der Waals contact with the main chain atoms of Ala 133 and Arg 134, as well as packing against the aliphatic portion of the sidechain of Arg 134. EPSP, in contrast, has a central ring which kinks in such away as to place several atoms (C1, C6 and pendant hydroxyl oxygen O21) close to the plane of the FMN rings. This does not bring these atoms close enough to the protein for any direct interactions, as discussed above, but it does bring EPSP closer in space to Arg 45 and Asp 339, both of which interact with O21 via a water molecule.

Although CMIP exhibits a 1,3,5-substitution pattern on a central six-membered ring, analogous to that seen in EPSP, the remaining substituent (5-carboxylic acid) does not come close to overlapping the corresponding moiety in EPSP (the phosphate group). Instead, the 5-carboxylic acid of CMIP sits approximately in the position of the guanidinium group of the Arg 48 sidechain. As already discussed, this prevents this region of the protein from adopting its ternary conformation, but also has the effect that the inhibitor is unable to fulfill any of the interactions which are made by the EPSP phosphate group. Despite the fact that the protein is in the “closed” conformation, the residues on the “lid” are too remote from and have incorrect orientations relative to the 5-carboxylate of the inhibitor to be able to make any interactions. There is therefore slightly more space in this region of the active site in the inhibitor structure, and this space is filled by solvent molecules, several of which make strong interactions with the 5-carboxylate. There are also ‘a number of solvent molecules’ whose positions are conserved in both crystal structures. Of particular interest is the water molecule which mediates the interaction between Ser 9, Ser 132 and O10 of EPSP, which has been discussed previously.

5) Three-Dimensional Structure of Chorismate Synthase-FMN-CMSPD Complex.

The structure of CMSPD bound to the complex of SpCS and FMN was determined to 2.6 Å resolution. An overlay of the protein coordinates from the CMSPD and ternary structures showed that there were few significant differences between them. Comparison of the Calpha positions of the ternary “closed” form with that of the CMSPD structure showed they are essentially identical, with an RMSD of 0.62 Å. As was the case for the CMIP structure, five residues between Gly 47 and Ile 51 were impossible to place in the electron density for the CMSPD structure. It is clear from the positions of surrounding residues which it has been possible to fit, that the loop bearing those residues (from Tyr 43 to Glu 52) has flexed out of the active site, and therefore increases the space which is available at the EPSP site, specifically at the O21 (hydroxyl) and C17 (vinyl) positions as well as that of the phosphate.

CMSPD mimics the interactions made by the carboxylate groups of EPSP, in a similar way to CMIP. Once again, when the protein coordinates from the EPSP, CMIP and CMSPD complexes are overlaid, the positions of the oxygen atoms of the carboxylate groups from each ligand superimpose almost exactly. Both CMSPD and CMIP possess two carboxylate groups separated by a five atom chain in a trans configuration, and this simple motif appears to be a major determinant of the binding of each molecule. In contrast to the binding mode of CMIP, the position of the central phenyl ring of CMSPD is closer to that of EPSP when each of the ligands is overlaid. In CMSPD, it is the benzoic acid carboxylate which interacts with FMN O2 and the sidechain of His 110. The pendant thio-acetate group mimics the conformation of the enol-pyruvate moiety in EPSP, making similar interactions with the sidechains of Arg 39, Arg45 and Arg 134. In contrast with CMIP, the remaining carboxylate group sits in a position close to that occupied by the phosphate group of EPSP. This allows a hydrogen bond between the carboxylate group and the sidechain of His 10, as well as a water-mediated interaction with Arg 107. The formation of these extra interactions appears to be the reason for the difference in binding modes of CMIP and CMSP.

6) Three-Dimensional Structure of Chorismate Synthase-FMN-CPCD Complex.

The structure of CPCD bound to the complex of SpCS and FMN was determined to 2.6 Å resolution. An overlay of the protein coordinates from the CPCD and ternary structures showed that there were few significant differences between them. Comparison of the Calpha positions of the “closed” forms of both ternary and CPCD structures shows they are essentially identical, with an RMSD of 1.15 Å. As in the CMIP structure, five residues between Gly 47 and Ile 51 were impossible to place in the electron density for the inhibitor structure. The movement of this loop away from the active site creates additional space in the region occupied by the phosphate group of EPSP in the ternary structure, which is exploited in the binding of CPCD.

CPCD differs from CMIP and CMSPD in possessing just a single carboxylate group. It is this benzoic acid that mimics the interactions with O2 of FMN and the sidechain of His 110. In contrast with EPSP and the other inhibitors, CPCD uses a cyano functionality to interact with Arg 39. Cyano is a poor mimic for a carboxylate group in this position as it forms just a single hydrogen bond with Arg 39, in contrast to the four hydrogen bonds formed by EPSP (two with Arg 39, one each with Arg 45, Arg 134). CPCM also differs from CMIP and CMSPD in possessing a link to a second phenyl ring, making the molecule longer, with the consequence that CPCD extends considerably farther out of the active site than the other inhibitors. Although the ether oxygen of CPCD makes no direct interactions with the protein, the terminal carboxamide forms a hydrogen bond with NE of the fully conserved Arg 337, and also makes water-mediated interactions with main chain carbonyls of Arg 45 and Gly 47. Although the carboxamide is extending out of the active site towards regions of the protein that are not fully conserved, the observed interactions are with mainchain atoms whose positions are restricted, or with conserved sidechain atoms. In this structure, the sidechain of Arg 337 has moved slightly from its position in the EPSP structure in order to make the observed hydrogen bond with the carboxamide oxygen. While the replacement of the second carboxylate with a cyano group reduces the number of interactions made by the inhibitor at the common interaction points, the overall shape fit of CPCD and the extra interactions made by the carboxamide group compensate for this.

7) Three-Dimensional Structure of Chorismate Synthase-FMN-BSACB Complex.

The structure of BSACB bound to the complex of SpCS and FMN was determined to 2.3 Å resolution. An overlay of the protein coordinates from the BSACB and ternary structures showed that there were few significant differences between them. Comparison of the Calpha positions of the “closed” forms of both ternary and BSACB structures shows they are essentially identical, with an RMSD of 0.67 Å. As in the other structures, the absence of five residues between Gly 47 and Ile 51 creates additional space in the region occupied by the phosphate group of EPSP in the ternary structure, which is exploited by BSACB.

BSACB possesses two carboxylate groups, which mimic the interactions made by the two carboxylates of CMIP, CMSPD and EPSP. The binding mode is similar to that of CMIP, the interaction with Arg 39 being made by the benzoic acid moiety, while the carboxylate of the cinnamic acid moiety makes the interaction with O2 of FMN and the sidechain of His 110. The sulphonamide linker group is positioned close to the location of the EPSP phosphate group in the ternary structure, although it does not make any interactions with the corresponding residues. However, one of the sulphonamide oxygen atoms sits in a position that is occupied by a conserved water molecule in the EPSP structure. This water molecule is coordinated by Ser 9 and Ser 132, and also interacts with O11 of EPSP. The second phenyl ring of BSACB lacks the functionality to make any further specific interactions, but provides a complementary shape fit with the surface of the active site.

8) The use of Molecular Replacement to Solve a Novel CS Structure.

The method of Molecular Replacement was used to determine the three-dimensional coordinates of CS from each of the pathogenic bacteria Enterococcus faecalis and Haemophilus influenzae. The crystal structure coordinates of CS from Streptococcus pneumoniae were used as a starting model in order to determine approximate phase information. Said phases were used in the determination of electron density maps, which were treated as described above. The differences (both sequence and structural) between these new Chorismate Synthases and the starting model were apparent from these maps, allowing the accurate determination of the three-dimensional coordinates of EFCS and HICS.

Definition of the CS Active Site.

The residues composing the CS active site can be divided into two groups. First, there are the residues which are involved in contacts between the protein and FMN (the ‘FMN-binding site’). Second, there are the residues which are involved in contacts between the protein and EPSP (the ‘EPSP-binding site’). There is some overlap in the content of these two sites, although they are largely distinct. There are additional interactions between the ligand at the FMN-binding site (FMN) and the ligand at the EPSP-binding site (EPSP, CMIP CMSPD, CPCD or BSACB), and therefore each ligand can be considered to comprise part of the binding site of the other. In the structures of the inhibitor complexes described above, the inhibitor molecule is accommodated within the EPSP-binding site, and makes interactions only with residues which have been implicated in the binding of EPSP by the CS-FMN complex. Comparison of the structures of SpCS, EfCS and HiCS has shown that the active sites of each of these proteins are the same, and that the positions of the residues comprising the FMN-binding site and the EPSP-binding site are essentially identical.

The FMN-binding site comprises residues from two monomers, related by the tight dimerisation interaction. Specifically, the residues Arg 39, Arg 45, Gly 109, His 110, Ala 111, Ser 131, Ser 132, Ala 133, Thr 136, Ile250, Asn 251, Ala 252, Phe 253, Lys 254, Met 310, Lys 311, Ile 313, Pro 314, Thr 315, Arg 337, Ser 338, Asp 339, Ala 342, Ala 345, Ala 346, Val 349 from the monomer to which the FMN is bound are within 5 Å of the FMN atoms and therefore can be considered to form part of the binding site. In addition, residues Asp 240, Phe 294, Glu 295, Gly 296, Gly 297 from an adjacent monomer are also within 5 Å of FMN and form part of the binding site. In addition, residue Lys 238, also from the adjacent monomer, is more than 5 Å from FMN but is involved in a water mediated interaction with the FMN phosphate group, and therefore must also be considered to be a part of the FMN-binding site. As stated above, EPSP itself also forms part of the FMN-binding site.

The EPSP-binding site is displaced from the dimerisation interface relative to FMN, and therefore comprises residues from only the monomer to which the ligands are directly bound. Specifically, residues Ser 9, His 10, Arg 39, Arg 45, Arg 48; Met 49, Asp 154, Asp 80, Arg 107, His 110, Ser 131, Ser 132, Ala 133, Arg 134, Thr 136, Thr 137, Glu 336, Arg 337, Ser 338, Asp 339 are within 5 Å of EPSP in the closed form of the active site and therefore can be considered to form part of the EPSP binding site. As stated above, FMN itself also forms part of the EPSP-binding site.

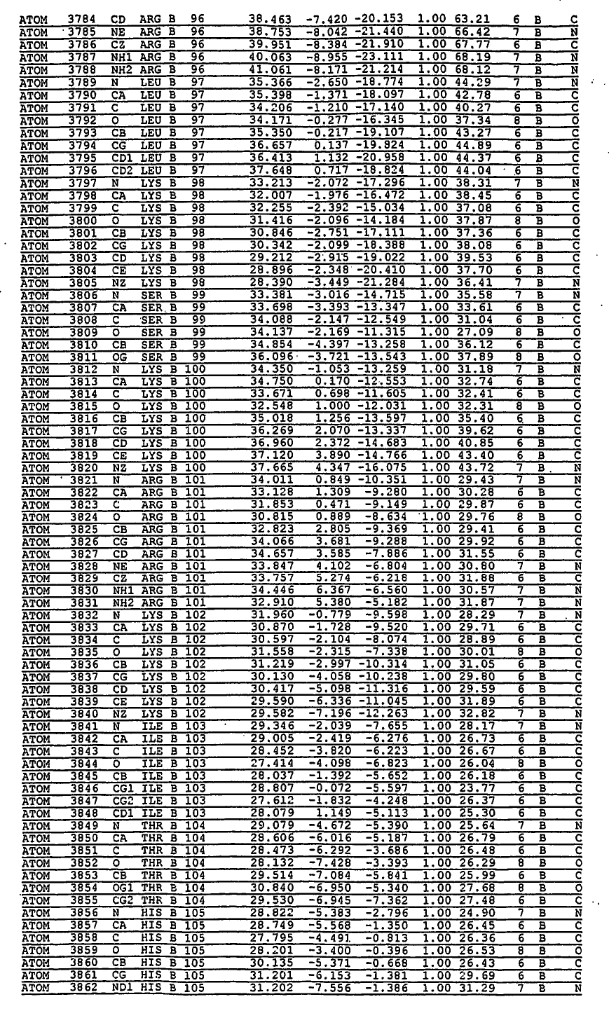

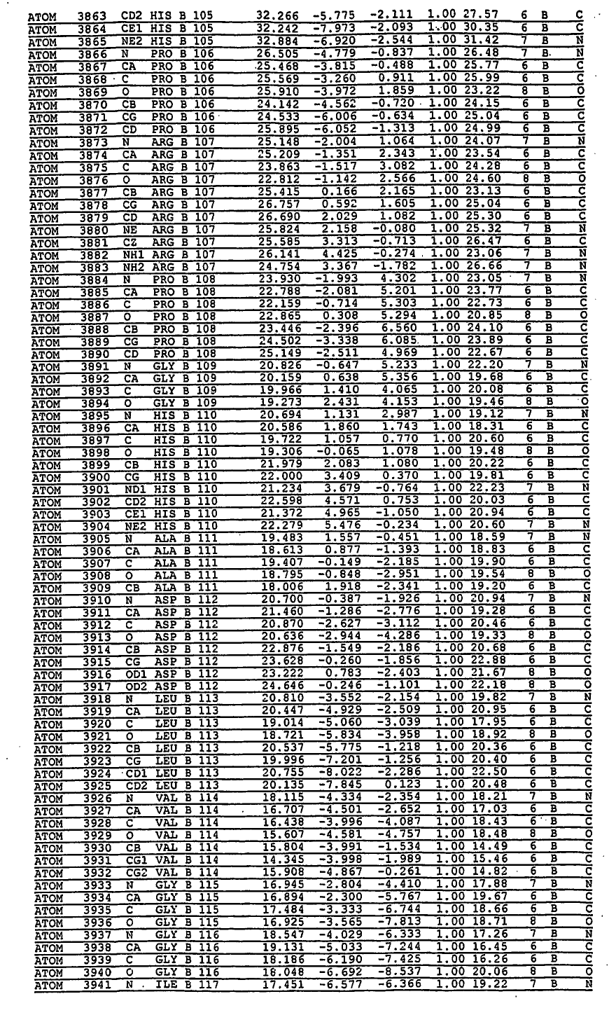

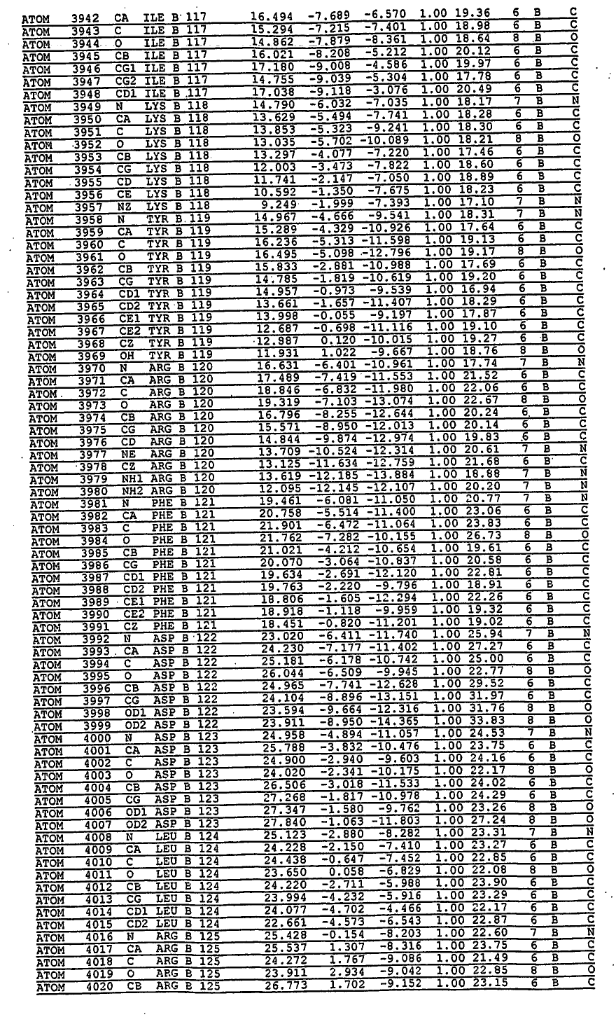

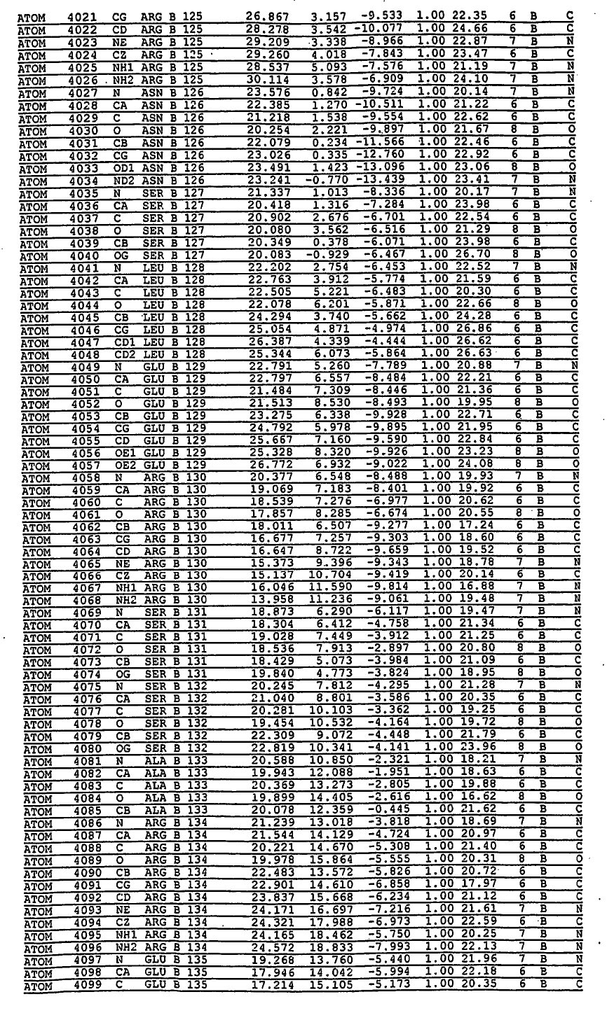

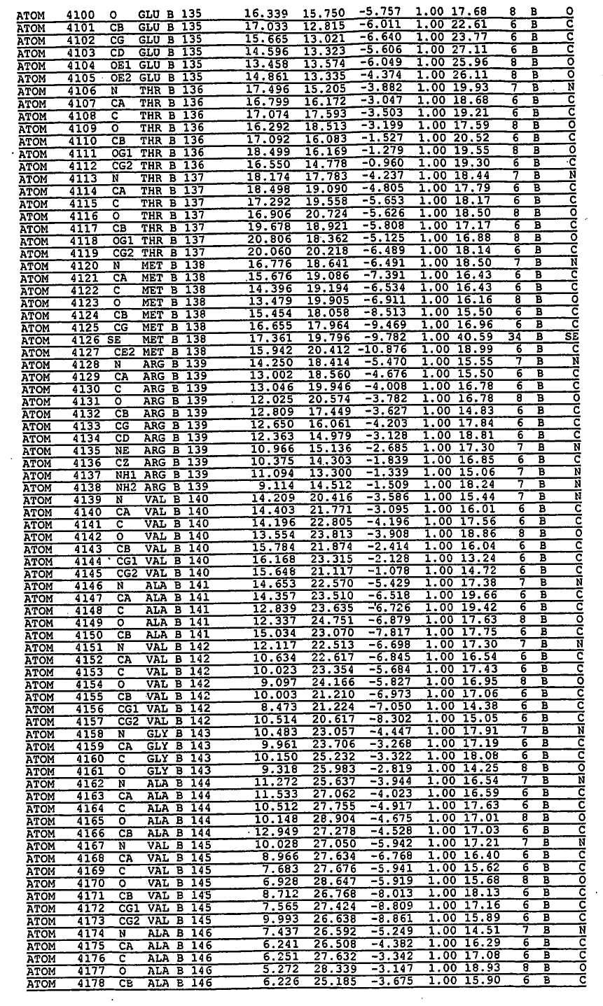

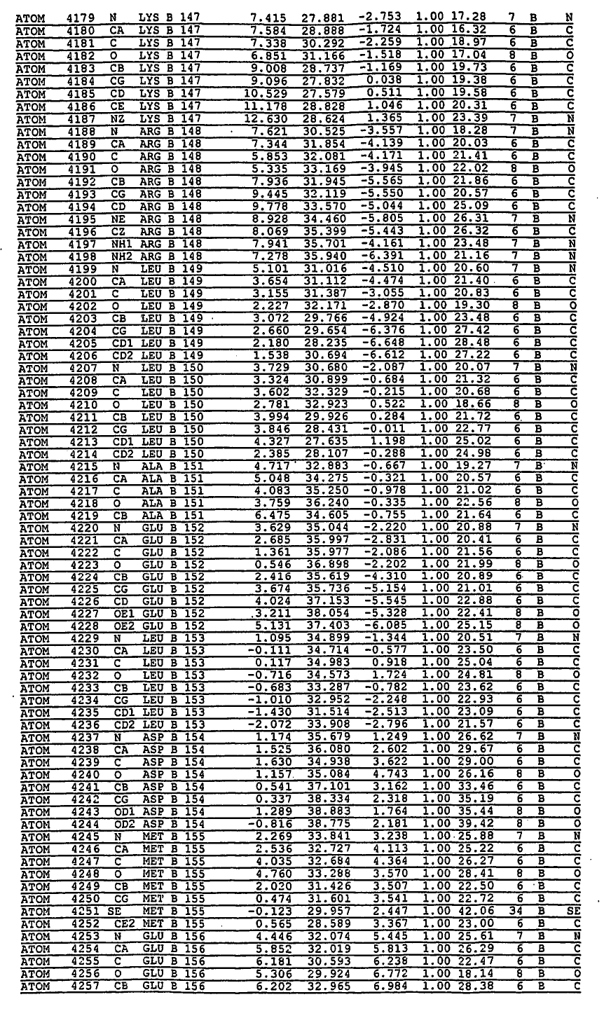

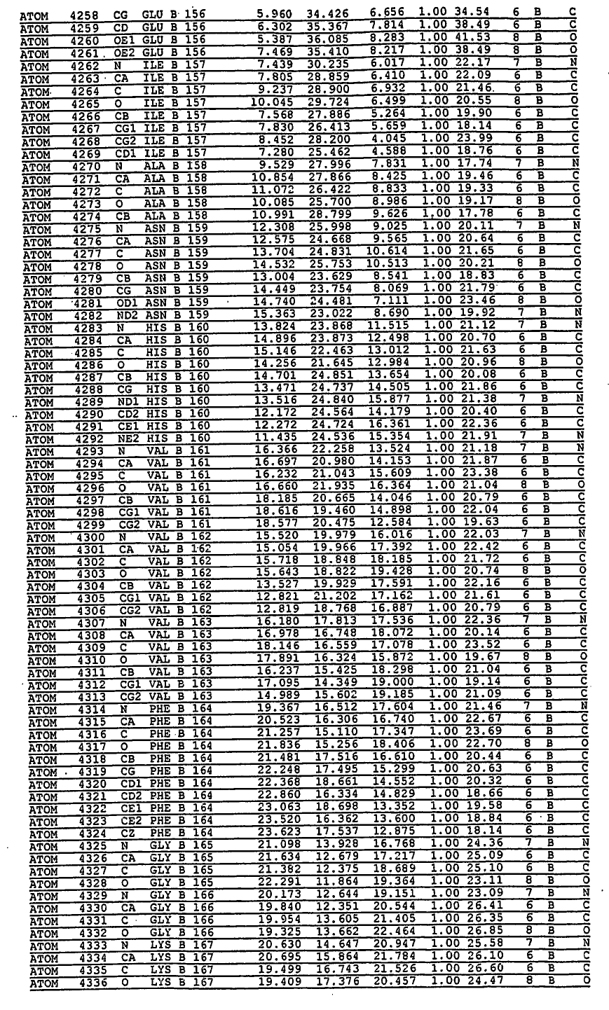

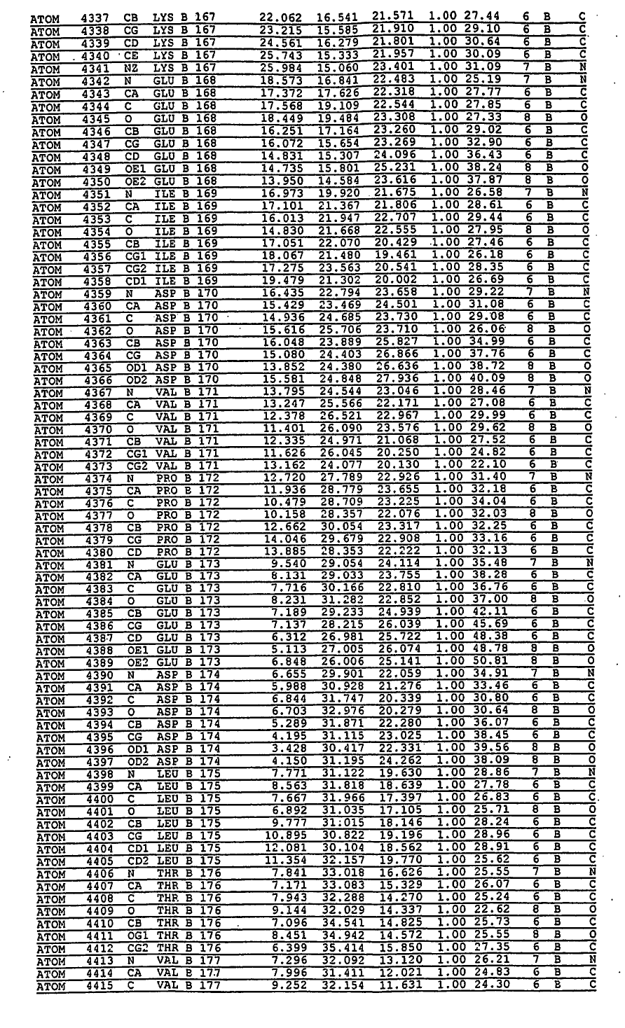

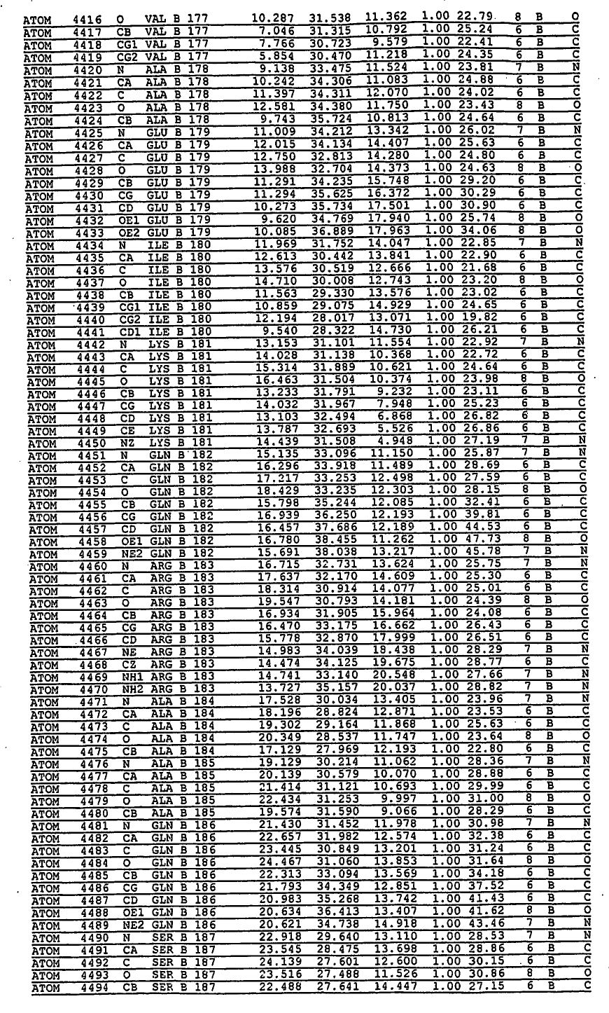

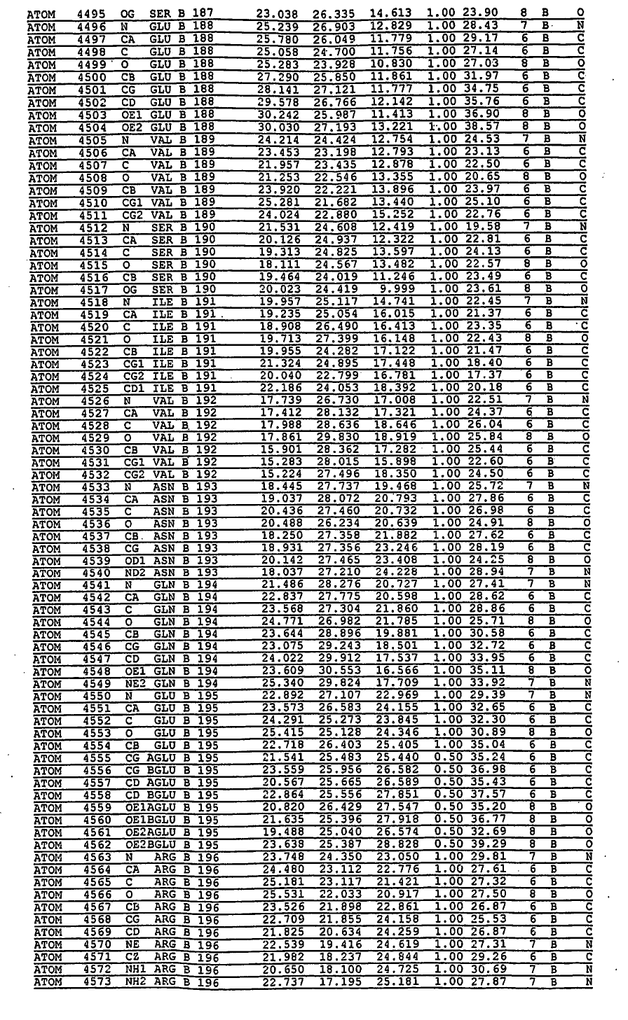

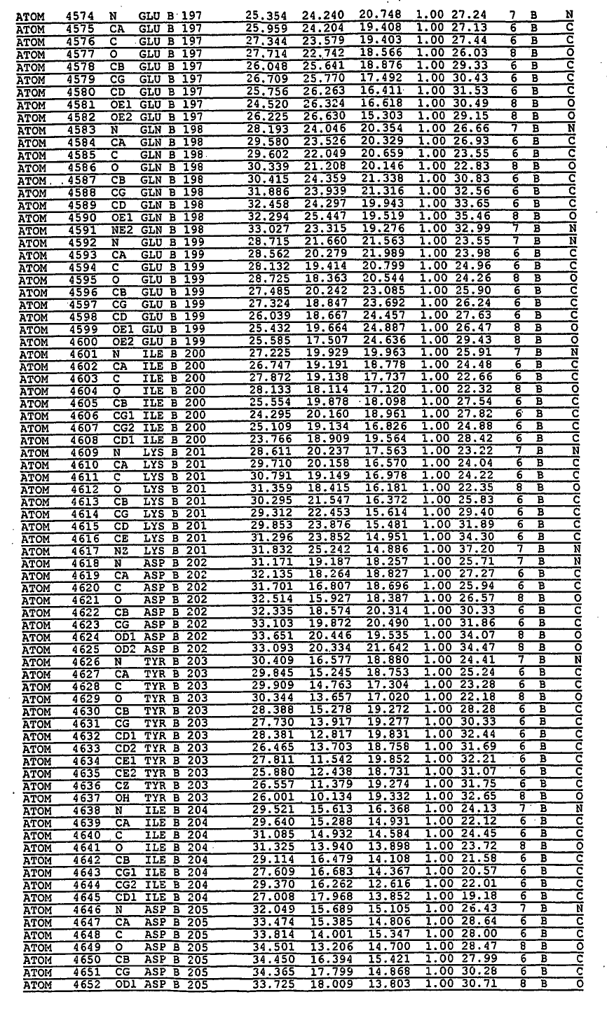

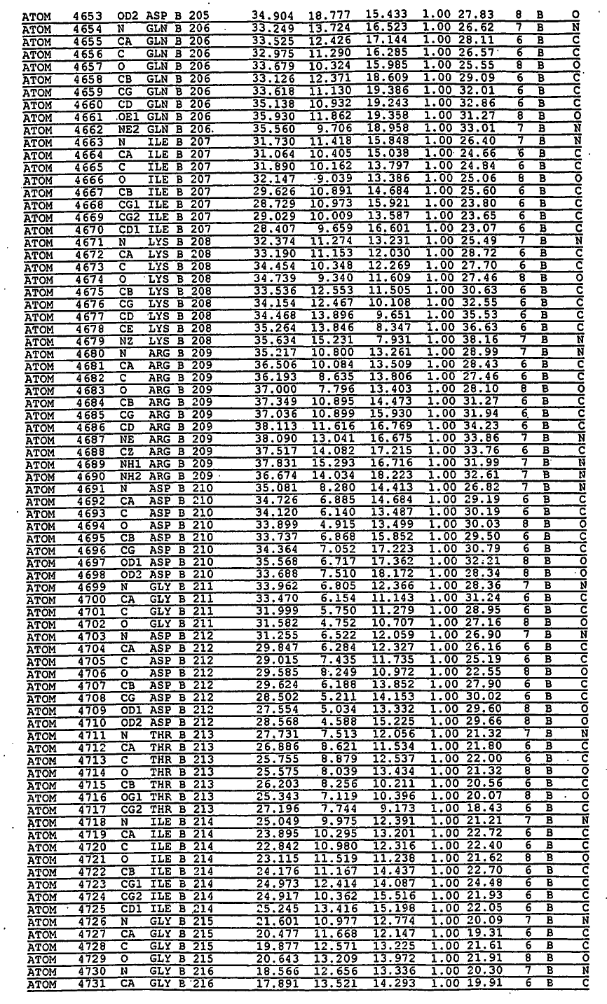

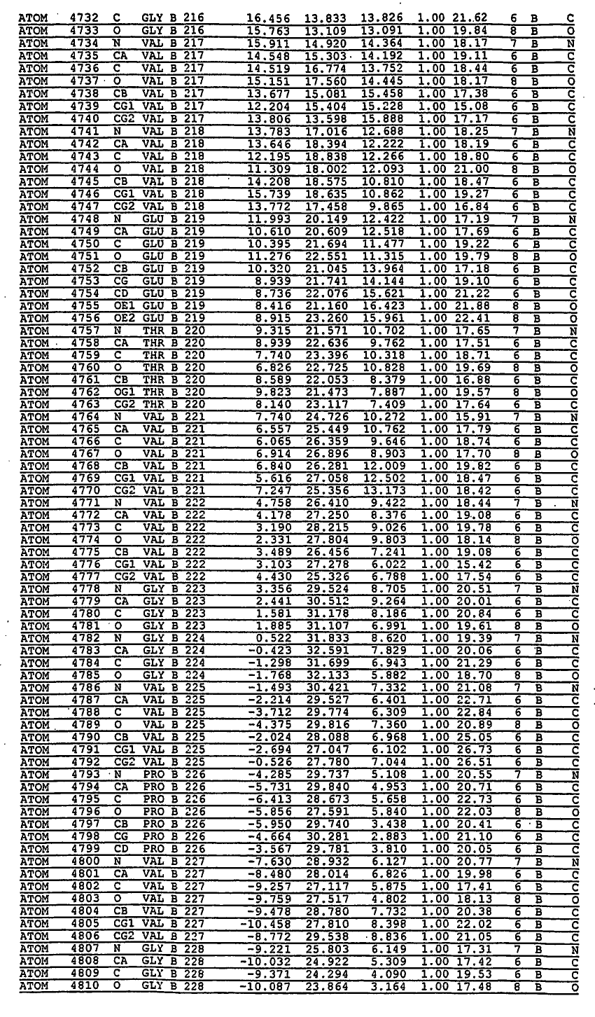

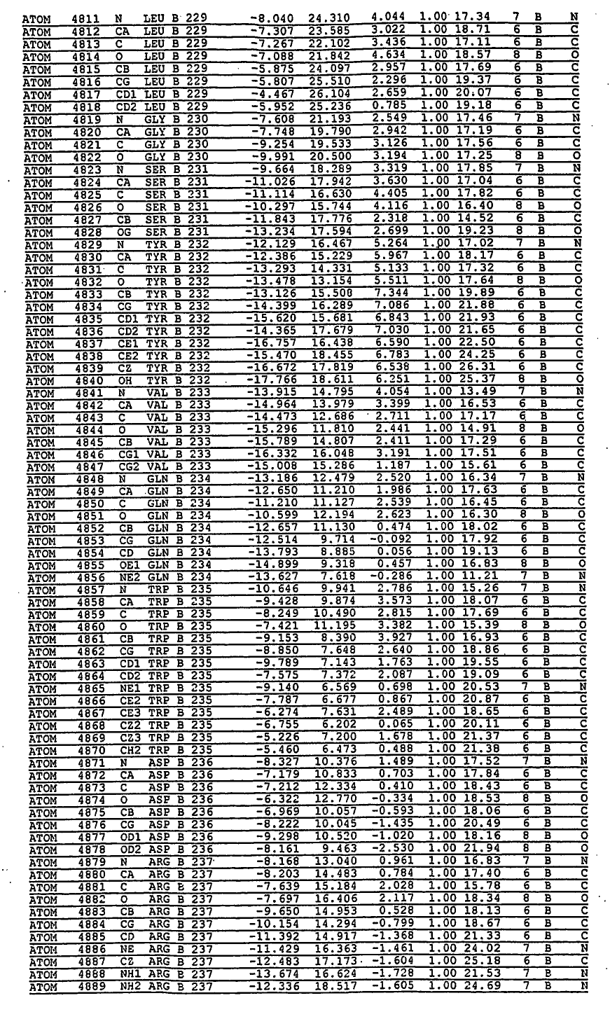

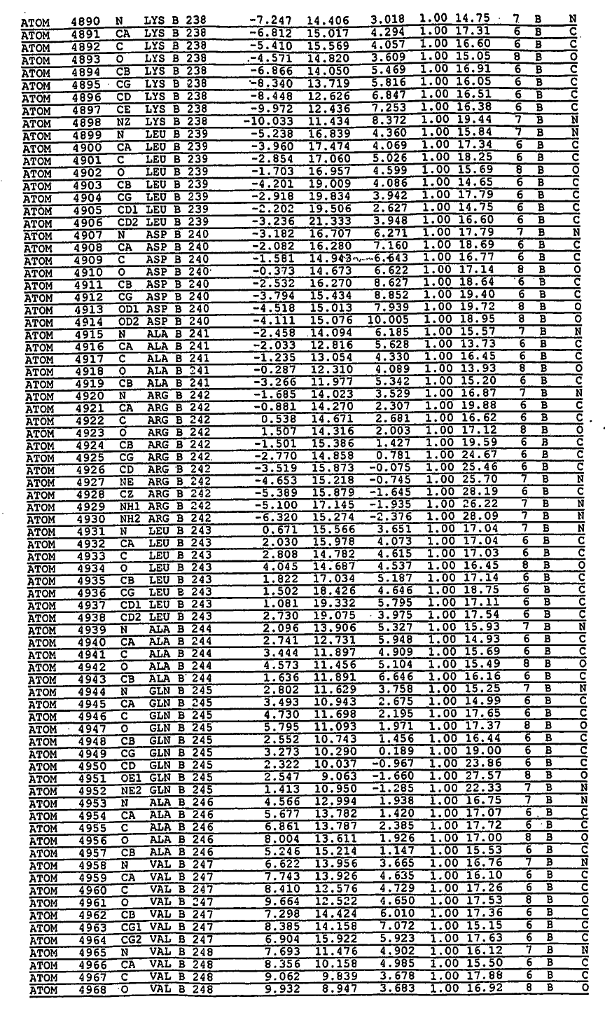

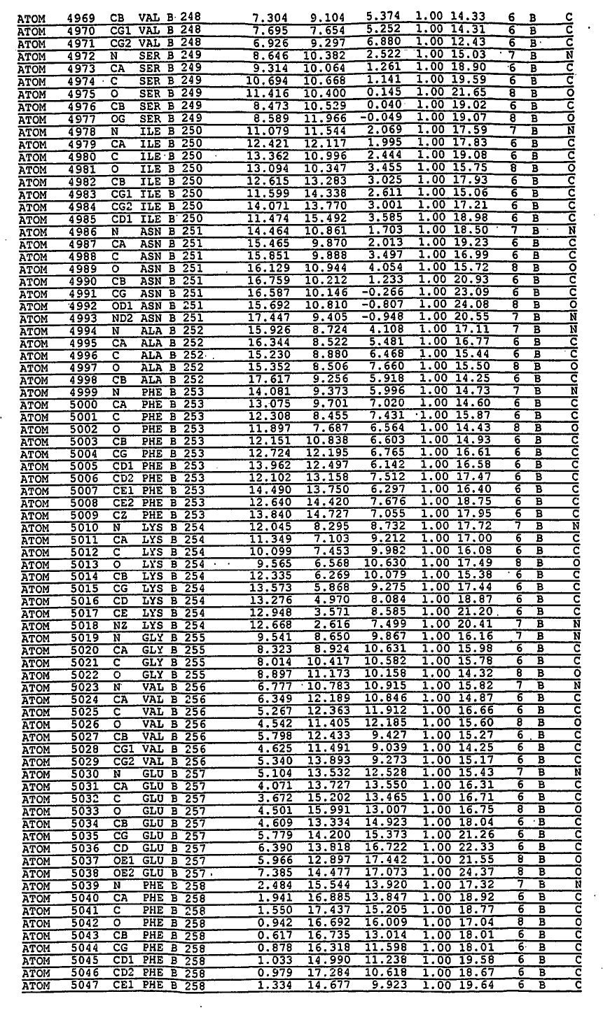

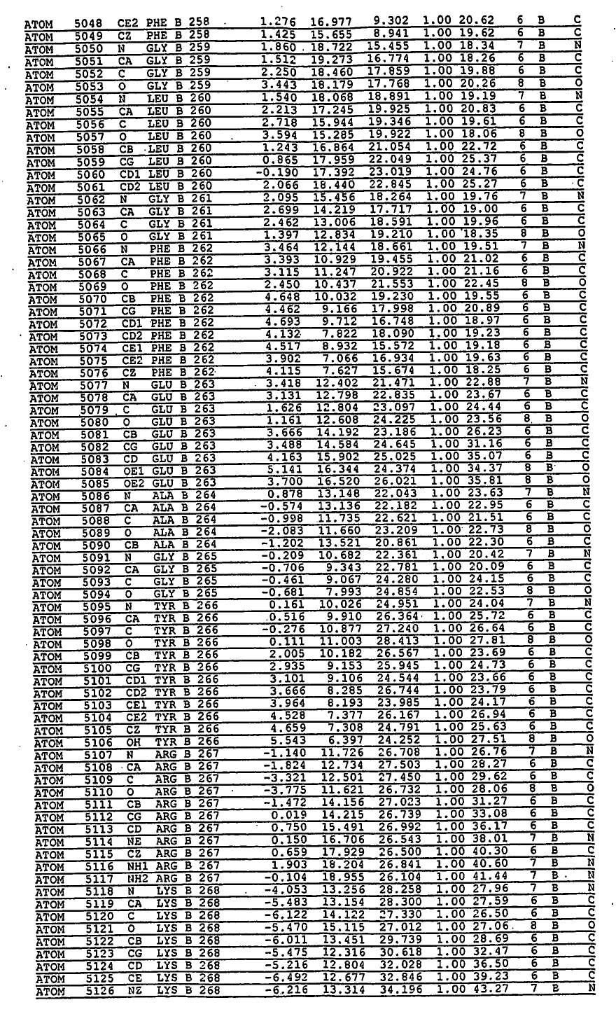

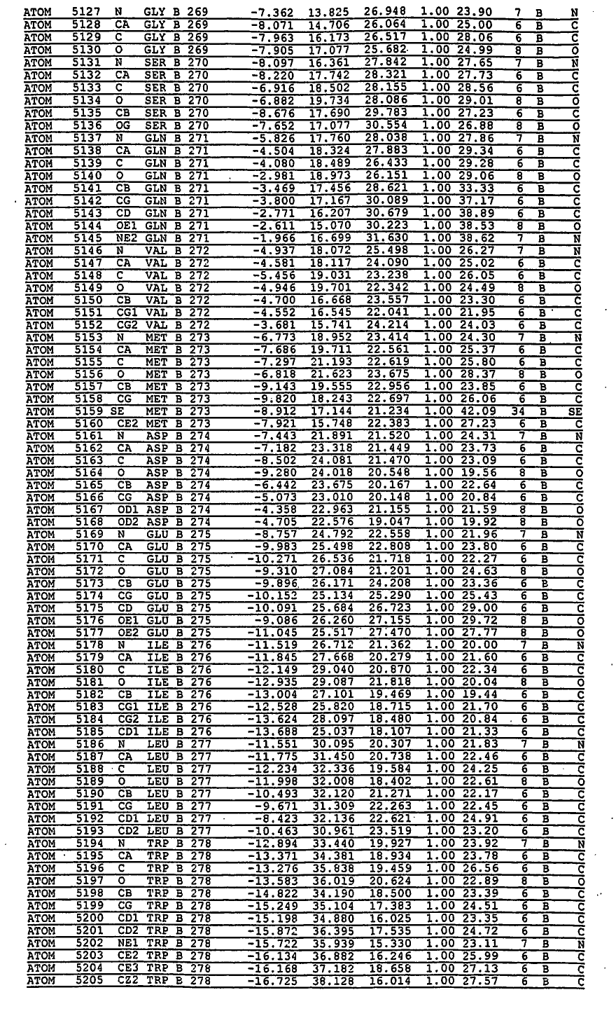

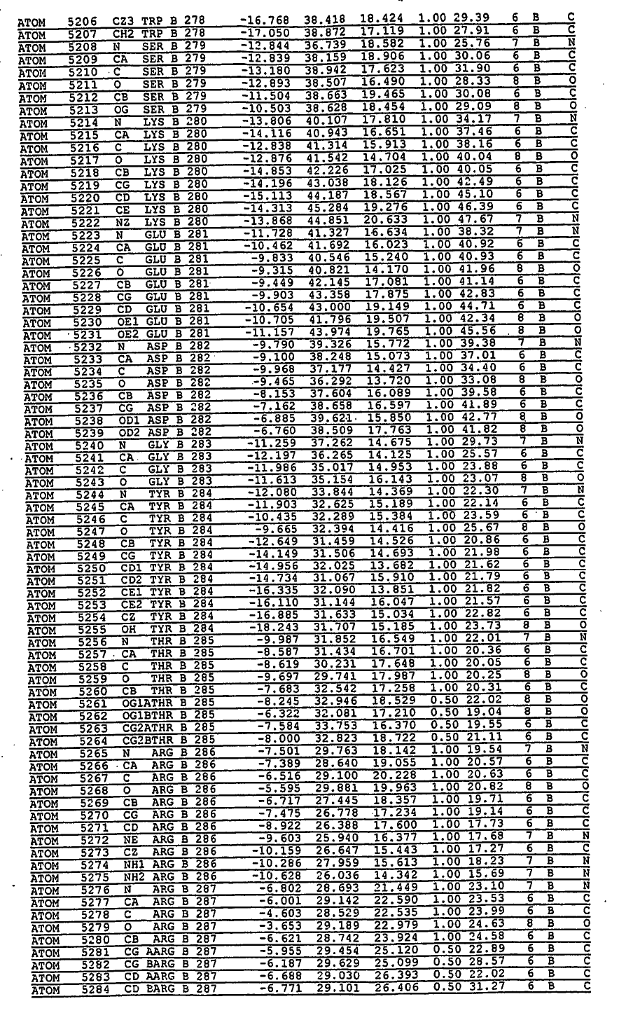

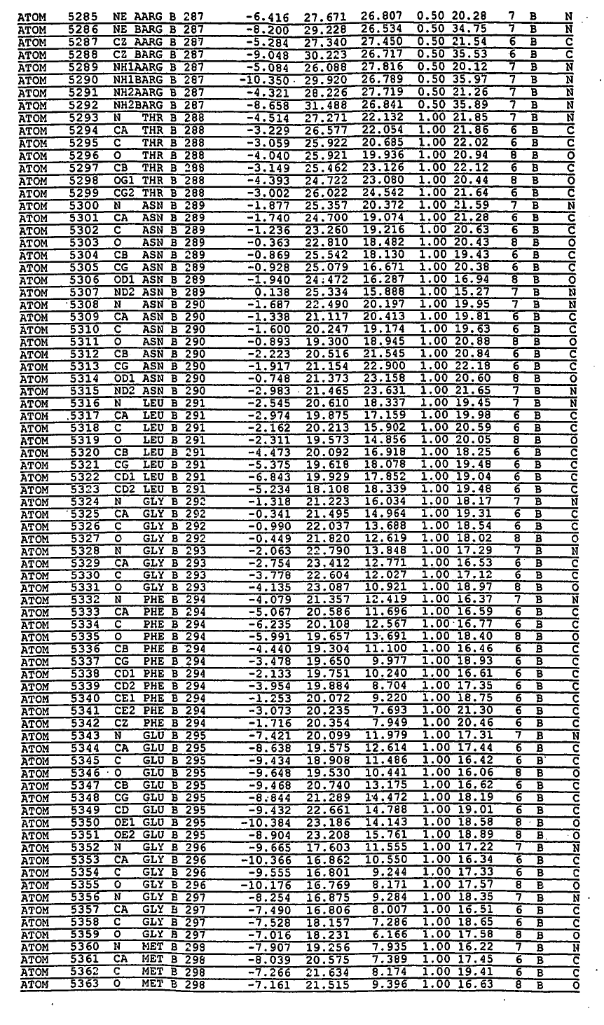

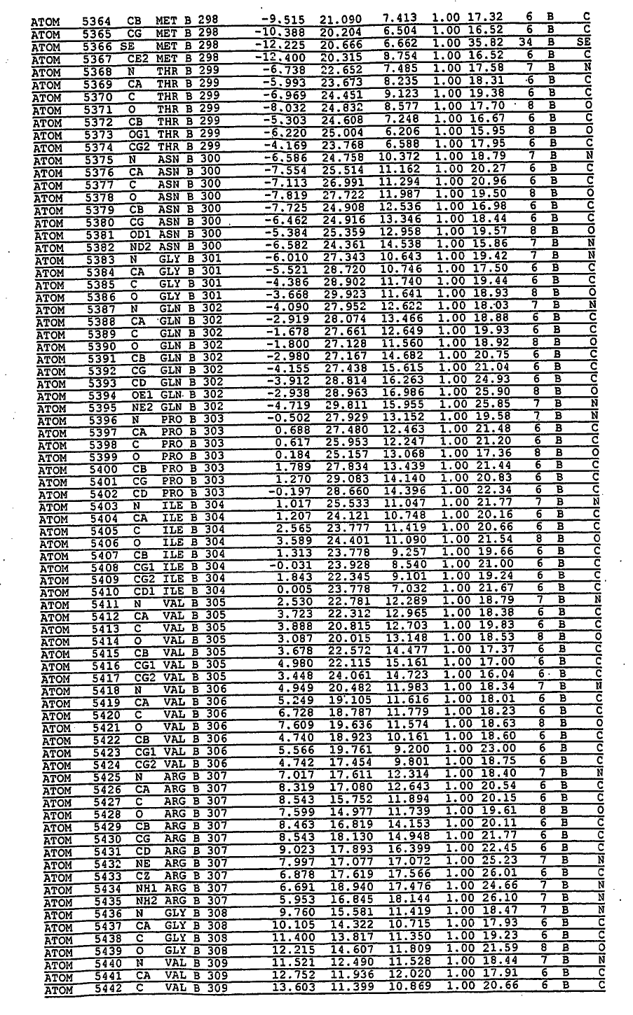

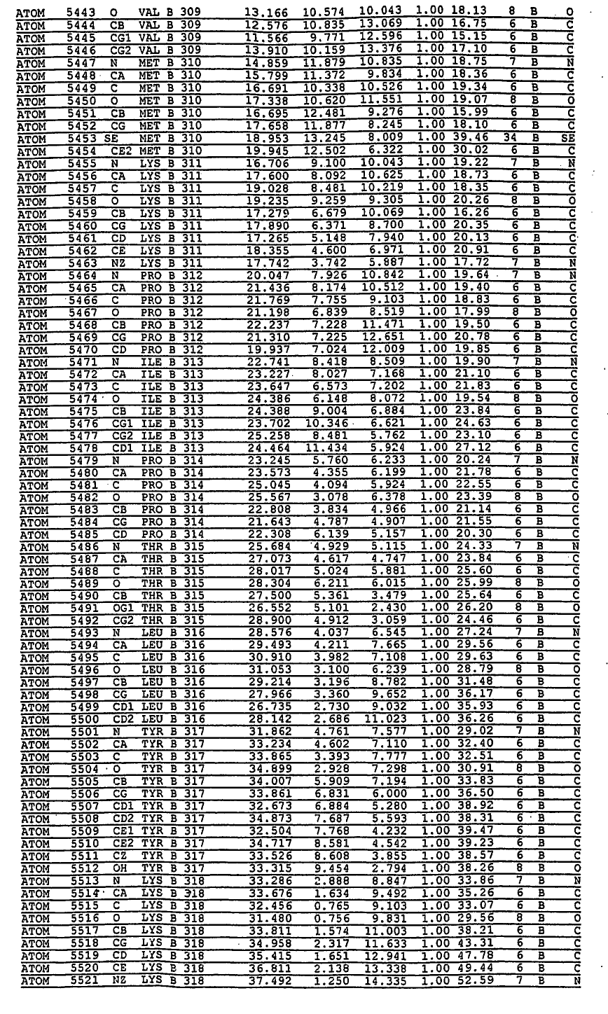

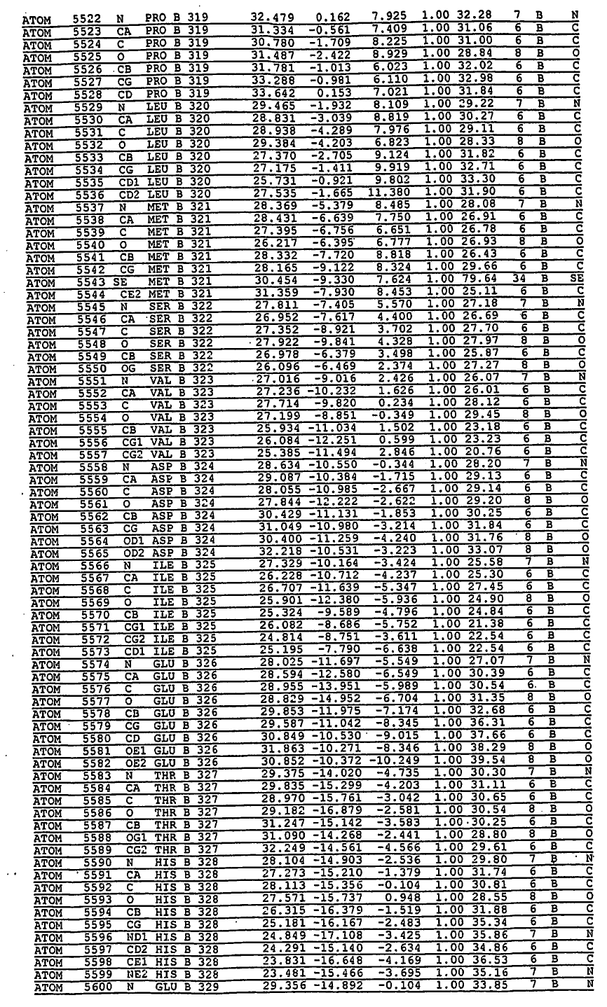

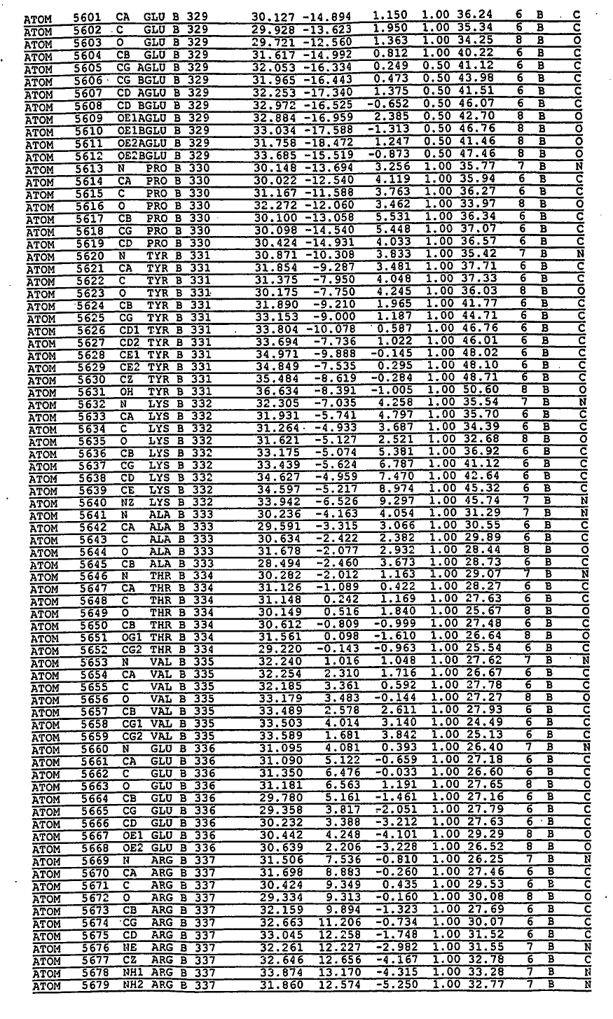

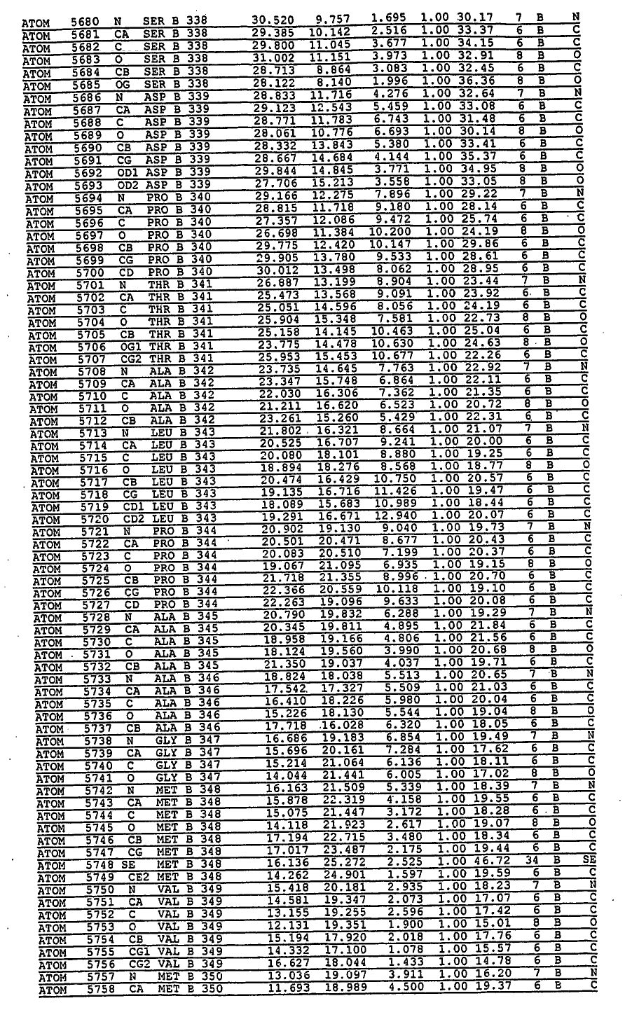

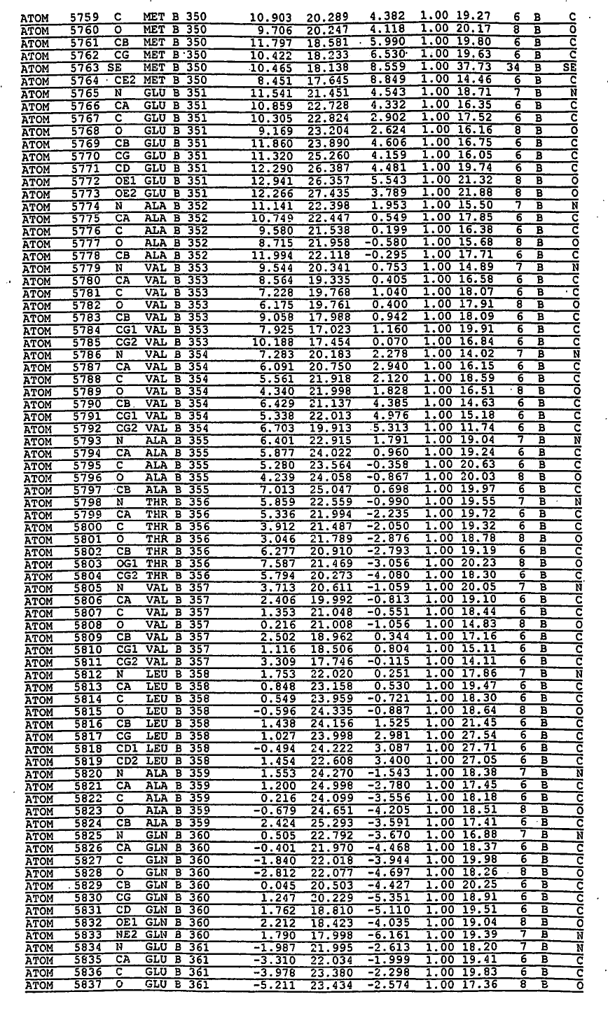

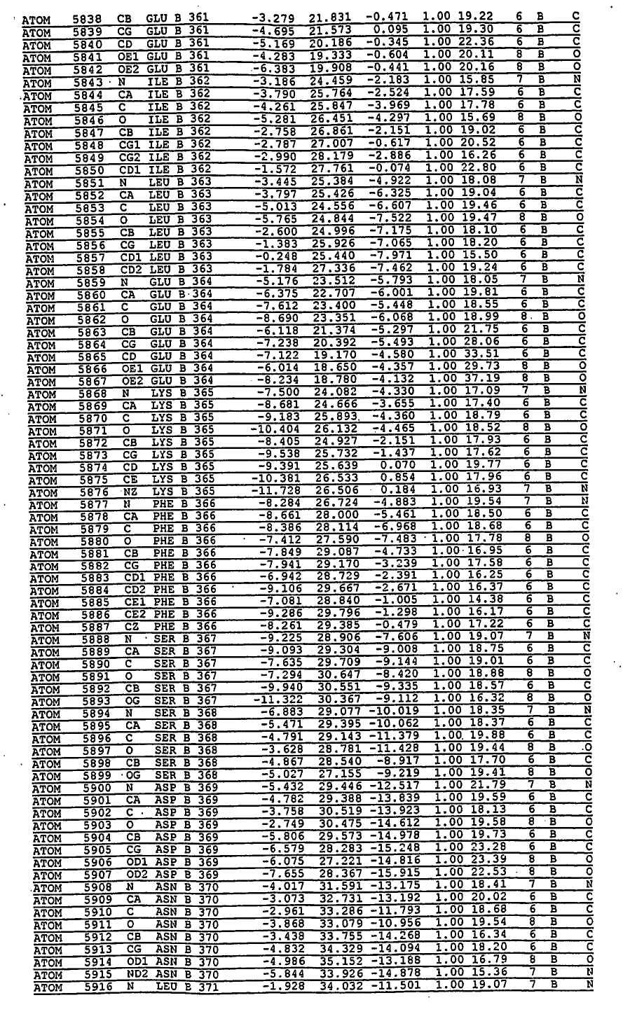

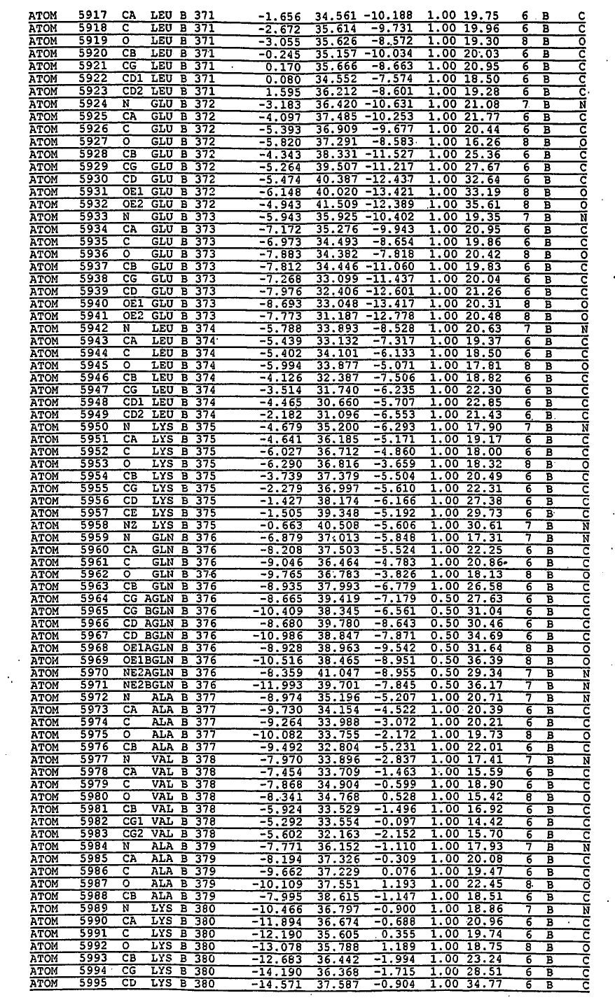

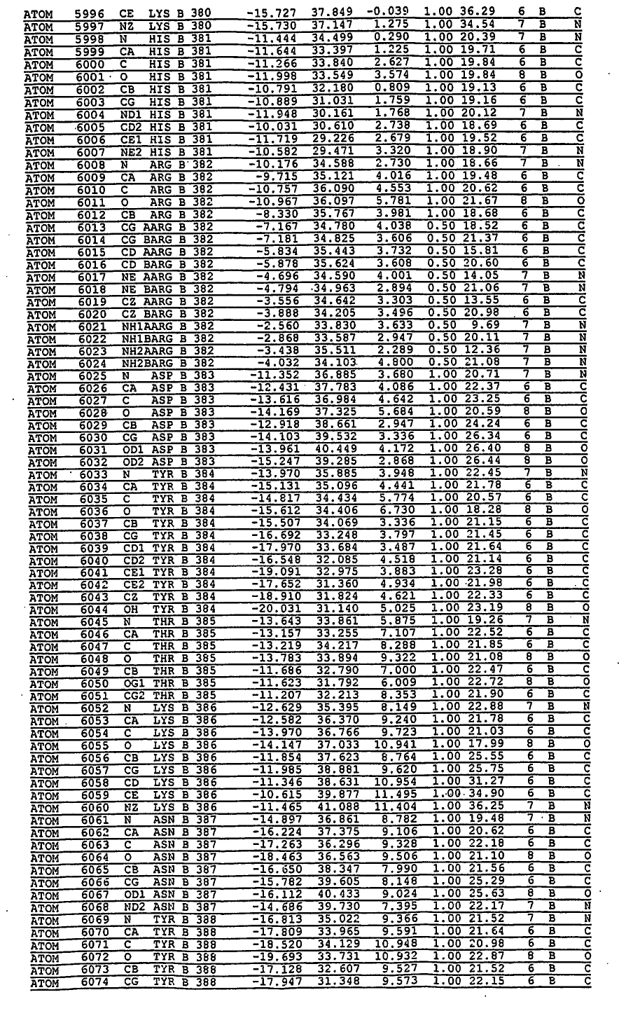

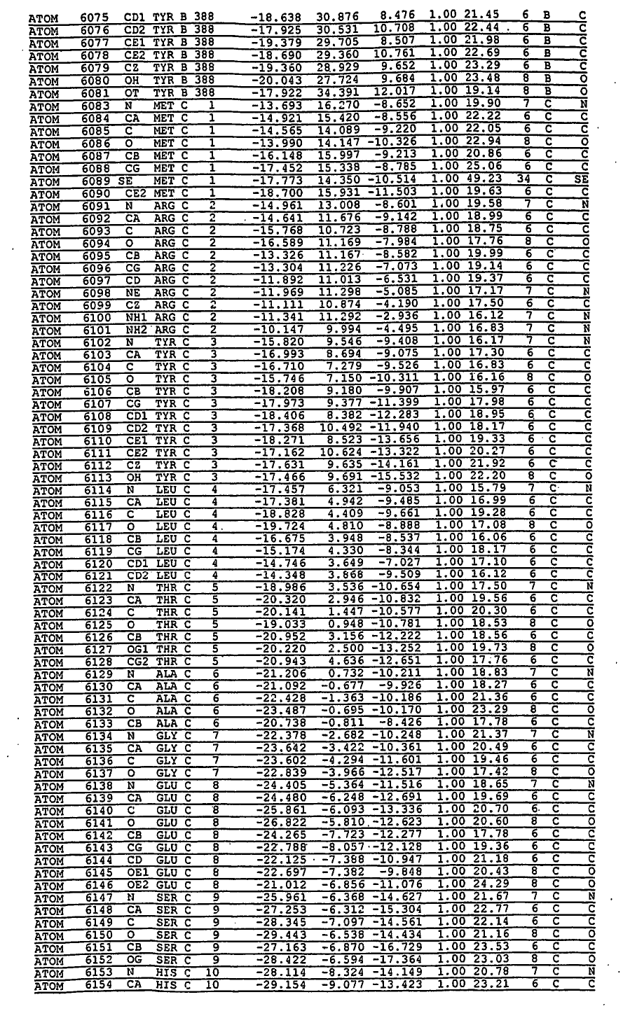

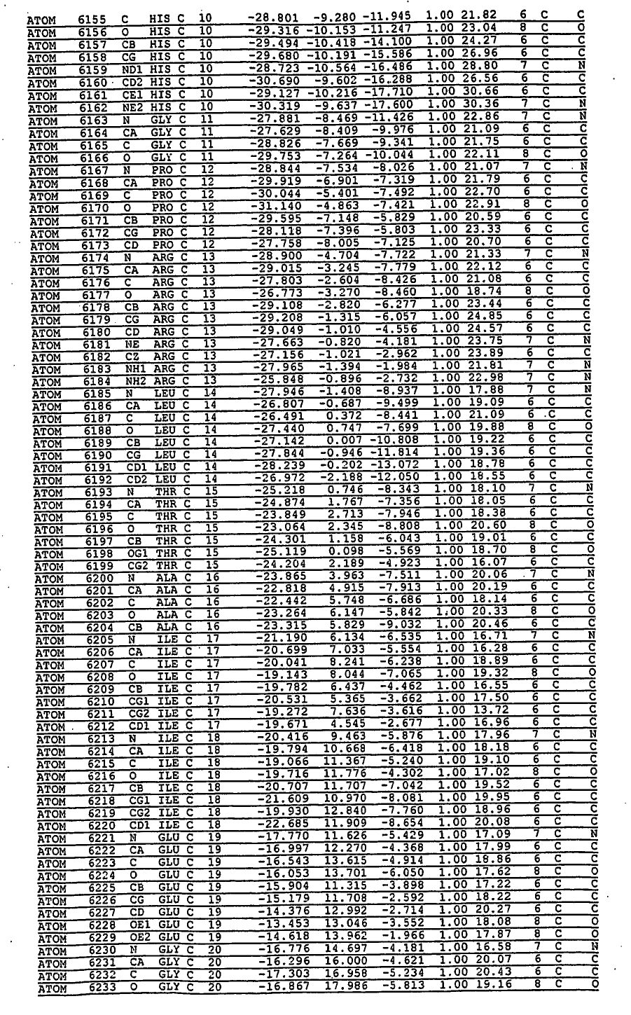

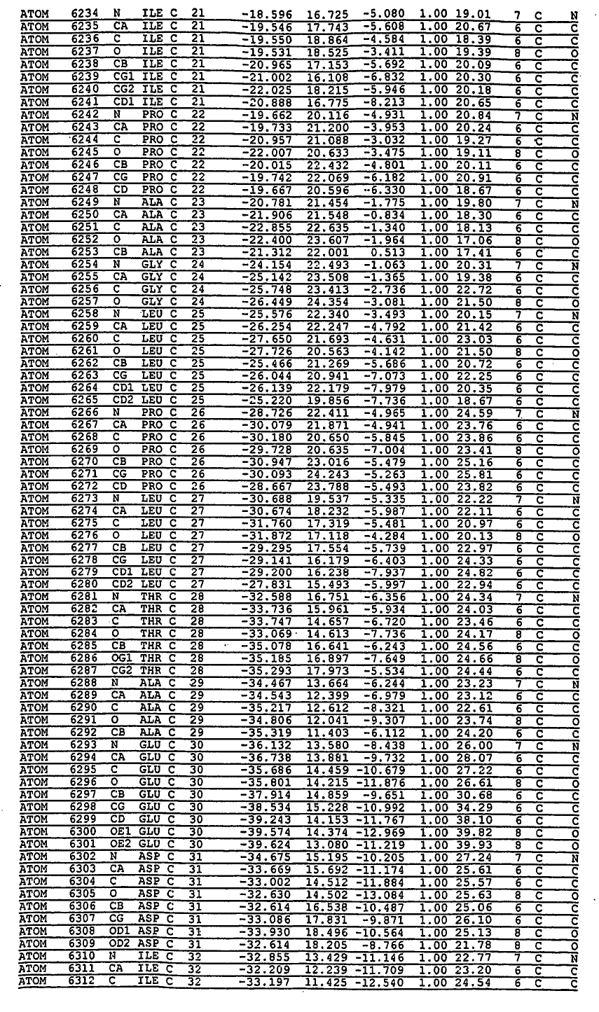

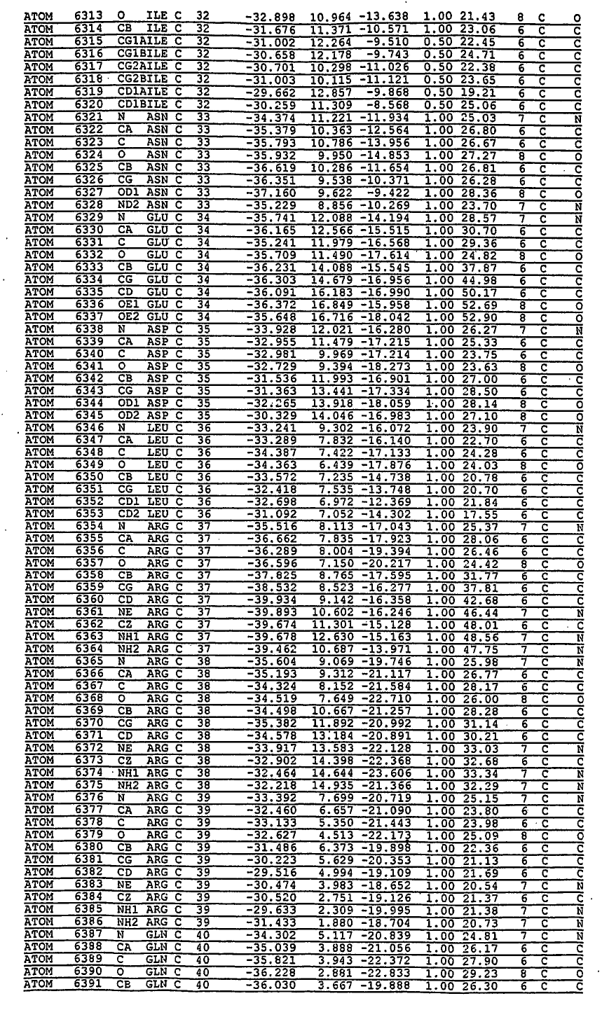

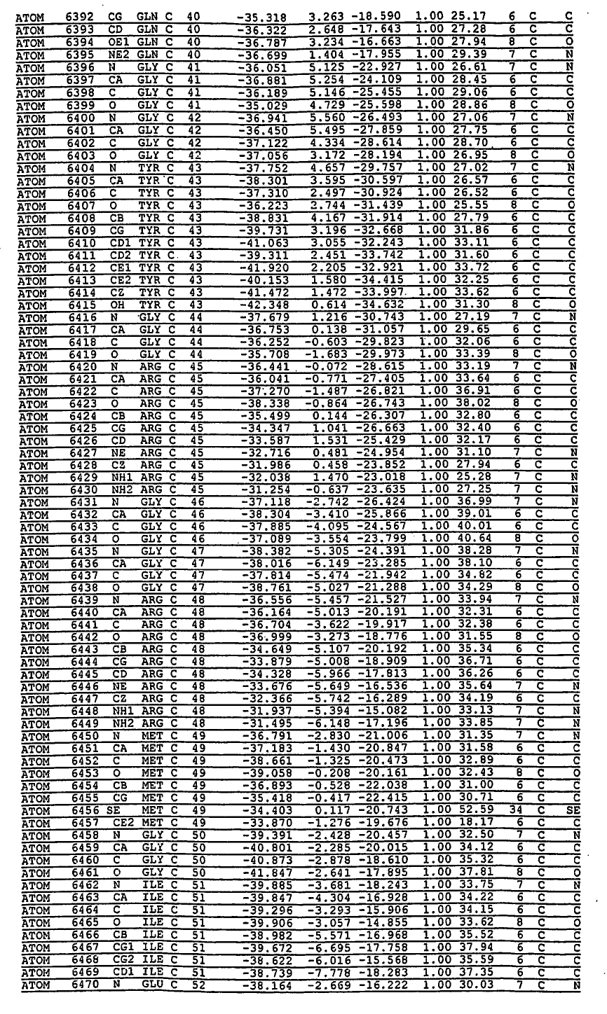

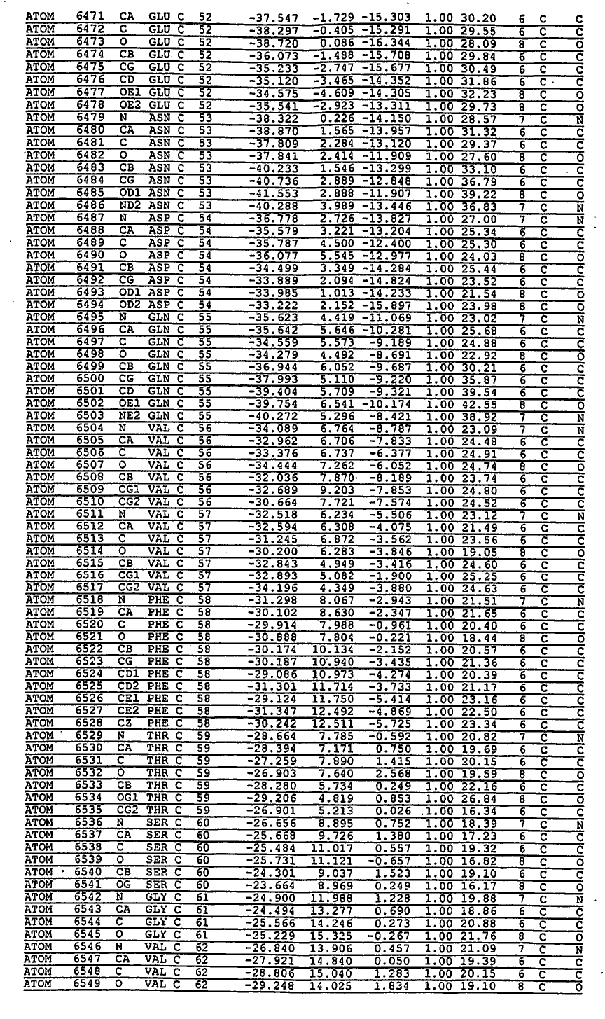

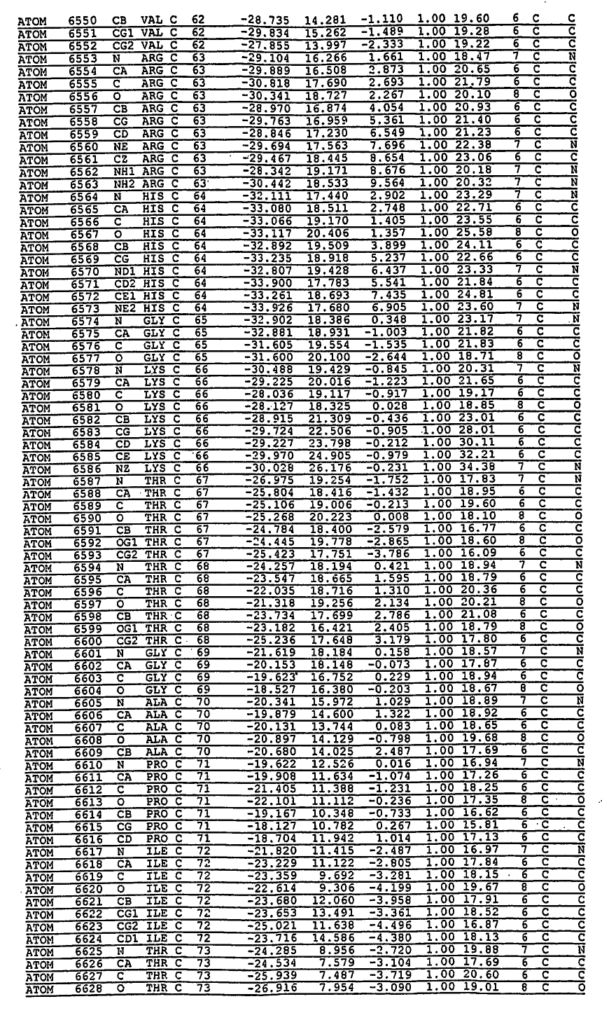

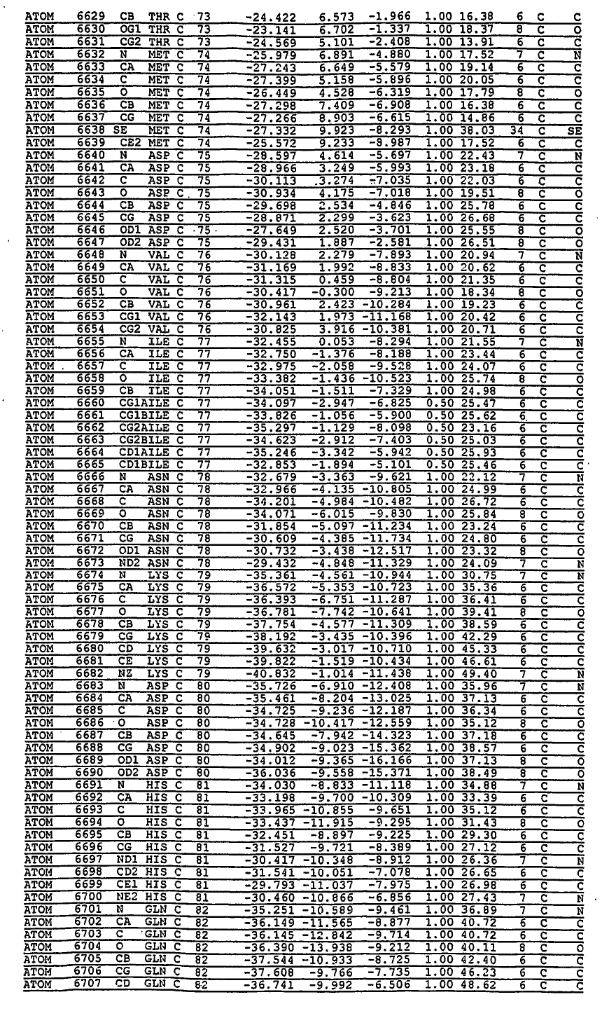

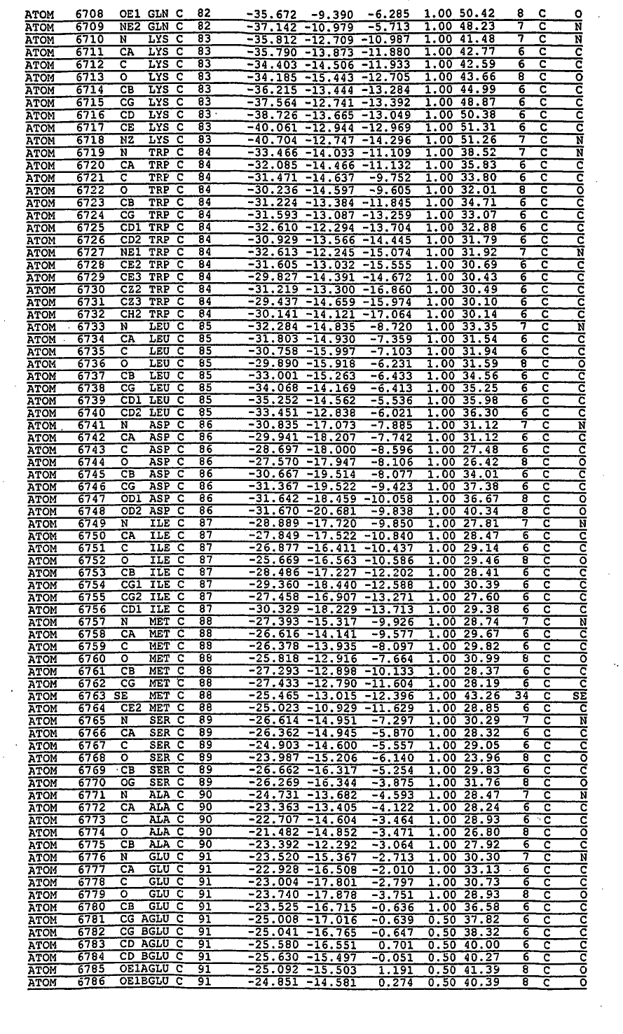

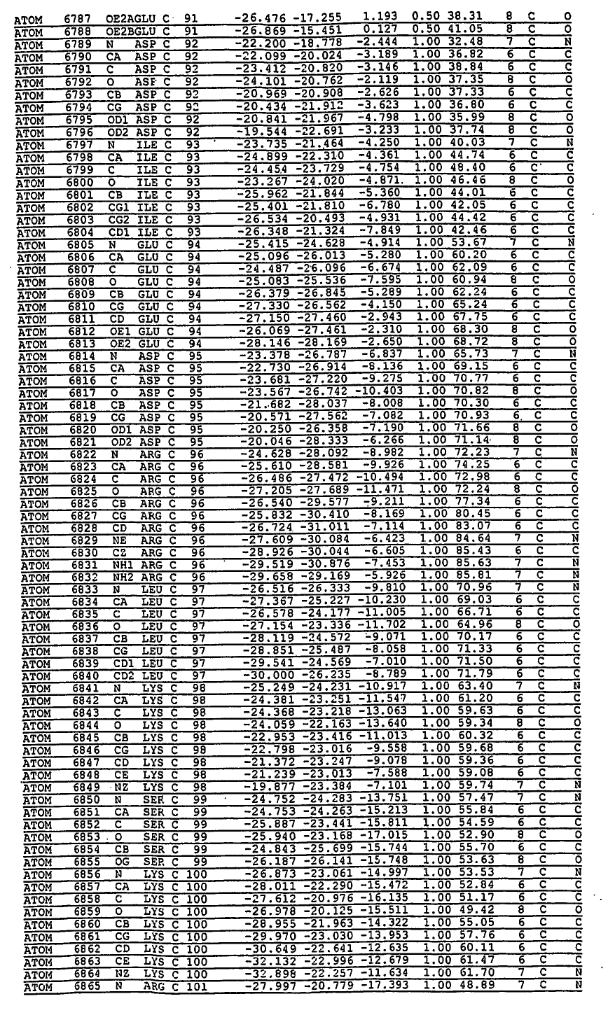

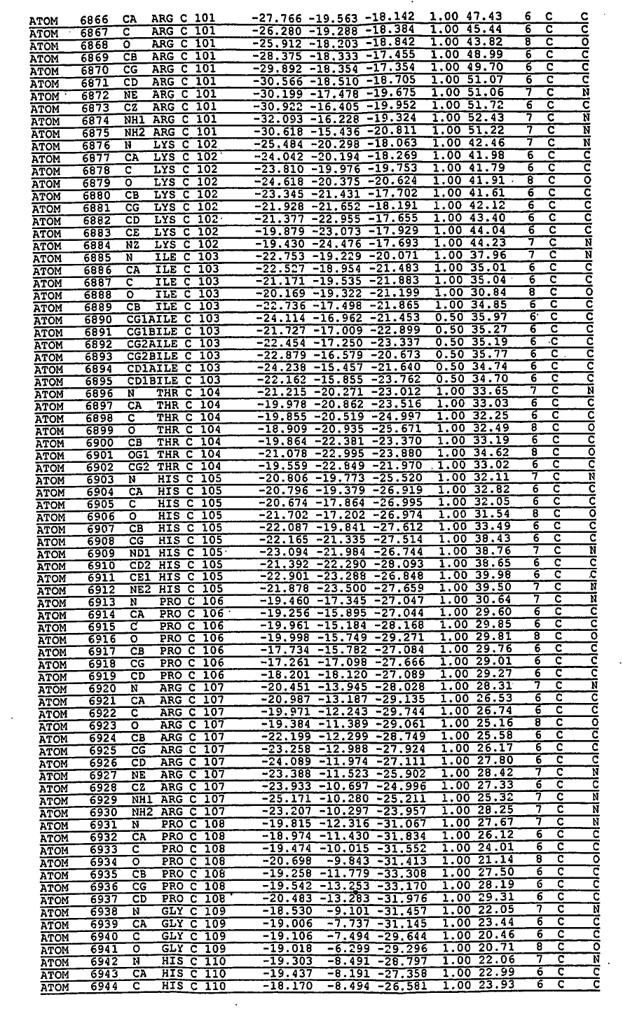

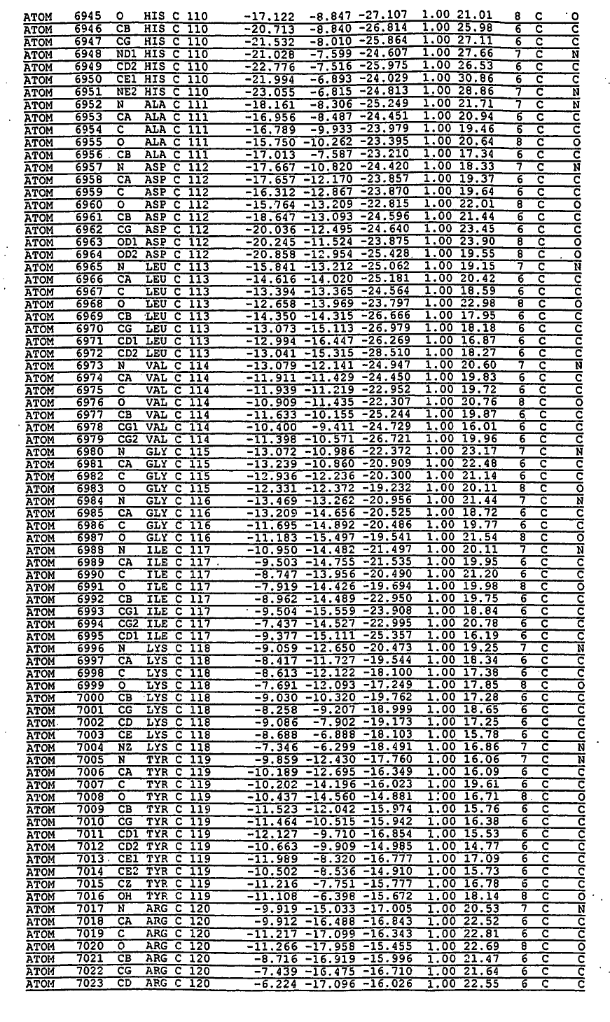

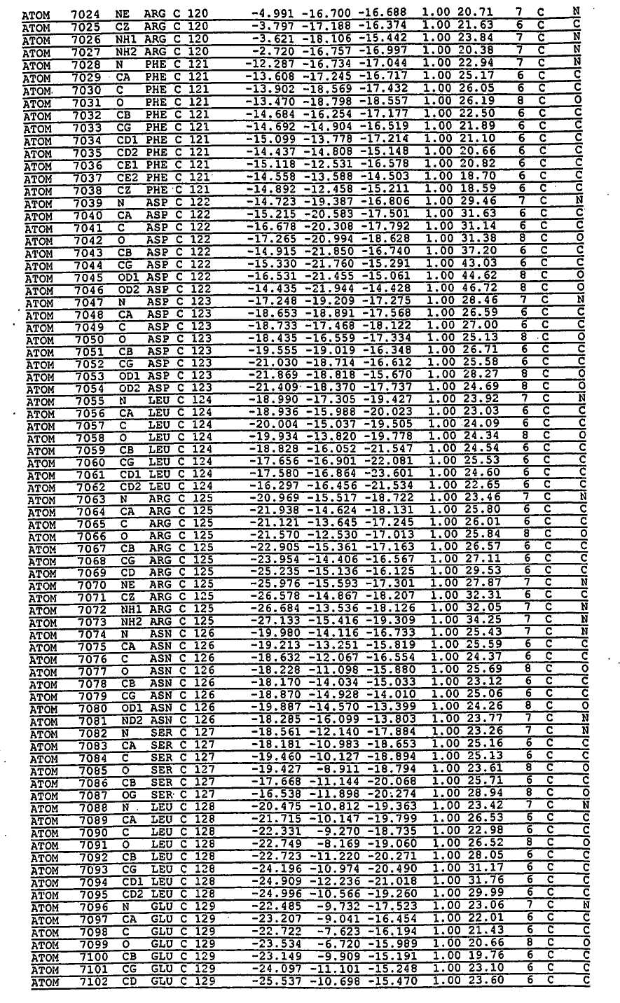

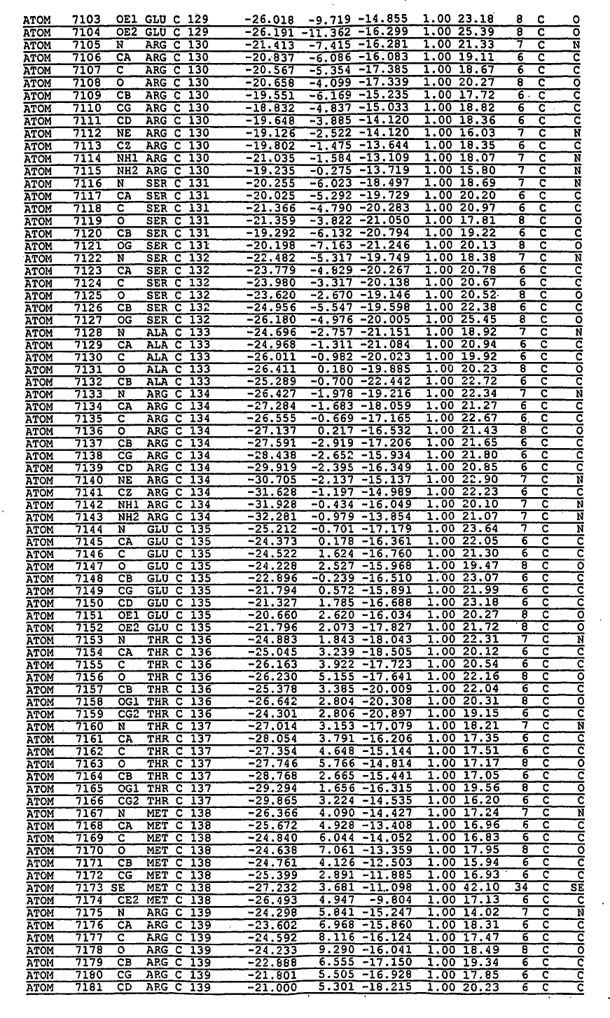

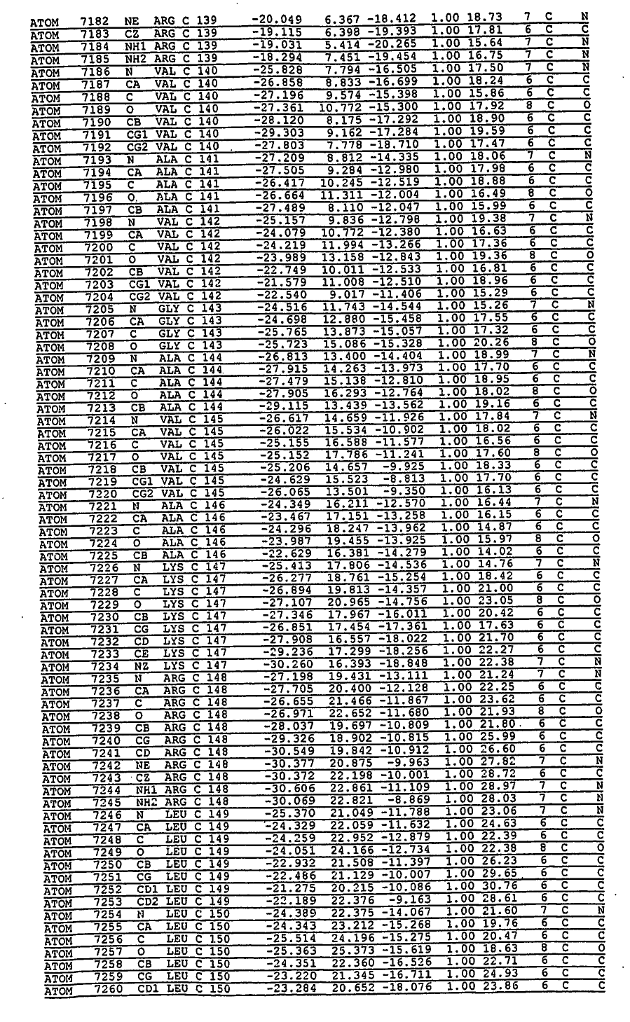

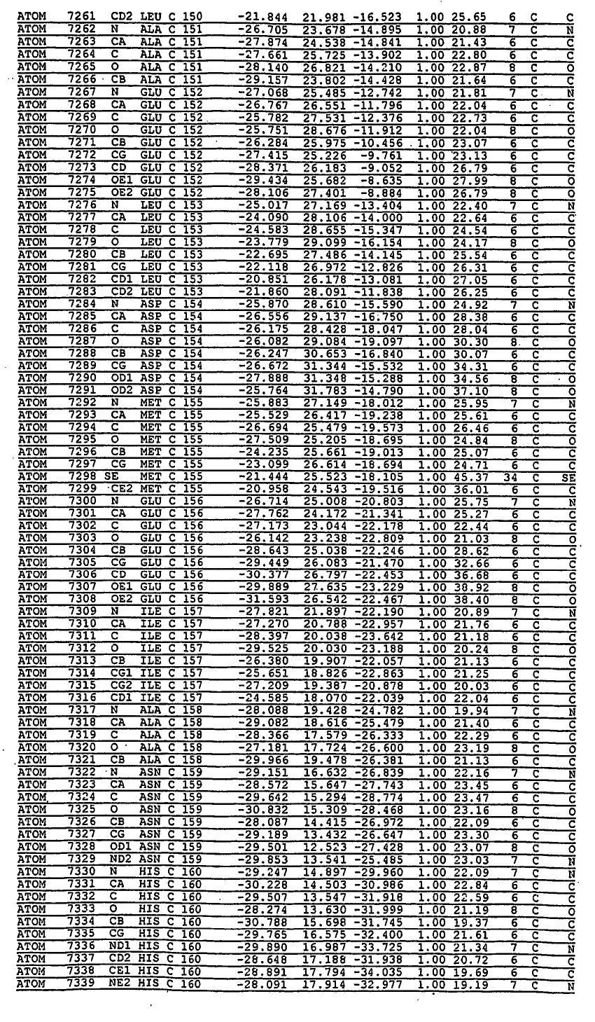

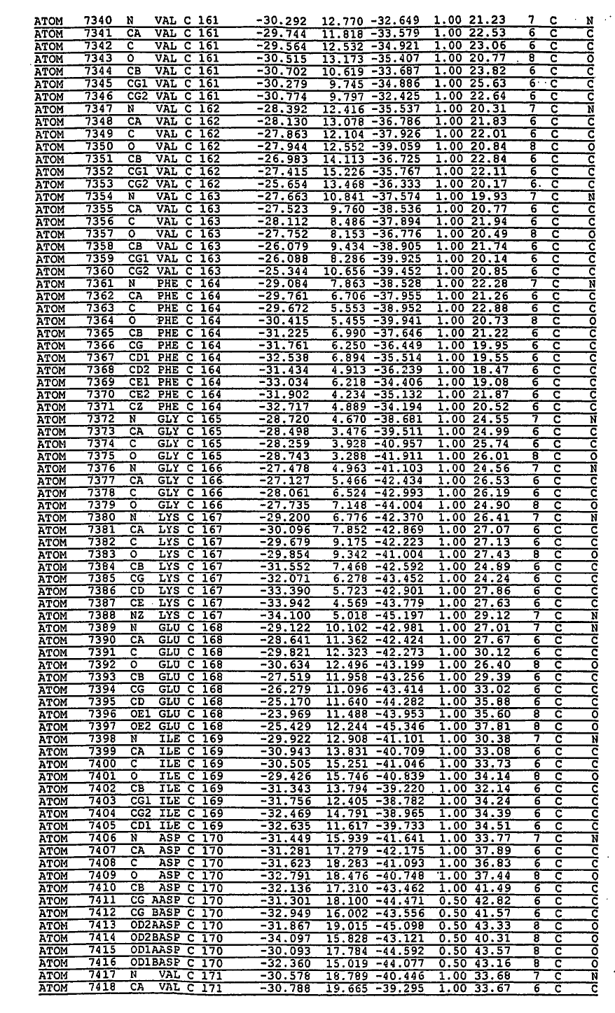

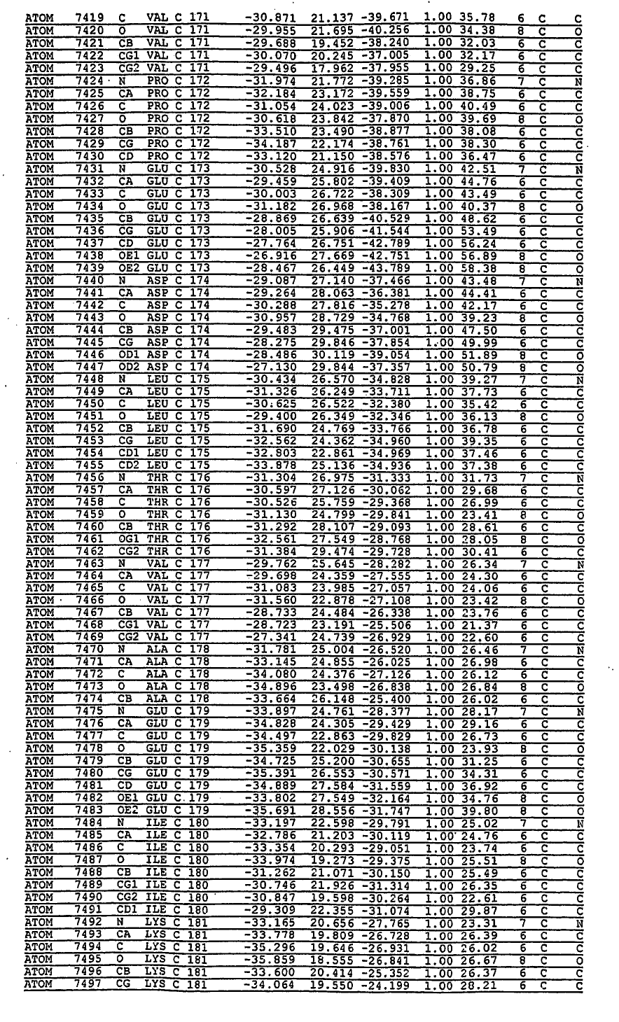

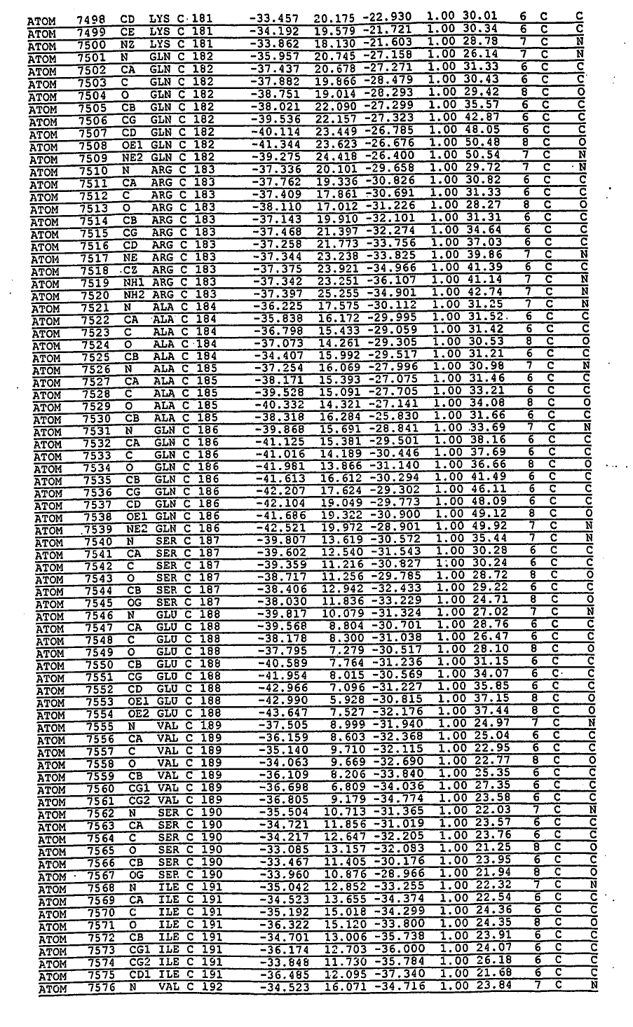

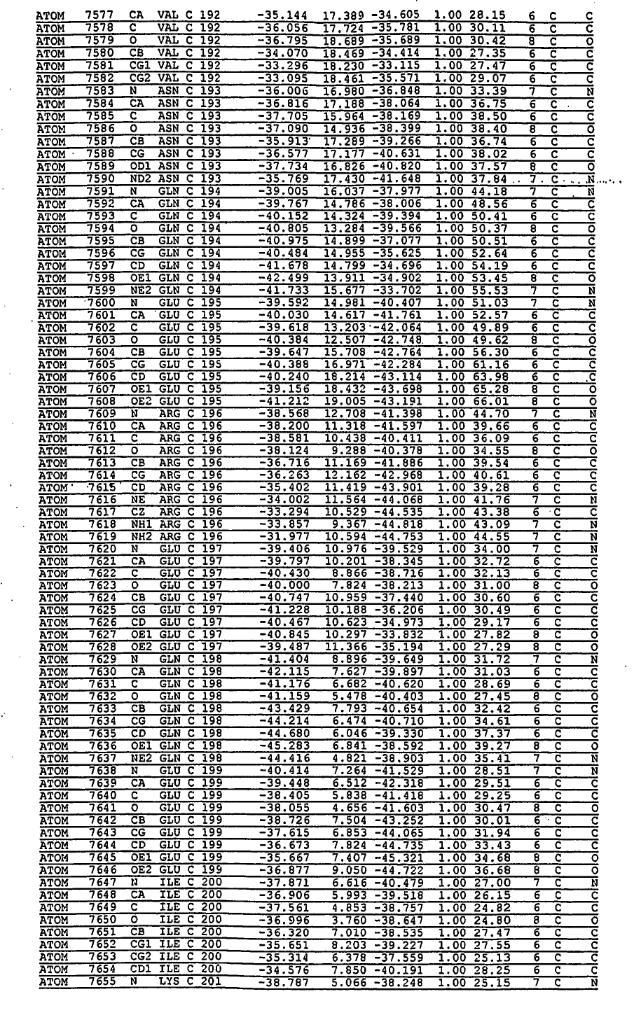

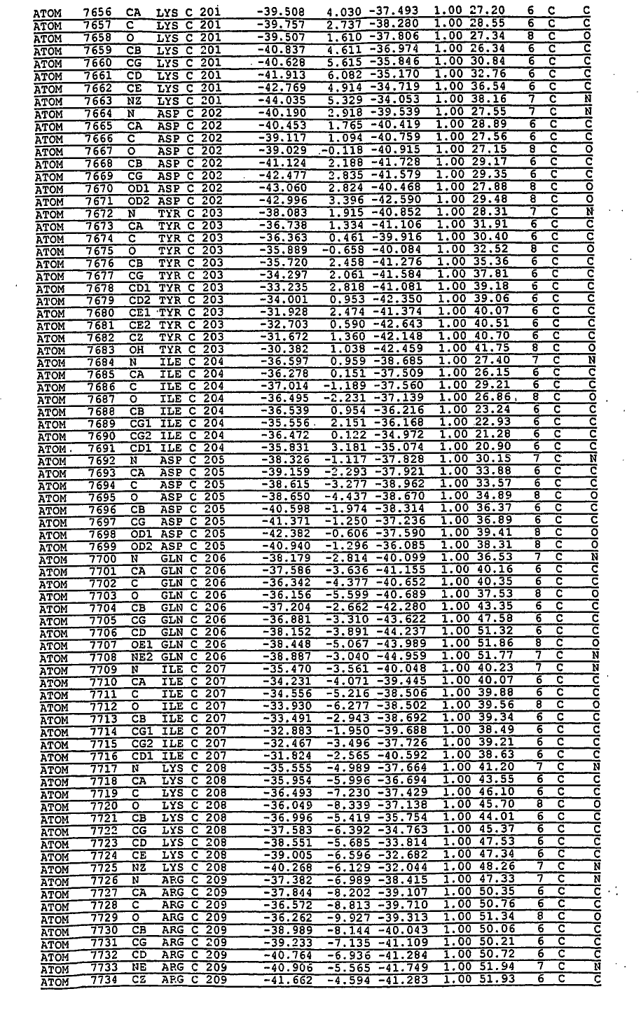

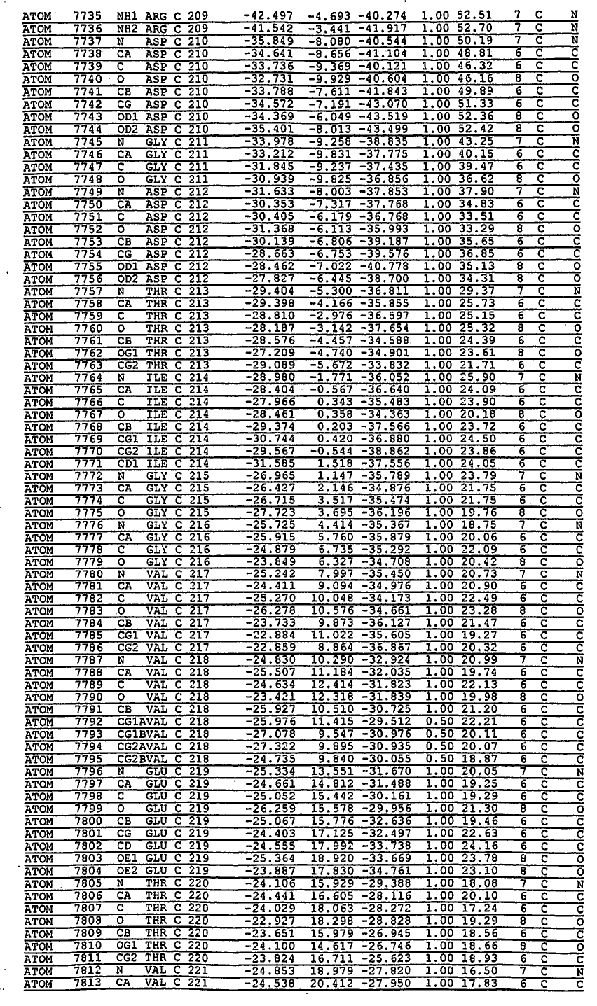

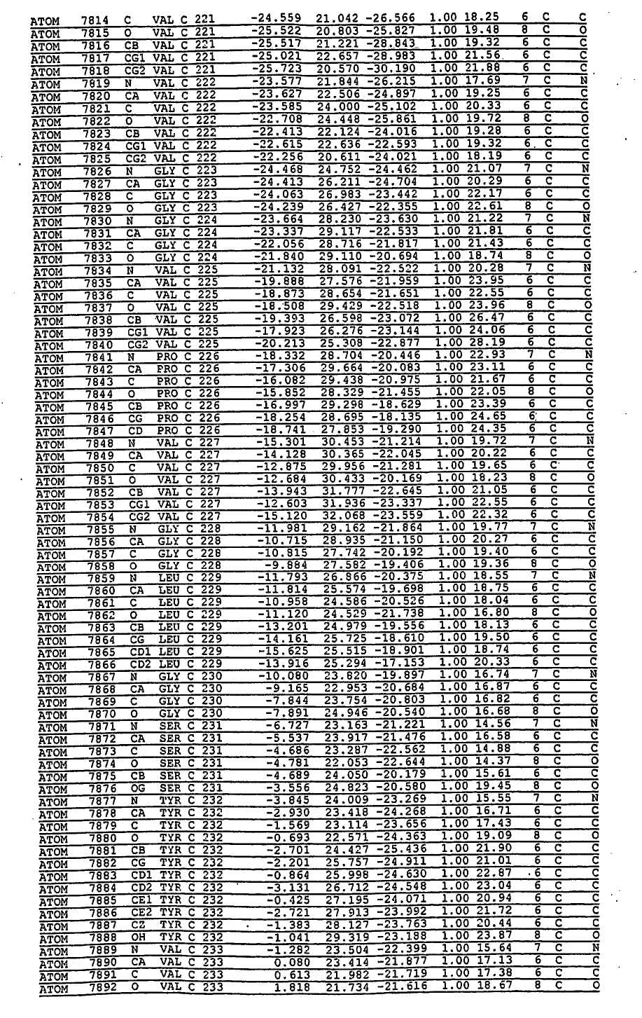

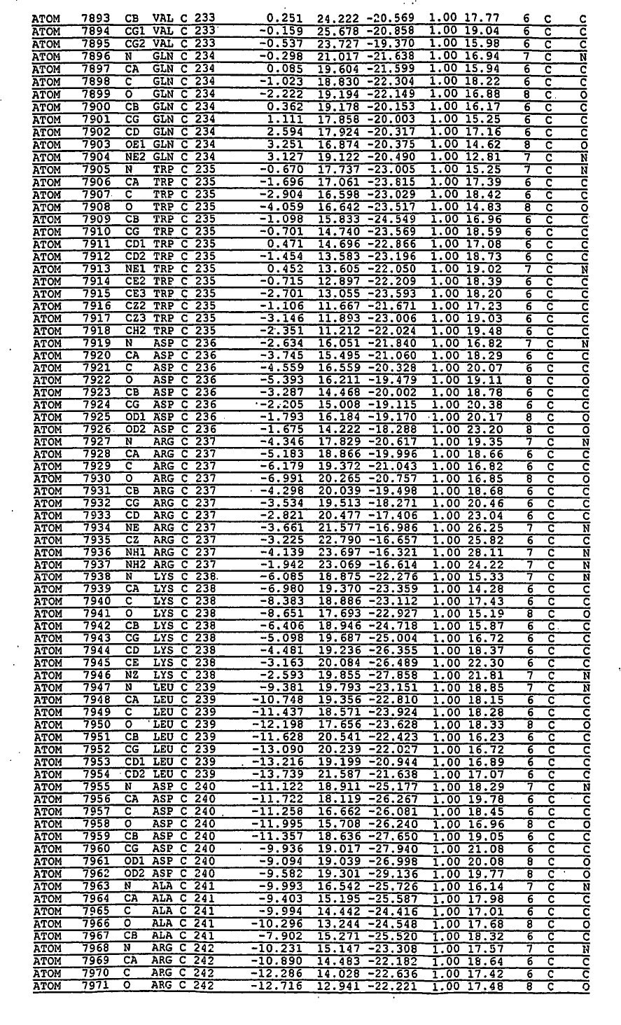

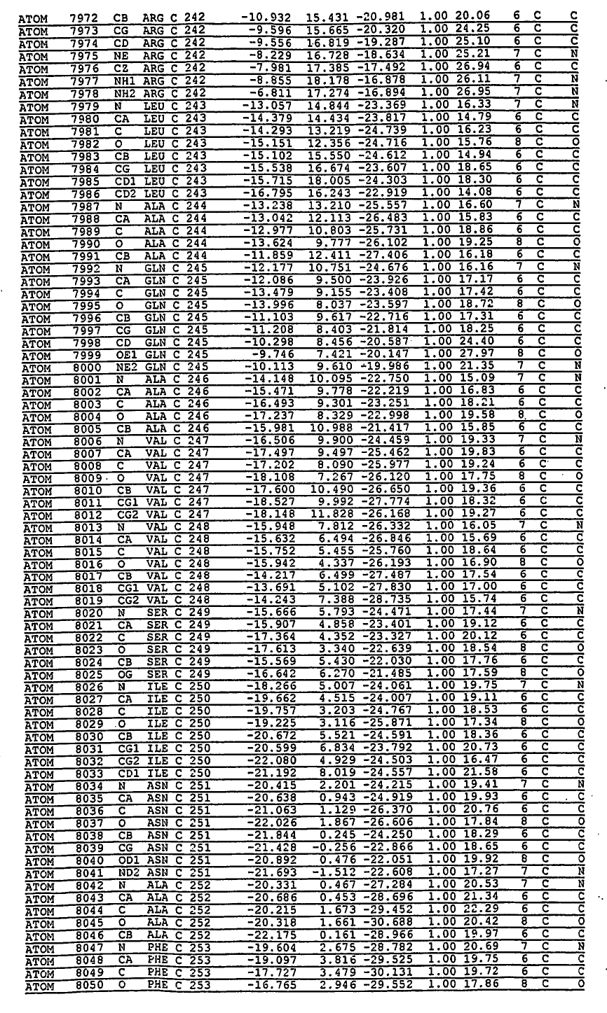

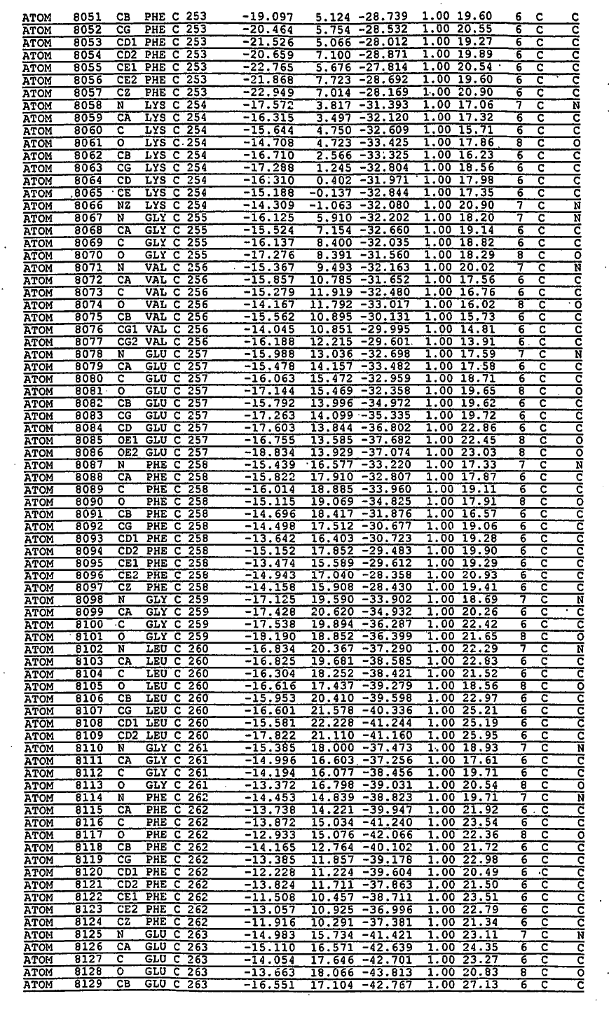

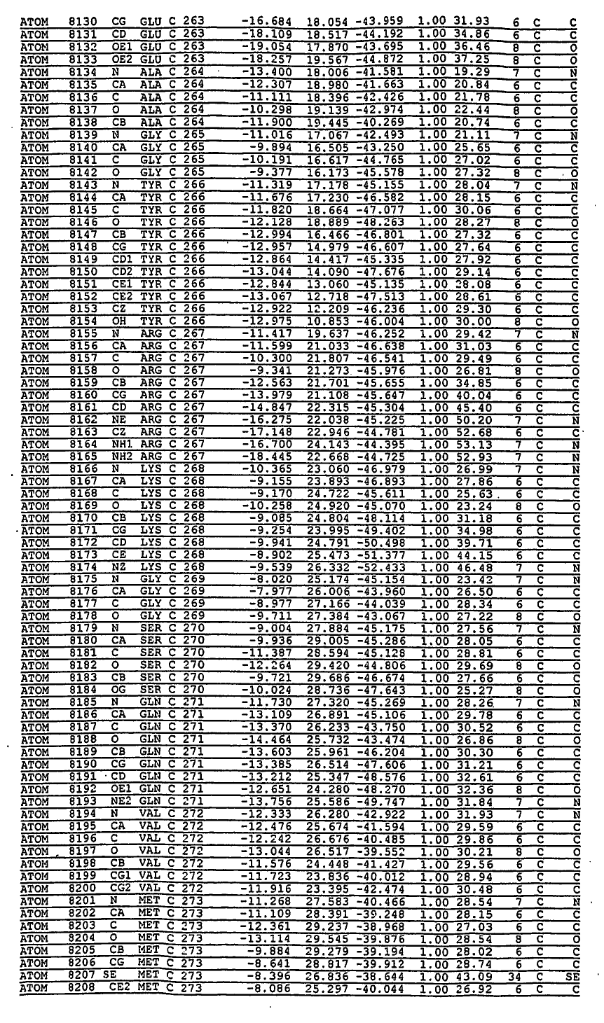

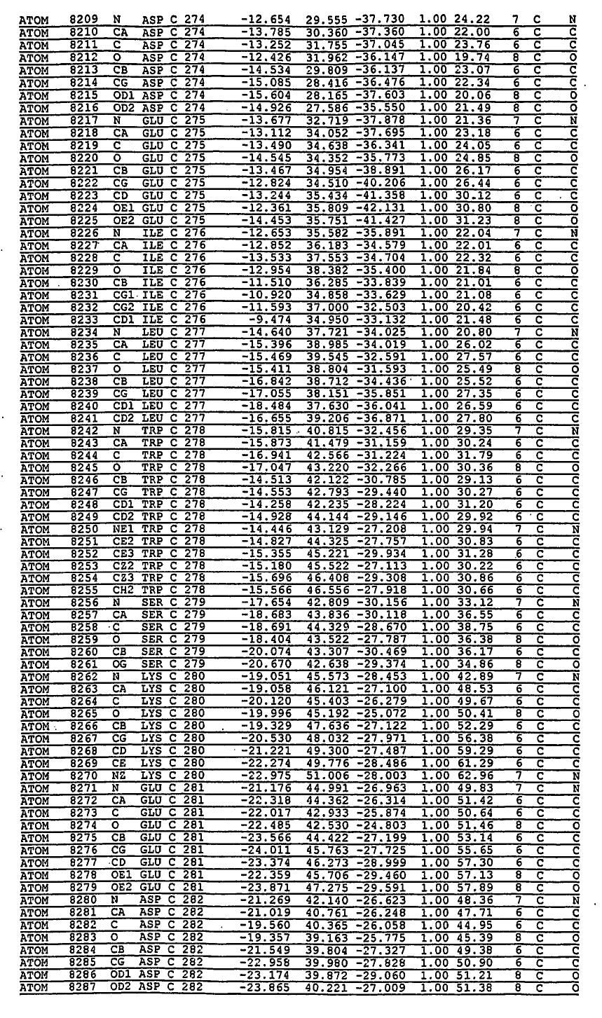

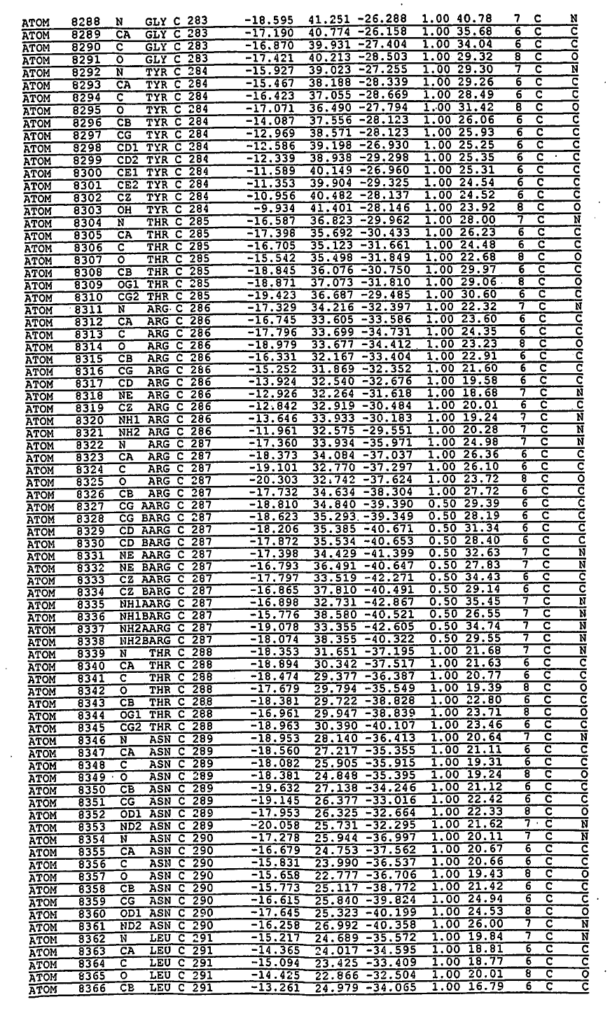

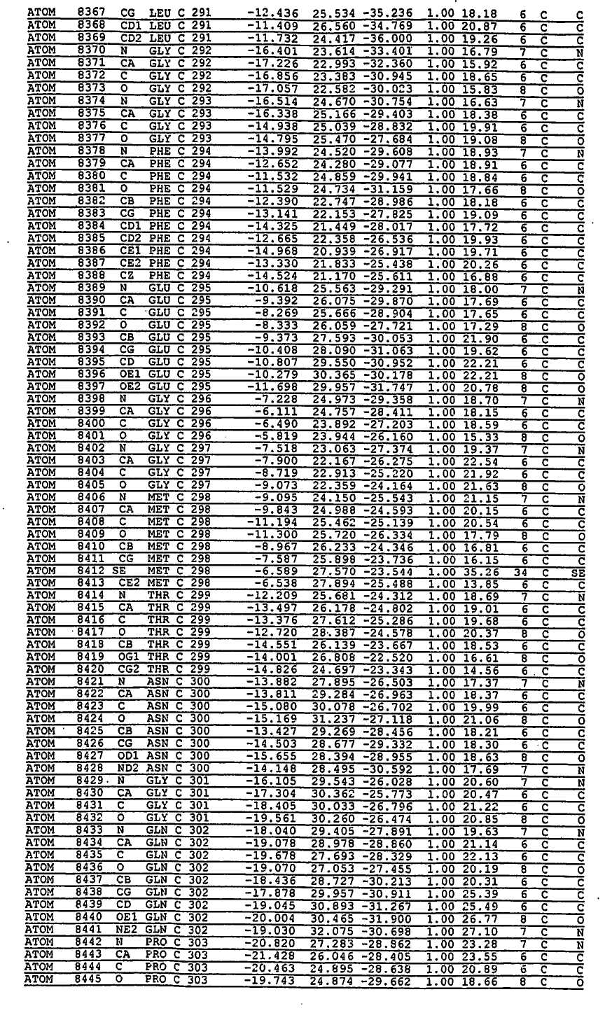

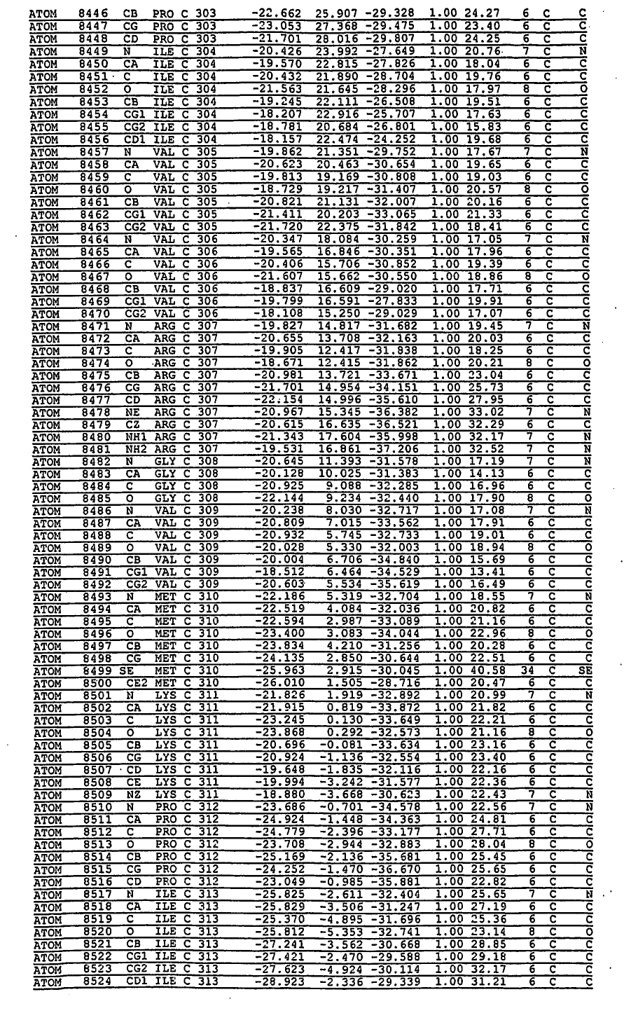

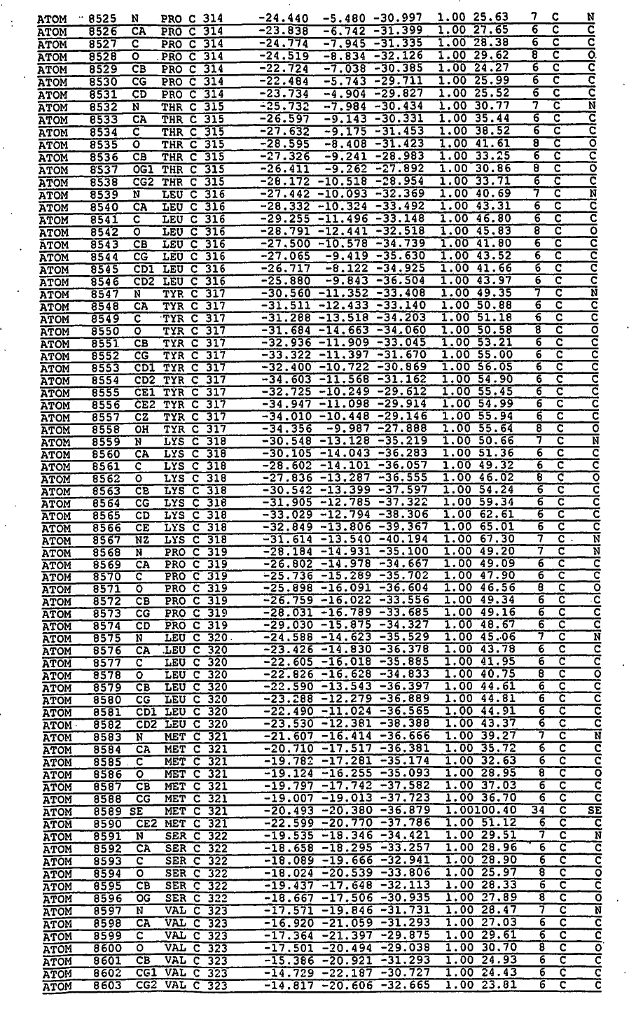

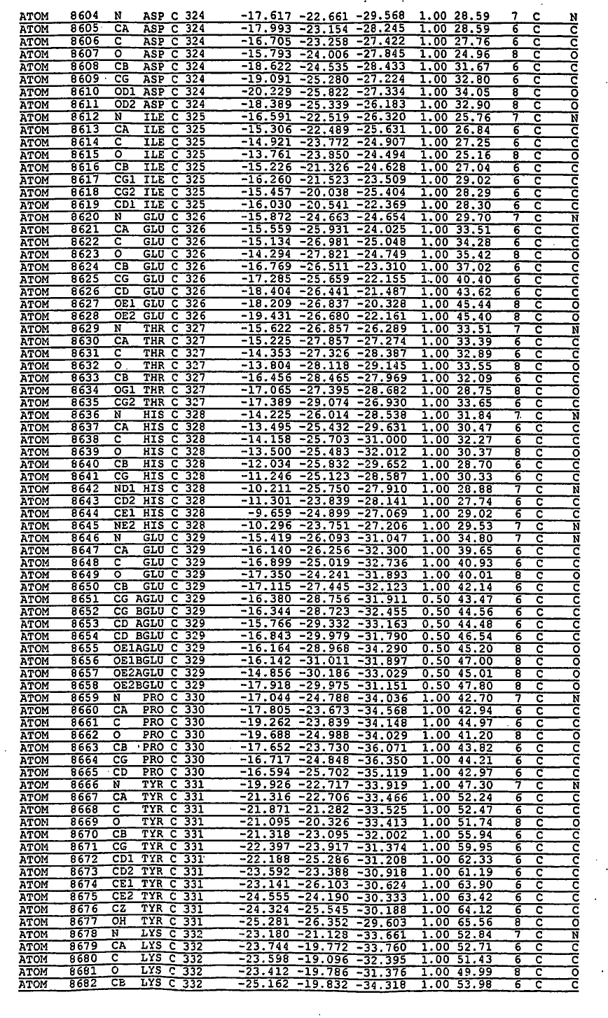

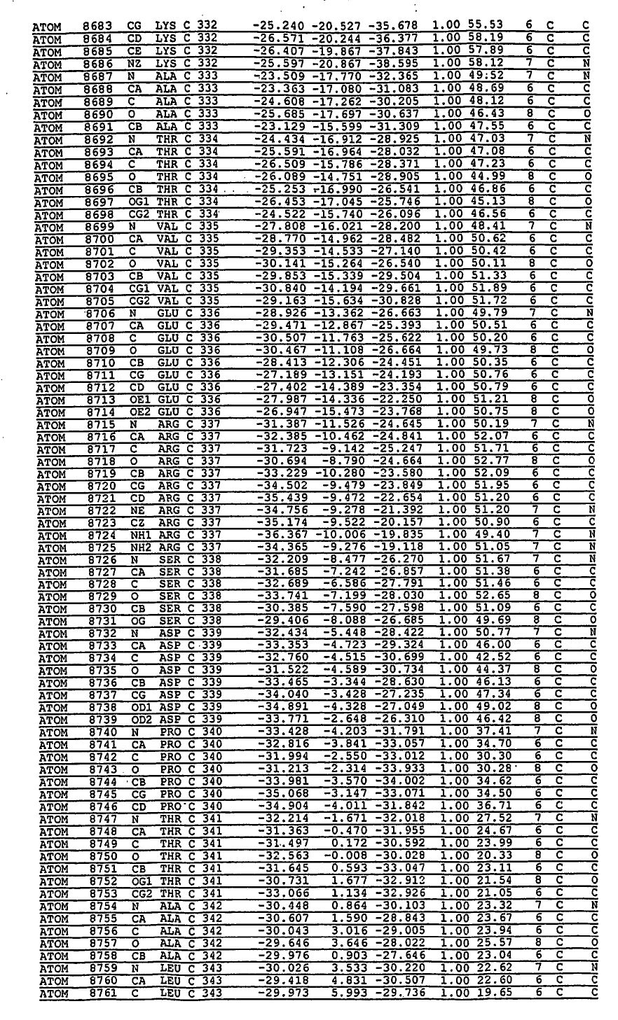

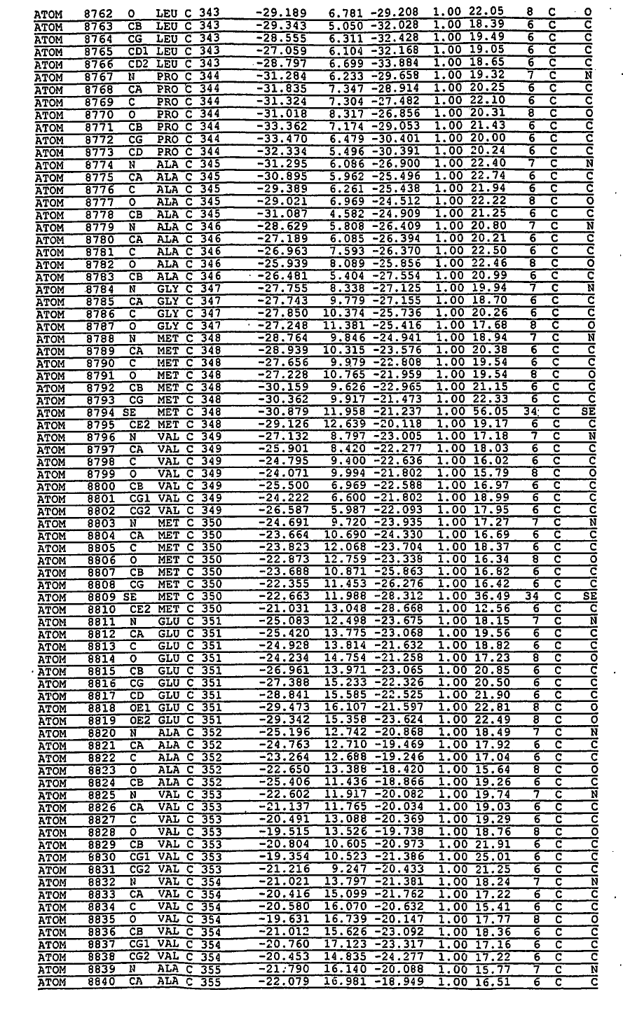

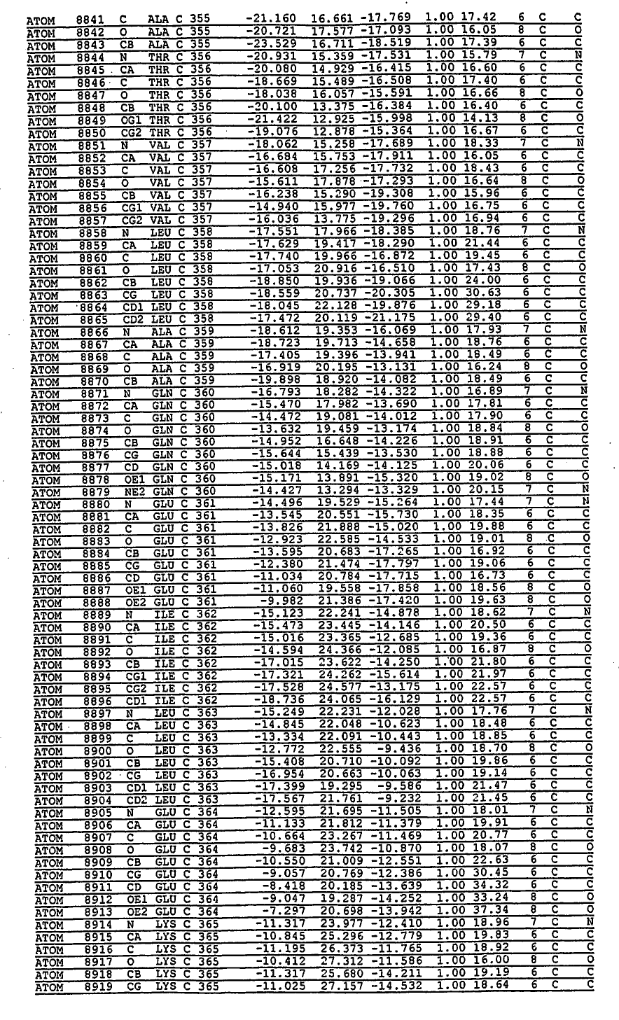

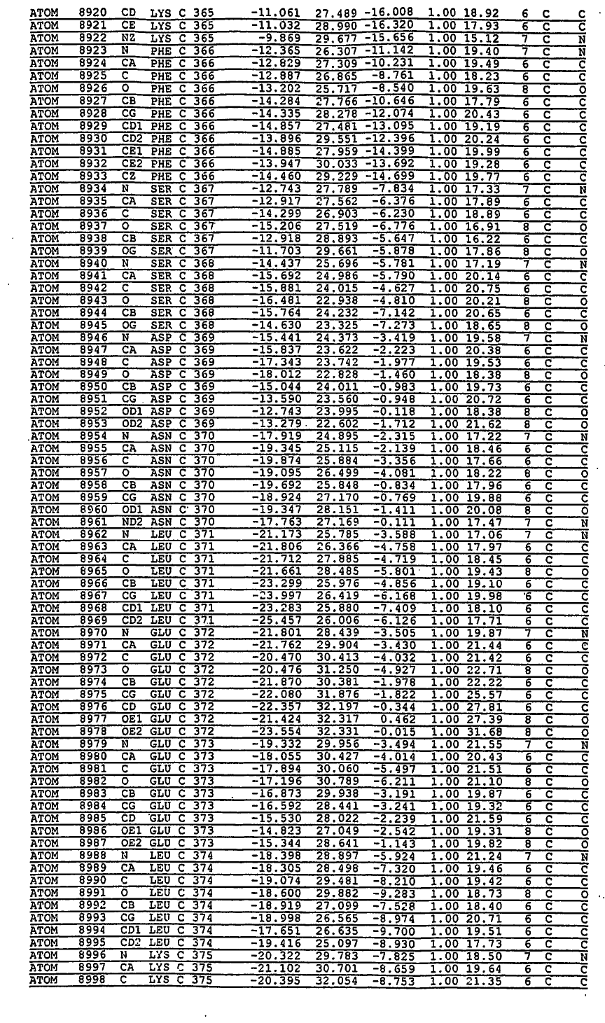

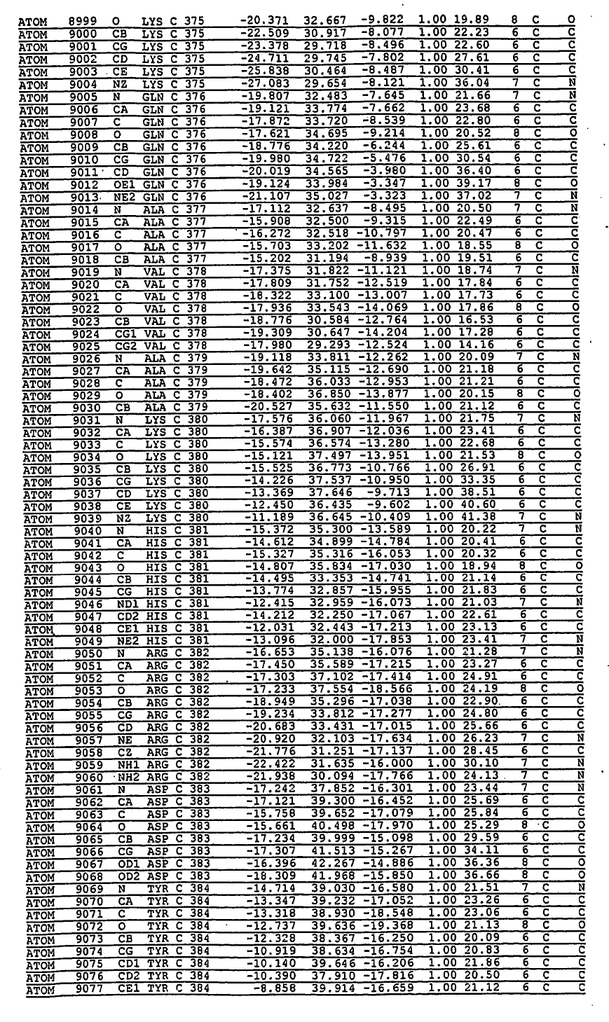

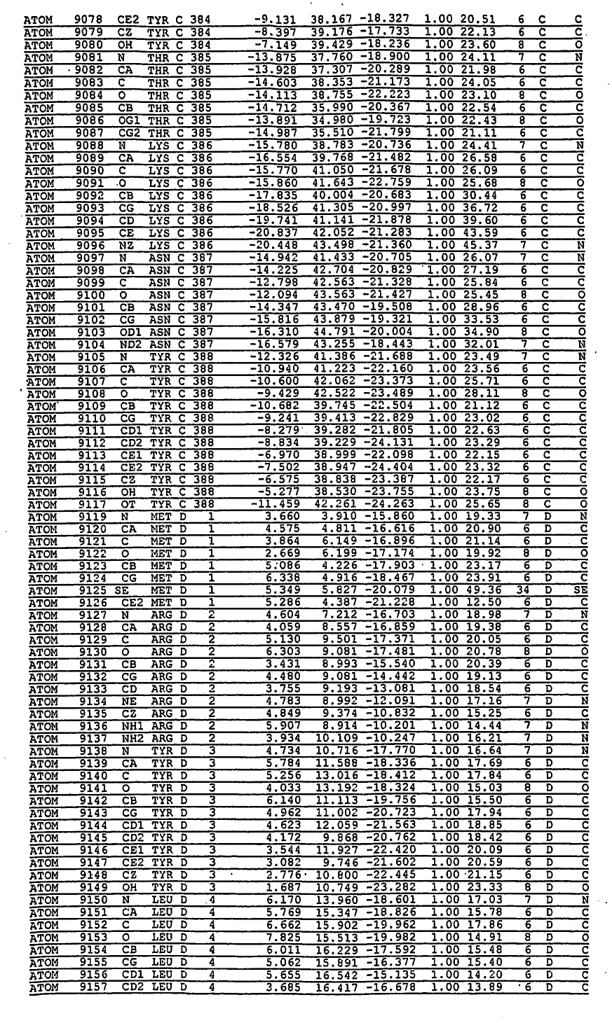

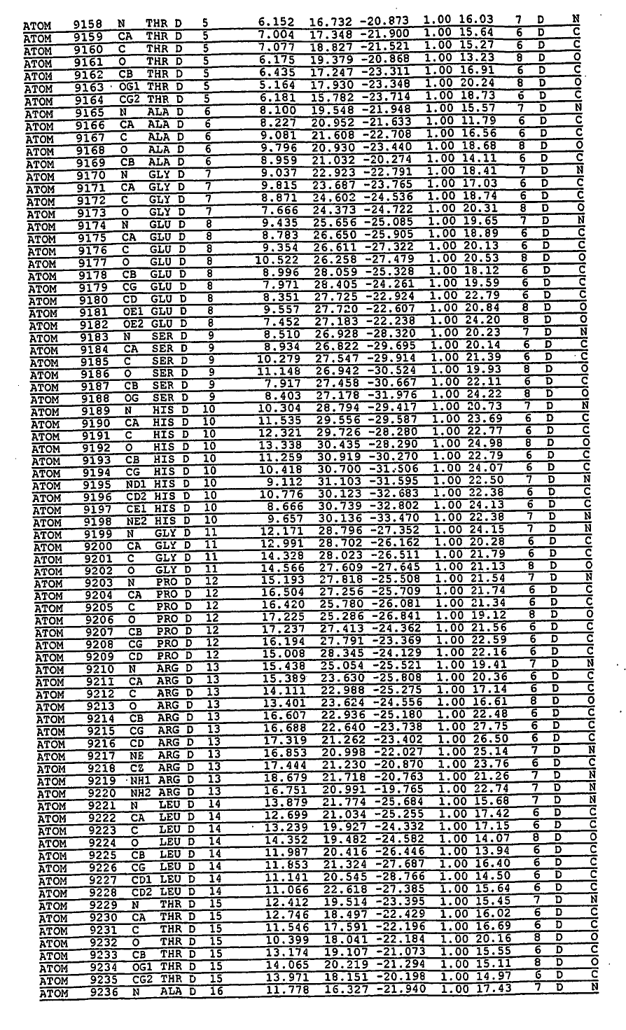

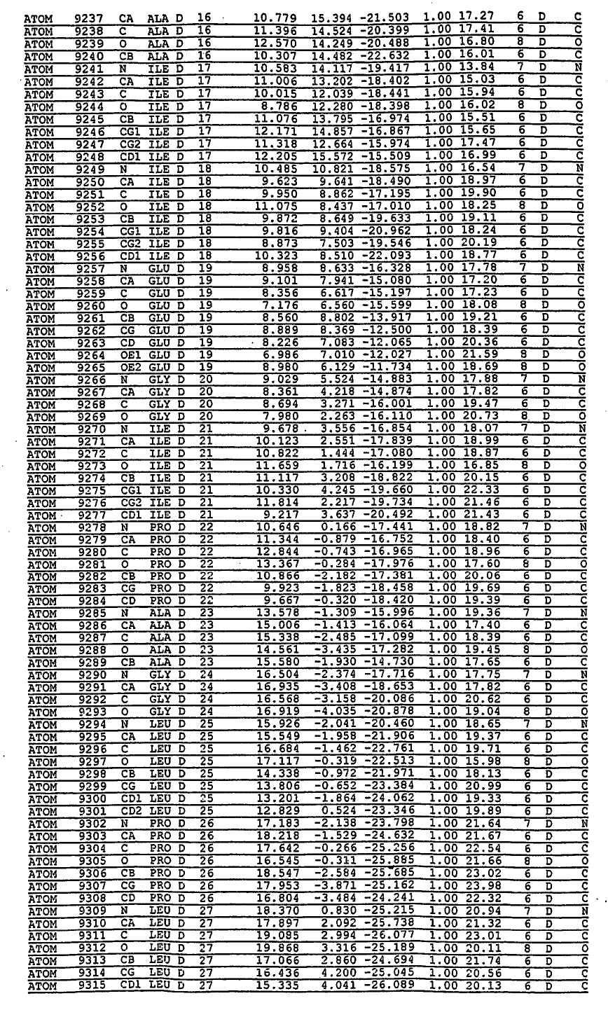

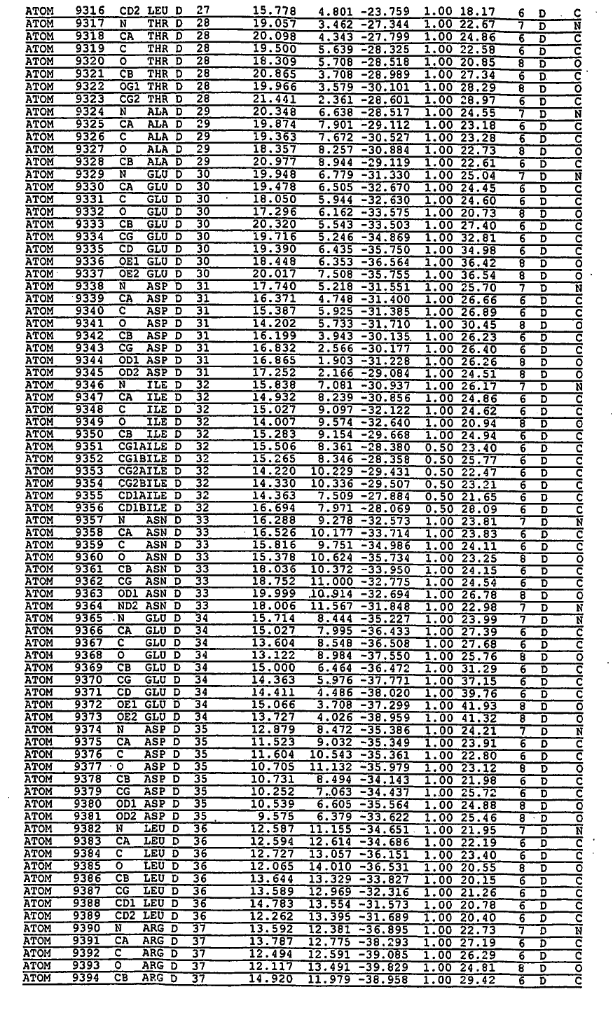

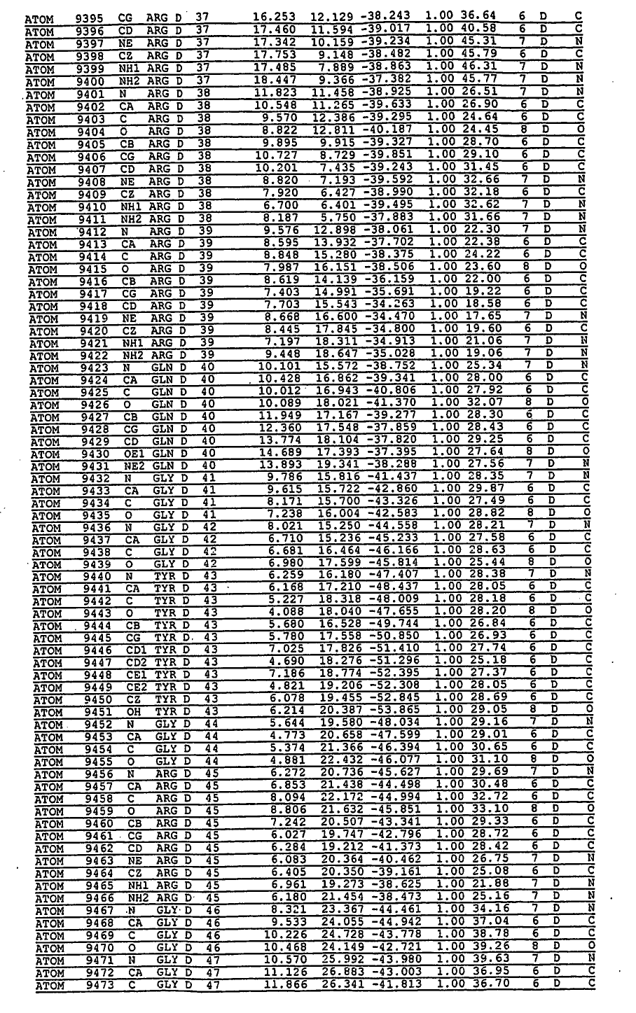

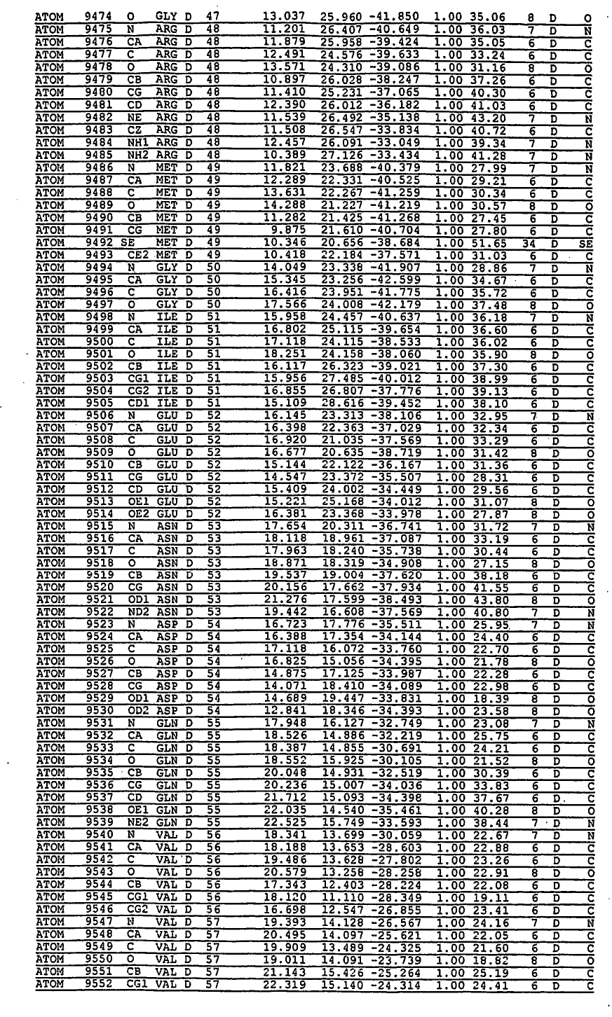

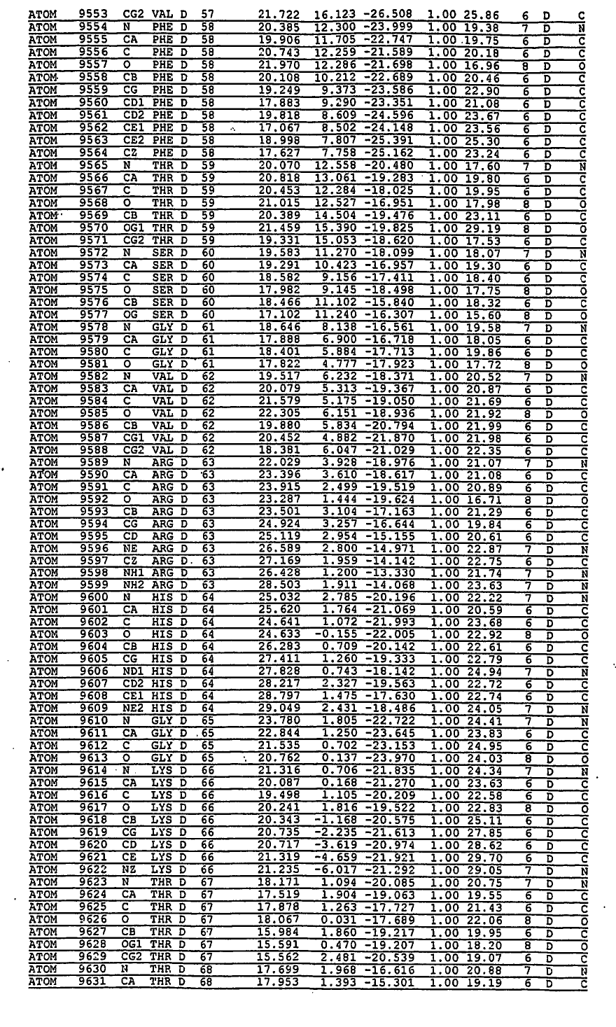

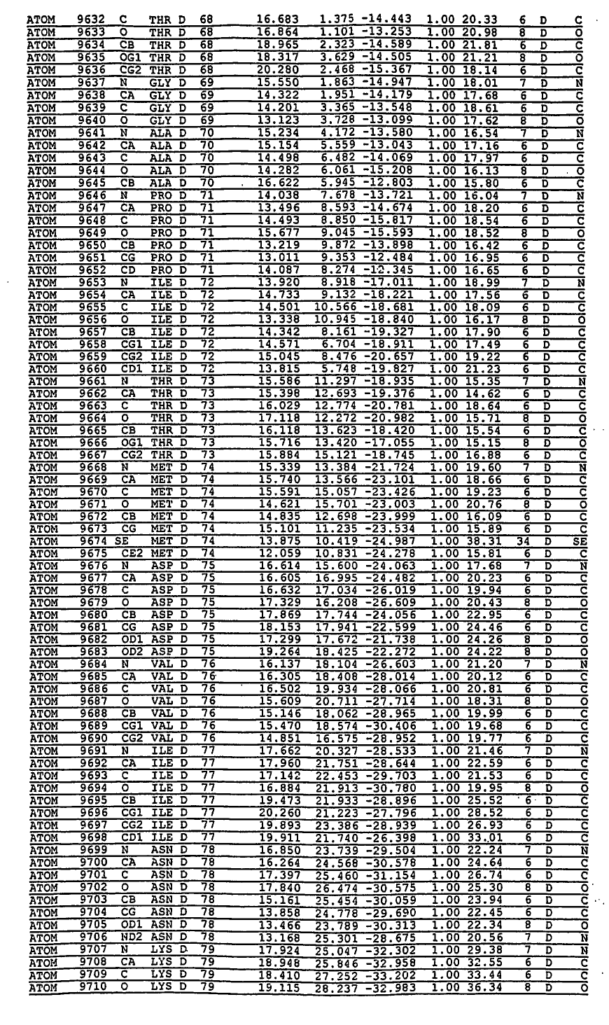

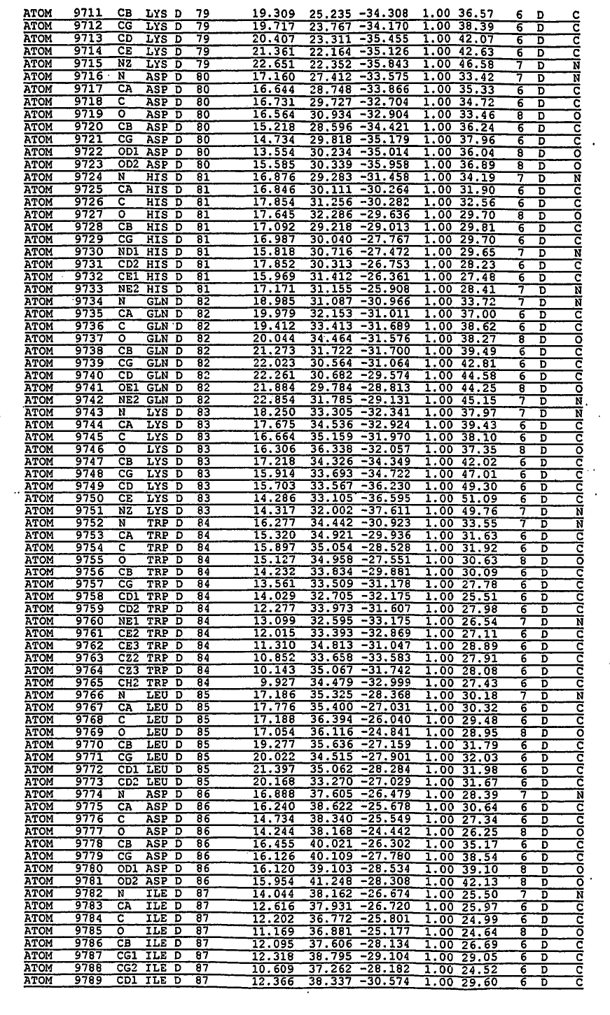

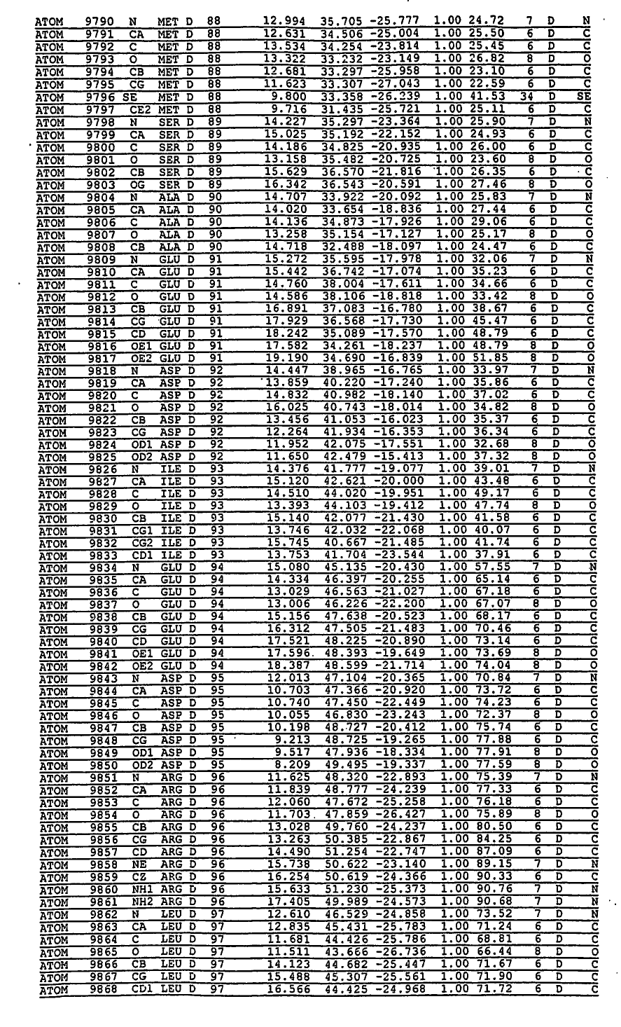

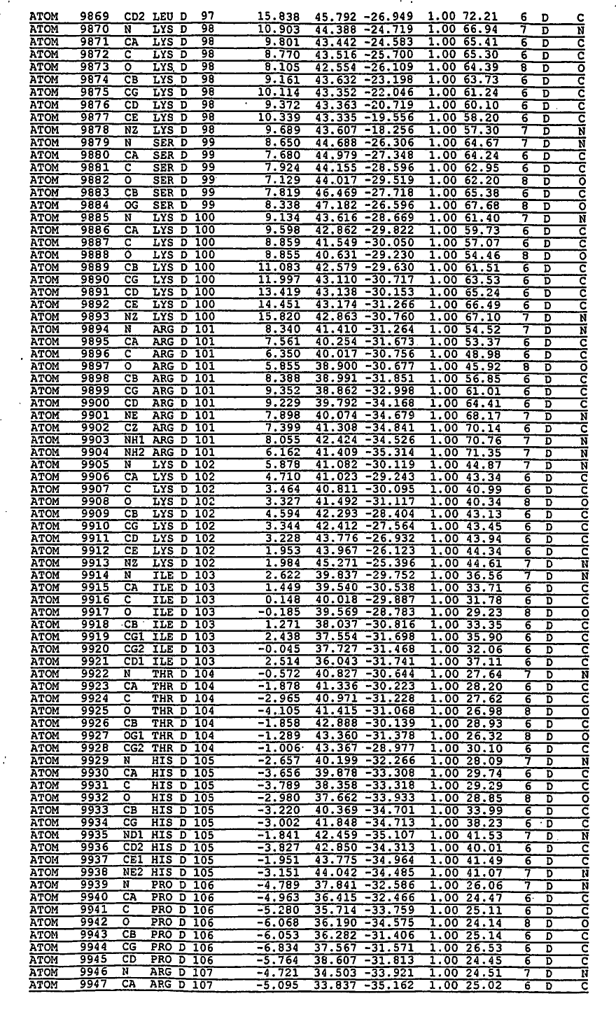

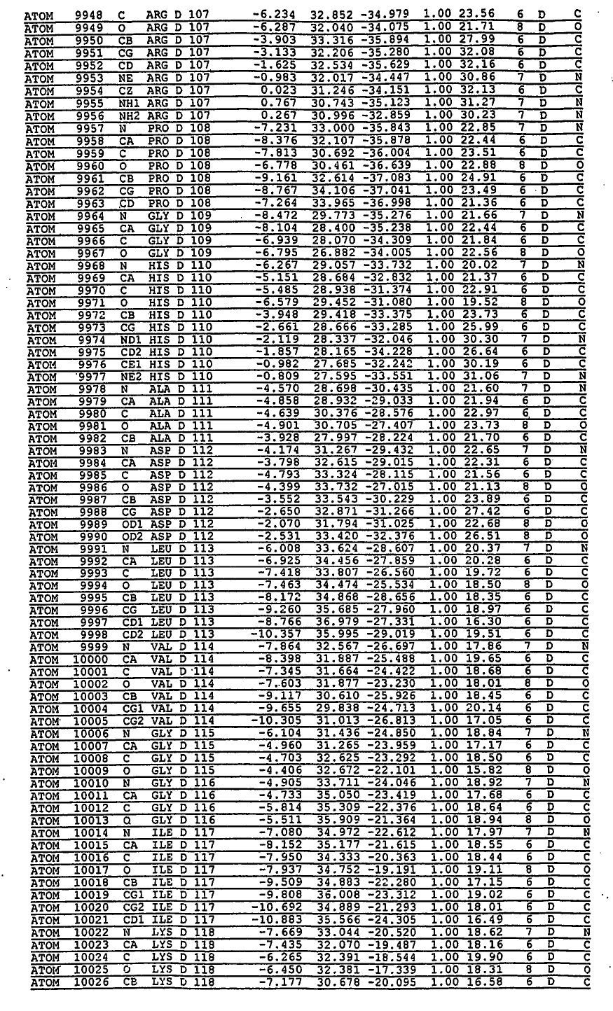

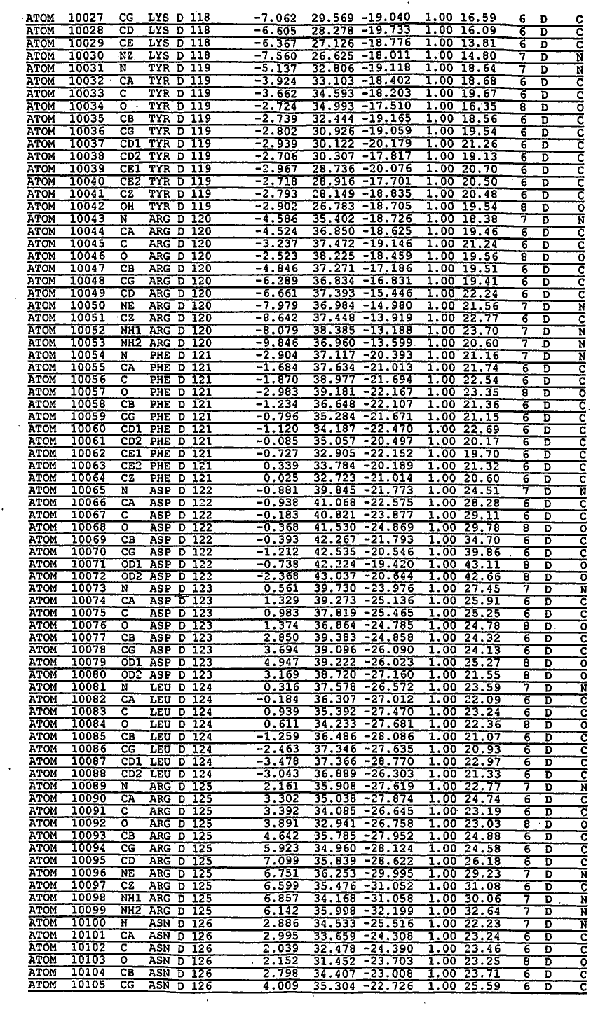

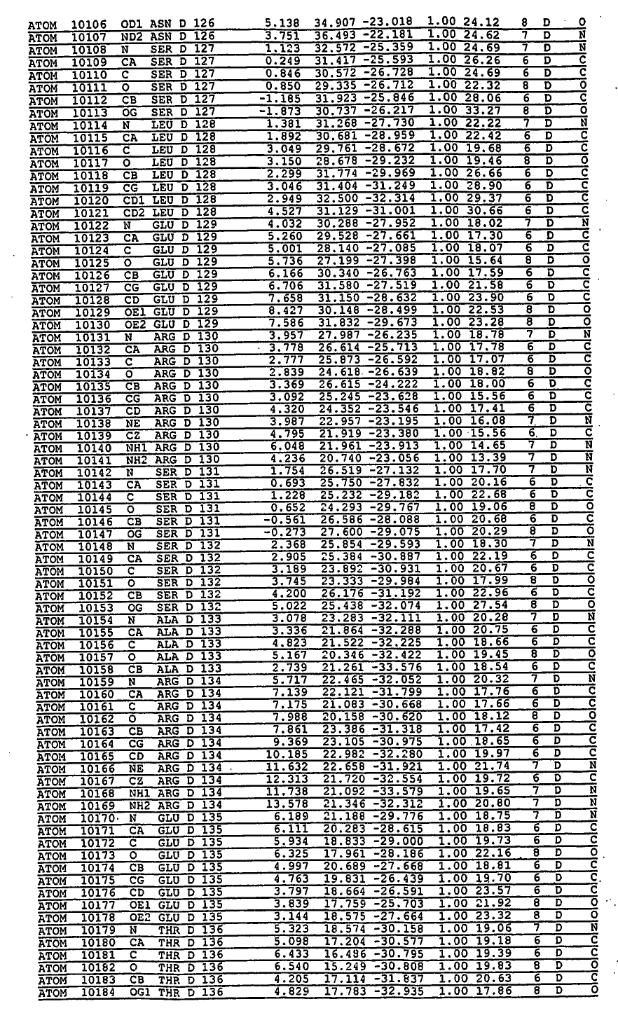

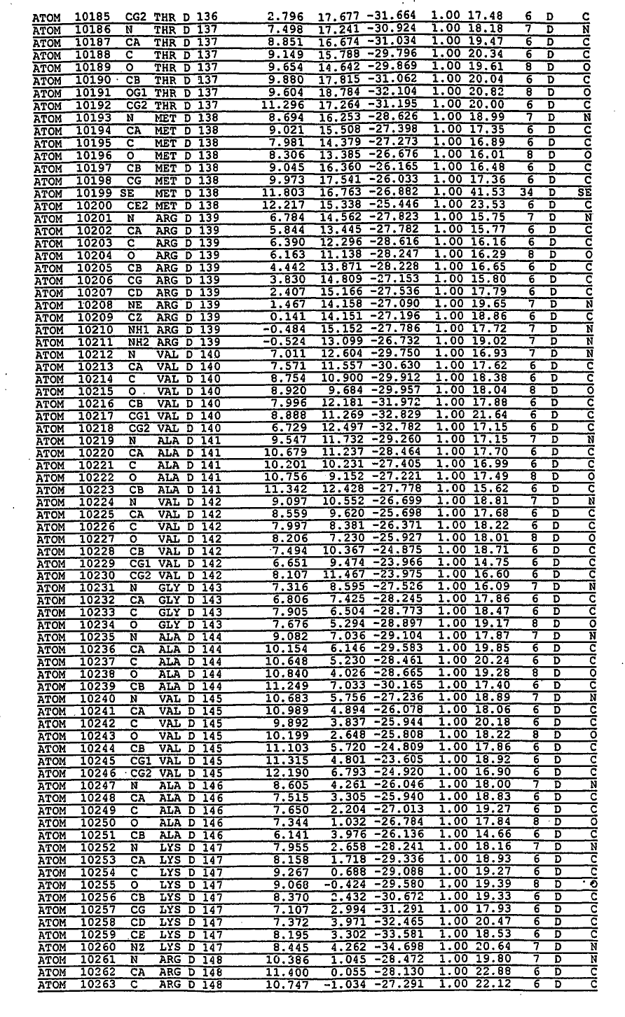

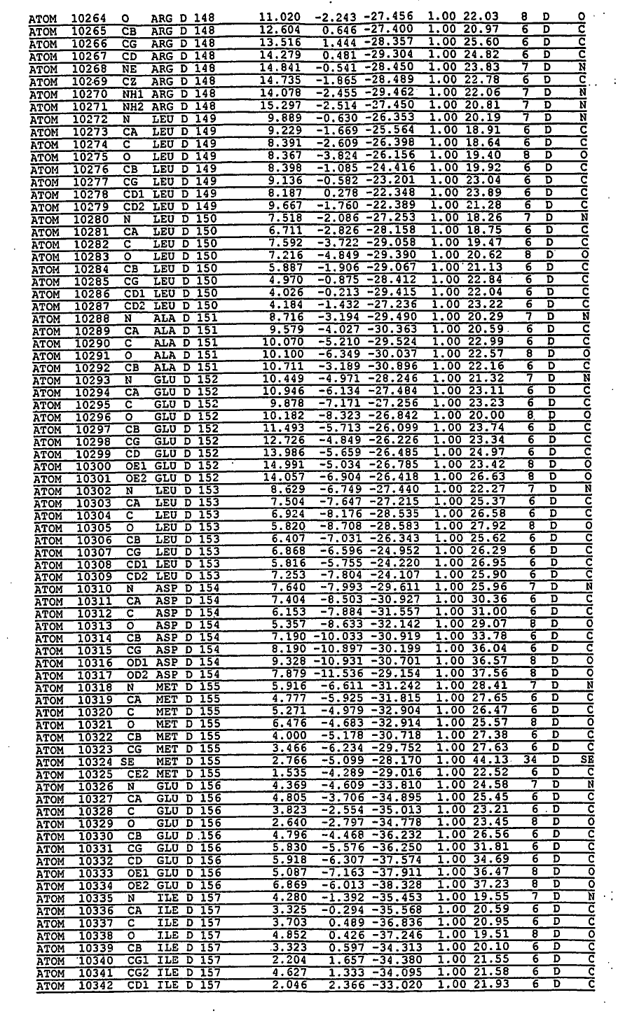

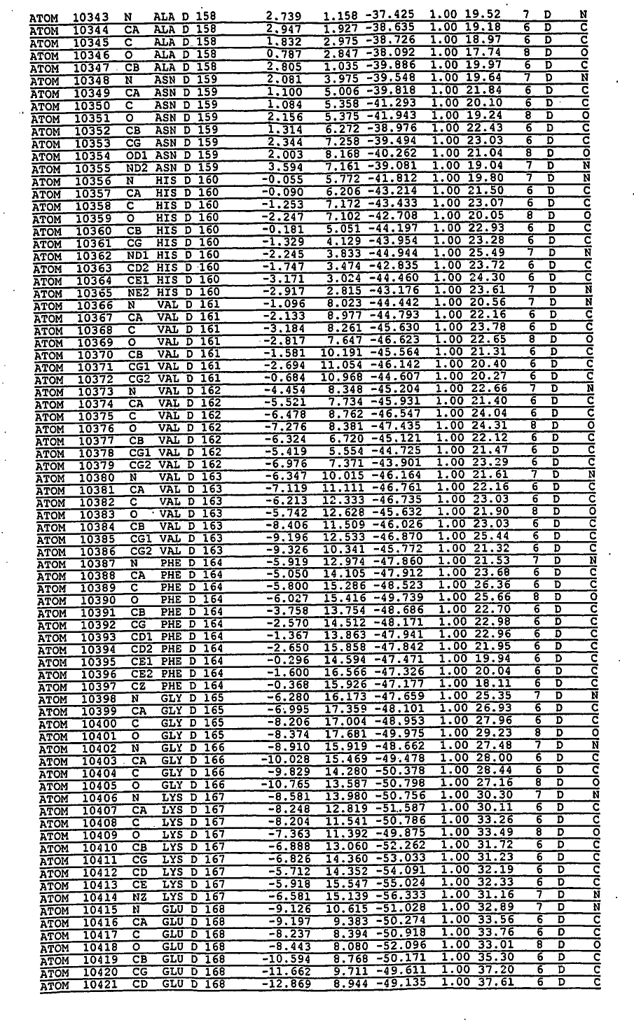

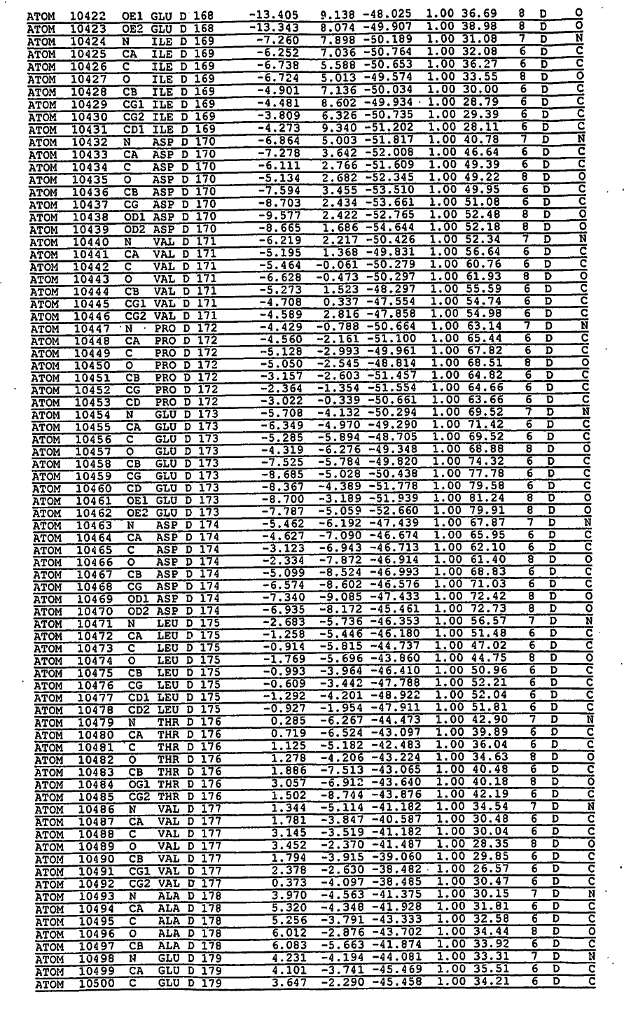

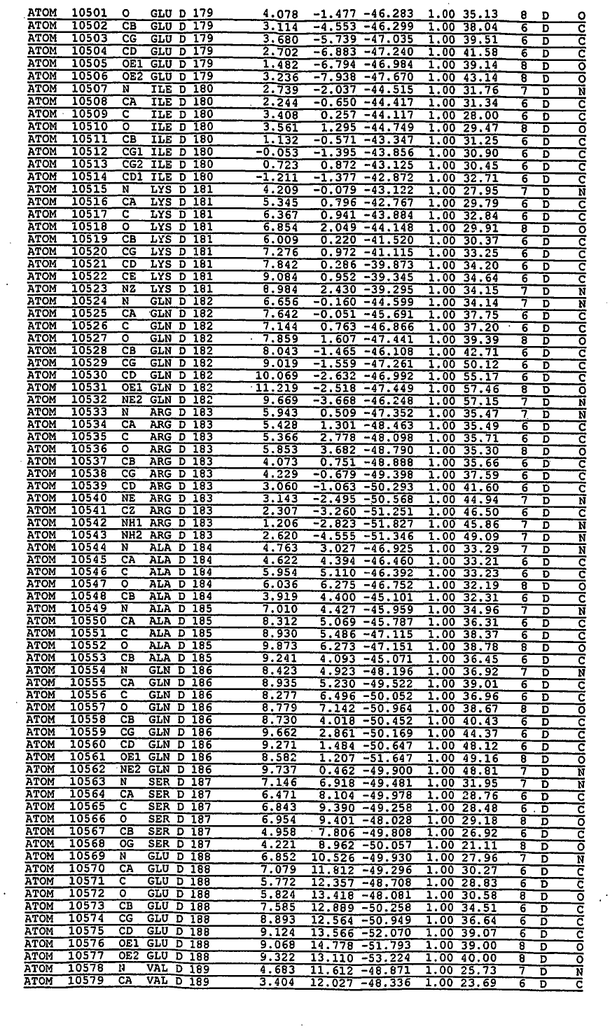

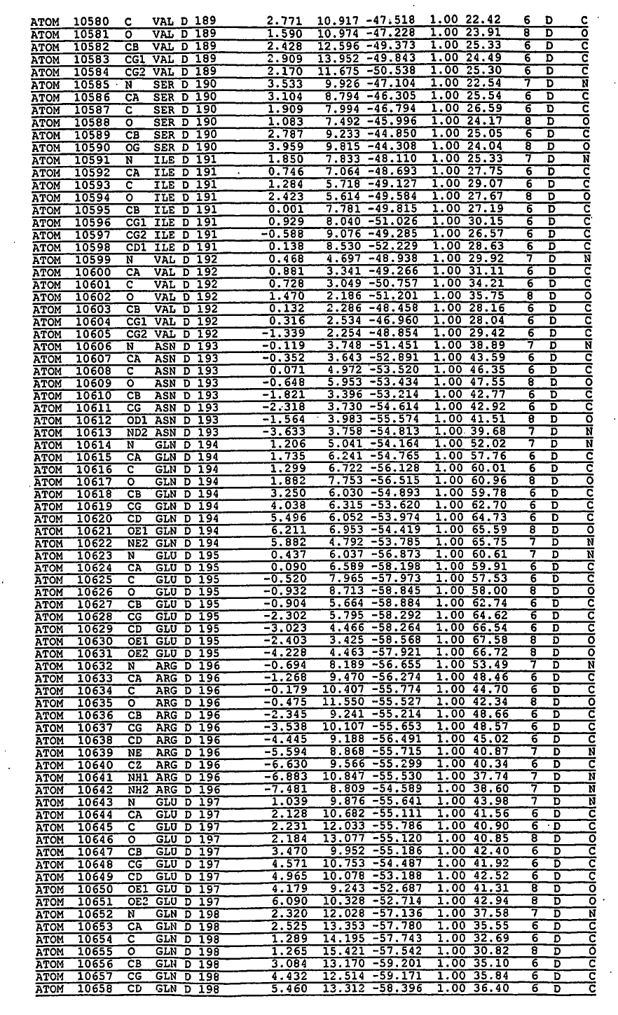

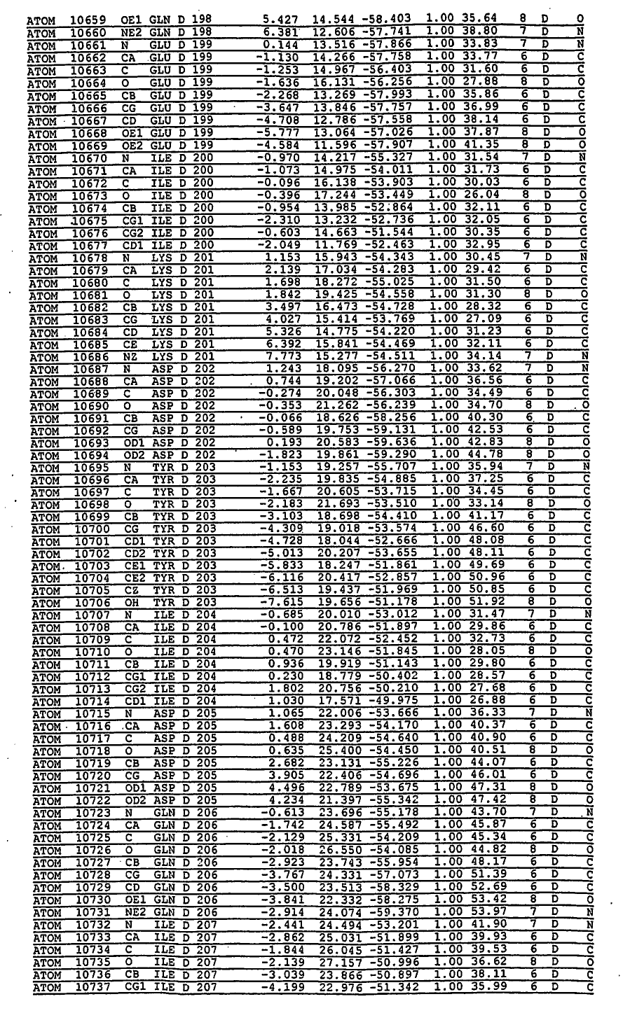

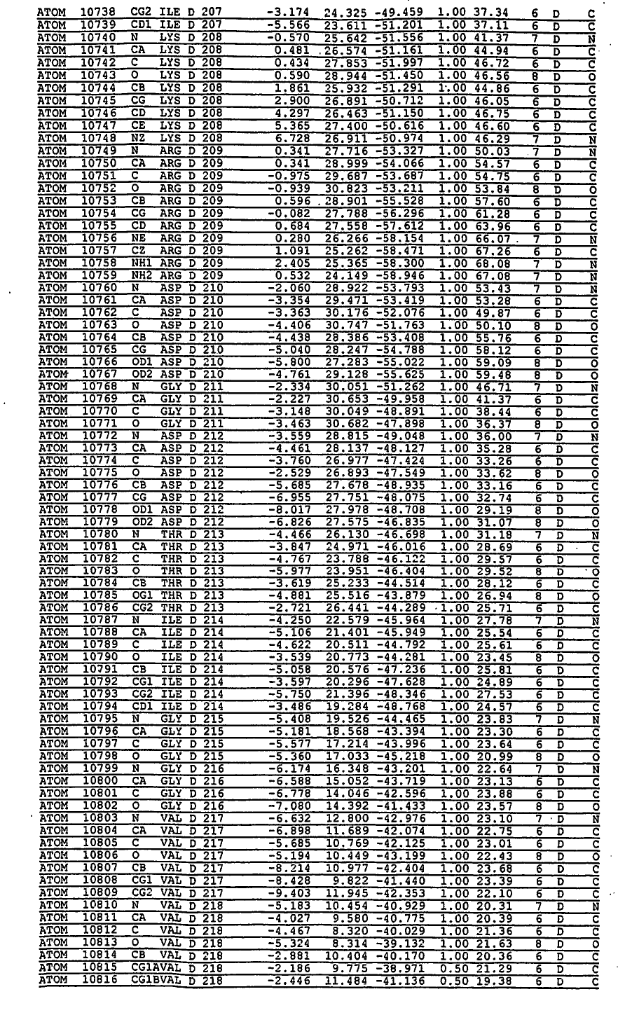

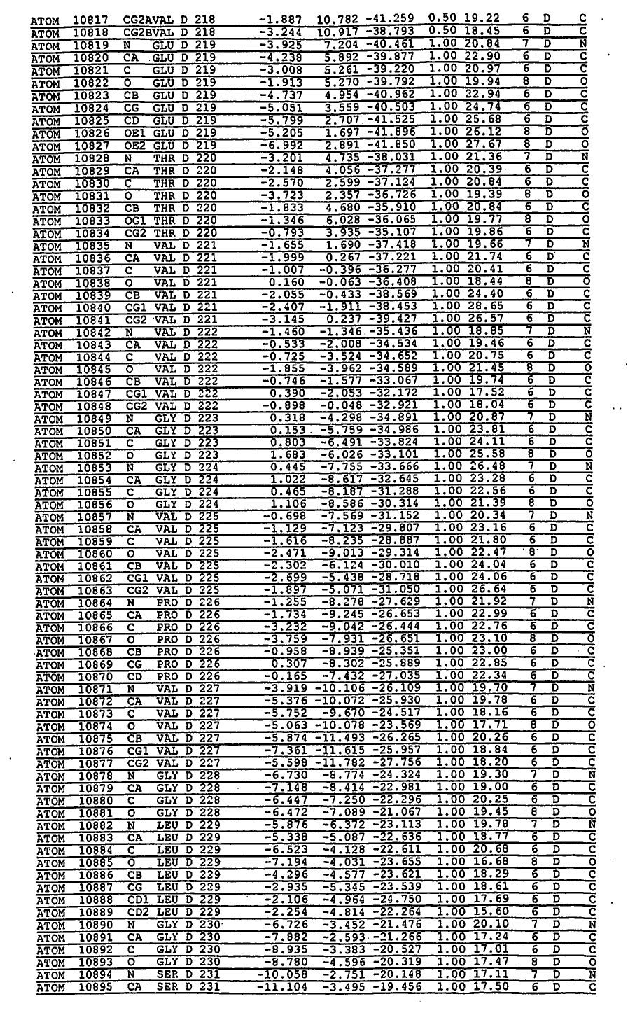

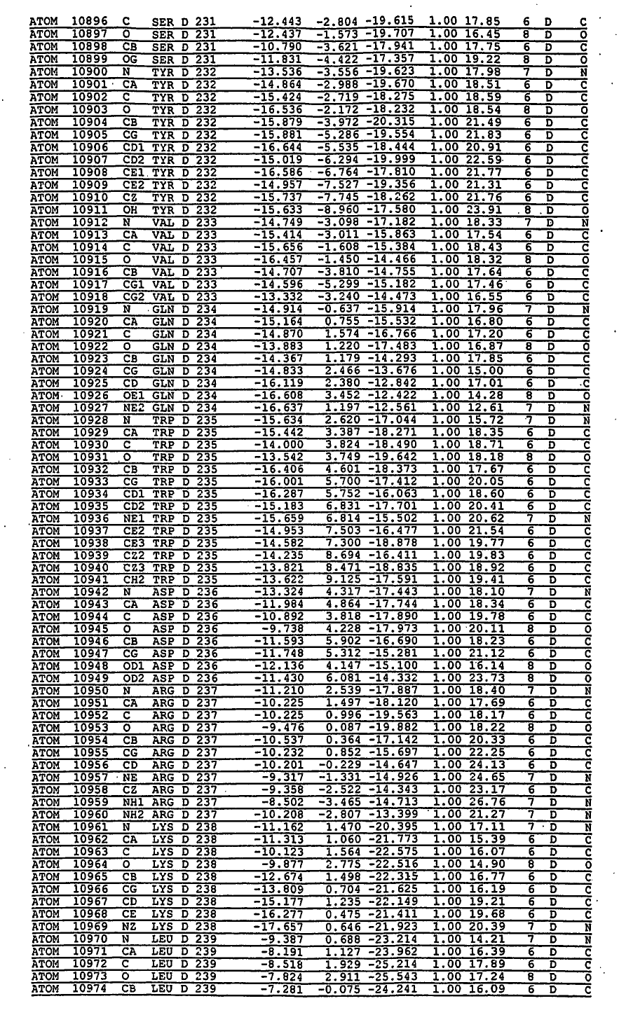

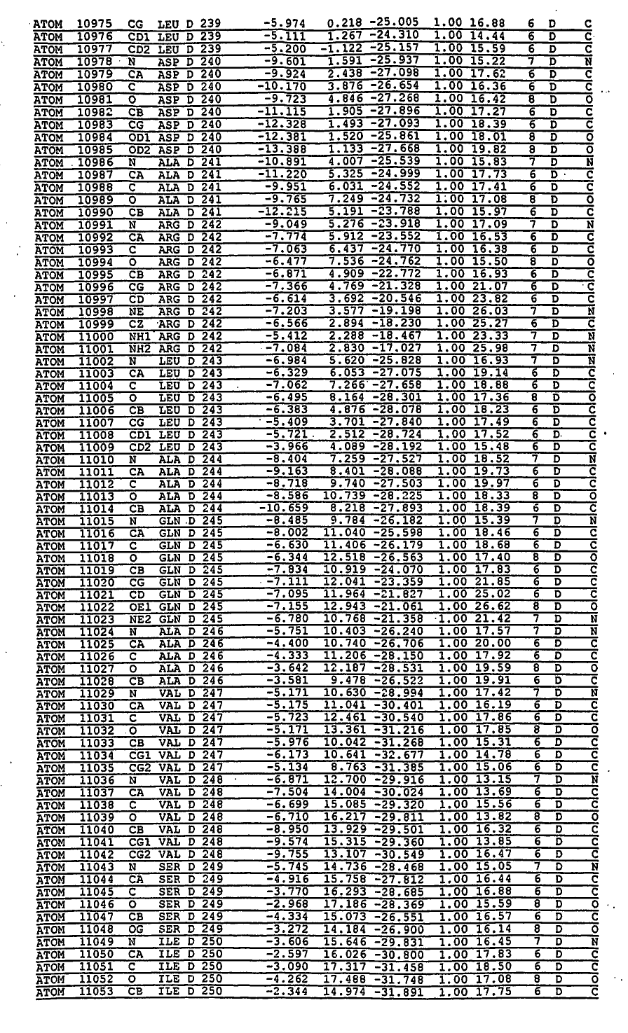

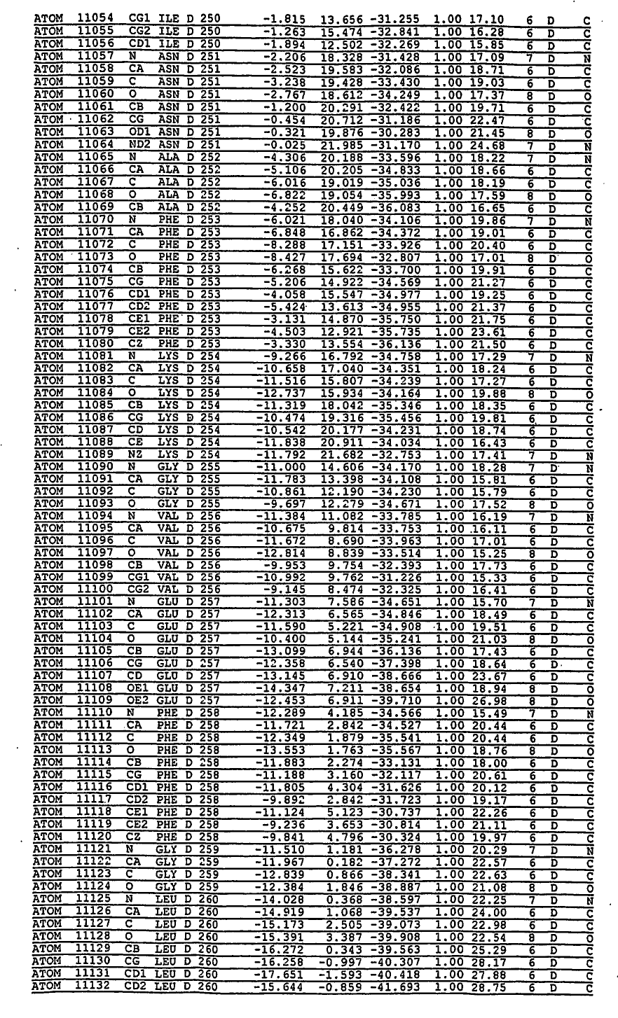

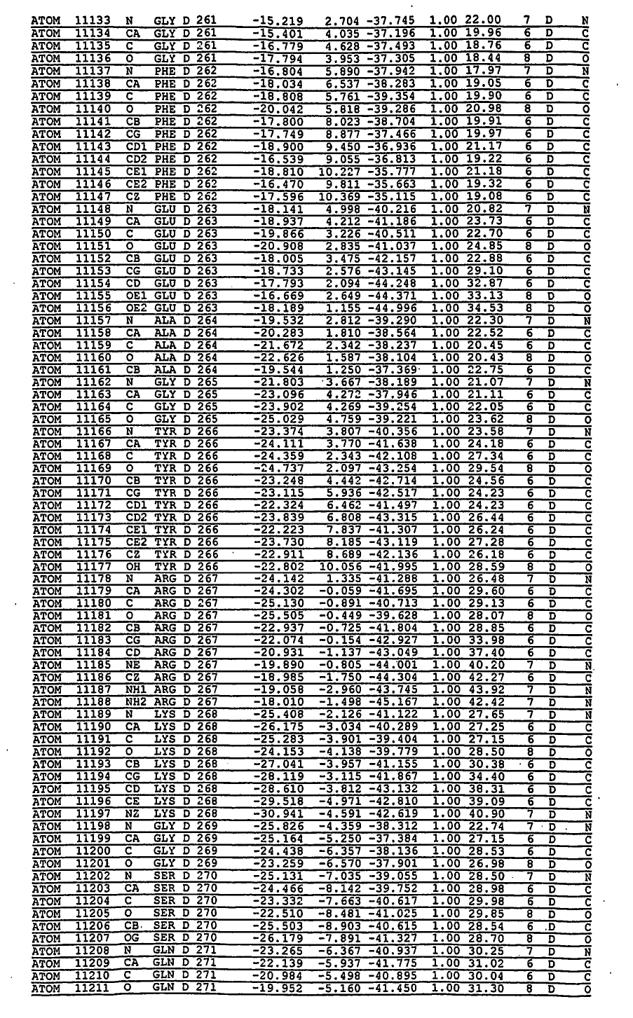

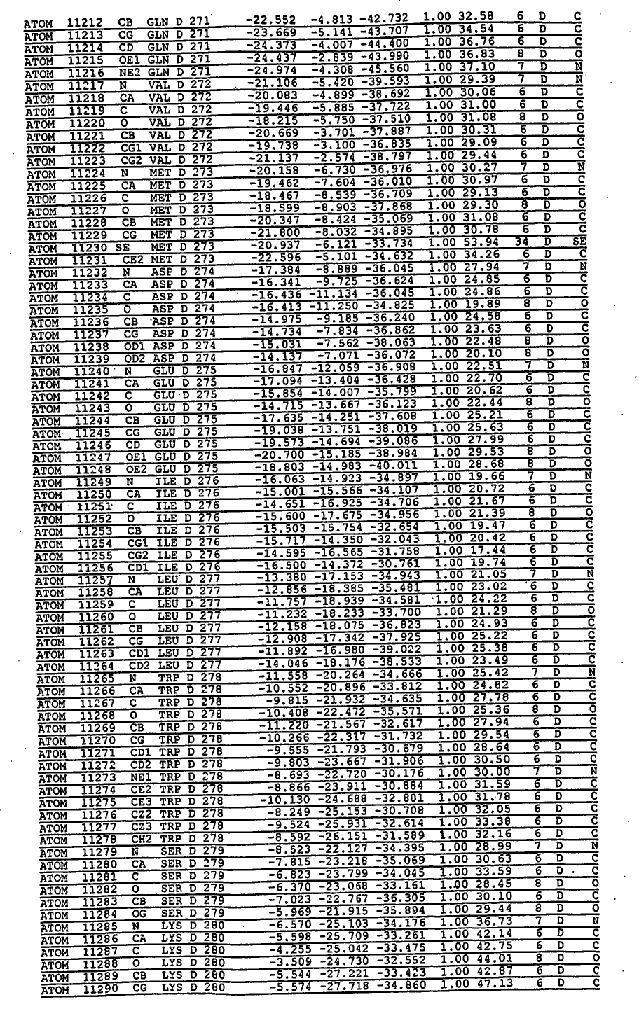

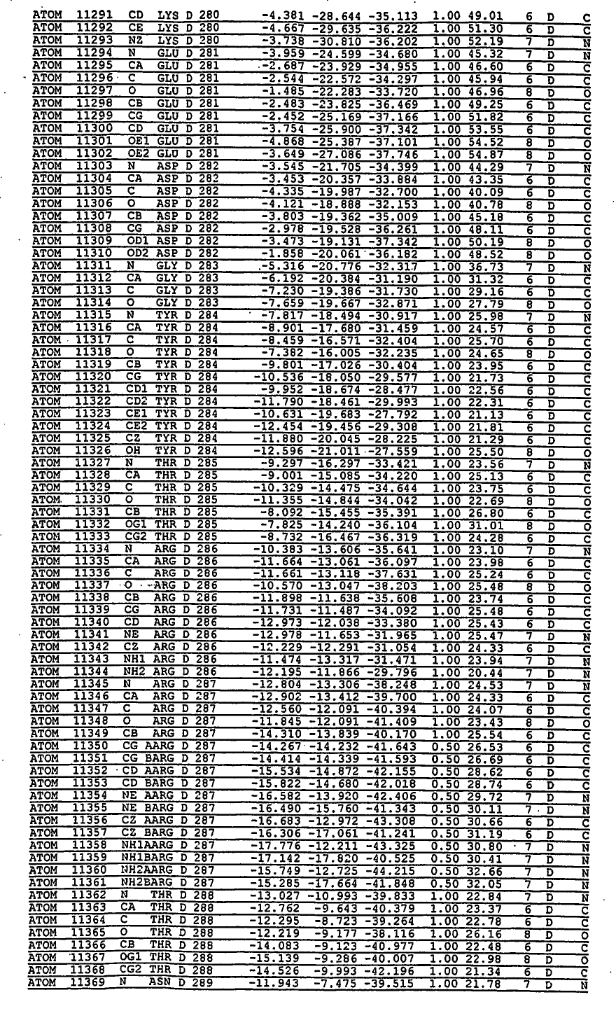

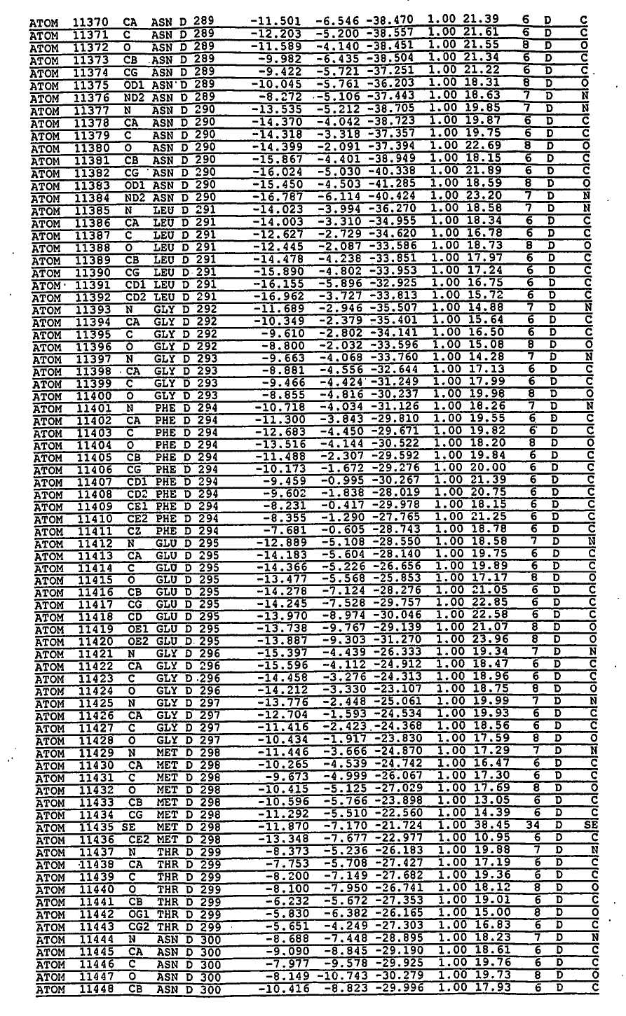

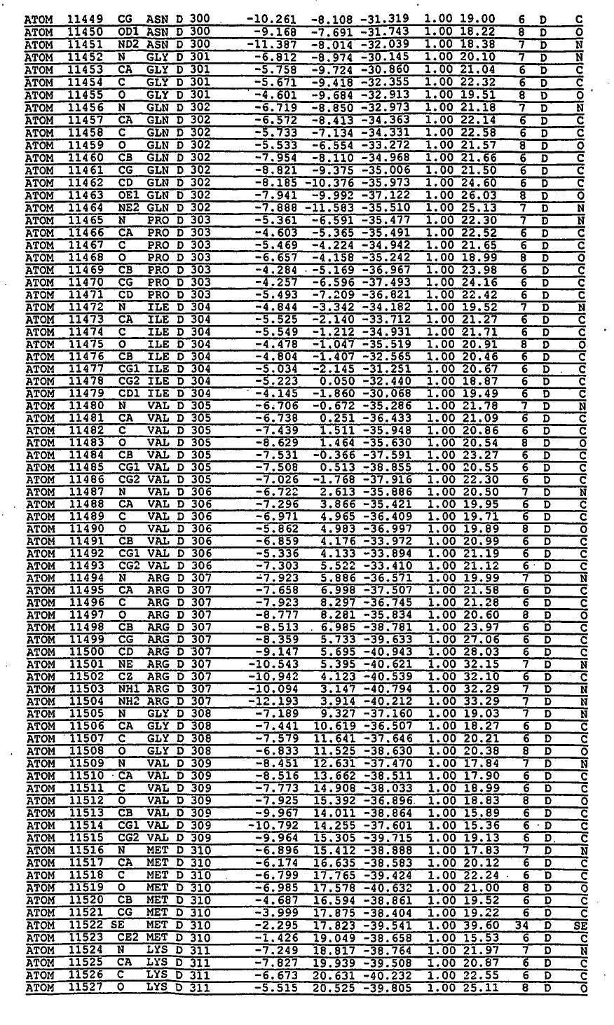

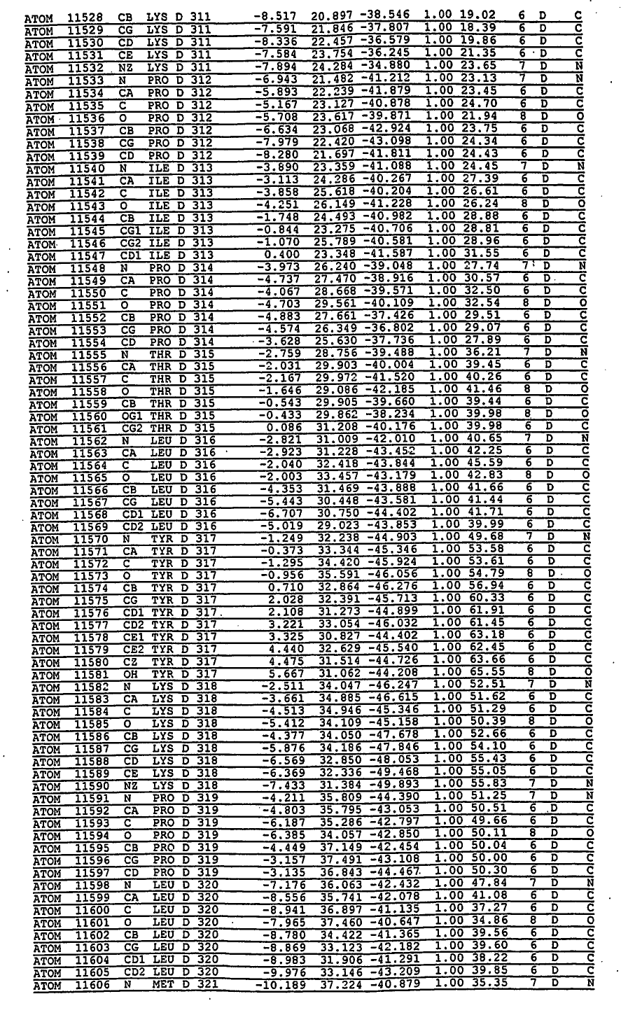

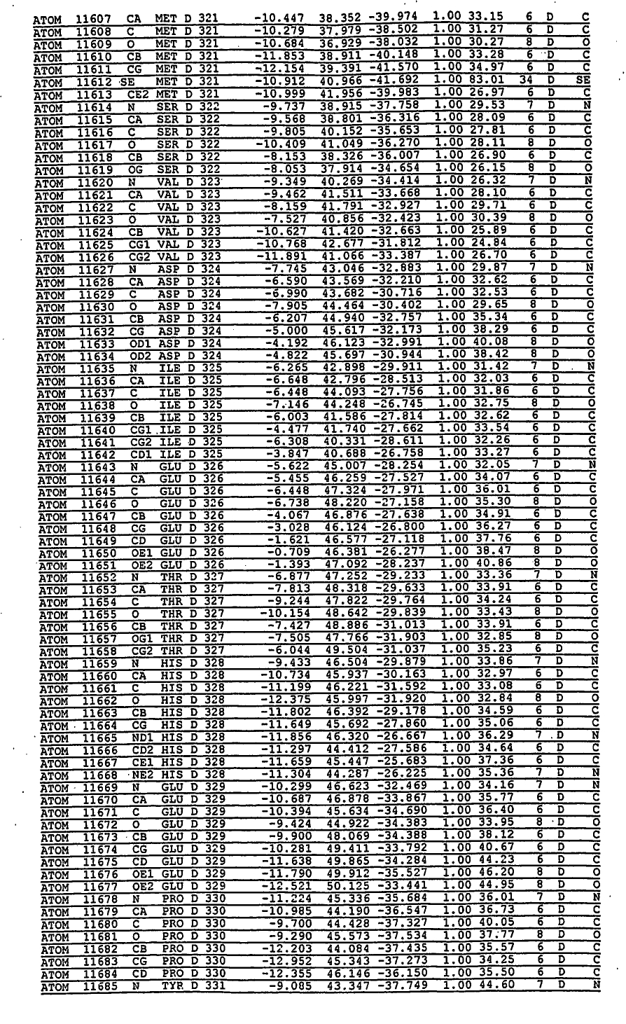

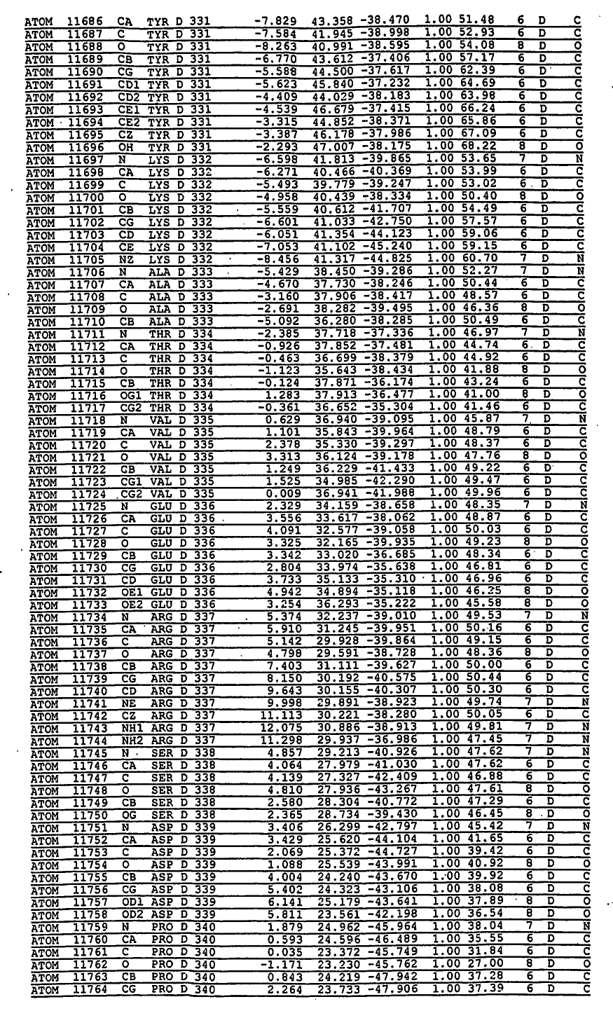

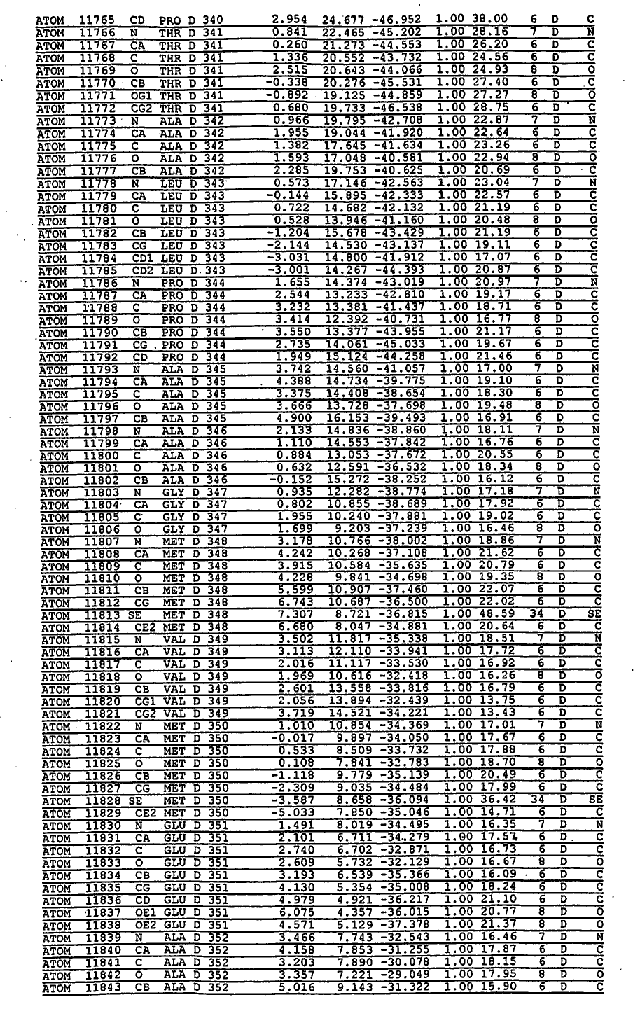

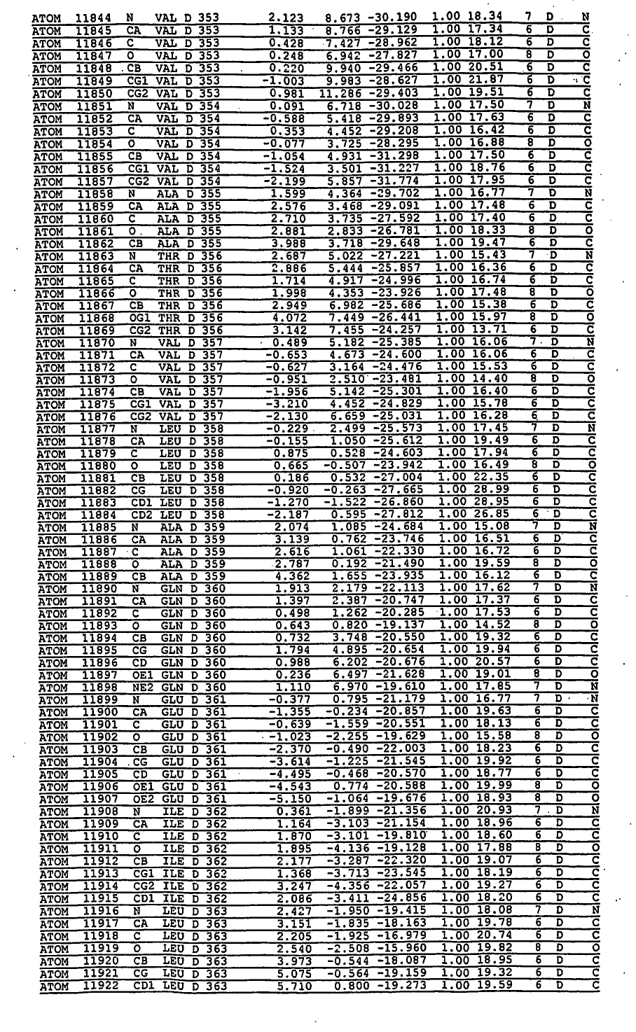

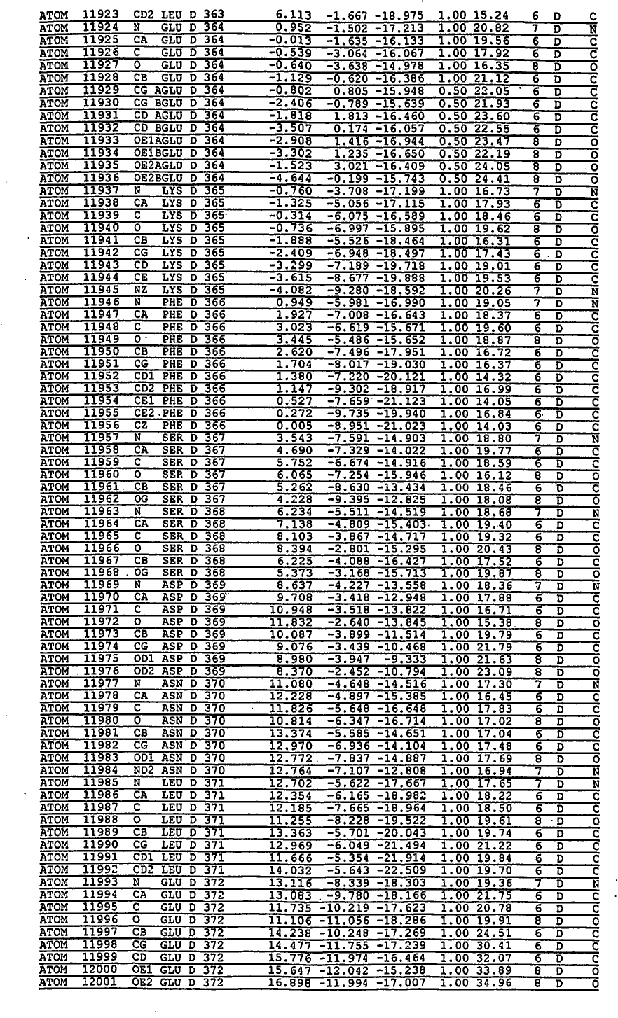

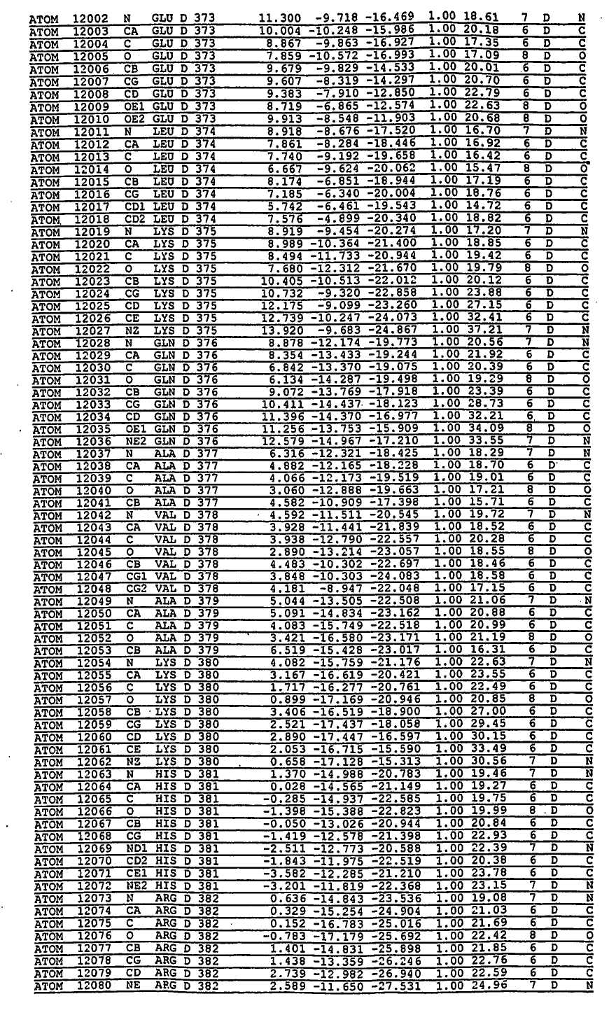

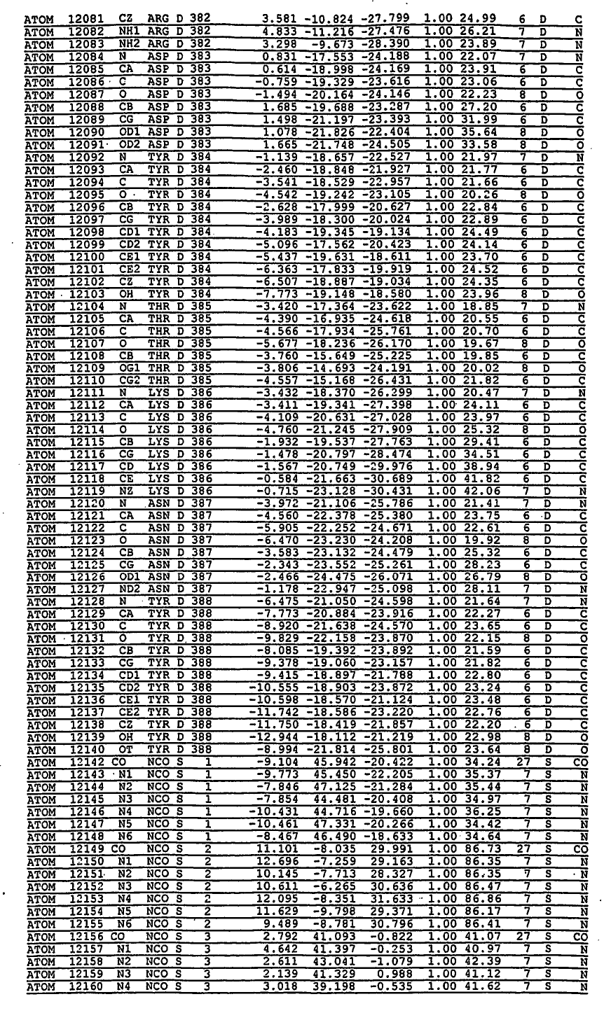

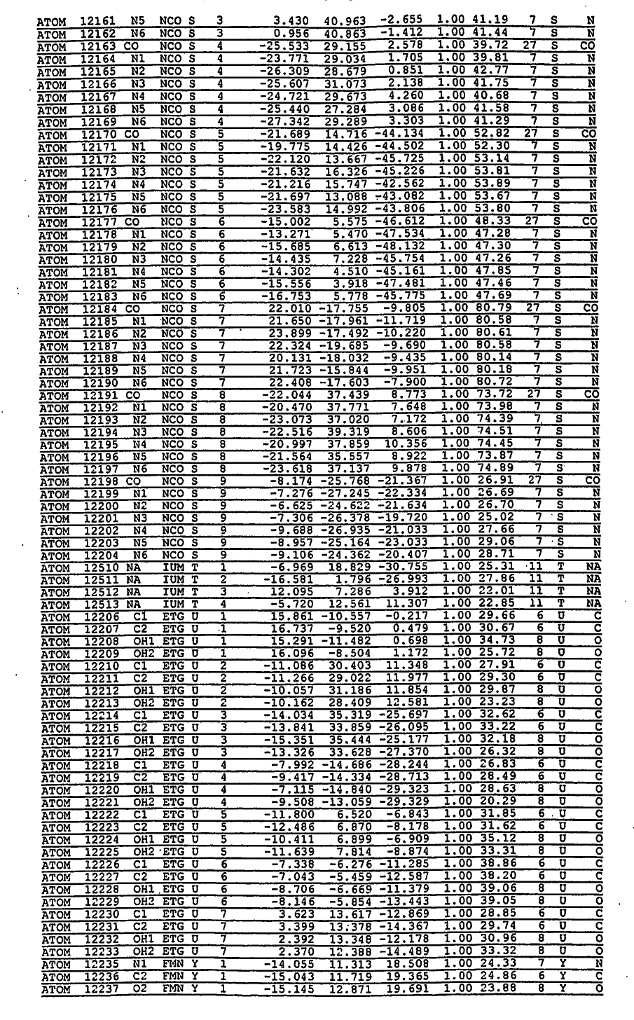

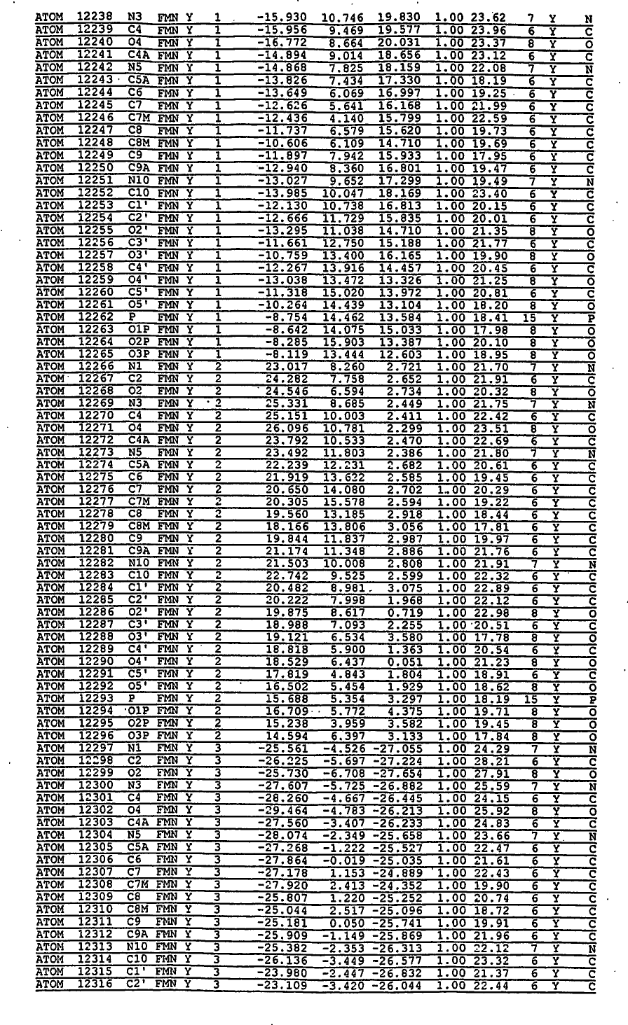

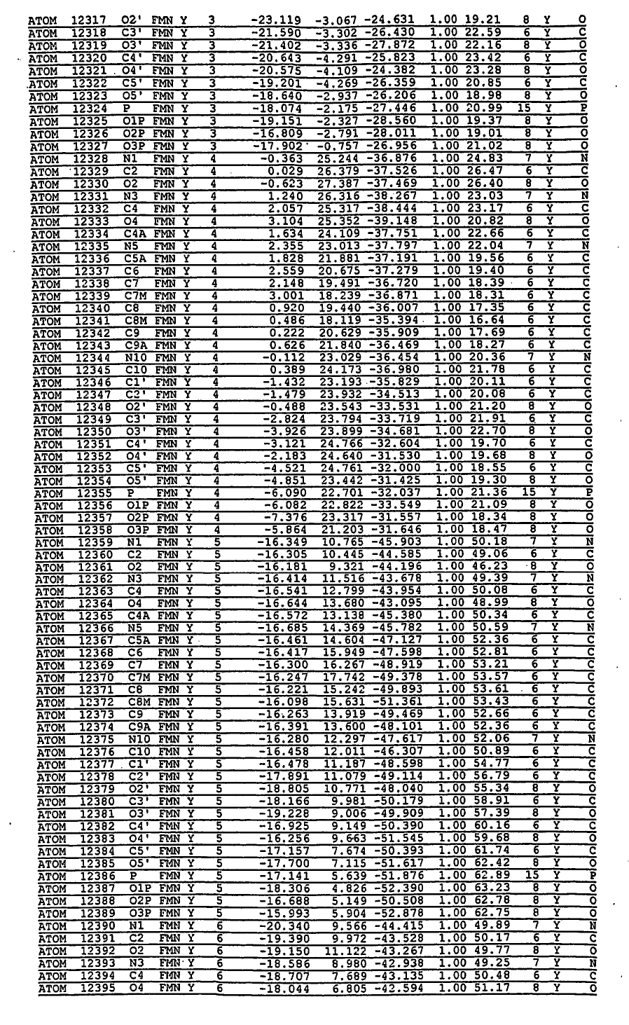

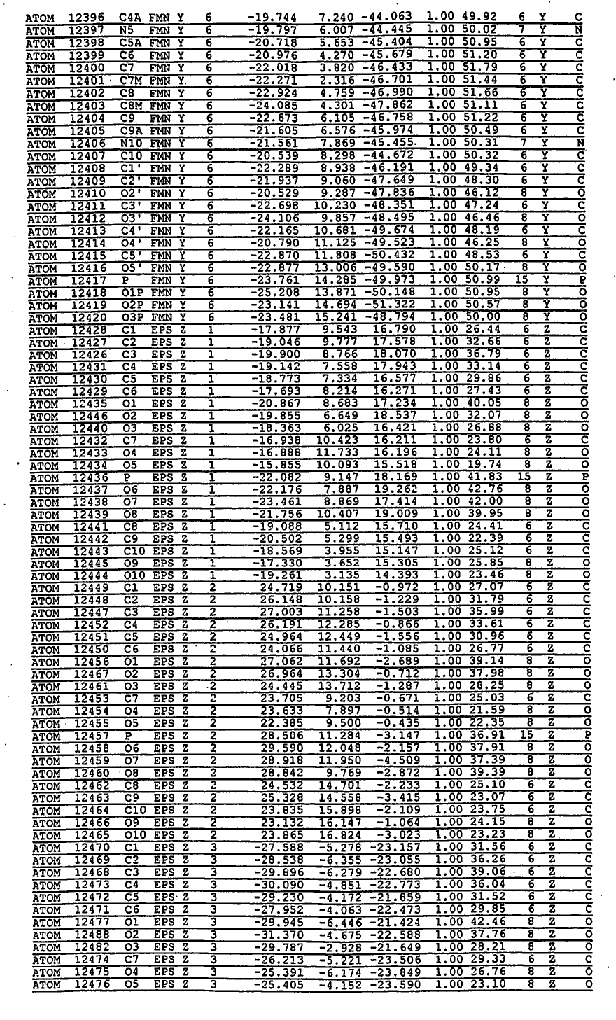

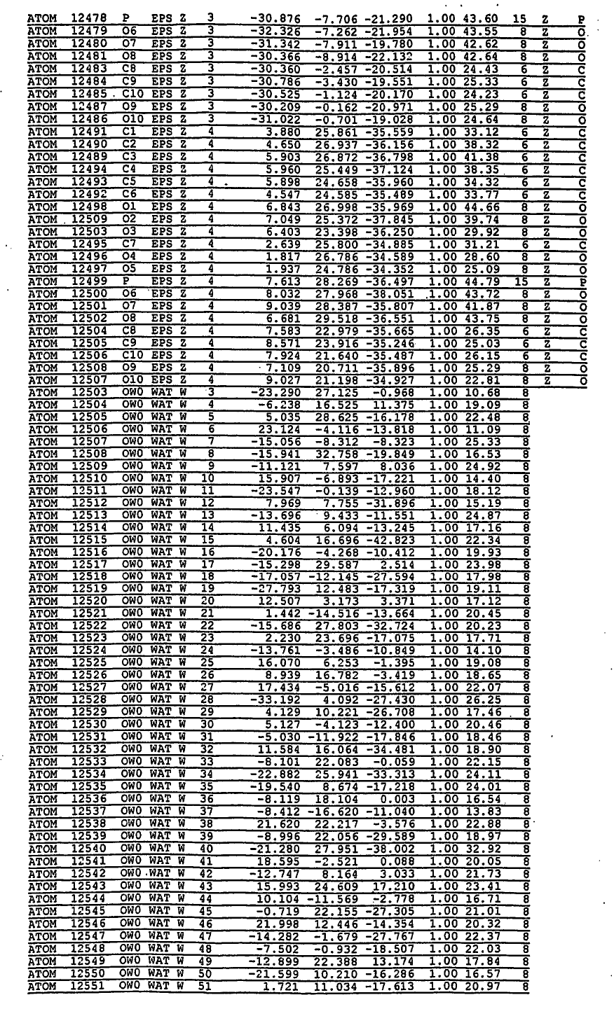

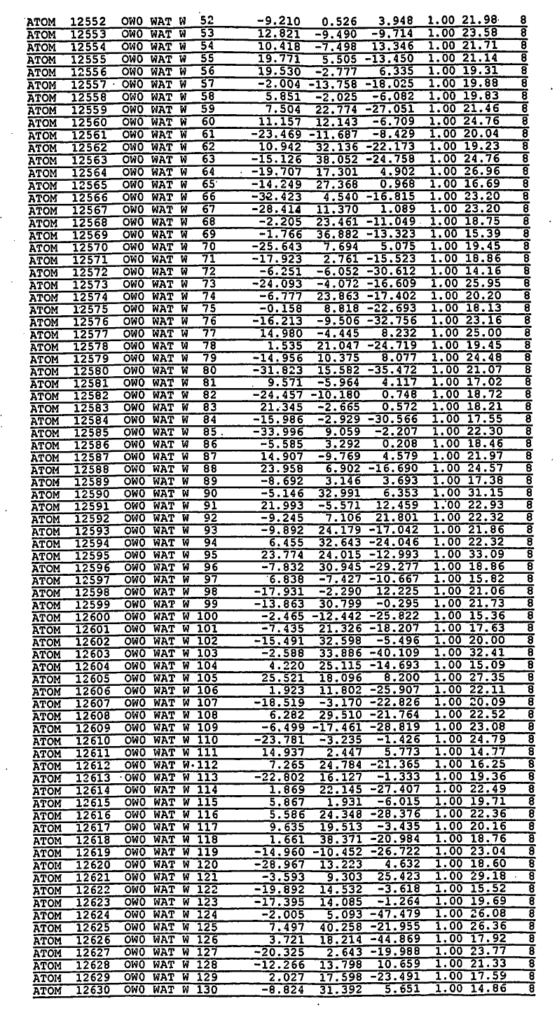

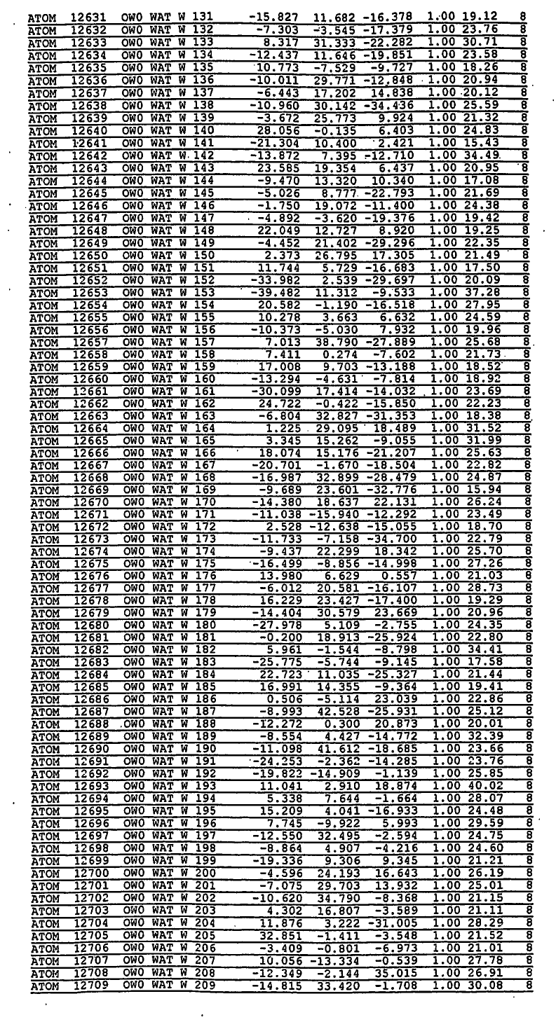

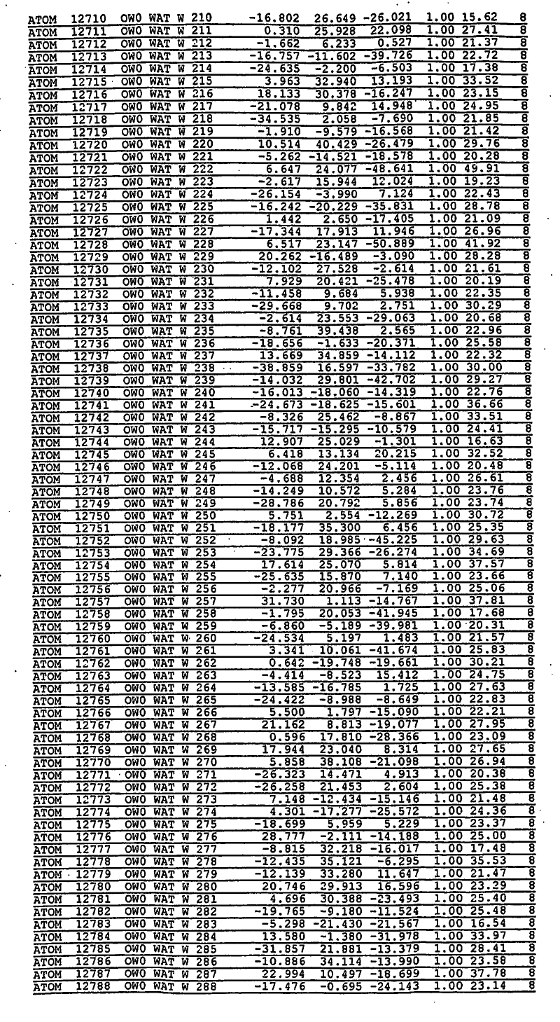

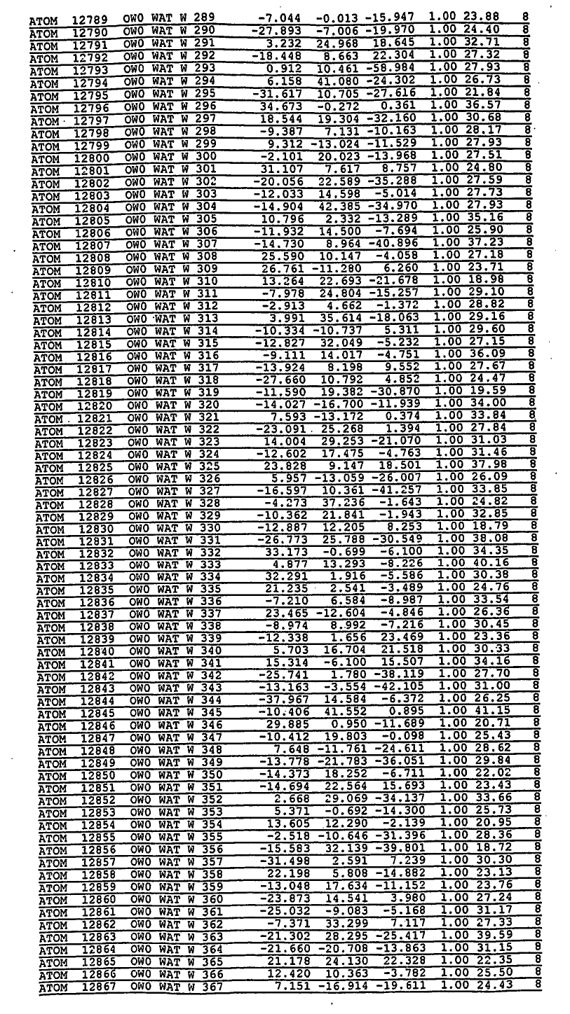

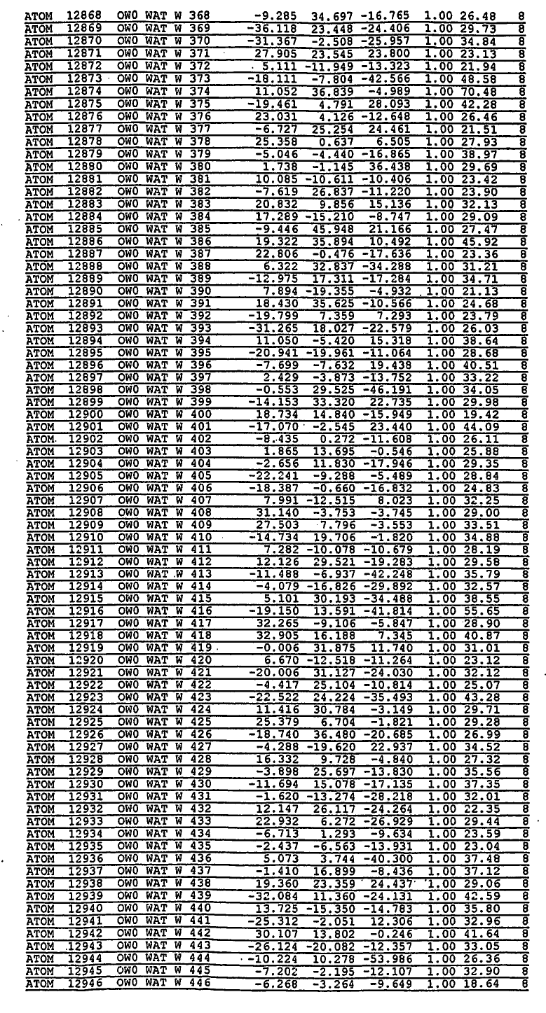

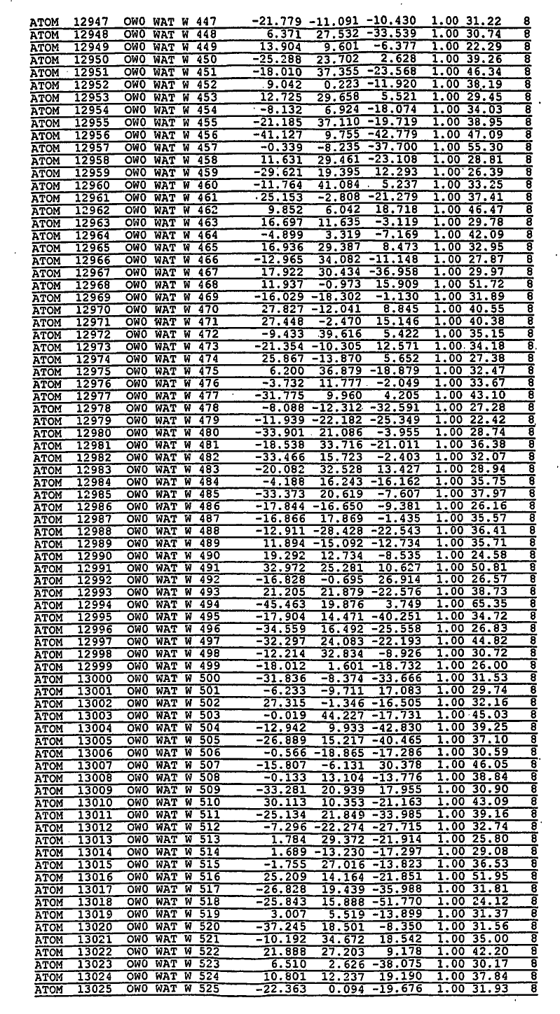

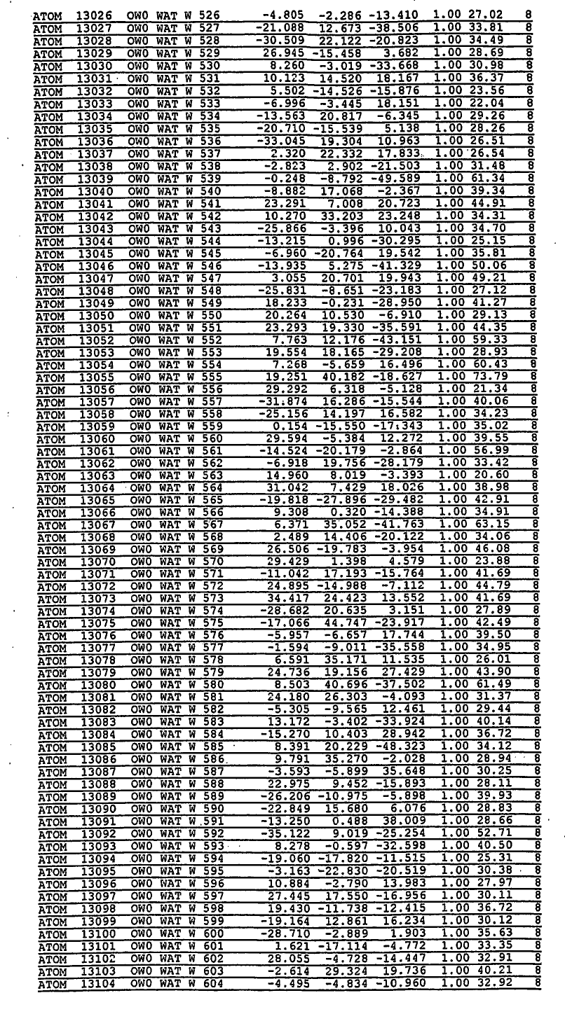

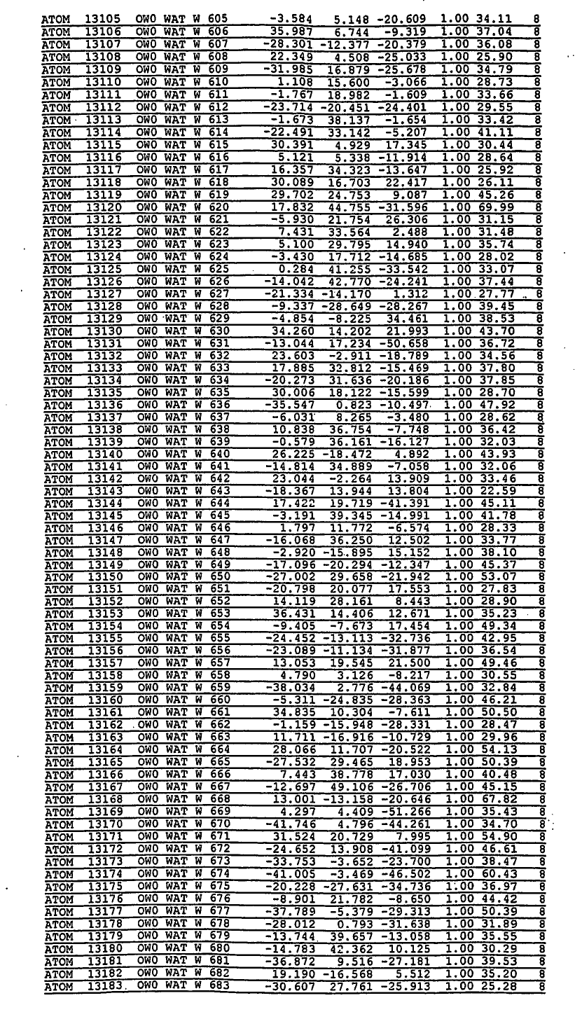

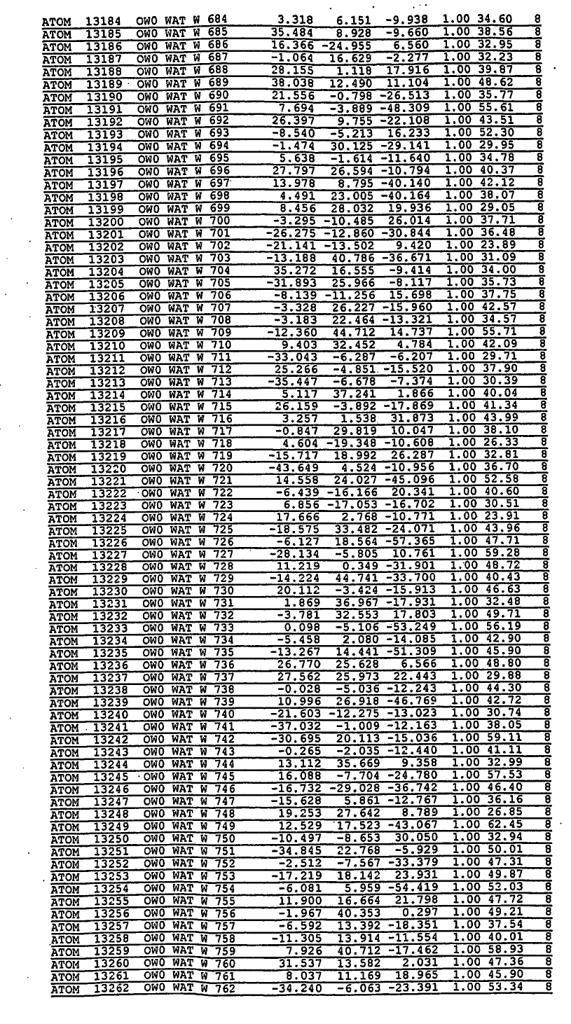

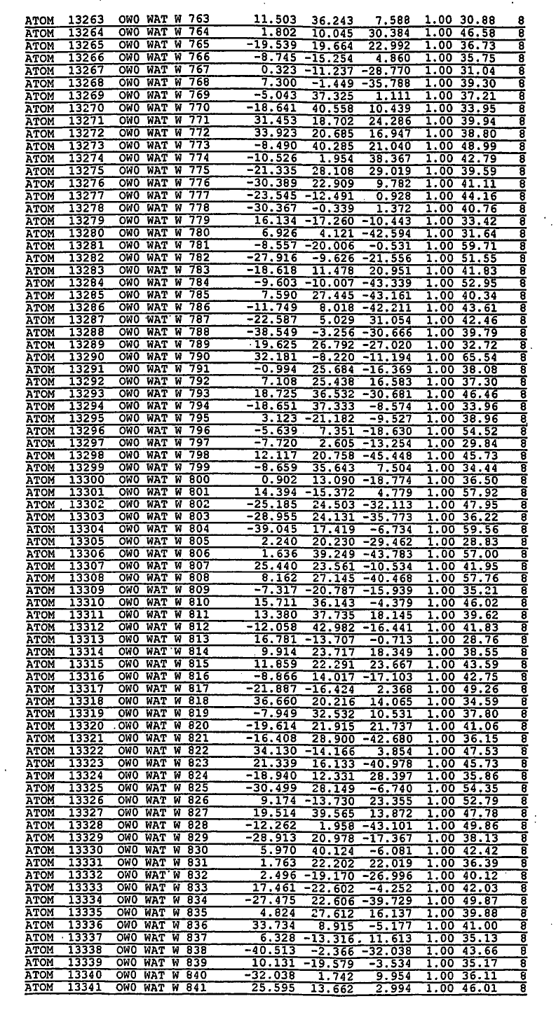

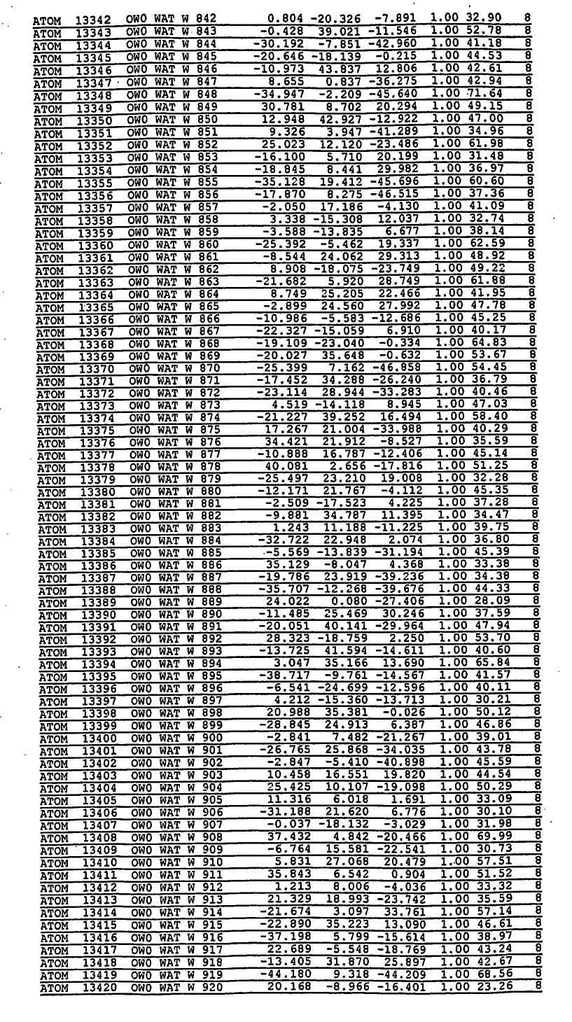

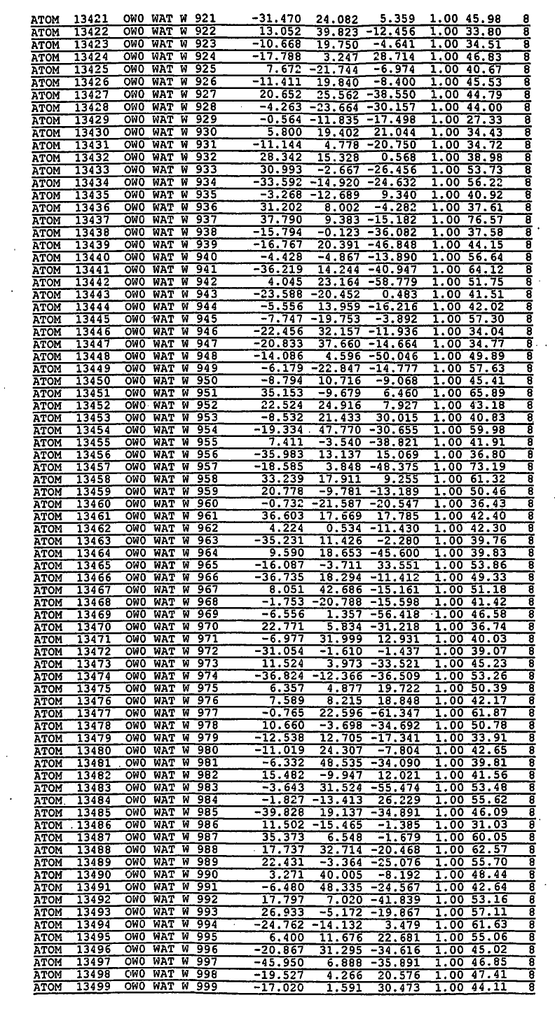

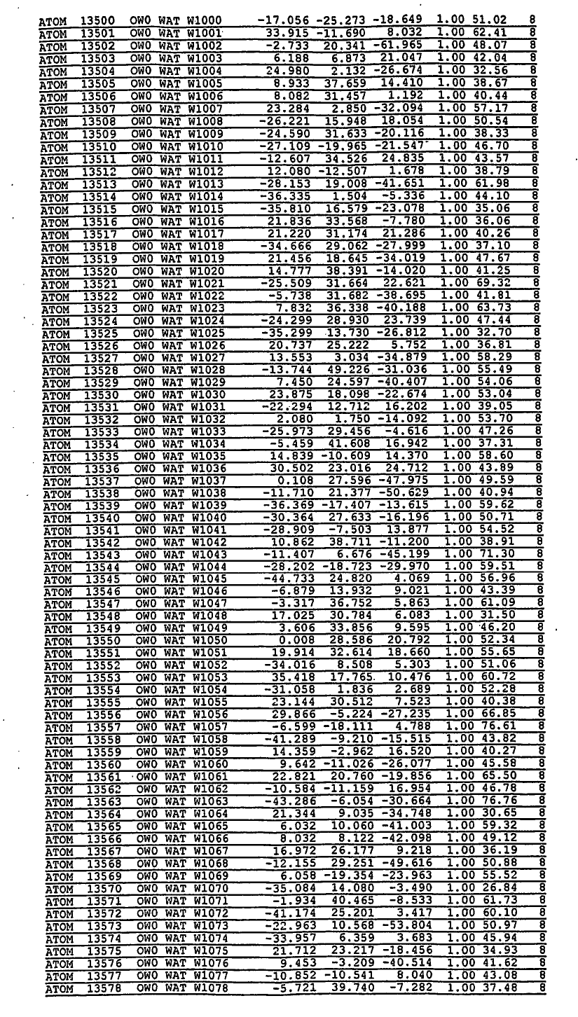

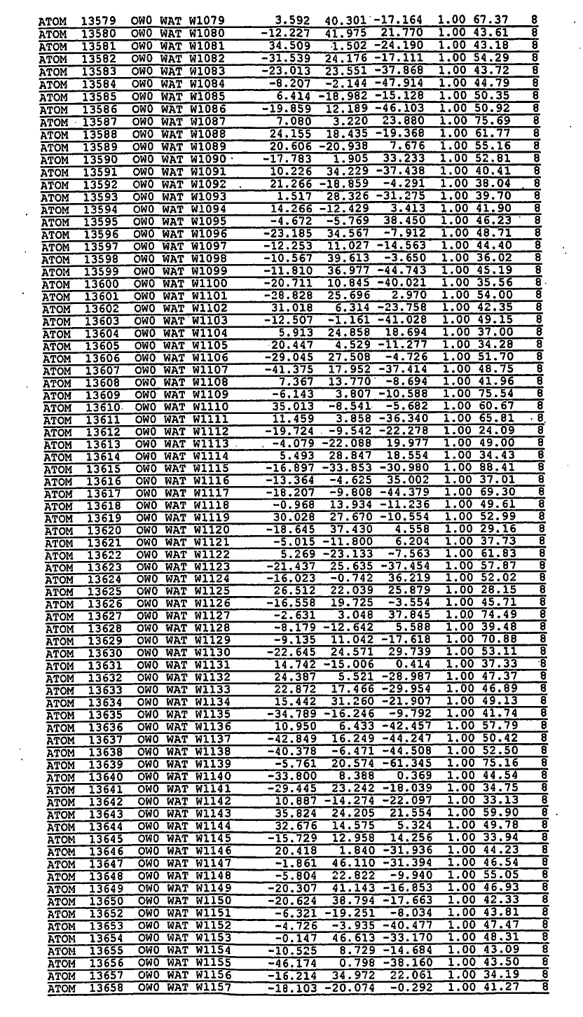

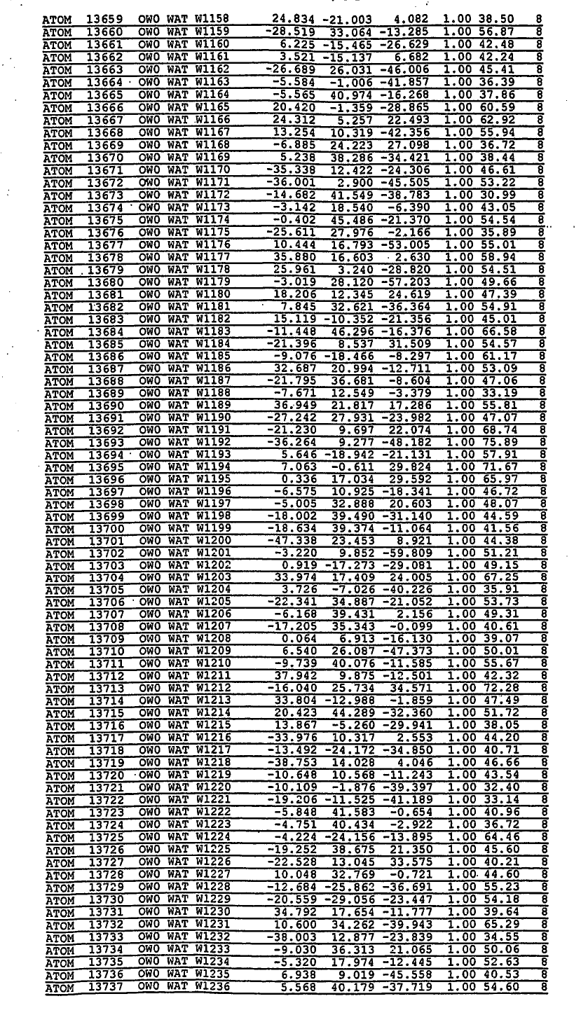

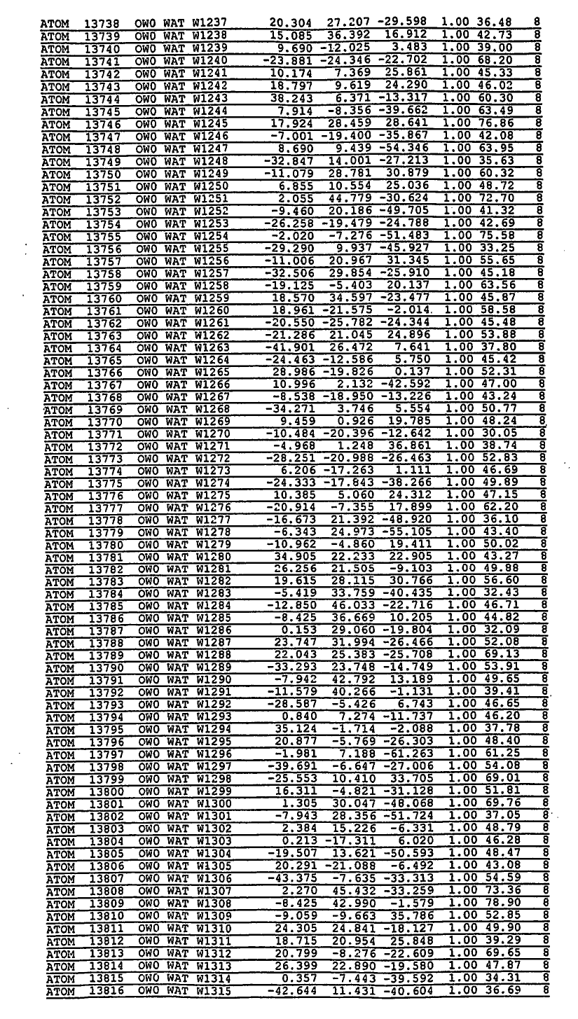

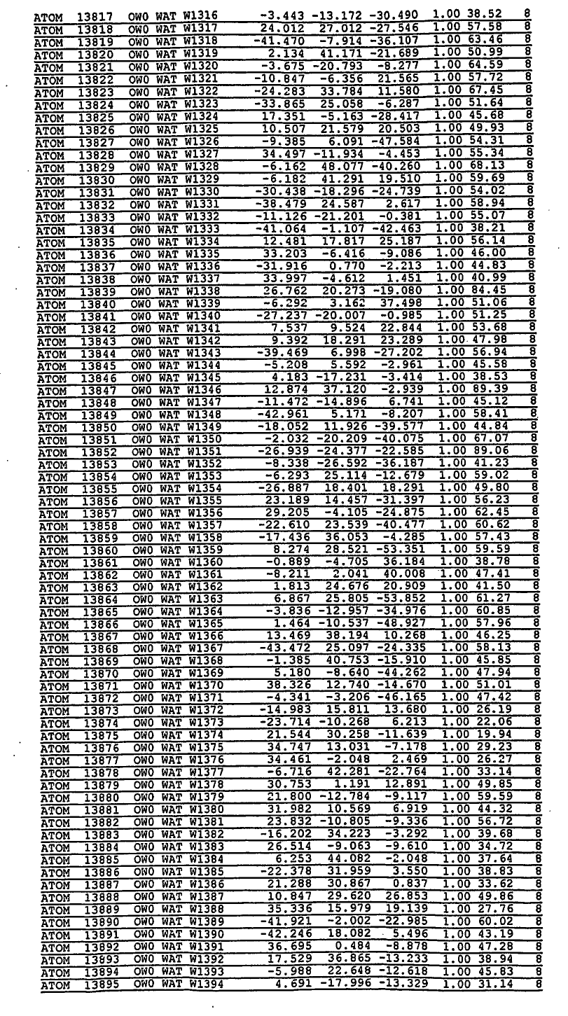

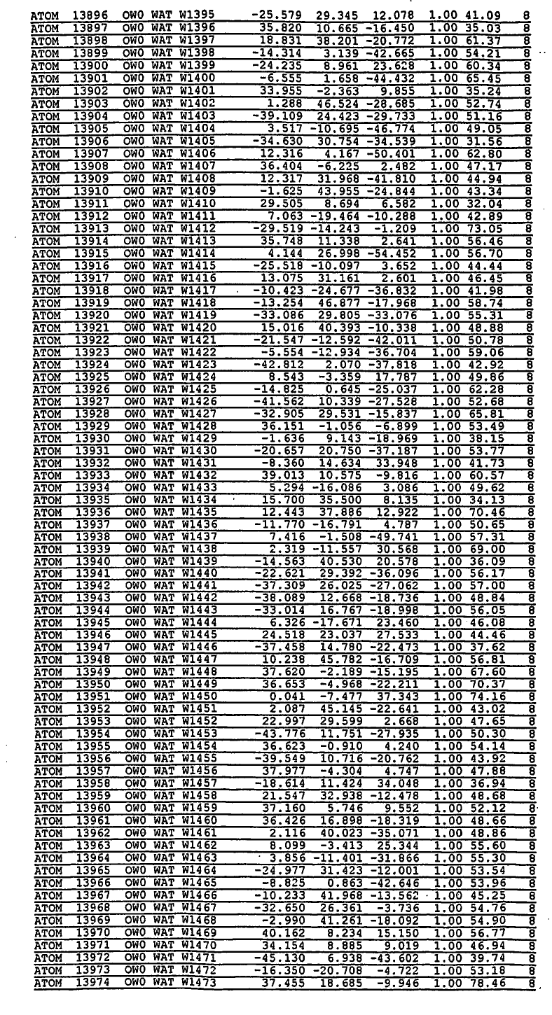

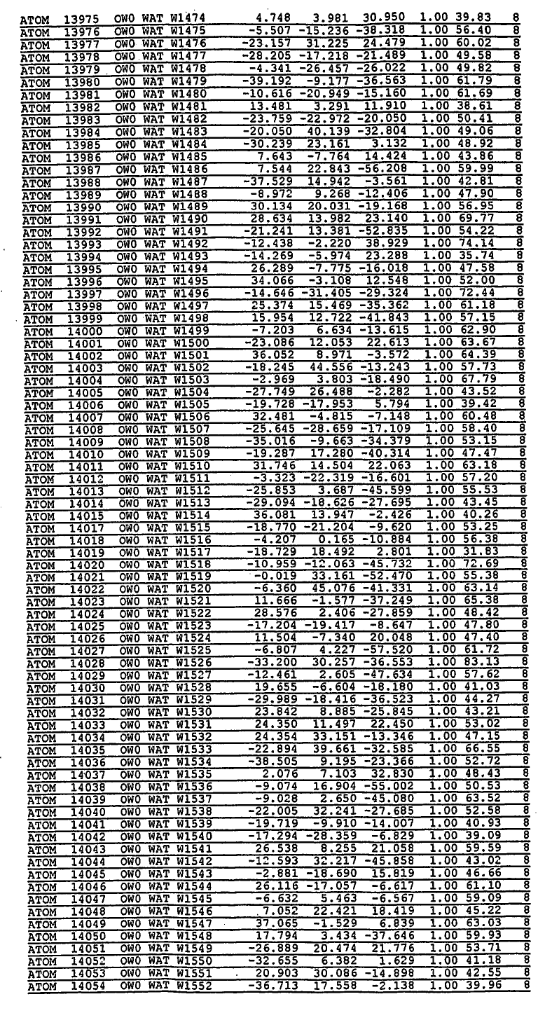

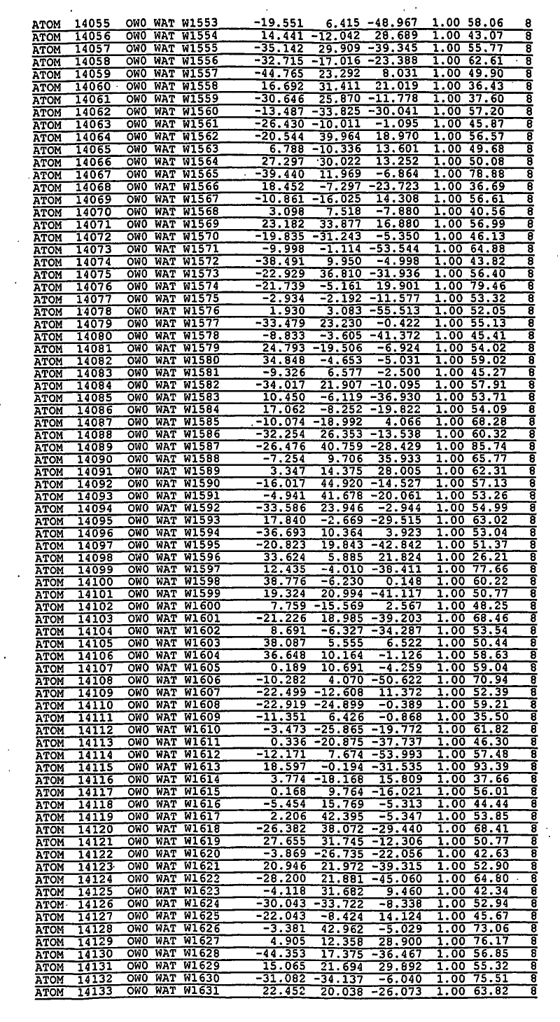

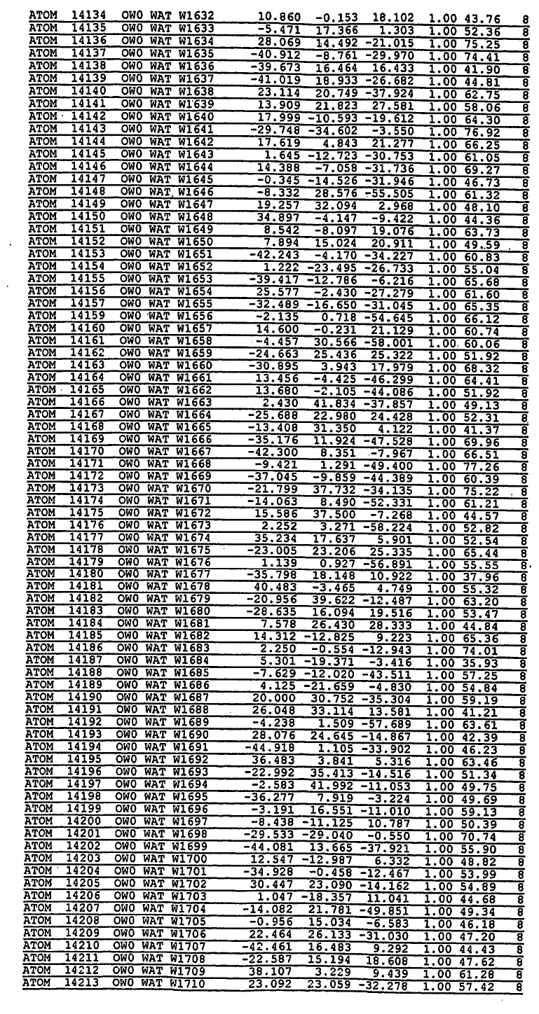

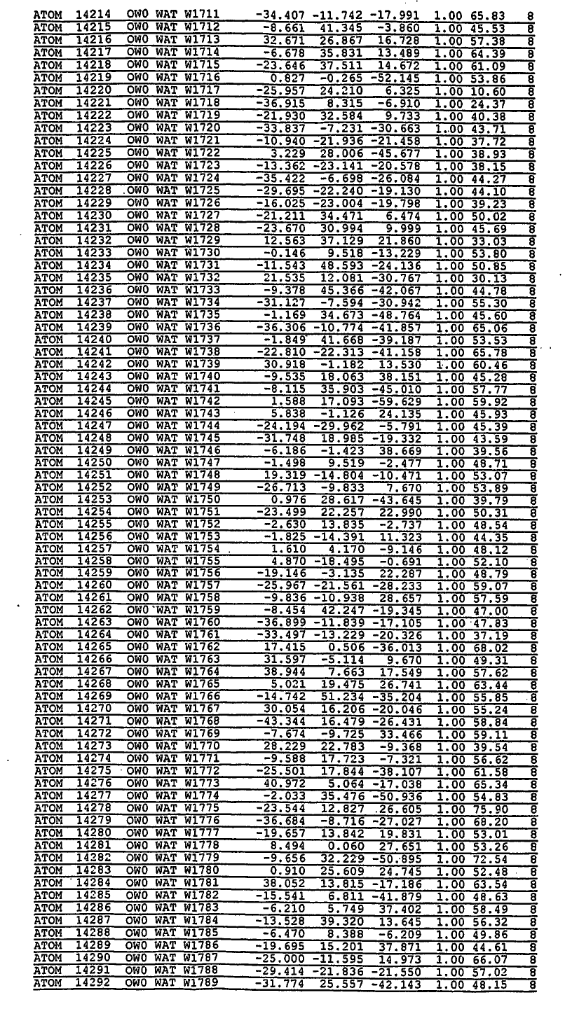

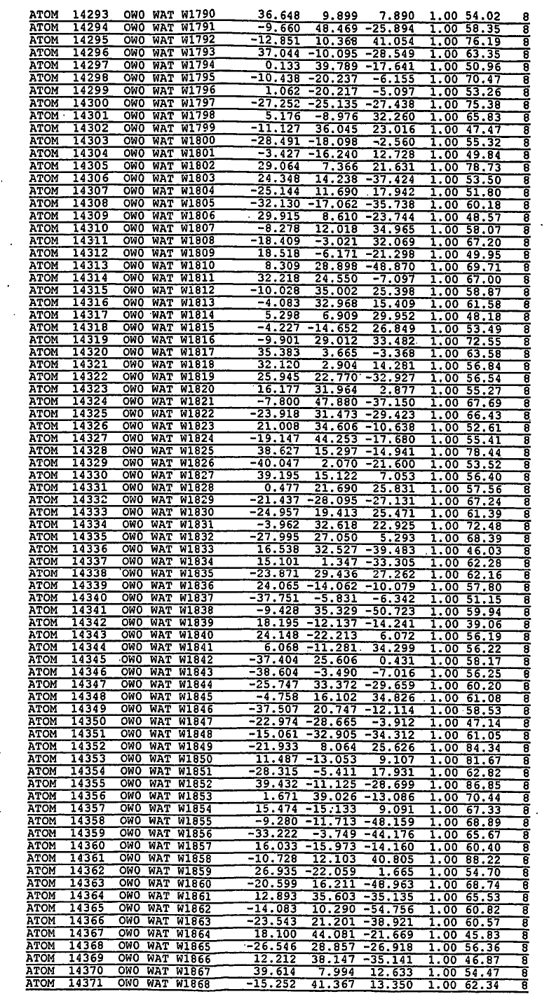

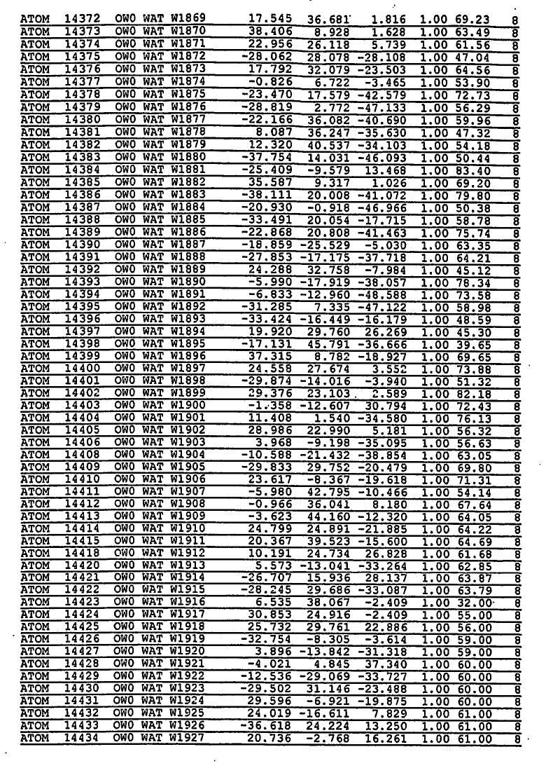

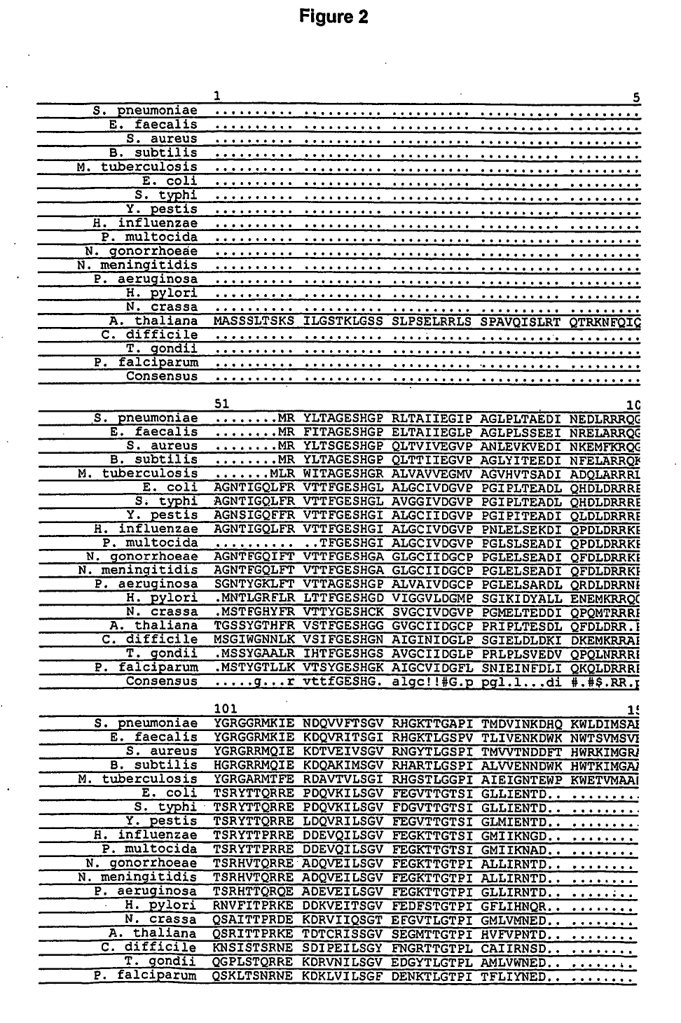

FIG. 2 shows a sequence alignment for CS from the following bacterial species: E. coli, S. typhi, Y. pestis, H. influenza, P. aeruginosa, N. meningiditis, N. gonorrhoeae, C. difficile, S. aureus, B. subtilis, S. pneumoniae, E. faecalis, M. tuberculosis, P. multocida, H. pylori. Sequences from fungi (N. crassa), plant (A. thaliana) and apicomplexan parasites (P. falciparum, T. gondii) are also included for comparison. The residues which comprise the FMN and EPSP-binding sites, as listed above, are highlighted. Of these, Ser 9, His 10, Arg 39, Arg 45, Asp 54, Asp 80, Arg 107, Gly 109, His 110, Ala 111, Ser 131, Ser 132, Ala 133, Arg 134, Thr 136, Asp 240, Ile 250, Asn 251, Ala 252, Lys 254, Gly 296, Gly 297, Lys 311, Thr 315, Arg 337, Asp 339, Ala 346, Val 349 are either completely conserved or are very highly conserved and only conservative mutations occur across the sequences of bacterial pathogens, fungi plants and apicomplexan parasites. In addition, residues at positions Met 49, Thr 137, Phe 253, Phe 294, Met 310, Ala 242, are well conserved in terms of size and hydrophobicity across the same range of species. The residues which are involved in hydrogen-bonding or salt-bridge interactions with FMN (these comprise His 110, Lys 311) or either of EPSP or the inhibitors CMIP, CMSPD, CPCD and BSACB (these comprise Ser 9, His 10, Arg 39, Arg 45, Arg 107, His 110, Ser 132, Arg 134 and Arg 337) are totally conserved across all of the species listed above, with the exception of Arg 45, which is completely conserved in gram-positive, bacteria, but less conserved in other species. However, residue 345, which is Ala in gram-positive bacteria but is a completely conserved Arginine in all other species, is perfectly placed to interact with EPSP or inhibitor when Arg 45 is not present. When Arginine is modeled at position 345, the guanidinium group is within 1 Å of the guanidinium group of Arg 45. Therefore each of the residues required for essential hydrogen-bonded or salt-bridge interactions between CS and ligand or inhibitor is present in bacterial, fungal, plant and parasite species.

1. A computer programmed to produce a three-dimensional representation of a molecule or molecular complex, wherein the molecule or molecular complex comprises a binding domain defined by structure coordinates selected from the group consisting of (a) Arg 39, His 110, Ser 132, Thr 136, Lys 254, Gly. 297, Lys 311, Thr 315, Arg337 and Asp339 according to FIG. 1; (b) Ser 9, His 10, Arg39, Asp 54, Arg 107, His 110, Ser132, Ala133, Arg 134, Thr136, Arg 337 and Asp 339 according to FIG. 1, and (c) a molecular complex or binding domain with a root mean square deviation of conserved residue backbone atoms of less than 2 A when superimposed on the relevant backbone atoms described by the structure coordinates of said amino acids.

2. A computer programmed according to claim 1, wherein (a) further comprises the structure coordinates of (i) Arg 45, Gly109, Ala111, Ser131, Ala 133, Lys238, Asp 240, lie 250, Asn251, Ala 252, Phe 253, Phe 294, Gly 296, Met310, Ile 313, Pro 314, Ala 342, Ala 345, Ala 346 and Val 349 according to FIG. 1; and (b) further comprises the structure coordinates of (ii) Arg 45, Met 49, Asp 80, Ser 131, and Thr 137 according to FIG. 1, or where the molecular complex or binding domain has a root mean square deviation of conserved residue backbone atoms of less than 2 A when superimposed on the relevant backbone atoms described by the structure coordinates of said amino acids, or where the molecular complex or binding domain has conservative amino acid substitutions for those amino acids specified in (i) or (ii).

3. A computer programmed according to claims 1 or 2, wherein (a) further comprises the structure coordinates of Ser 338 according to FIG. 1, and (b) further comprises the structure coordinates of Arg 48, Glu 336 and Ser 338 according to FIG. 1.

4. A computer according to any of claims 1 to 3, wherein the molecule is Chorismate Synthase.

5. A computer according to any of claims 1 to 4, wherein the molecule is Chorismate Synthase from S. pneumoniae.

6. A method for identifying the potential of a chemical entity to associate with a Chorismate Synthase enzyme, comprising the steps of: (a) applying computational means to perform a fitting operation between the chemical entity and the Chorismate Synthase binding domain defined by the structure coordinates defined in any of claims 1 to 3; and (b) analysing the results of the fitting operation to quantify the association.

7. A method according to claim 6, wherein the computational means is provided by a computer as defined in any of claims 1 to 5.

8. A method for identifying a potential inhibitor or agent that interacts with a Chorismate Synthase binding domain, comprising the steps of: (a) using the atomic coordinates defined in any of claims 1 to 3 to generate a three-dimensional structure of a molecule comprising a Chorismate Synthase binding domain; (b) employing the three-dimensional structure to design or select the inhibitor or agent; (c) synthesising the inhibitor or agent; and (d) contacting the inhibitor or agent with the Chorismate Synthase binding domain to determine the ability of the inhibitor or agent to interact with the domain.

9. A crystal of the binding domain of Chorismate Synthase, wherein the binding domain has a three-dimensional structure characterised by the atomic structure coordinates of FIG. 1.


SEQUENCE LISTING (19 sequences)

SEQ ID NO: 1 - protein, 359 aa, Escherichia coli
AGNTIGQLFRVTTFGESHGLALGCIVDGVPPGIPLTQADLQHDLDRRRPGTRYTTQRREPDQVKILSGVFEGVTTGTSIGLLIENTDQRSQDYSAIKDVFRPGHADYTYEQKYGLRDYRGGGRSSARETAMRVAAGAIAKKYLAEKFGIEIRGCLTQMGDIPLDIKDWSQVEQNPFFCPDPDKIDALDELMRALKKEGDSIGAKVTVVASGVPAGLGEPVFDRLDADIAHALMSINAVKGVEIGDGFDVVALRGSQNRDEITKDGFQSNHAGGILGGISSGQQIIAHMALKPTSSITVPGRTINRFGEEVEMITKGRHDPCVGIRAVPIAEAMLAIVLMDHLLRQRAQNADVKTDIPRW

SEQ ID NO: 2 - protein, 388 aa, Streptococcus pneumoniae
MRYLTAGESHGPRLTAIIEGIPAGLPLTAEDINEDLRRRQGGYGRGGRMKIENDQVVFTSGVRHGKTTGAPITMDVINKDHQKWLDIMSAEDIEDRLKSKRKITHPRPGHADLVGGIKYRFDDLRNSLERSSARETTMRVAVGAVAKRLLAELDMEIANHVVVFGGKEIDVPENLTVAEIKQRAAQSEVSIVNQEREQEIKDYIDQIKRDGDTIGGVVETVVGGVPVGLGSYVQWDRKLDARLAQAVVSINAFKGVEFGLGFEAGYRKGSQVMDEILWSKEDGYTRRTNNLGGFEGGMTNGQPIVVRGVMKPIPTLYKPLMSVDIETHEPYKATVERSDPTALPAAGMVMEAVVATVLAQEILEKFSSDNLEELKEAVAKHRDYTKNY

SEQ ID NO: 3 - protein, 388 aa, Enterococcus faecalis
MRFITAGESHGPELTAIIEGLPAGLPLSSEEINRELARRQGGYGRGGRMKIEKDQVRITSGIRHGKTLGSPVTLIVENKDWKNWTSVMSVEPVPEKQKKIRRVSKPRPGHADLVGGMKYQHDDLRNVLERSSARETTMRVAIGAVAKKLLAELDIQVAGHVAVLGGIEATIPENLTIREIQERSEQSAVRVLDPSVEEKMKELIDQTKKNGDTIGGVVEVLVGGVPAGLGSYVQWDRKLDAKIAQAVVSINAFTGAEFGIGFEMAQRIGSQLMDEIVWDESTGYTRTSNNLGGFEGGMTNGMPIIVRGVMKPIPTLYKPLQSVNIDTKEPYKASVERSDSTAVPAASVVCEAVVATEVAKAMLEKFDSDSFEQMKEAVKRYRLYTQNF

SEQ ID NO: 4 - protein, 388 aa, Staphylococcus aureus
MRYLTSGESHGPQLTVIVEGVPANLEVKVEDINKEMFKRQGGYGRGRRMQIEKDTVEIVSGVRNGYTLGSPITMVVTNDDFTHWRKIMGRAPISDEERENMKRTITKPRPGHADLLGGMKYNHRDLRNVLERSSARETAARVAVGALCKVLLEQLDIEIYSRVVEIGGIKDKDFYDSETFKANLDRNDVRVIDDGIAQAMRDKIDEAKTDGDSIGGVVQVVVENMPVGVGSYVHYDRKLDGRIAQGVVSINAFKGVSFGEGFKAAEKPGSEIQDEILYNTELGYYRGSNHLGGLEGGMSNGMPIIVNGVMKPIPTLYKPLNSVDINTKEDFKATIERSDSCAVPAASIVCEHVVAFAIAKALLEEFQSNHIEQLKQQIIERRQLNVEF

SEQ ID NO: 5 - protein, 368 aa, Bacillus subtilis
MRYLTAGESHGPQLTTIIEGVPAGLYITEEDINFELARRQKGHGRGRRMQIEKDQAKIMSGVRHARTLGSPIALVVENNDWKHWTKIMGAAPITEDEEKEMKRQISRPRPGHADLNGAIKYNHRDMRNVLERSSARETTVRVAAGAVAKKILSELGIKVAGHVLQIGAVKAEKTGYTSIEDLQRVTEESPVRCYDEEAGKKMMAAIDEAKANGDSIGGIVEVIVEGMPVGVGSYVHYDRKLDSKLAAAVLSINAFKGVEFGIGFEAAGRNGSEVHDEIIWDEEKGYTRATNRLGGLEGGMTTGMPIVVRGVMKPIPTLYKPLKSVDIETKEPFSASIERSDSCAVPAASVVAEALSLGKLQPSLNNSD

SEQ ID NO: 6 - protein, 527 aa, Plasmodium falciparum
MSTYGTLLKVTSYGESHGKAIGCVIDGFLSNIEINFDLIQKQLDRRRPNQSKLTSNRNEKDKLVILSGFDENKTLGTPITFLIYNEDIKKEDYNSFINIPRPGHGDYTYFMKYHVKNKSGSSRFSGRETATRVAAGACIEQWLYKSYNCSIVSYVHSVGNIKIPEQVSKELENKNPPSRDLVDSYGTVRYNEKEKIFMDCFNRIYDMNASMLKTDEYNKNTLTIPSIDNTYINVKTNECNINQVDNNHNNYINDKDNTFNNSEKSDEWIYLQTRCPHPYTAVQICSYILKLKNKGDSVGGIATCIIQNPPIGIGEPIFDKLEAELAKMILSIPPVKGIEFGSGFNGTYMFGSMHNDIFIPVENMSTKKESDLLYDDKGECKNMSYHSTIQNNEDQILNSTKGFMPPKNDKNFNNIDDYNVTFNNNEEKLLITKTNNCGGILAGISTGNNIVFRSAIKPVSSIQIEKETSDFYGNMCNLKVQGRHDSCILPRLPPIIEASSSMVIGDLILRQISKYGDKKLPTLFRNM

SEQ ID NO: 7 - protein, 401 aa, Mycobacterium tuberculosis
MLRWITAGESHGRALVAVVEGMVAGVHVTSADIADQLARRRLGYGRGARMTFERDAVTVLSGIRHGSTLGGPIAIEIGNTEWPKWETVMAADPVDPAELADVARNAPLTRPRPGHADYAGMLKYGFDDARPVLERASARETAARVAAGTVARAFLRQALGVEVLSHVISIGASAPYEGPPPRAEDLPAIDASPVRAYDKAAEADMIAQIEAAKKDGDTLGGVVEAVALGLPVGLGSFTSGDHRLDSQLAAAVMGIQAIKGVEIGDGFQTARRRGSRAHDEMYPGPDGVVRSTNRAGGLEGGMTNGQPLRVRAAMKPISTVPRALATVDLATGDEAVAIHQRSDVCAVPAAGVVVETMVALVLARAALEKFGGDSLAETQRNIAAYQRSVADREAPAARVSG

SEQ ID NO: 8 - protein, 360 aa, Salmonella enterica
AGNTIGQLFRVTTFGESHGLAVGGIVDGVPPGIPLTEADLQHDLDRRRPGTSRYTTQRREPDQVKILSGVFDGVTTGTSIGLLIENTDQRSQDYSAIKDVFRPGHADYTYEQKYGLRDYRGGGRSSARETAMRVAAGAIAKKYLAEKFGIEIRGCLTQMGDIPLEIKDWRQVELNPFFCPDADKLDALDELMRALKKEGDSIGAKVTVMASGVPAGLGEPVFDRLDADIAHALMSINAVKGVEIGEGFNVVALRGSQNRDEITAQGFQSNHAGGILGGISSGQHIVAHMALKPTSSITVPGRTINRMGEEVEMITKGRHDPCVGIRAVPIAEAMLAIVLMDHLLRHRAQNADVKTEIPRW

SEQ ID NO: 9 - protein, 360 aa, yersinia pestis
AGNSIGQFFRVTTFGESHGIALGCIIDGVPPGIPITEADIQLDLDRRRPGTSRYTTQRRELDQVRILSGVFEGVTTGTSIGLMIENTDQRSQDYSAIKDVFRPGHADYTYEQKYGVRDYRGGGRSSARETAMRVAAGAIAKKYLAQKFGVQVRGYLAQMGDVSCDLLDWDLVEQNPFFCPDASKLEPLDALMRELKKAGDSIGAKITVVAENVPVGLGEPVFDRLDADLAHALMSINAVKGVEIGDGFAVVTKRGSENRDEITPQGFQSNHAGGILGGISSGQPVVAHIALKPTSSIMVPGQTINRQGEAVEMVTRGRHDPCVGIRAVPIAEAMMAIVLMDHLLRQRAQCGDVASDVPRW

SEQ ID NO: 10 - protein, 356 aa, Haemophilus influenzae
AGNTIGQLFRVTTFGESHGIALGCIVDGVPPNLELSEKDIQPDLDRRKPGTSRYTTPRREDDEVQILSGVFEGKTTGTSIGMIIKNGDQRSQDYGDIKDRFRPGHADFTYQQKYGIRDYRGGGRSSARETAMRVAAGAIAKKYLREHFGIEVRGFLSQIGNIKIAPQKVGQIDWEKVNSNPFFCPDESAVEKFDELIRELKKEGDSIGAKLTVIAENVPVGLGEPVFDRLDADLAHALMGINAVKGVEIGDGFAVVEQRGSEHRDEMTPNGFESNHAGGILGGISSGQPIIATIALKPTSSITIPGRSINLNGEAVEVVTKGRHDPCVGIRAVPIAEAMVAIVLLDHLLRFKAQCK

SEQ ID NO: 11 - protein, 343 aa, Pasteurella multocida
TFGESHGIALGCIVDGVPPGLSLSEADIQPDLDRRKPGTSRYTTPRREDDEVQILSGVFEGKTTGTSIGMIIKNADQRSQDYGDIKDRFRPGHADFTYQQKYGIRDYRGGGRSSARETAMRVAAGAIAKKYLREHFGVEVRGFLAQIGDVAIAPQVIEQIDWQQVNSNPFFCPDPSAVEKFDELIRQLKKEGDSIGAKLTVVAENVPVGLGEPVFDRLDADLAHALMGINAVKAVEIGDGFAVVNQRGSAHRDEMTPEGFLSNHAGGILGGISSGQPIVATIALKPTSSITIPGRSVNLANEPVEVITKGRHDPCVGIRAVPIAEAMVAIVLLDHLLRHKAQN

SEQ ID NO: 12 - protein, 358 aa, Neisseria gonorrhoeae
AGNTFGQIFTVTTFGESHGAGLGCIIDGCPPGLELSEADIQFDLDRRKPGTSRHVTQRREADQVEILSGVFEGKTTGTPIALLIRNTDQRSEDYGDIATAFRPGHADYTYWHKYGTRDYRGGGRSSARETAARVAAGAVAKKWLKEKFGTEITAYVTQVGEKKIRFEGSEHISQNPFFAANQSQIAELEHYMDGVRKSLDSVGAKLHIEAANVPVGLGEPVFDRLDAEIAYAMMGINAVKGVEIGAGFDSVTQRGSEHGDELTPQGFLSNHSGGILGGISTGQDICVNIAIKPTSSIATPRRSIDIHGNPVELATRGRHDPCVGLRTAPIAEAMLALVLIDHALRHRAQNADVAADTP

SEQ ID NO: 13 - protein, 358 aa, Neisseria meningitidis
AGNTFGQLFTVTTFGESHGAGLGCIIDGCPPGLELSEADIQFDLDRRKPGTSRHVTQRREADQVEILSGVFEGKTTGTPIALLIRNTDQRSKDYGNIATSFRPGHADYTYWHKYGTRDYRGGGRSSARETAARVAAGAVAKKWLKEKFGTEITAYVTQVGEKEIRFEGCEHISQNPFFAANHSQIAELENYMDSVRKSLDSVGAKLHIEAANVPVGLGEPVFDRLDAEIAYAMMGINAVKGVEIGAGFDSVTQRGSEHGDELTPQGFLSNHSGGILGGISTGQDIHVNIAIKPTSSIATPRRSIDINGNPIELATHGRHDPCVGLRAAPIAEAMLALVLIDHALRHRAQNADVQVNTP

SEQ ID NO: 14 - protein, 357 aa, Pseudomonas aeruginosa
SGNTYGKLFTVTTAGESHGPALVAIVDGCPPGLELSARDLQRDLDRRNPGTSRHTTQRQEADEVEILSGVFEGKTTGTPIGLLIRNTDQKSKDYSAIKDLFRPAHADYTYHHKYGVRDYRGGGRSSARETAMRVAAGAIAKKYLAGLGIQVRGYMSQLGPIEIPFRSWDSVEQNAFFSPDPDKVPELEAYMDQLRRDQDSVGAKITVVAECVPPGLGEPIFDRLDAELAHALMSINAVKGVEIGAPFASIAQRGTEHRDELTPQGFLSNNAGGILGGISSGQPIVAHLALKPTSSITTPGRSIDTAGEPVDMITKGRHDPCVGIRATPIAEAMMAIVLLDQLVRQRGQNADVRVDTP

SEQ ID NO: 15 - protein, 361 aa, Helicobacter pylori
MNTLGRFLRLTTFGESHGDMIGGVLDGMPSGIKIDYDLLENEMKRRQGGRNPRKEDDKVEITSGVFEDFSTGTPIGFLIHNQRARSKDYDNIKNLFRPSHADFTYFHKYGIRDFRGGGRSSARESAIRVAAGAFAKMLLREIGIVCESGIIEIGGIKAKNYDFNHALKSEIFALDEEQEEAQKTAIQNAIKNHDSIGGVALIRARSIKTNQKLPIGLGQGLYAKLDAKIAEAMMGLNGVKAVEIGKGVESSLLKGSEYNDLMDQKGFLSNRSGGVLGGMSNGEEIIVKVHFKPTPSIFQPQRTIDINGNECECLLKGRHDPCIAIRGSVVCESLLALVLADMVLLNLTSKIEYLKTIYNEN

SEQ ID NO: 16 - protein, 432 aa, Neurospora crassa
MSTFGHYFRVTTYGESHCKSVGCIVDGVPPGMELTEDDIQPQMTRRRPGQSAITTPRDEKDRVIIQSGTEFGVTLGTPIGMLVMNEDQPPKDYGNKTMDIYPRPSHADWTYLEKYGVKASSGGGRSSARETIGRVAAGAIAEKYLKPRYGVEIVAFVSSVGSEHLFPPTAEHPSPSTNPEFLKLVNSITRETVDSFLPVRCPDAEANKRMEDLITKFRDNHDSIGGTVTCVIRNVPSGLGEPAFDKLEAMLAHAMLSIPATKGFEVGSGFGGCEVPGSIHNDPFVSAENTEIPPSVAASGAARNGIPRPKLTTKTNFSGGIQGGISNGAPIYFRVGFKPAATIGQEQTTATYDGTSEGVLAAKGRHDPSVVPRAVPIVEAMAALVIMDAVLAHEARVTAKSLLPPLKQTINSGKDTVGNGVSENVQESDLAQ

SEQ ID NO: 17 - protein, 435 aa, Arabidopsis thaliana
MASSSLTSKSILGSTKLGSSSLPSELRRLSSPAVQISLRTQTRKNFQIQATGSSYGTHFRVSTFGESHGGGVGCIIDGCPPRIPLTESDLQFDLDRRPGQSRITTPRKETDTCRISSGVSEGMTTGTPIHVFVPNTDQRGLDYSEMSVAYRPSHADATYDMKYGVRSVQGGGRSSARETIGRVAPGALAKKILKQFAGTEILAYVSQVHHVVLPEELVDHENLTLEQIENNIVRCPNPEYAEKMIAAIDAVRTKGNSVGGVVTCIVRNAPRGLGTPVFDKLEAELAKACMSLPATKGFEFGSGFAGTFLTGLEHNDEFYTDENGRIRTRTNRSGGIQGGISNGEIINMRVAFKPTSTIGRKQNTVTRDKVETEMIARGRHDPCVVPRAVPMVEAMVALVLVDQLMAQYAQCHLFPINPELQEPLQIEQPQNATAL

SEQ ID NO: 18 - protein, 359 aa, Clostridium difficile
MSGIWGNNLKVSIFGESHGNAIGINIDGLPSGIELDLDKIDKEMKRRAPGKNSISTSRNESDIPEILSGYFNGRTTGTPLCAIIRNSDTRSKDYGELKNLMRPGHADFTGNVRYSGFNDYRGGGHFSGRITAPLVFCGAICKQILSQKGIEIGAHIKKIKNIEDMSFDYVNISKQQLSNLQTLELPLLDLSKEEAMKNTIIDAKNQGDSVGGIIECAVVGINVGLGNPFFDSVESTLSHLLFSVPAVKGVEFGLGFELADMYGSQSNDEMYYEGNQVKSKTNNNGGIIGGITTGMPIIFKVAIKPTPSISRQQNTVNIKDKKDDILYIKGRHDPCIVQRAIPVIEAVTAIGIFDLMKGR

SEQ ID NO: 19 - protein, 536 aa, Toxoplasma gondii
MSSYGAALRIHTFGESHGSAVGCIIDGLPPRLPLSVEDVQPQLNRRRPGQGPLSTQRREKDRVNILSGVEDGYTLGTPLAMLVWNEDRRPQEYHALATVPRPGHGDFTYHAKYHIHAKSGGGRSSARETLARVAAGAVVEKWLGMHYGTSFTAWVCQVGDVSVPRSLRRKWERQPPTRQDVDRLGVVRVSPDGTTFLDANNRLYDERGEELVEEEDKARRRLLFGVDNPTPGETVIETRCPCPSTAVRMAVKINQTRSLGDSIGGCISGAIVRPPLGLGEPCFDKVEAELAKAMMSLPATKGFEIGQGFASVTLRGSEHNDRFIPFERASCSFSESAASTIKHERDGCSAATLSRERASDGRTTSRHEEEVERGRERIQRDTLHVTGVDQQNGNSEDSVRYTSKSEASITRLSGNAASGGAPVCRIPLGEGVRIRCGSNNAGGTLAGITSGENIFFRVAFKPVSSIGLEQETADFAGEMNQLAVKGRHDPCVLPRAPPLVESMAALVIGDLCLRQRAREGPHPLLVLPQHSGCPSC